(19) United States
(12) Patent Application Publication
(10) Pub. No.: US 2024/0370093 A1
(43) Pub. Date: Nov. 7, 2024

(54) USER INTERFACES FOR GESTURES

(71) Applicant: Apple Inc., Cupertino, CA (US)

(72) Inventors: Yiqiang NIE, San Francisco, CA (US); Giovanni M. AGNOLI, San Mateo, CA (US); Gary I. BUTCHER, Los Gatos, CA (US); Edward CHAO, Palo Alto, CA (US); David S. CLARK, Corona Del Mar, CA (US); Dylan R. EDWARDS, San Jose, CA (US); Adam J. LEONARD, San Francisco, CA (US)

(21) Appl. No.: 18/499,970

(22) Filed: Nov. 1, 2023

Related U.S. Application Data
(60) Provisional application No. 63/542,057, filed on Oct. 2, 2023.
(60) Provisional application No. 63/540,919, filed on Sep. 27, 2023.
(60) Provisional application No. 63/537,807, filed on Sep. 11, 2023.
(60) Provisional application No. 63/470,750, filed on Jun. 2, 2023.
(60) Provisional application No. 63/464,494, filed on May 5, 2023.

(51) Int. Cl. G06F 3/01; G06F 3/0482

(52) U.S. Cl. CPC G06F 3/017; G06F 3/014; G06F 3/0482

(57) ABSTRACT

A computer system detects an input and performs an operation based on the input. In some embodiments, the input is a touch input. In some embodiments, the input is a button press. In some embodiments, the input is a motion gesture. In some embodiments, the input is an air gesture.

### CROSS-REFERENCE TO RELATED APPLICATIONS

This application claims priority to U.S. Patent Application Ser. No. 63/542,057, entitled “USER INTERFACES FOR GESTURES,” filed Oct. 2, 2023, and U.S. Provisional Patent Application Ser. No. 63/464,494, entitled “USER INTERFACES FOR GESTURES,” filed May 5, 2023, and U.S. Provisional Patent Application Ser. No. 63/470,750, entitled “USER INTERFACES FOR GESTURES,” filed Jun. 2, 2023, and U.S. Provisional Patent Application Ser. No. 63/537,807, entitled “USER INTERFACES FOR GESTURES,” filed Sep. 11, 2023, and U.S. Provisional Patent Application Ser. No. 63/540,919, entitled “USER INTERFACES FOR GESTURES,” filed Sep. 27, 2023, the contents of which are hereby incorporated by reference in their entirety.

### FIELD

The present disclosure relates generally to computer user interfaces, and more specifically to techniques for performing operations based on detected gestures.

### BACKGROUND

Computer systems use input devices to detect user inputs. Based on the detected user inputs, computer systems perform operations and provide the user with feedback. By providing different user inputs, users can cause computer systems to perform various operations.

### BRIEF SUMMARY

Some techniques for performing operations based on detected gestures using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for performing operations based on detected gestures. Such methods and interfaces optionally complement or replace other methods for interacting with computer system. Such methods and interfaces reduce the cognitive burden on a user and produce a more efficient human-machine interface. For battery-operated computing devices, such methods and interfaces conserve power and increase the time between battery charges.

In some embodiments, a method is disclosed. The method comprises: at a computer system that is in communication with a display generation component and a plurality of input devices: displaying, via the display generation component, a user interface that includes a plurality of options that are selectable via a first type of input received via a first input device of the plurality of input devices; while displaying the user interface that includes the plurality of options, detecting, via a second input device of the plurality of input devices that is different from the first input device, a second type of input that is different from the first type of input; and in response to detecting the second type of input: in accordance with a determination that the second type of input includes movement in a first input direction, navigating through a subset of the plurality of options in a first navigation direction; and in accordance with a determination that the second type of input includes movement in a second input direction that is different from the first input direction, navigating through the subset of the plurality of options in a second navigation direction that is different from the first navigation direction.

In some embodiments, a non-transitory computer-readable storage medium is disclosed. The non-transitory computer-readable storage medium stores one or more programs configured to be executed by one or more processors of a computer system that is in communication with a display generation component and a plurality of input devices, the one or more programs including instructions for: displaying, via the display generation component, a user interface that includes a plurality of options that are selectable via a first type of input received via a first input device of the plurality of input devices; while displaying the user interface that includes the plurality of options, detecting, via a second input device of the plurality of input devices that is different from the first input device, a second type of input that is different from the first type of input; and in response to detecting the second type of input: in accordance with a determination that the second type of input includes movement in a first input direction, navigating through a subset of the plurality of options in a first navigation direction; and in accordance with a determination that the second type of input includes movement in a second input direction that is different from the first input direction, navigating through the subset of the plurality of options in a second navigation direction that is different from the first navigation direction.

In some embodiments, a transitory computer-readable storage medium is disclosed. The transitory computer-readable storage medium stores one or more programs configured to be executed by one or more processors of a computer system that is in communication with a display generation component and a plurality of input devices, the one or more programs including instructions for: displaying, via the display generation component, a user interface that includes a plurality of options that are selectable via a first type of input received via a first input device of the plurality of input devices; while displaying the user interface that includes the plurality of options, detecting, via a second input device of the plurality of input devices that is different from the first input device, a second type of input that is different from the first type of input; and in response to detecting the second type of input: in accordance with a determination that the second type of input includes movement in a first input direction, navigating through a subset of the plurality of options in a first navigation direction; and in accordance with a determination that the second type of input includes movement in a second input direction that is different from the first input direction, navigating through the subset of the plurality of options in a second navigation direction that is different from the first navigation direction.

In some embodiments, a computer system is disclosed. The computer system is configured to communicate with a display generation component and a plurality of input devices. The computer system comprises: one or more processors; and memory storing one or more programs configured to be executed by the one or more processors, the one or more programs including instructions for: displaying, via the display generation component, a user interface that includes a plurality of options that are selectable via a first type of input received via a first input device of the plurality of input devices; while displaying the user interface that includes the plurality of options, detecting, via a second input device of the plurality of input devices that is different from the first input device, a second type of input that is different from the first type of input; and in response to detecting the second type of input: in accordance with a determination that the second type of input includes movement in a first input direction, navigating through a subset of the plurality of options in a first navigation direction; and in accordance with a determination that the second type of input includes movement in a second input direction that is different from the first input direction, navigating through the subset of the plurality of options in a second navigation direction that is different from the first navigation direction.

In some embodiments, a computer system is disclosed. The computer system is configured to communicate with a display generation component and a plurality of input devices. The computer system comprises: means for displaying, via the display generation component, a user interface that includes a plurality of options that are selectable via a first type of input received via a first input device of the plurality of input devices; means, while displaying the user interface that includes the plurality of options, for detecting, via a second input device of the plurality of input devices that is different from the first input device, a second type of input that is different from the first type of input; and means, responsive to detecting the second type of input, for: in accordance with a determination that the second type of input includes movement in a first input direction, navigating through a subset of the plurality of options in a first navigation direction; and in accordance with a determination that the second type of input includes movement in a second input direction that is different from the first input direction, navigating through the subset of the plurality of options in a second navigation direction that is different from the first navigation direction.

In some embodiments, a computer program product is disclosed. The computer program product comprises one or more programs configured to be executed by one or more processors of a computer system that is in communication with a display generation component and a plurality of input devices, the one or more programs including instructions for: displaying, via the display generation component, a user interface that includes a plurality of options that are selectable via a first type of input received via a first input device of the plurality of input devices; while displaying the user interface that includes the plurality of options, detecting, via a second input device of the plurality of input devices that is different from the first input device, a second type of input that is different from the first type of input; and in response to detecting the second type of input: in accordance with a determination that the second type of input includes movement in a first input direction, navigating through a subset of the plurality of options in a first navigation direction; and in accordance with a determination that the second type of input includes movement in a second input direction that is different from the first input direction, navigating through the subset of the plurality of options in a second navigation direction that is different from the first navigation direction.

In some embodiments, a method is disclosed. The method comprises: at a computer system that is in communication with a display generation component and a plurality of input devices: displaying, via the display generation component, a user interface; while displaying the user interface, detecting, via a first input device of the plurality of input devices, a first input; and in response to detecting the first input via the first input device of the plurality of input devices, performing a first operation; while displaying the user interface, detecting, via a second input device, different from the first input device, of the plurality of input devices, a second input; in response to detecting the second input via the second input device of the plurality of input devices that is different from the first input device, performing a second operation that is different from the first operation; while displaying the user interface, detecting a third input that is detected separately from the first input device and the second input device; and in response to detecting the third input: in accordance with a determination that the third input is a first type of input that is detected without detecting input directed to the first input device and the second input device, performing the first operation; and in accordance with a determination that the third input is a second type of input that is detected without detecting input directed to the first input device and the second input device, performing the second operation.

In some embodiments, a non-transitory computer-readable storage medium is disclosed. The non-transitory computer-readable storage medium stores one or more programs configured to be executed by one or more processors of a computer system that is in communication with a display generation component and a plurality of input devices, the one or more programs including instructions for: displaying, via the display generation component, a user interface; while displaying the user interface, detecting, via a first input device of the plurality of input devices, a first input; and in response to detecting the first input via the first input device of the plurality of input devices, performing a first operation; while displaying the user interface, detecting, via a second input device, different from the first input device, of the plurality of input devices, a second input; in response to detecting the second input via the second input device of the plurality of input devices that is different from the first input device, performing a second operation that is different from the first operation; while displaying the user interface, detecting a third input that is detected separately from the first input device and the second input device; and in response to detecting the third input: in accordance with a determination that the third input is a first type of input that is detected without detecting input directed to the first input device and the second input device, performing the first operation; and in accordance with a determination that the third input is a second type of input that is detected without detecting input directed to the first input device and the second input device, performing the second operation.

In some embodiments, a transitory computer-readable storage medium is disclosed. The transitory computer-readable storage medium stores one or more programs configured to be executed by one or more processors of a computer system that is in communication with a display generation component and a plurality of input devices, the one or more programs including instructions for: displaying, via the display generation component, a user interface; while displaying the user interface, detecting, via a first input device of the plurality of input devices, a first input; and in response to detecting the first input via the first input device of the plurality of input devices, performing a first operation; while displaying the user interface, detecting, via a second input device, different from the first input device, of the plurality of input devices, a second input; in response to detecting the second input via the second input device of the plurality of input devices that is different from the first input device, performing a second operation that is different from the first operation; while displaying the user interface, detecting a third input that is detected separately from the first input device and the second input device; and in response to detecting the third input: in accordance with a determination that the third input is a first type of input that is detected without detecting input directed to the first input device and the second input device, performing the first operation; and in accordance with a determination that the third input is a second type of input that is detected without detecting input directed to the first input device and the second input device, performing the second operation.

In some embodiments, a computer system is disclosed. The computer system is configured to communicate with a display generation component and a plurality of input devices. The computer system comprises: one or more processors; and memory storing one or more programs configured to be executed by the one or more processors, the one or more programs including instructions for: displaying, via the display generation component, a user interface; while displaying the user interface, detecting, via a first input device of the plurality of input devices, a first input; and in response to detecting the first input via the first input device of the plurality of input devices, performing a first operation; while displaying the user interface, detecting, via a second input device, different from the first input device, of the plurality of input devices, a second input; in response to detecting the second input via the second input device of the plurality of input devices that is different from the first input device, performing a second operation that is different from the first operation; while displaying the user interface, detecting a third input that is detected separately from the first input device and the second input device; and in response to detecting the third input: in accordance with a determination that the third input is a first type of input that is detected without detecting input directed to the first input device and the second input device, performing the first operation; and in accordance with a determination that the third input is a second type of input that is detected without detecting input directed to the first input device and the second input device, performing the second operation.

In some embodiments, a computer system is disclosed. The computer system is configured to communicate with a display generation component and a plurality of input devices. The computer system comprises: means for displaying, via the display generation component, a user interface; means, while displaying the user interface, for detecting, via a first input device of the plurality of input devices, a first input; and means, responsive to detecting the first input via the first input device of the plurality of input devices, for performing a first operation; means, while displaying the user interface, for detecting, via a second input device, different from the first input device, of the plurality of input devices, a second input; means, responsive to detecting the second input via the second input device of the plurality of input devices that is different from the first input device, for performing a second operation that is different from the first operation; means, while displaying the user interface, for detecting a third input that is detected separately from the first input device and the second input device; and means, responsive to detecting the third input, for: in accordance with a determination that the third input is a first type of input that is detected without detecting input directed to the first input device and the second input device, performing the first operation; and in accordance with a determination that the third input is a second type of input that is detected without detecting input directed to the first input device and the second input device, performing the second operation.

In some embodiments, a computer program product is disclosed. The computer program product comprises one or more programs configured to be executed by one or more processors of a computer system that is in communication with a display generation component and a plurality of input devices, the one or more programs including instructions for: displaying, via the display generation component, a user interface; while displaying the user interface, detecting, via a first input device of the plurality of input devices, a first input; and in response to detecting the first input via the first input device of the plurality of input devices, performing a first operation; while displaying the user interface, detecting, via a second input device, different from the first input device, of the plurality of input devices, a second input; in response to detecting the second input via the second input device of the plurality of input devices that is different from the first input device, performing a second operation that is different from the first operation; while displaying the user interface, detecting a third input that is detected separately from the first input device and the second input device; and in response to detecting the third input: in accordance with a determination that the third input is a first type of input that is detected without detecting input directed to the first input device and the second input device, performing the first operation; and in accordance with a determination that the third input is a second type of input that is detected without detecting input directed to the first input device and the second input device, performing the second operation.

In some embodiments, a method is disclosed. The method comprises: at a wearable computer system that is in communication with an input device and one or more non-visual output devices: detecting, via the input device, at least a portion of a motion gesture that includes movement of a first portion of a hand of a user relative to a second portion of the hand of the user; and in response to detecting at least the portion of the motion gesture, outputting, via the one or more non-visual output devices, a non-visual indication that the portion of the motion gesture has been detected.

In some embodiments, a non-transitory computer-readable storage medium is disclosed. The non-transitory computer-readable storage medium stores one or more programs configured to be executed by one or more processors of a computer system that is in communication with an input device and one or more non-visual output devices, the one or more programs including instructions for: detecting, via the input device, at least a portion of a motion gesture that includes movement of a first portion of a hand of a user relative to a second portion of the hand of the user; and in response to detecting at least the portion of the motion gesture, outputting, via the one or more non-visual output devices, a non-visual indication that the portion of the motion gesture has been detected.

In some embodiments, a transitory computer-readable storage medium is disclosed. The transitory computer-readable storage medium stores one or more programs configured to be executed by one or more processors of a computer system that is in communication with an input device and one or more non-visual output devices, the one or more programs including instructions for: detecting, via the input device, at least a portion of a motion gesture that includes movement of a first portion of a hand of a user relative to a second portion of the hand of the user; and in response to detecting at least the portion of the motion gesture, outputting, via the one or more non-visual output devices, a non-visual indication that the portion of the motion gesture has been detected.

In some embodiments, a computer system is disclosed. The computer system is configured to communicate with an input device and one or more non-visual output devices. The computer system comprises: one or more processors; and memory storing one or more programs configured to be executed by the one or more processors, the one or more programs including instructions for: detecting, via the input device, at least a portion of a motion gesture that includes movement of a first portion of a hand of a user relative to a second portion of the hand of the user; and in response to detecting at least the portion of the motion gesture, outputting, via the one or more non-visual output devices, a non-visual indication that the portion of the motion gesture has been detected.

In some embodiments, a computer system is disclosed. The computer system is configured to communicate with an input device and one or more non-visual output devices. The computer system comprises: means for detecting, via the input device, at least a portion of a motion gesture that includes movement of a first portion of a hand of a user relative to a second portion of the hand of the user; and means, responsive to detecting at least the portion of the motion gesture, for outputting, via the one or more non-visual output devices, a non-visual indication that the portion of the motion gesture has been detected.

In some embodiments, a computer program product is disclosed. The computer program product comprises one or more programs configured to be executed by one or more processors of a computer system that is in communication with an input device and one or more non-visual output devices, the one or more programs including instructions for: detecting, via the input device, at least a portion of a motion gesture that includes movement of a first portion of a hand of a user relative to a second portion of the hand of the user; and in response to detecting at least the portion of the motion gesture, outputting, via the one or more non-visual output devices, a non-visual indication that the portion of the motion gesture has been detected.

In some embodiments, a method is disclosed. The method comprises: at a computer system that is in communication with a display generation component and one or more input devices: detecting, via the one or more input devices, an air gesture; and in response to detecting the air gesture: in accordance with a determination that a set of one or more gesture detection criteria is met, performing an operation that corresponds to the air gesture, wherein the operation that corresponds to the air gesture is not performed by the computer system when the air gesture occurs while the set of one or more gesture detection criteria is not met.

In some embodiments, a non-transitory computer-readable storage medium is disclosed. The non-transitory computer-readable storage medium stores one or more programs configured to be executed by one or more processors of a computer system that is in communication with a display generation component and one or more input devices, the one or more programs including instructions for: detecting, via the one or more input devices, an air gesture; and in response to detecting the air gesture: in accordance with a determination that a set of one or more gesture detection criteria is met, performing an operation that corresponds to the air gesture, wherein the operation that corresponds to the air gesture is not performed by the computer system when the air gesture occurs while the set of one or more gesture detection criteria is not met.

In some embodiments, a transitory computer-readable storage medium is disclosed. The transitory computer-readable storage medium stores one or more programs configured to be executed by one or more processors of a computer system that is in communication with a display generation component and one or more input devices, the one or more programs including instructions for: detecting, via the one or more input devices, an air gesture; and in response to detecting the air gesture: in accordance with a determination that a set of one or more gesture detection criteria is met, performing an operation that corresponds to the air gesture, wherein the operation that corresponds to the air gesture is not performed by the computer system when the air gesture occurs while the set of one or more gesture detection criteria is not met.

In some embodiments, a computer system is disclosed. The computer system is configured to communicate with a display generation component and one or more input devices and comprises: one or more processors; and memory storing one or more programs configured to be executed by the one or more processors, the one or more programs including instructions for: detecting, via the one or more input devices, an air gesture; and in response to detecting the air gesture: in accordance with a determination that a set of one or more gesture detection criteria is met, performing an operation that corresponds to the air gesture, wherein the operation that corresponds to the air gesture is not performed by the computer system when the air gesture occurs while the set of one or more gesture detection criteria is not met.

In some embodiments, a computer system is disclosed. The computer system is configured to communicate with a display generation component and one or more input devices and comprises: means for detecting, via the one or more input devices, an air gesture; and means, responsive to detecting the air gesture, for: in accordance with a determination that a set of one or more gesture detection criteria is met, performing an operation that corresponds to the air gesture, wherein the operation that corresponds to the air gesture is not performed by the computer system when the air gesture occurs while the set of one or more gesture detection criteria is not met.

In some embodiments, a computer program product is disclosed. The computer program product comprises one or more programs configured to be executed by one or more processors of a computer system that is in communication with a display generation component and one or more input devices, the one or more programs including instructions for: detecting, via the one or more input devices, an air gesture; and in response to detecting the air gesture: in accordance with a determination that a set of one or more gesture detection criteria is met, performing an operation that corresponds to the air gesture, wherein the operation that corresponds to the air gesture is not performed by the computer system when the air gesture occurs while the set of one or more gesture detection criteria is not met.

In some embodiments, a method is disclosed. The method comprises: at a computer system that is in communication with a display generation component and one or more input devices: detecting, via the one or more input devices, an input that includes a portion of an air gesture; and in response to detecting the input that includes the portion of the air gesture and in accordance with a determination that the air gesture corresponds to a selectable option that is not displayed in a current view of a user interface, navigating one or more user interfaces to display, via the display generation component, a respective view of a respective user interface that includes the selectable option.

In some embodiments, a non-transitory computer-readable storage medium is disclosed. The non-transitory computer-readable storage medium stores one or more programs configured to be executed by one or more processors of a computer system that is in communication with a display generation component and one or more input devices, the one or more programs including instructions for: detecting, via the one or more input devices, an input that includes a portion of an air gesture; and in response to detecting the input that includes the portion of the air gesture and in accordance with a determination that the air gesture corresponds to a selectable option that is not displayed in a current view of a user interface, navigating one or more user interfaces to display, via the display generation component, a respective view of a respective user interface that includes the selectable option.

In some embodiments, a transitory computer-readable storage medium is disclosed. The transitory computer-readable storage medium stores one or more programs configured to be executed by one or more processors of a computer system that is in communication with a display generation component and one or more input devices, the one or more programs including instructions for: detecting, via the one or more input devices, an input that includes a portion of an air gesture; and in response to detecting the input that includes the portion of the air gesture and in accordance with a determination that the air gesture corresponds to a selectable option that is not displayed in a current view of a user interface, navigating one or more user interfaces to display, via the display generation component, a respective view of a respective user interface that includes the selectable option.

In some embodiments, a computer system is disclosed. The computer system is configured to communicate with a display generation component and one or more input devices and comprises: one or more processors; and memory storing one or more programs configured to be executed by the one or more processors, the one or more programs including instructions for: detecting, via the one or more input devices, an input that includes a portion of an air gesture; and in response to detecting the input that includes the portion of the air gesture and in accordance with a determination that the air gesture corresponds to a selectable option that is not displayed in a current view of a user interface, navigating one or more user interfaces to display, via the display generation component, a respective view of a respective user interface that includes the selectable option.

In some embodiments, a computer system is disclosed. The computer system is configured to communicate with a display generation component and one or more input devices and comprises: means for detecting, via the one or more input devices, an input that includes a portion of an air gesture; and means, responsive to detecting the input that includes the portion of the air gesture and in accordance with a determination that the air gesture corresponds to a selectable option that is not displayed in a current view of a user interface, for navigating one or more user interfaces to display, via the display generation component, a respective view of a respective user interface that includes the selectable option.

In some embodiments, a computer program product is disclosed. The computer program product comprises one or more programs configured to be executed by one or more processors of a computer system that is in communication with a display generation component and one or more input devices, the one or more programs including instructions for: detecting, via the one or more input devices, an input that includes a portion of an air gesture; and in response to detecting the input that includes the portion of the air gesture and in accordance with a determination that the air gesture corresponds to a selectable option that is not displayed in a current view of a user interface, navigating one or more user interfaces to display, via the display generation component, a respective view of a respective user interface that includes the selectable option.

In some embodiments, a method is disclosed. The method comprises: at a computer system that is in communication with one or more input devices: while the computer system is operating in a first mode: detecting, via a respective input device of the one or more input devices, an input directed to the respective input device; and in response to detecting the input directed to the respective input device, performing a first operation that corresponds to the input directed to the respective input device; and while the computer system is operating in a second mode in which use of the respective input device is restricted and inputs directed to the respective input device do not cause the computer system to perform the first operation, wherein the second mode is different from the first mode: detecting, via the one or more input devices, an air gesture; and in response to detecting the air gesture, performing the first operation.

In some embodiments, a non-transitory computer-readable storage medium is disclosed. The non-transitory computer-readable storage medium stores one or more programs configured to be executed by one or more processors of a computer system that is in communication with one or more input devices, the one or more programs including instructions for: while the computer system is operating in a first mode: detecting, via a respective input device of the one or more input devices, an input directed to the respective input device; and in response to detecting the input directed to the respective input device, performing a first operation that corresponds to the input directed to the respective input device; and while the computer system is operating in a second mode in which use of the respective input device is restricted and inputs directed to the respective input device do not cause the computer system to perform the first operation, wherein the second mode is different from the first mode: detecting, via the one or more input devices, an air gesture; and in response to detecting the air gesture, performing the first operation.

In some embodiments, a transitory computer-readable storage medium is disclosed. The transitory computer-readable storage medium stores one or more programs configured to be executed by one or more processors of a computer system that is in communication with one or more input devices, the one or more programs including instructions for: while the computer system is operating in a first mode: detecting, via a respective input device of the one or more input devices, an input directed to the respective input device; and in response to detecting the input directed to the respective input device, performing a first operation that corresponds to the input directed to the respective input device; and while the computer system is operating in a second mode in which use of the respective input device is restricted and inputs directed to the respective input device do not cause the computer system to perform the first operation, wherein the second mode is different from the first mode: detecting, via the one or more input devices, an air gesture; and in response to detecting the air gesture, performing the first operation.

In some embodiments, a computer system is disclosed. The computer system is configured to communicate with one or more input devices and comprises: one or more processors; and memory storing one or more programs configured to be executed by the one or more processors, the one or more programs including instructions for: while the computer system is operating in a first mode: detecting, via a respective input device of the one or more input devices, an input directed to the respective input device; and in response to detecting the input directed to the respective input device, performing a first operation that corresponds to the input directed to the respective input device; and while the computer system is operating in a second mode in which use of the respective input device is restricted and inputs directed to the respective input device do not cause the computer system to perform the first operation, wherein the second mode is different from the first mode: detecting, via the one or more input devices, an air gesture; and in response to detecting the air gesture, performing the first operation.

In some embodiments, a computer system is disclosed. The computer system is configured to communicate with one or more input devices and comprises: means, while the computer system is operating in a first mode, for: detecting, via a respective input device of the one or more input devices, an input directed to the respective input device; and in response to detecting the input directed to the respective input device, performing a first operation that corresponds to the input directed to the respective input device; and means, while the computer system is operating in a second mode in which use of the respective input device is restricted and inputs directed to the respective input device do not cause the computer system to perform the first operation, wherein the second mode is different from the first mode, for: detecting, via the one or more input devices, an air gesture; and in response to detecting the air gesture, performing the first operation.

In some embodiments, a computer program product is disclosed. The computer program product comprises one or more programs configured to be executed by one or more processors of a computer system that is in communication with one or more input devices, the one or more programs including instructions for: while the computer system is operating in a first mode: detecting, via a respective input device of the one or more input devices, an input directed to the respective input device; and in response to detecting the input directed to the respective input device, performing a first operation that corresponds to the input directed to the respective input device; and while the computer system is operating in a second mode in which use of the respective input device is restricted and inputs directed to the respective input device do not cause the computer system to perform the first operation, wherein the second mode is different from the first mode: detecting, via the one or more input devices, an air gesture; and in response to detecting the air gesture, performing the first operation.

In some embodiments, a method is disclosed. In some embodiments, the method is performed at a computer system that is in communication with one or more display generation components and one or more input devices. The method comprises: while the computer system is worn on the wrist of a user, detecting a first user input via the one or more input devices of the computer system; and in response to detecting the first user input: in accordance with a determination that the first user input is detected while a head-mounted device separate from the computer system is not worn on the head of the user, performing a first operation at the computer system that is worn on the wrist of the user; and in accordance with a determination that the first user input is detected while a head-mounted device separate from the computer system is worn on the head of the user, forgoing performance of the first operation at the computer system that is worn on the wrist of the user.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: while the computer system is worn on the wrist of a user, detecting a first user input via the one or more input devices of the computer system; and in response to detecting the first user input: in accordance with a determination that the first user input is detected while a head-mounted device separate from the computer system is not worn on the head of the user, performing a first operation at the computer system that is worn on the wrist of the user; and in accordance with a determination that the first user input is detected while a head-mounted device separate from the computer system is worn on the head of the user, forgoing performance of the first operation at the computer system that is worn on the wrist of the user.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: while the computer system is worn on the wrist of a user, detecting a first user input via the one or more input devices of the computer system; and in response to detecting the first user input: in accordance with a determination that the first user input is detected while a head-mounted device separate from the computer system is not worn on the head of the user, performing a first operation at the computer system that is worn on the wrist of the user; and in accordance with a determination that the first user input is detected while a head-mounted device separate from the computer system is worn on the head of the user, forgoing performance of the first operation at the computer system that is worn on the wrist of the user.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: while the computer system is worn on the wrist of a user, detecting a first user input via the one or more input devices of the computer system; and in response to detecting the first user input: in accordance with a determination that the first user input is detected while a head-mounted device separate from the computer system is not worn on the head of the user, performing a first operation at the computer system that is worn on the wrist of the user; and in accordance with a determination that the first user input is detected while a head-mounted device separate from the computer system is worn on the head of the user, forgoing performance of the first operation at the computer system that is worn on the wrist of the user.

In some embodiments, a computer system is disclosed. The computer system is configured to communicate with one or more display generation components and one or more input devices, and comprises: means for, while the computer system is worn on the wrist of a user, detecting a first user input via the one or more input devices of the computer system; and means for, in response to detecting the first user input: in accordance with a determination that the first user input is detected while a head-mounted device separate from the computer system is not worn on the head of the user, performing a first operation at the computer system that is worn on the wrist of the user; and in accordance with a determination that the first user input is detected while a head-mounted device separate from the computer system is worn on the head of the user, forgoing performance of the first operation at the computer system that is worn on the wrist of the user.

In some embodiments, a computer program product is disclosed. The computer program product comprises one or more programs configured to be executed by one or more processors of a computer system that is in communication with one or more display generation components and one or more input devices, the one or more programs including instructions for: while the computer system is worn on the wrist of a user, detecting a first user input via the one or more input devices of the computer system; and in response to detecting the first user input: in accordance with a determination that the first user input is detected while a head-mounted device separate from the computer system is not worn on the head of the user, performing a first operation at the computer system that is worn on the wrist of the user; and in accordance with a determination that the first user input is detected while a head-mounted device separate from the computer system is worn on the head of the user, forgoing performance of the first operation at the computer system that is worn on the wrist of the user.

In some embodiments, a method is disclosed. In some embodiments, the method is performed at a computer system that is in communication with one or more display generation components and one or more input devices. The method comprises: displaying, via the one or more display generation components, a first status indicator that includes first status information that corresponds to a first device function; while displaying the first status indicator, detecting, via the one or more input devices, a first air gesture user input; and in response to detecting the first air gesture user input, advancing from the first status indicator to a second status indicator different from the first status indicator and that includes second status information that corresponds to a second device function different from the first device function.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: displaying, via the one or more display generation components, a first status indicator that includes first status information that corresponds to a first device function; while displaying the first status indicator, detecting, via the one or more input devices, a first air gesture user input; and in response to detecting the first air gesture user input, advancing from the first status indicator to a second status indicator different from the first status indicator and that includes second status information that corresponds to a second device function different from the first device function.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: displaying, via the one or more display generation components, a first status indicator that includes first status information that corresponds to a first device function; while displaying the first status indicator, detecting, via the one or more input devices, a first air gesture user input; and in response to detecting the first air gesture user input, advancing from the first status indicator to a second status indicator different from the first status indicator and that includes second status information that corresponds to a second device function different from the first device function.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a first status indicator that includes first status information that corresponds to a first device function; while displaying the first status indicator, detecting, via the one or more input devices, a first air gesture user input; and in response to detecting the first air gesture user input, advancing from the first status indicator to a second status indicator different from the first status indicator and that includes second status information that corresponds to a second device function different from the first device function.

In some embodiments, a computer system is disclosed. The computer system is configured to communicate with one or more display generation components and one or more input devices, and comprises: means for displaying, via the one or more display generation components, a first status indicator that includes first status information that corresponds to a first device function; means for, while displaying the first status indicator, detecting, via the one or more input devices, a first air gesture user input; and means for, in response to detecting the first air gesture user input, advancing from the first status indicator to a second status indicator different from the first status indicator and that includes second status information that corresponds to a second device function different from the first device function.

In some embodiments, a computer program product is disclosed. The computer program product comprises one or more programs configured to be executed by one or more processors of a computer system that is in communication with one or more display generation components and one or more input devices, the one or more programs including instructions for: displaying, via the one or more display generation components, a first status indicator that includes first status information that corresponds to a first device function; while displaying the first status indicator, detecting, via the one or more input devices, a first air gesture user input; and in response to detecting the first air gesture user input, advancing from the first status indicator to a second status indicator different from the first status indicator and that includes second status information that corresponds to a second device function different from the first device function.

In some embodiments, a method is disclosed. In some embodiments, the method is performed at a computer system that is in communication with one or more input devices, and comprises: detecting, via the one or more input devices, a first air gesture; and in response to detecting the first air gesture: in accordance with a determination that a wrist gesture is not detected within a threshold period of time after the first air gesture is detected, performing a respective operation associated with the first air gesture; and in accordance with a determination that a wrist gesture is detected within the threshold period of time after the first air gesture is detected, modifying performance of the respective operation.

In some embodiments, a non-transitory computer-readable storage medium is disclosed. In some embodiments, the non-transitory computer-readable storage medium stores one or more programs configured to be executed by one or more processors of a computer system that is in communication with one or more input devices, the one or more programs including instructions for: detecting, via the one or more input devices, a first air gesture; and in response to detecting the first air gesture: in accordance with a determination that a wrist gesture is not detected within a threshold period of time after the first air gesture is detected, performing a respective operation associated with the first air gesture; and in accordance with a determination that a wrist gesture is detected within the threshold period of time after the first air gesture is detected, modifying performance of the respective operation.

In some embodiments, a transitory computer-readable storage medium is disclosed. In some embodiments, the transitory computer-readable storage medium stores one or more programs configured to be executed by one or more processors of a computer system that is in communication with one or more input devices, the one or more programs including instructions for: detecting, via the one or more input devices, a first air gesture; and in response to detecting the first air gesture: in accordance with a determination that a wrist gesture is not detected within a threshold period of time after the first air gesture is detected, performing a respective operation associated with the first air gesture; and in accordance with a determination that a wrist gesture is detected within the threshold period of time after the first air gesture is detected, modifying performance of the respective operation.

In some embodiments, a computer system is disclosed. The computer system is configured to communicate with one or more input devices, and comprises: one or more processors; and memory storing one or more programs configured to be executed by the one or more processors, the one or more programs including instructions for: detecting, via the one or more input devices, a first air gesture; and in response to detecting the first air gesture: in accordance with a determination that a wrist gesture is not detected within a threshold period of time after the first air gesture is detected, performing a respective operation associated with the first air gesture; and in accordance with a determination that a wrist gesture is detected within the threshold period of time after the first air gesture is detected, modifying performance of the respective operation.

In some embodiments, a computer system is disclosed. The computer system is configured to communicate with one or more input devices, and comprises: means for detecting, via the one or more input devices, a first air gesture; and means for, in response to detecting the first air gesture: in accordance with a determination that a wrist gesture is not detected within a threshold period of time after the first air gesture is detected, performing a respective operation associated with the first air gesture; and in accordance with a determination that a wrist gesture is detected within the threshold period of time after the first air gesture is detected, modifying performance of the respective operation.

In some embodiments, a computer program product is disclosed. The computer program product comprises one or more programs configured to be executed by one or more processors of a computer system that is in communication with one or more input devices, the one or more programs including instructions for: detecting, via the one or more input devices, a first air gesture; and in response to detecting the first air gesture: in accordance with a determination that a wrist gesture is not detected within a threshold period of time after the first air gesture is detected, performing a respective operation associated with the first air gesture; and in accordance with a determination that a wrist gesture is detected within the threshold period of time after the first air gesture is detected, modifying performance of the respective operation.

In some embodiments, a method is disclosed. In some embodiments, the method is performed at a computer system that is in communication with one or more display generation components and one or more input devices, and comprises: displaying, via the one or more display generation components, a first portion of first content; while displaying the first portion of the first content, detecting, via the one or more input devices, a first air gesture; and in response to detecting the first air gesture: in accordance with a determination that the first content includes scrollable content, that the first content corresponds to a first affordance for performing a first operation, and that the first affordance is not displayed via the one or more display generation components, scrolling the first content to display a second portion of the first content that is different from the first portion of the first content.

In some embodiments, a non-transitory computer-readable storage medium is disclosed. In some embodiments, the non-transitory computer-readable storage medium stores one or more programs configured to be executed by one or more processors of a computer system that is in communication with one or more display generation components and one or more input devices, the one or more programs including instructions for: displaying, via the one or more display generation components, a first portion of first content; while displaying the first portion of the first content, detecting, via the one or more input devices, a first air gesture; and in response to detecting the first air gesture: in accordance with a determination that the first content includes scrollable content, that the first content corresponds to a first affordance for performing a first operation, and that the first affordance is not displayed via the one or more display generation components, scrolling the first content to display a second portion of the first content that is different from the first portion of the first content.

In some embodiments, a transitory computer-readable storage medium is disclosed. In some embodiments, the transitory computer-readable storage medium stores one or more programs configured to be executed by one or more processors of a computer system that is in communication with one or more display generation components and one or more input devices, the one or more programs including instructions for: displaying, via the one or more display generation components, a first portion of first content; while displaying the first portion of the first content, detecting, via the one or more input devices, a first air gesture; and in response to detecting the first air gesture: in accordance with a determination that the first content includes scrollable content, that the first content corresponds to a first affordance for performing a first operation, and that the first affordance is not displayed via the one or more display generation components, scrolling the first content to display a second portion of the first content that is different from the first portion of the first content.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a first portion of first content; while displaying the first portion of the first content, detecting, via the one or more input devices, a first air gesture; and in response to detecting the first air gesture: in accordance with a determination that the first content includes scrollable content, that the first content corresponds to a first affordance for performing a first operation, and that the first affordance is not displayed via the one or more display generation components, scrolling the first content to display a second portion of the first content that is different from the first portion of the first content.

In some embodiments, a computer system is disclosed. The computer system is configured to communicate with one or more display generation components and one or more input devices, and comprises: means for displaying, via the one or more display generation components, a first portion of first content; means for, while displaying the first portion of the first content, detecting, via the one or more input devices, a first air gesture; and means for, in response to detecting the first air gesture: in accordance with a determination that the first content includes scrollable content, that the first content corresponds to a first affordance for performing a first operation, and that the first affordance is not displayed via the one or more display generation components, scrolling the first content to display a second portion of the first content that is different from the first portion of the first content.

In some embodiments, a computer program product is disclosed. The computer program product comprises one or more programs configured to be executed by one or more processors of a computer system that is in communication with one or more input devices, the one or more programs including instructions for: displaying, via the one or more display generation components, a first portion of first content; while displaying the first portion of the first content, detecting, via the one or more input devices, a first air gesture; and in response to detecting the first air gesture: in accordance with a determination that the first content includes scrollable content, that the first content corresponds to a first affordance for performing a first operation, and that the first affordance is not displayed via the one or more display generation components, scrolling the first content to display a second portion of the first content that is different from the first portion of the first content.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for performing operations based on detected gestures, thereby increasing the effectiveness, efficiency, and user satisfaction with such devices. Such methods and interfaces may complement or replace other methods for user interactions with computer systems.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6G illustrate exemplary devices and user interfaces for performing operations based on detected gestures in accordance with some embodiments.

FIGS. 7A-7L illustrate exemplary devices and user interfaces for performing operations based on detected gestures in accordance with some embodiments.

FIG. 8 is a flow diagram illustrating methods of navigating through options in accordance with some embodiments.

FIG. 9 is a flow diagram illustrating methods of performing an operation in accordance with some embodiments.

FIG. 10 is a flow diagram illustrating methods of outputting non-visual feedback in accordance with some embodiments.

FIGS. 11A-11AE illustrate exemplary devices and user interfaces for performing operations based on detected gestures in accordance with some embodiments.

FIG. 12 is a flow diagram illustrating methods of conditionally performing an operation corresponding to an air gesture in accordance with some embodiments.

FIG. 13 is a flow diagram illustrating methods of navigating user interfaces to display a selectable option in accordance with some embodiments.

FIG. 14 is a flow diagram illustrating methods of performing an operation based on an air gesture in accordance with some embodiments.

FIGS. 15A-15CC illustrate exemplary devices and user interfaces for performing operations at a computer system, in accordance with some embodiments.

FIG. 16 is a flow diagram illustrating methods of performing operations at a computer system, in accordance with some embodiments.

FIGS. 17A-17Q illustrate exemplary devices and user interfaces for advancing status indicators in response to user input, in accordance with some embodiments.

FIG. 18 is a flow diagram illustrating methods of advancing status indicators in response to user input, in accordance with some embodiments.

FIGS. 19A-19J illustrate exemplary devices and user interfaces for performing operations based on detected gestures in accordance with some embodiments.

FIG. 20 is a flow diagram illustrating methods of performing operations based on detected gestures in accordance with some embodiments.

FIGS. 21A-21M illustrate exemplary devices and user interfaces for performing operations based on detected gestures in accordance with some embodiments.

FIG. 22 is a flow diagram illustrating methods of performing operations based on detected gestures in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for performing operations based on detected gestures. For example, single-handed gestures enable users to more easily provide inputs and enable the computer system to receive more timely inputs. Such techniques can reduce the cognitive burden on a user who control computer systems, thereby enhancing productivity. Further, such techniques can reduce processor and battery power otherwise wasted on redundant user inputs.

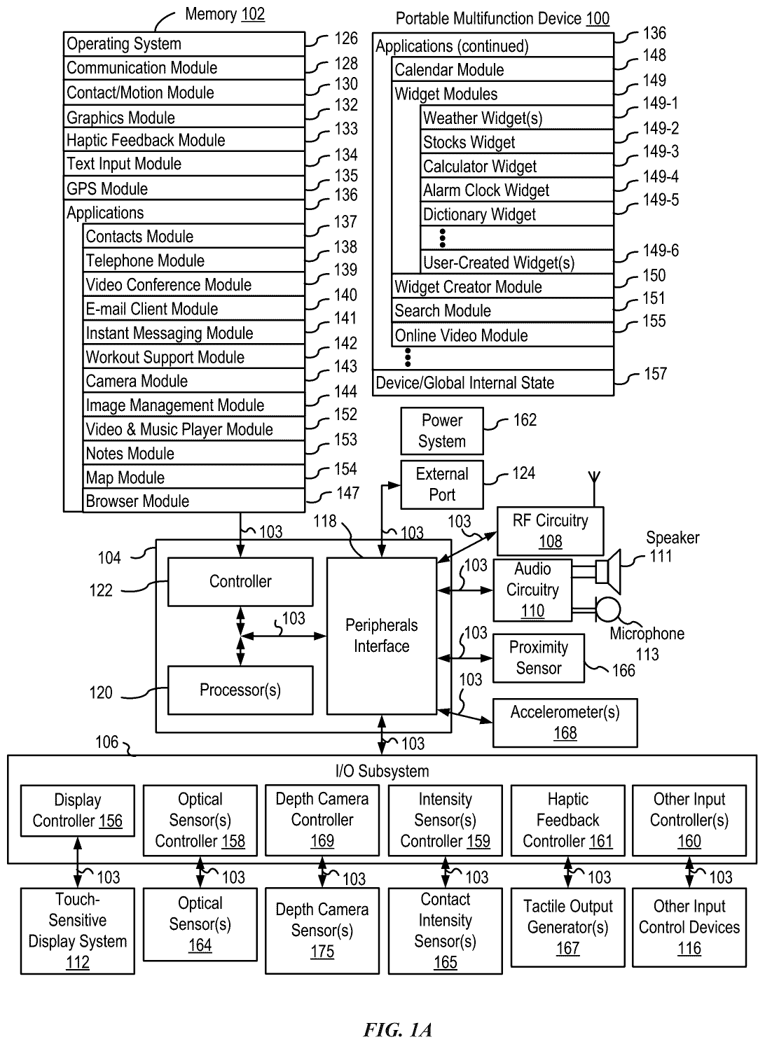

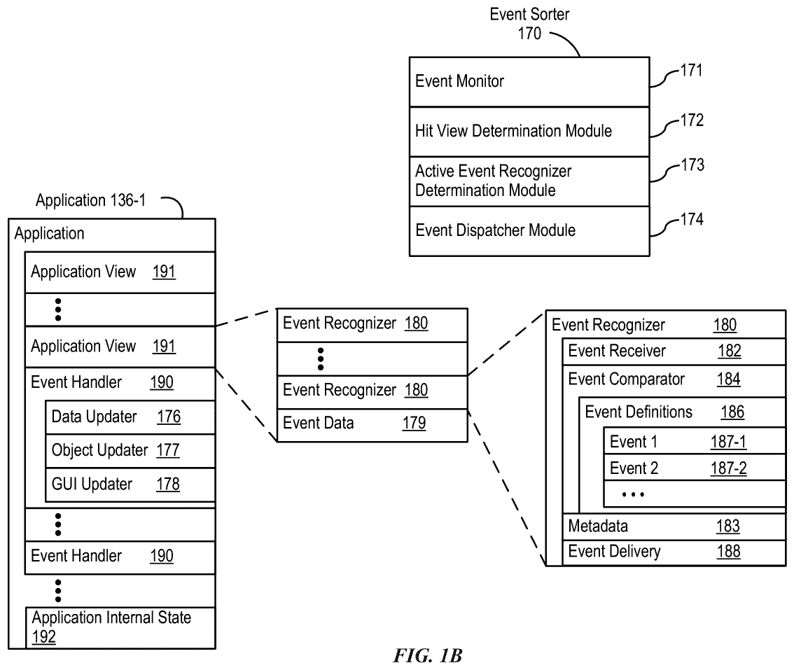

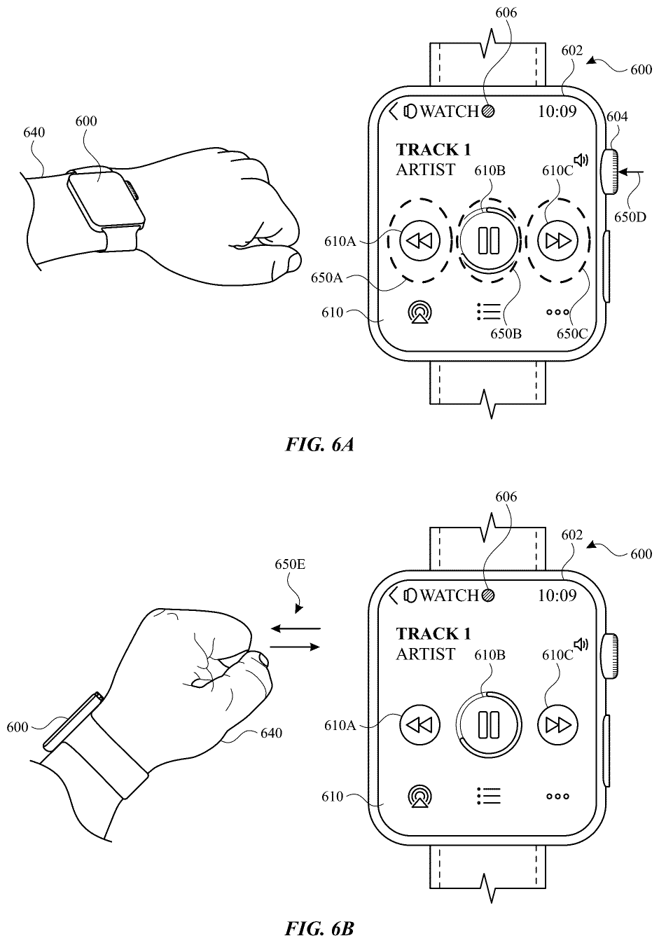

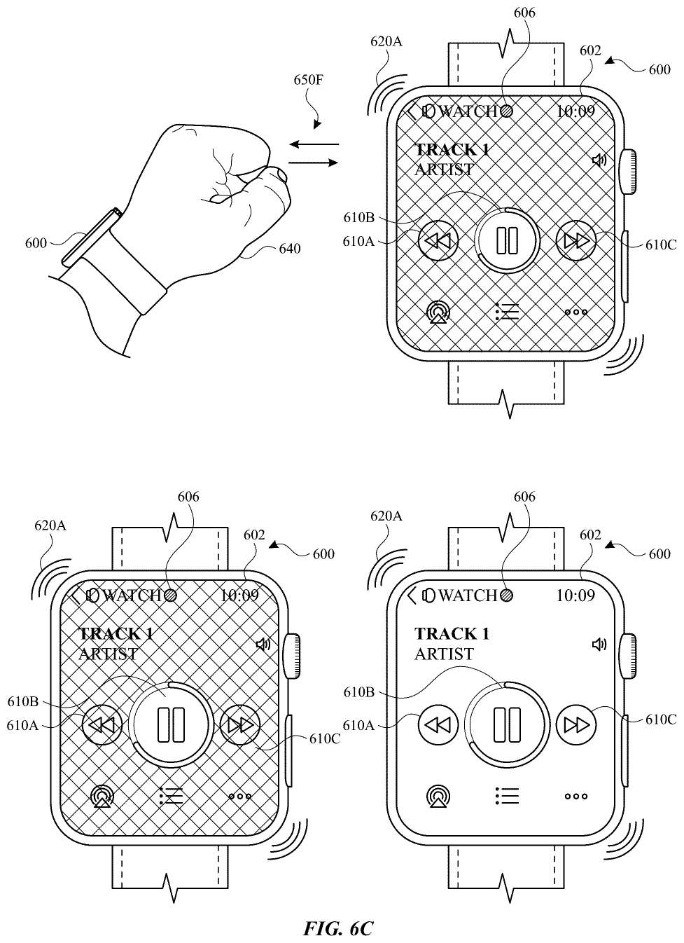

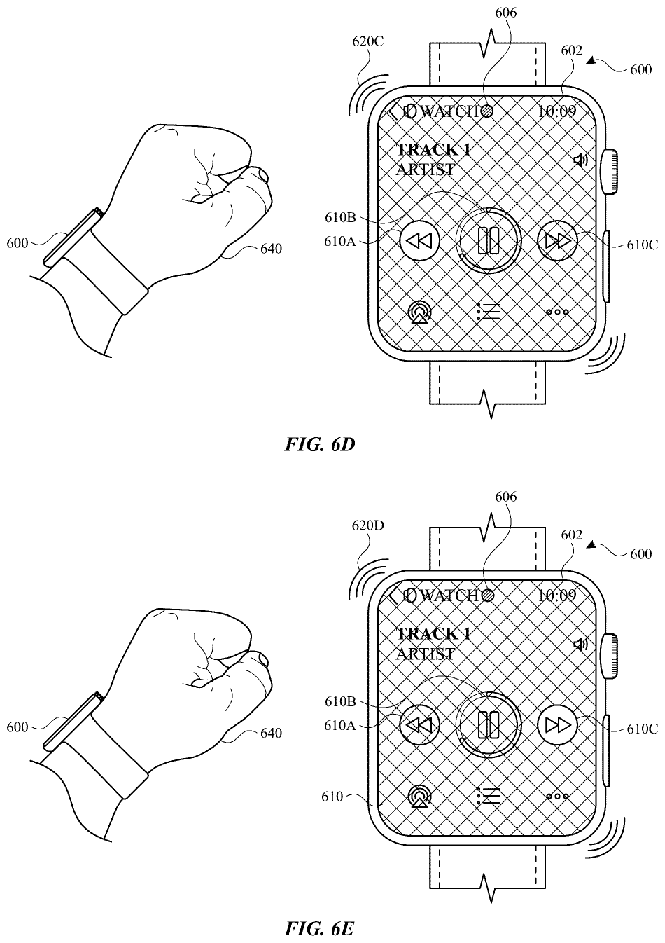

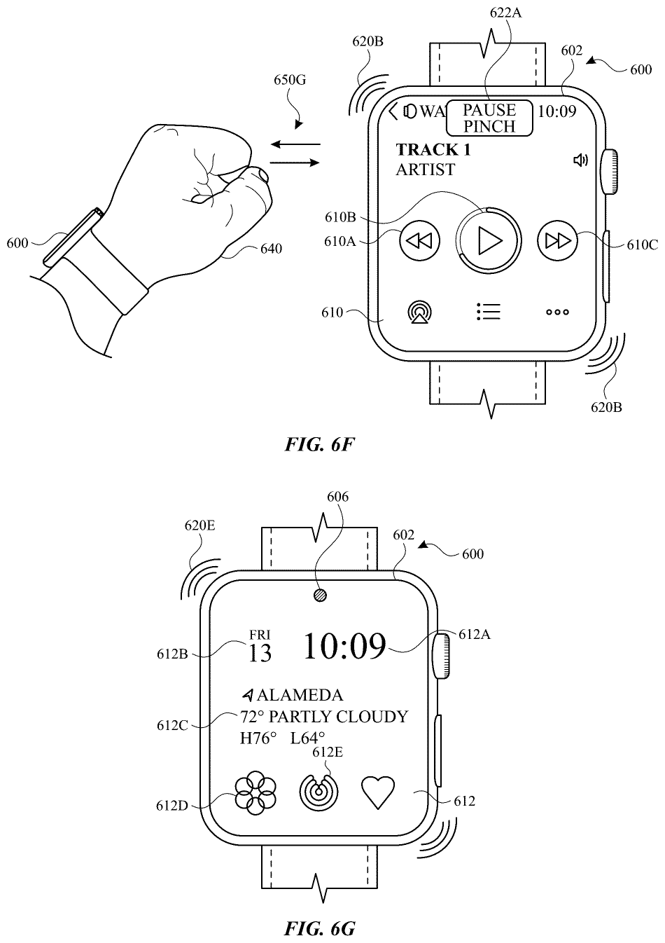

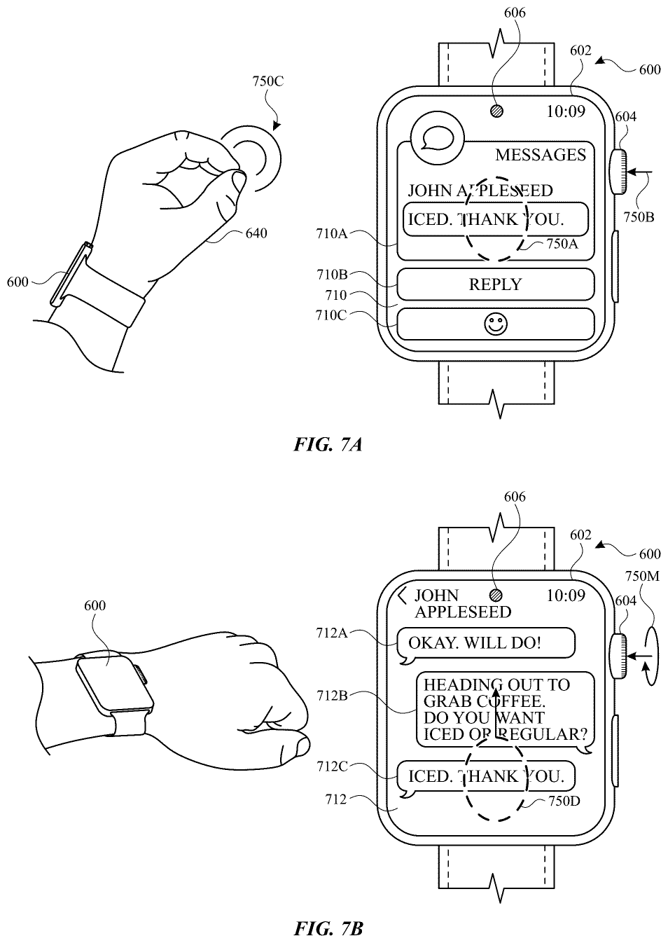

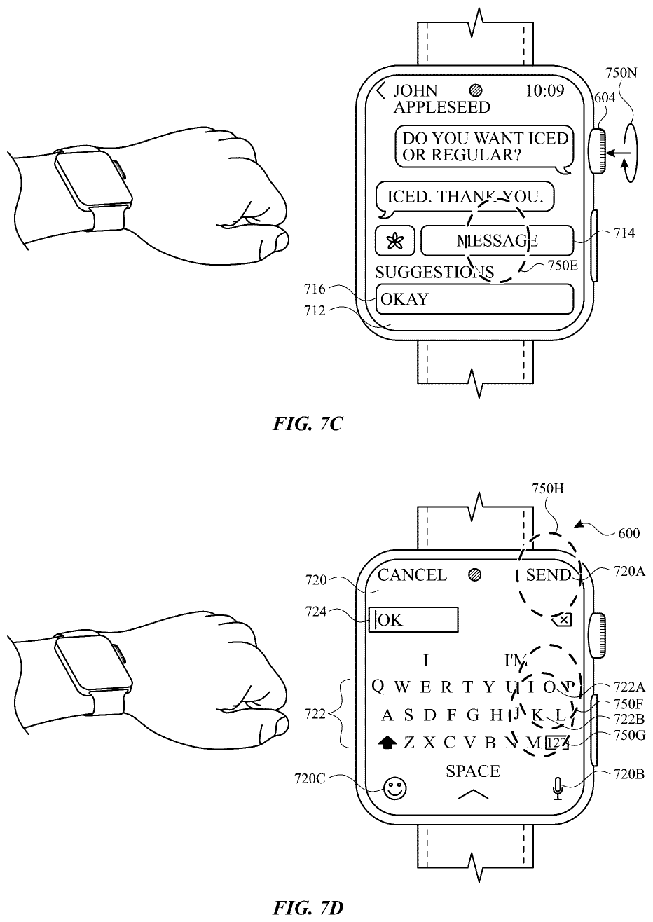

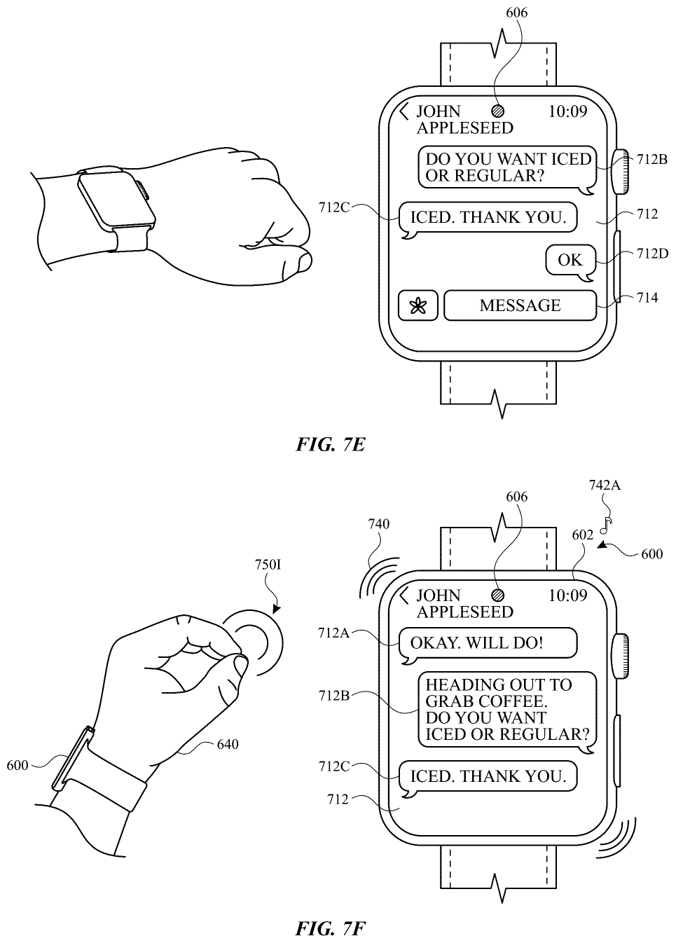

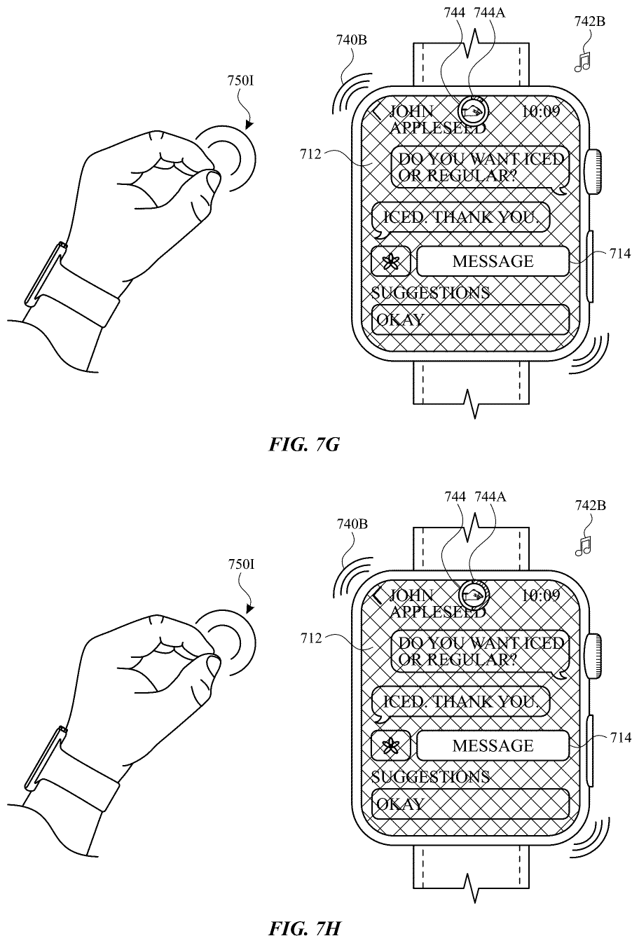

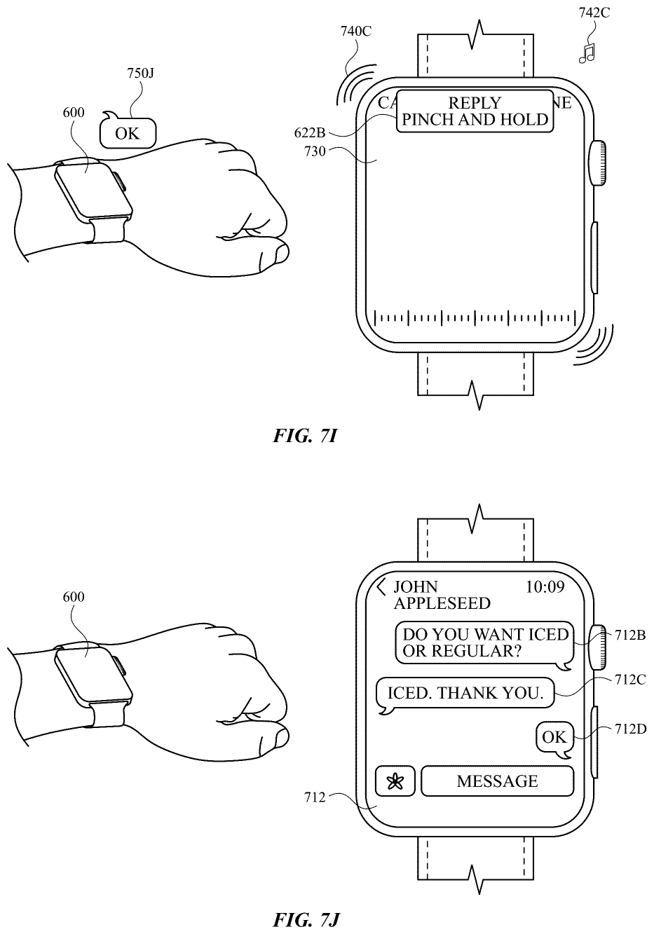

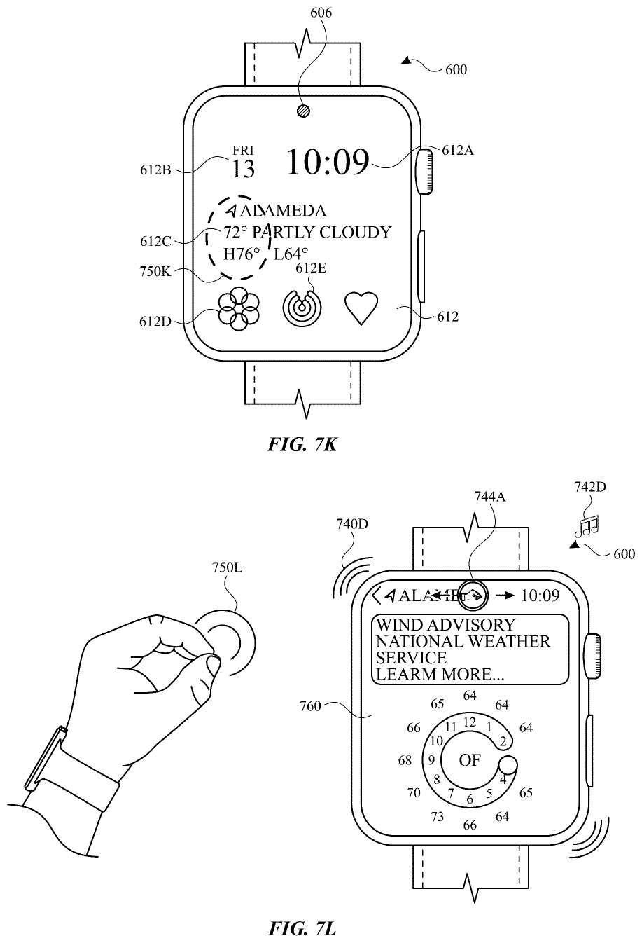

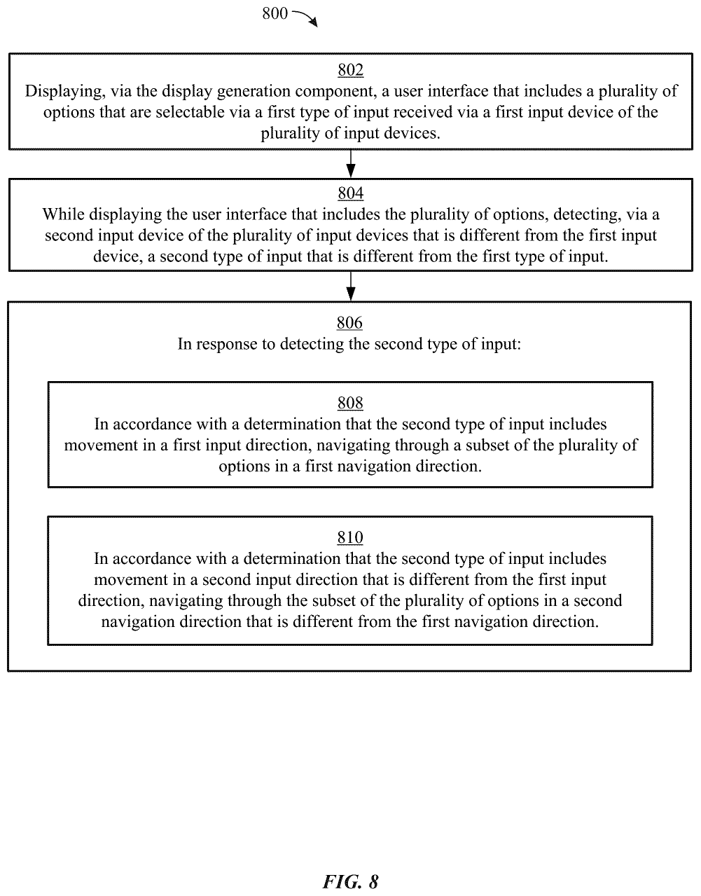

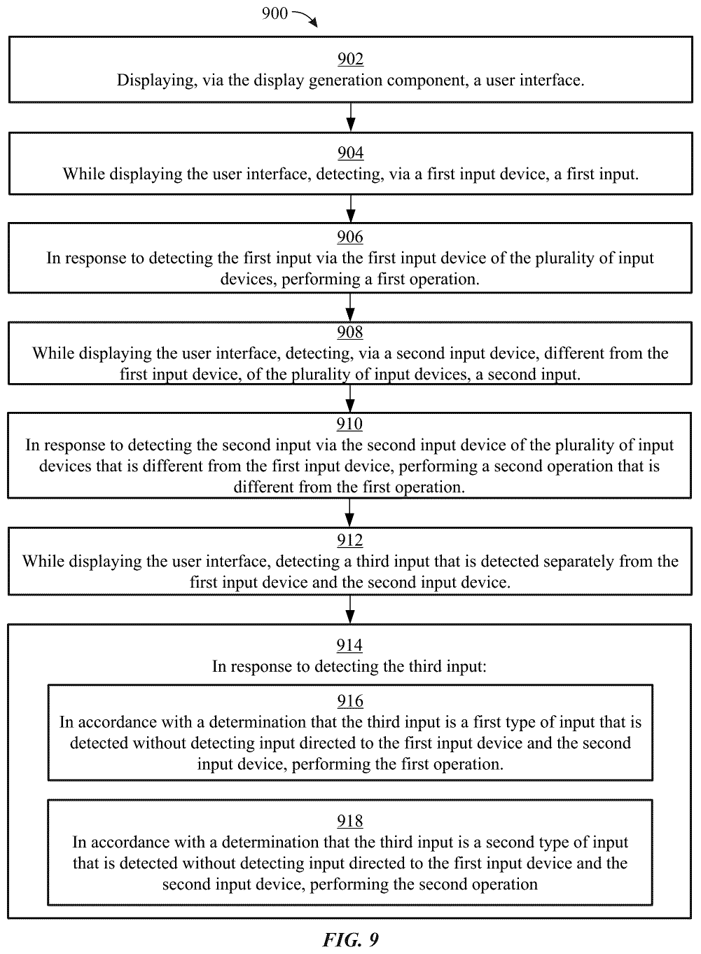

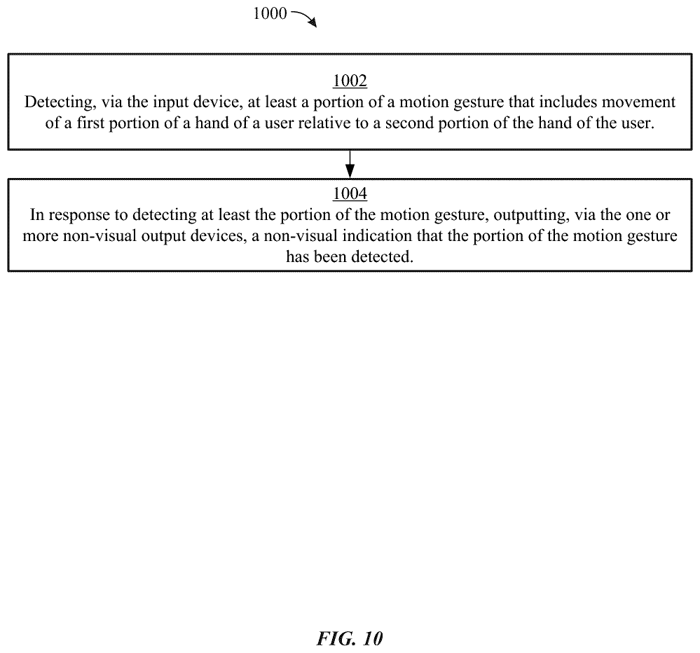

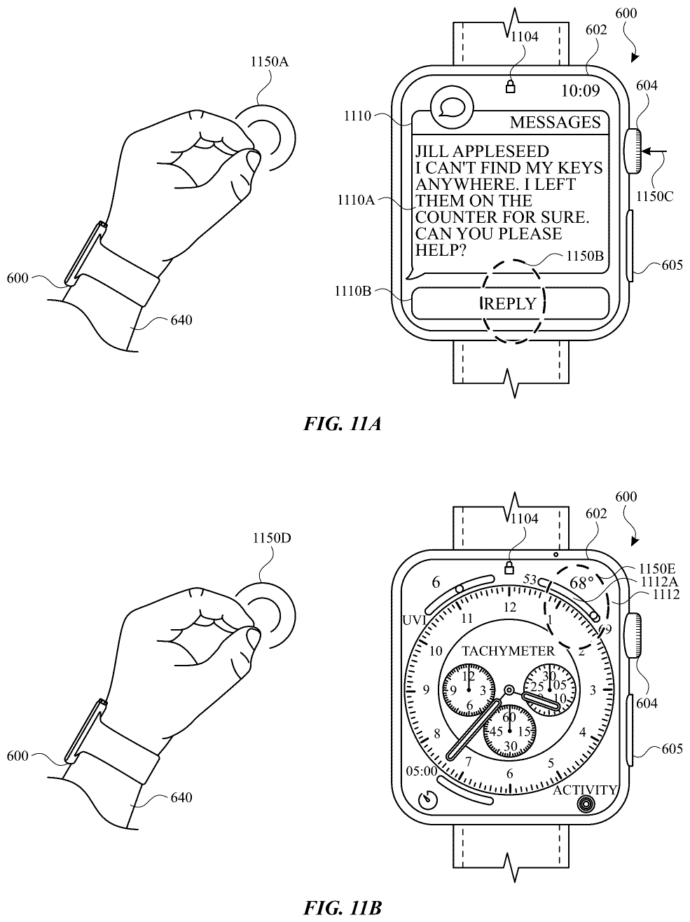

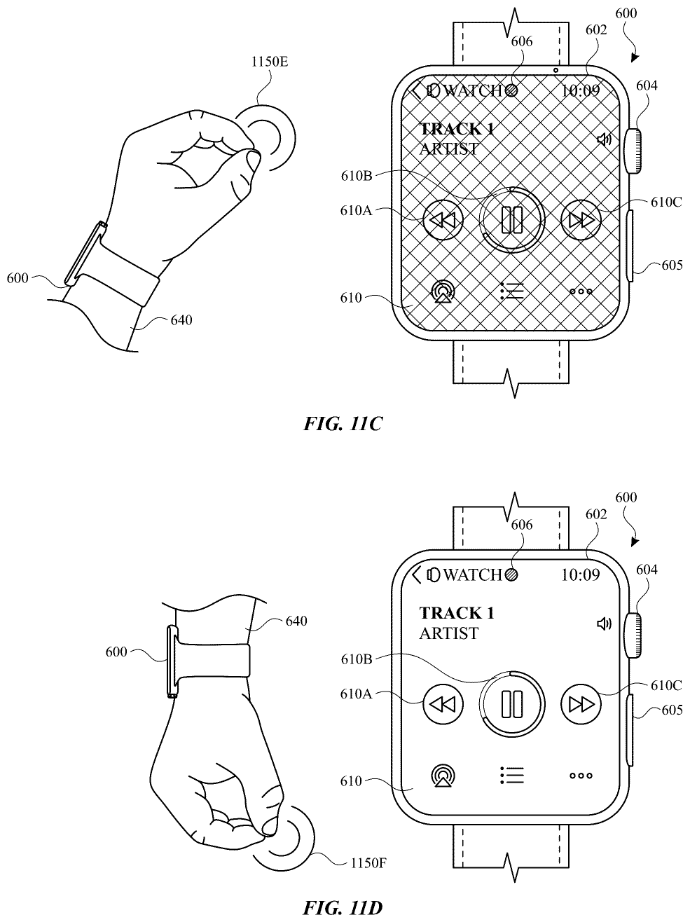

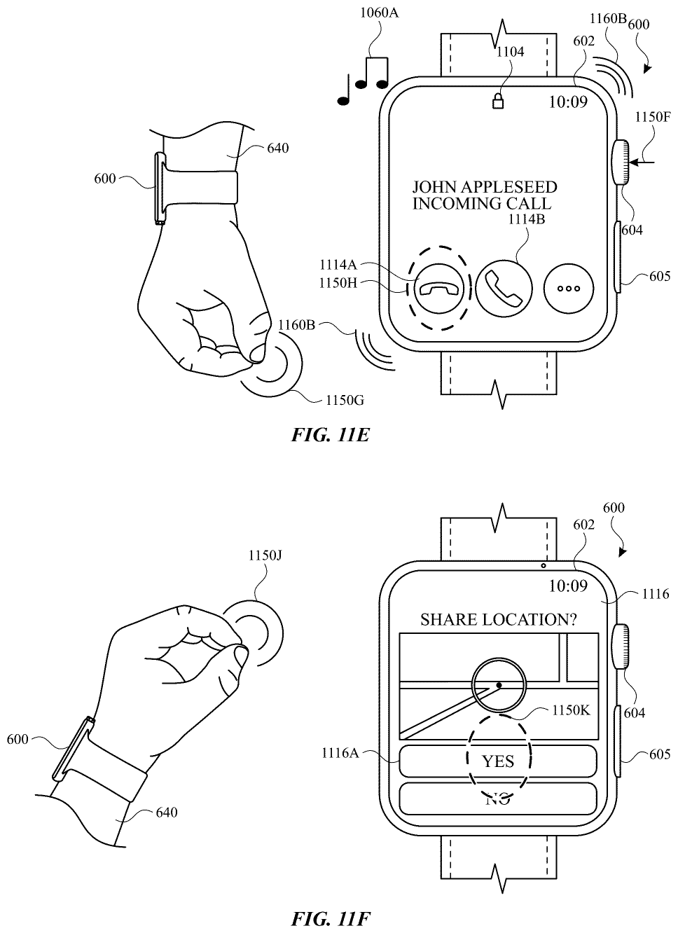

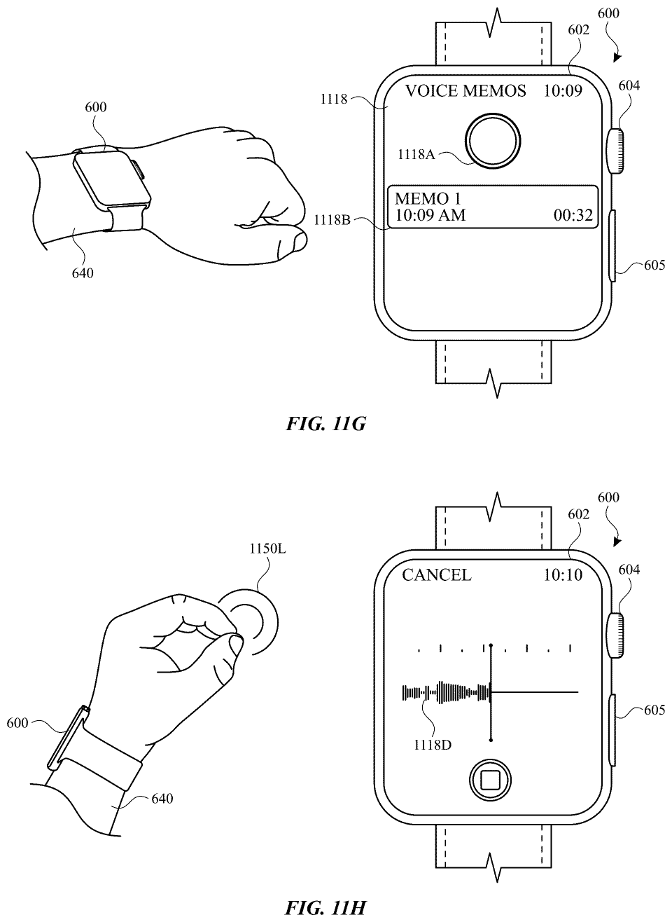

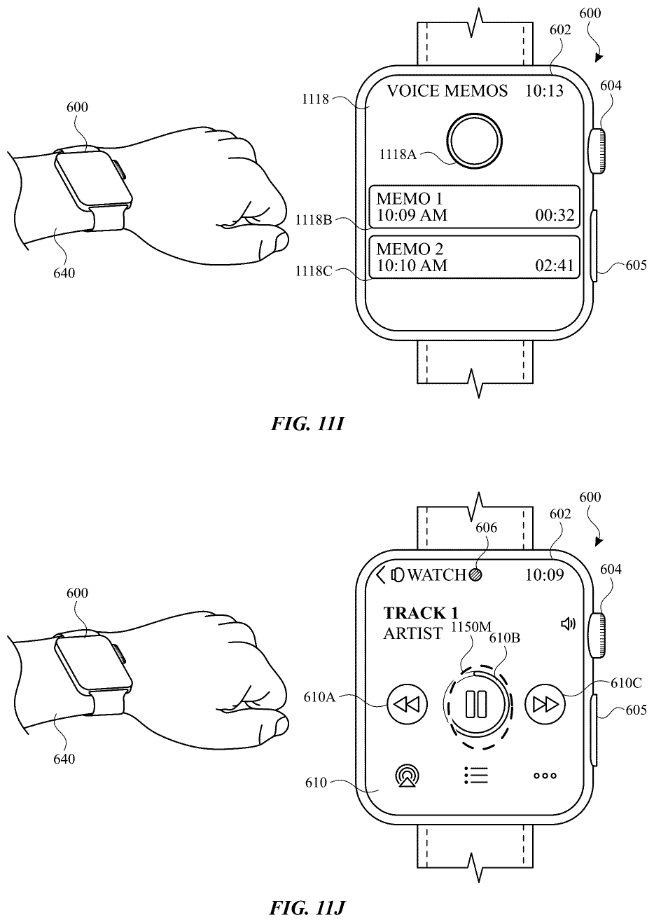

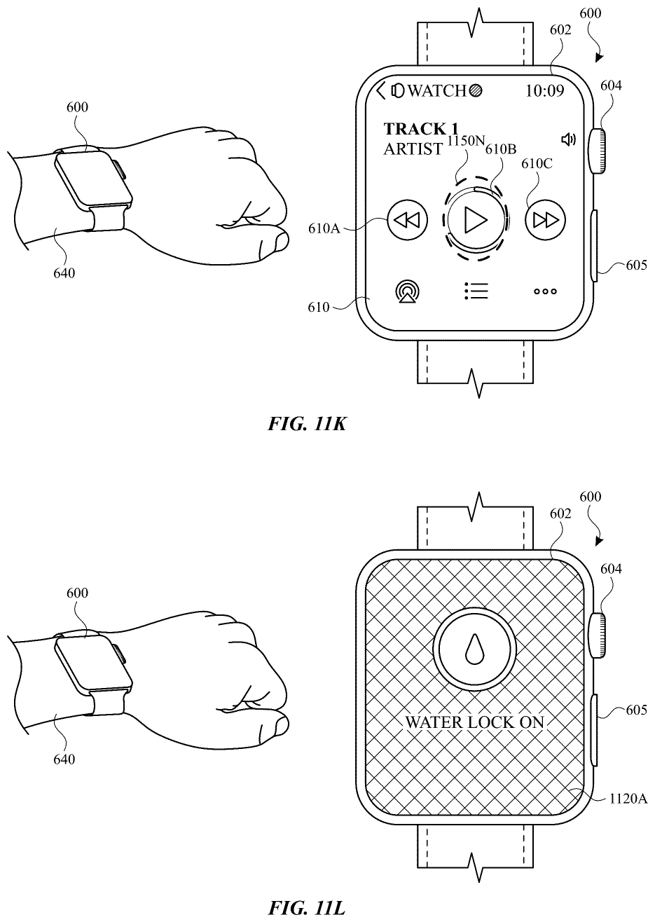

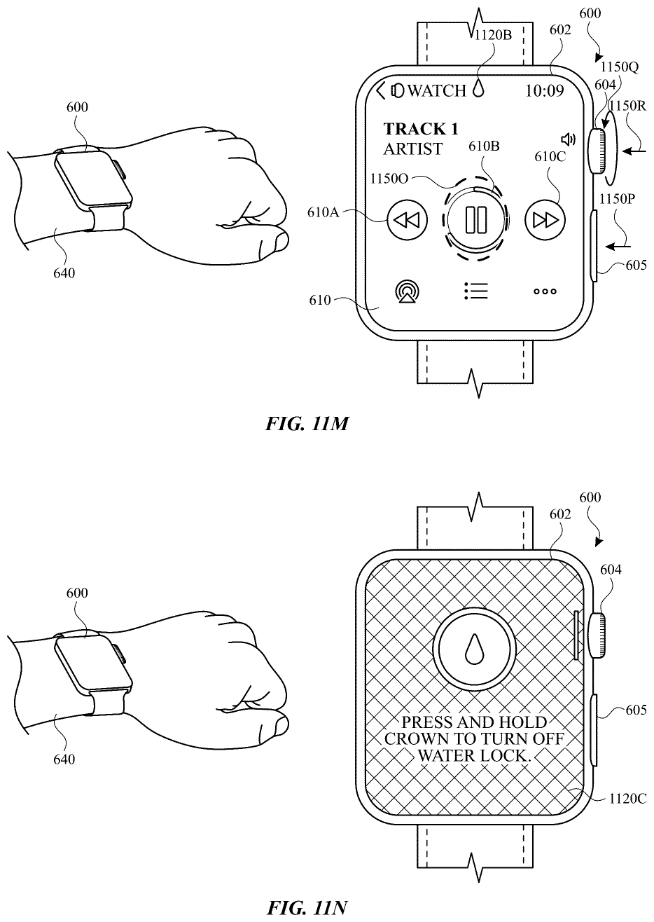

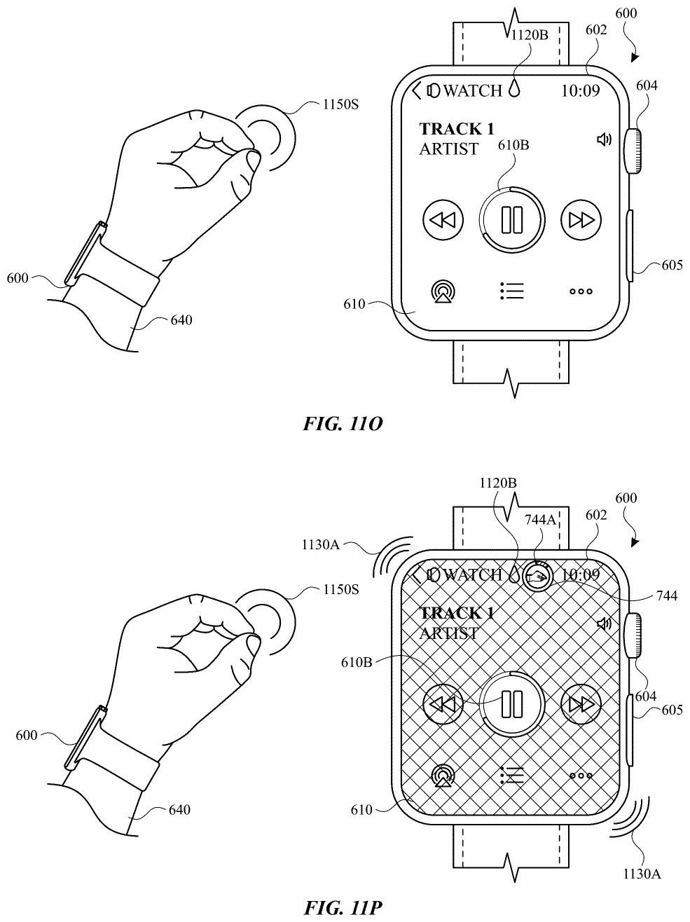

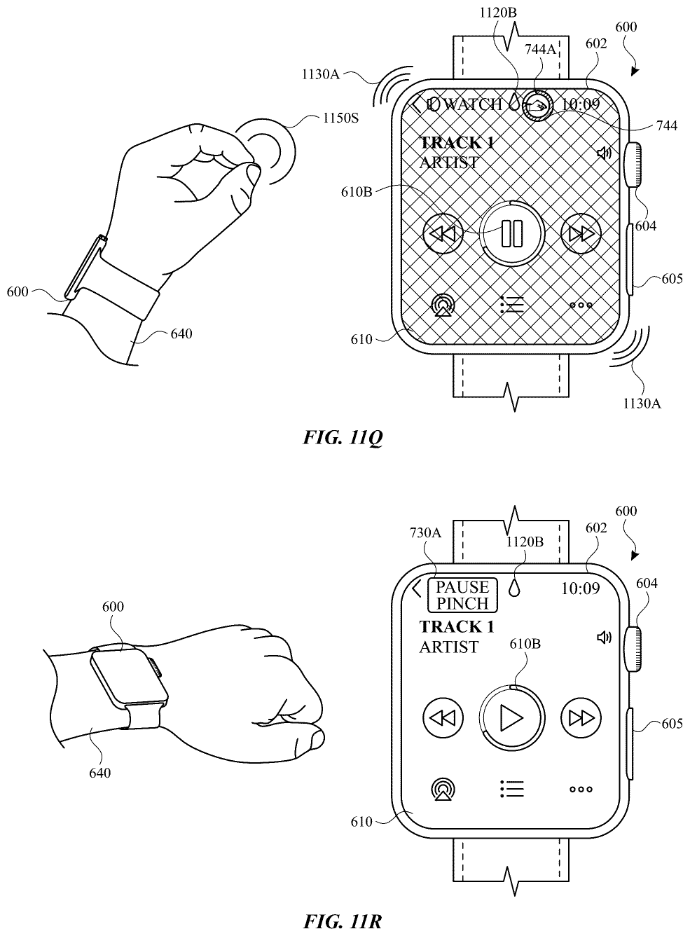

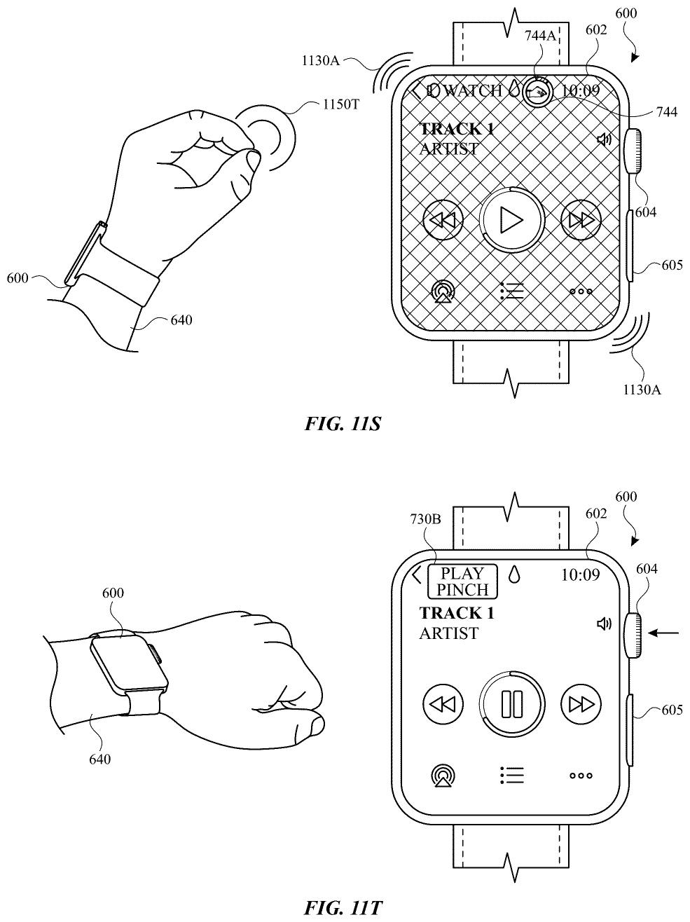

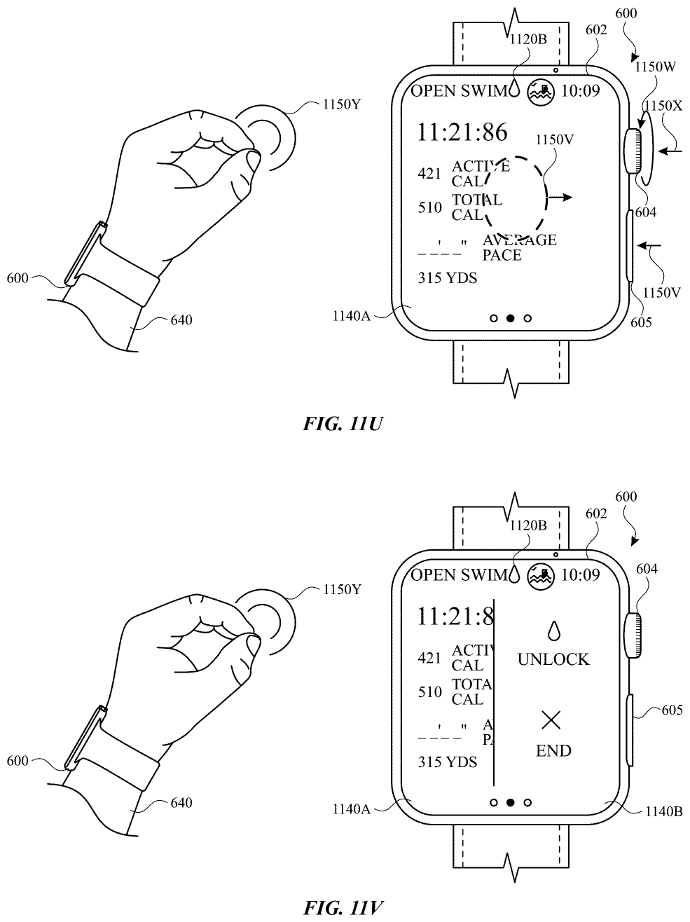

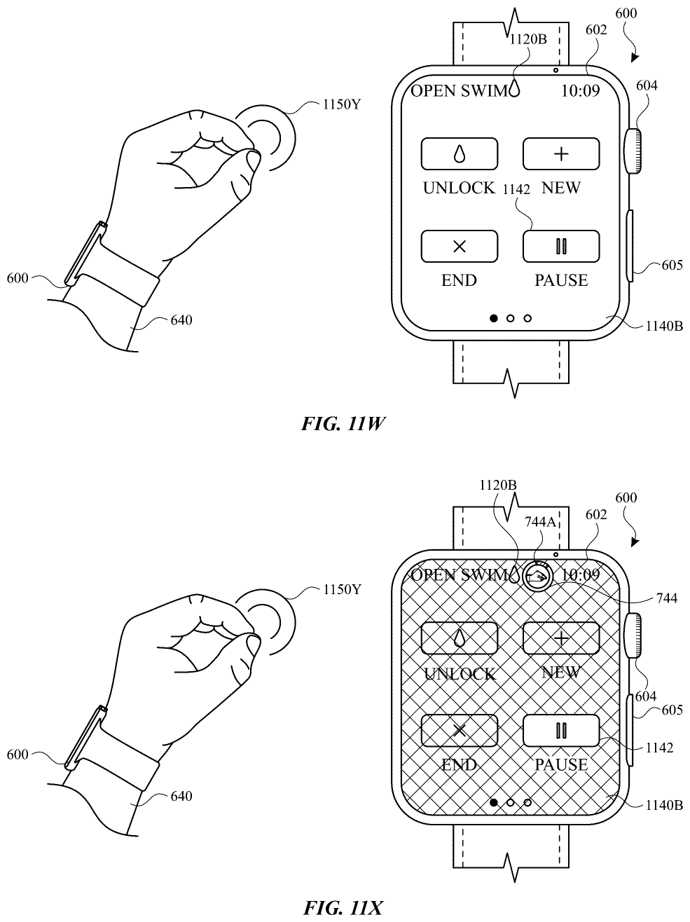

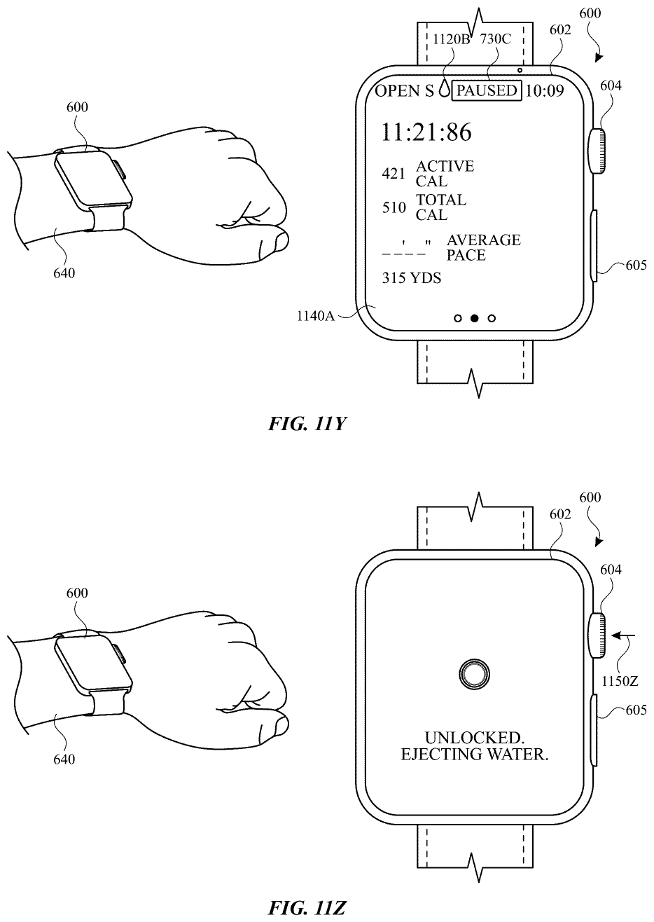

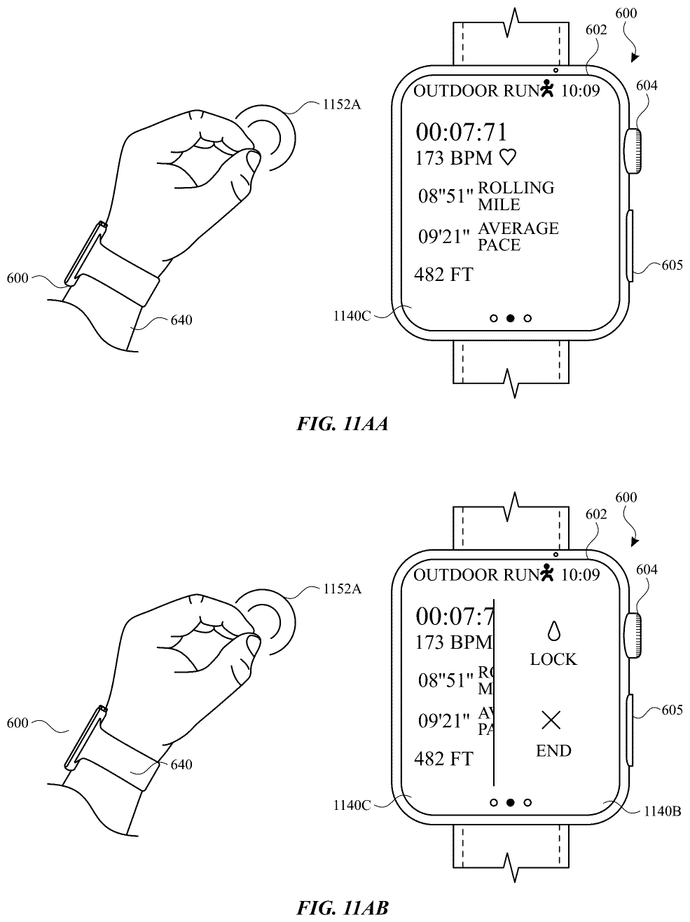

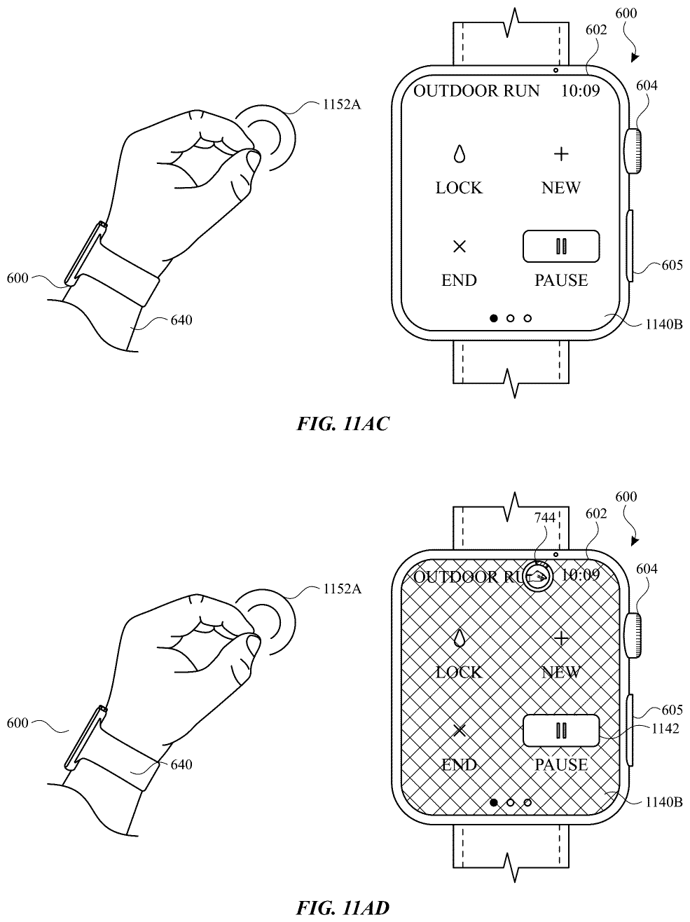

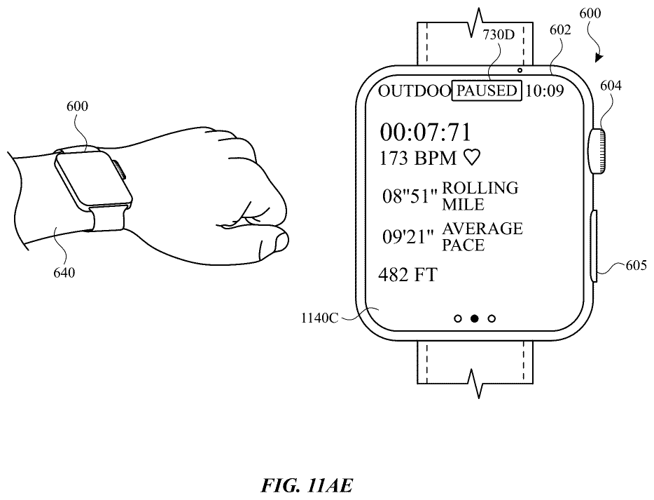

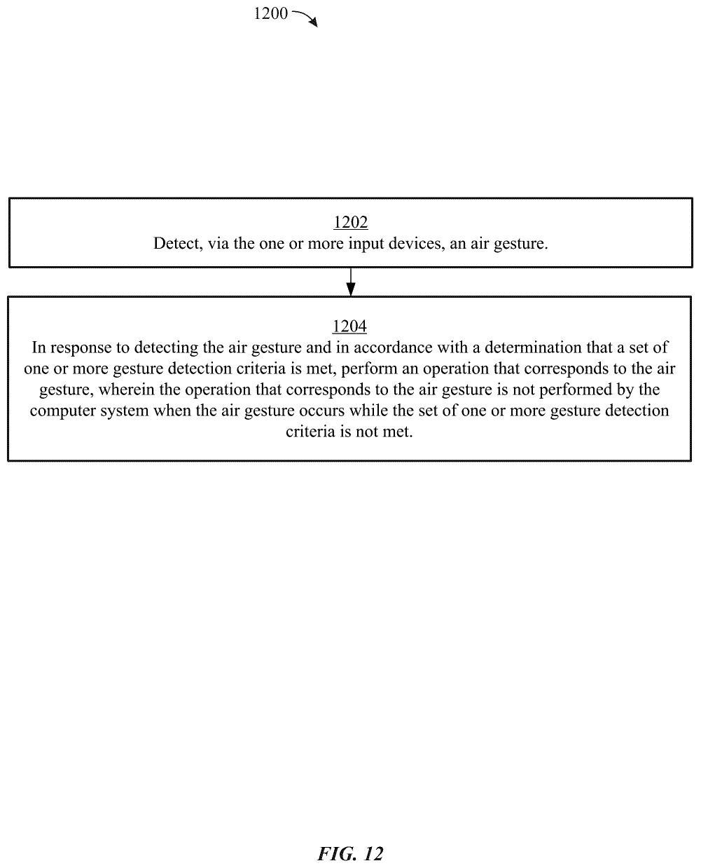

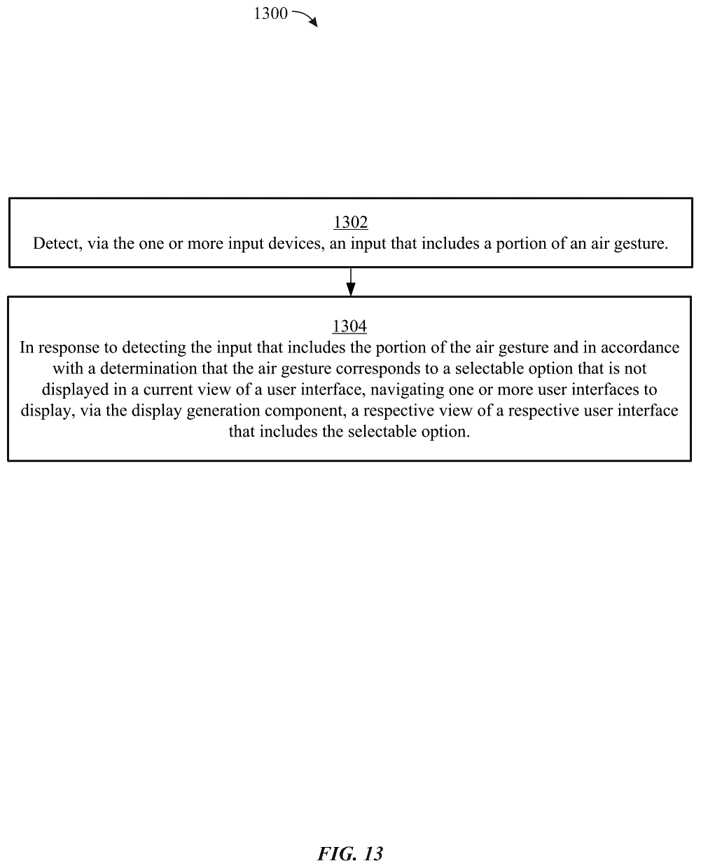

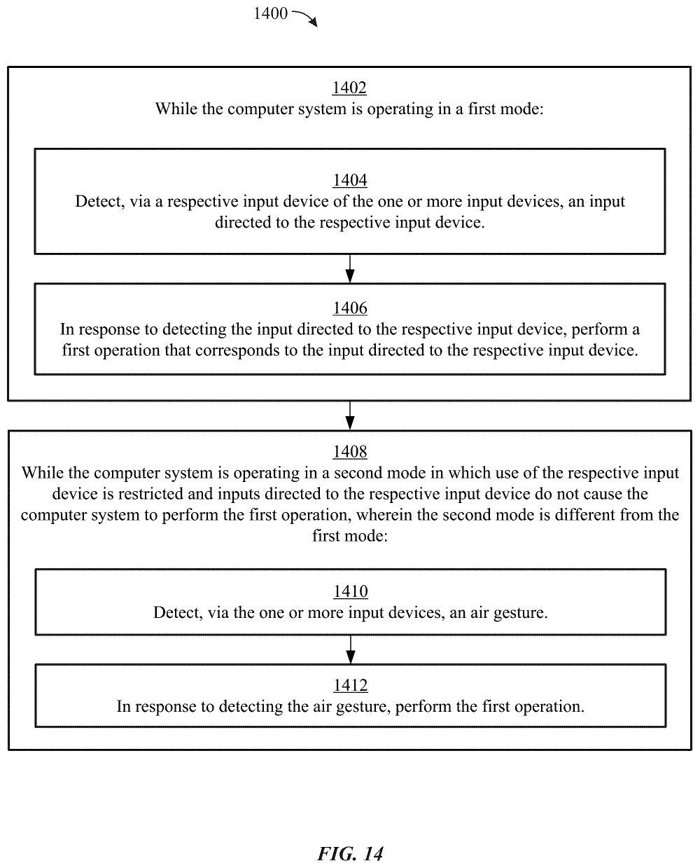

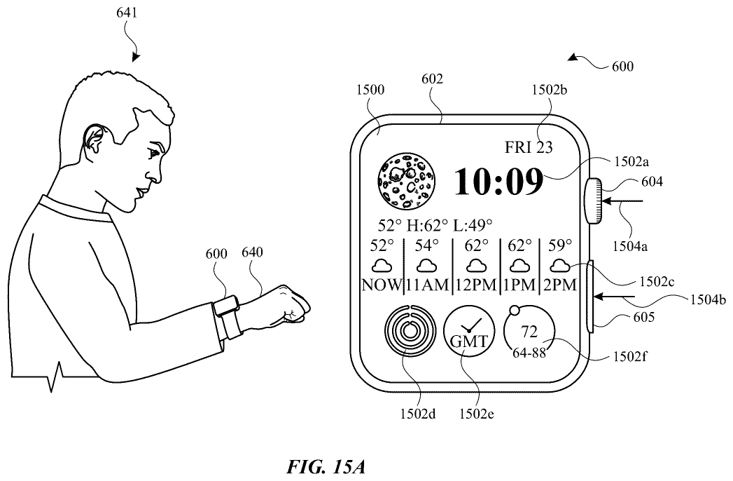

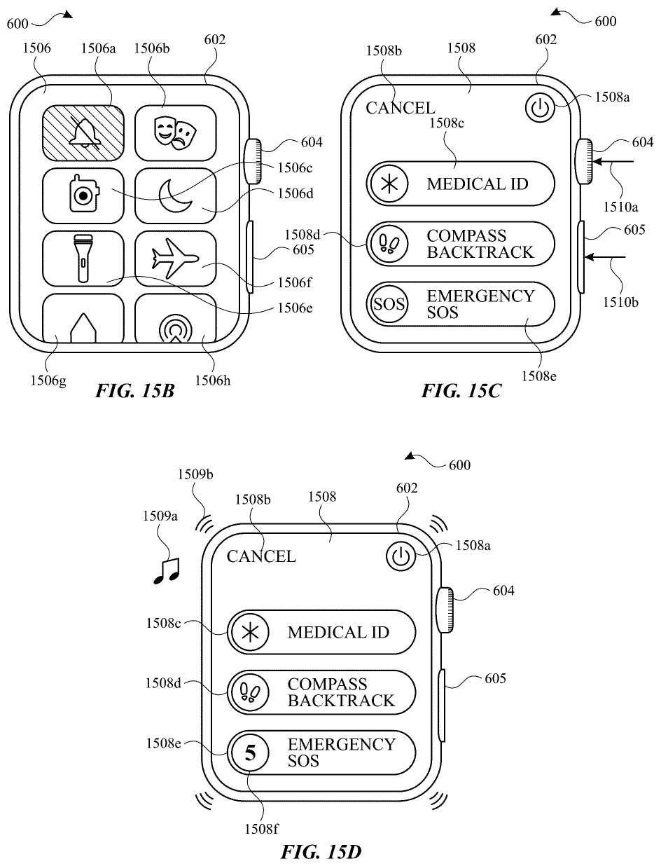

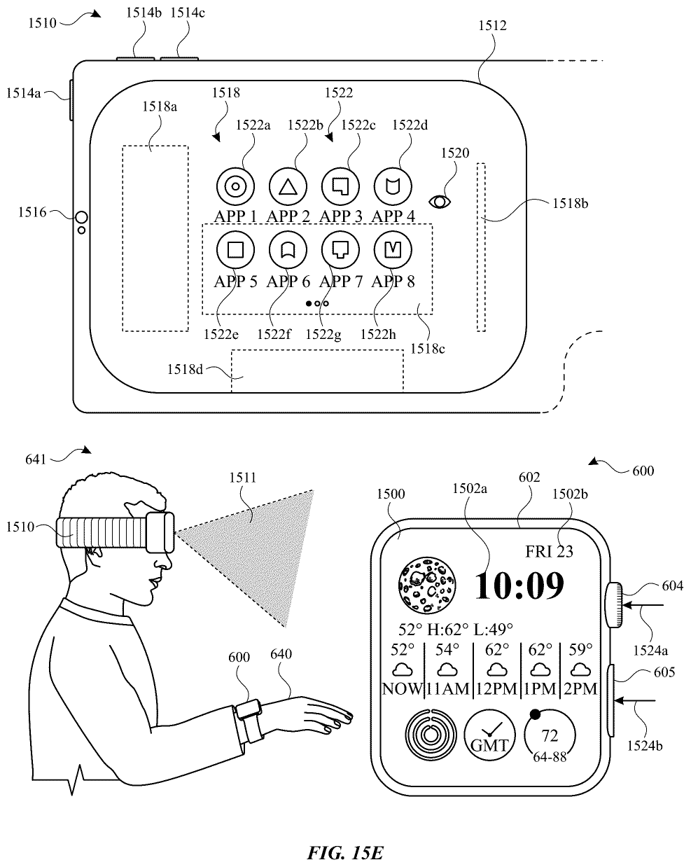

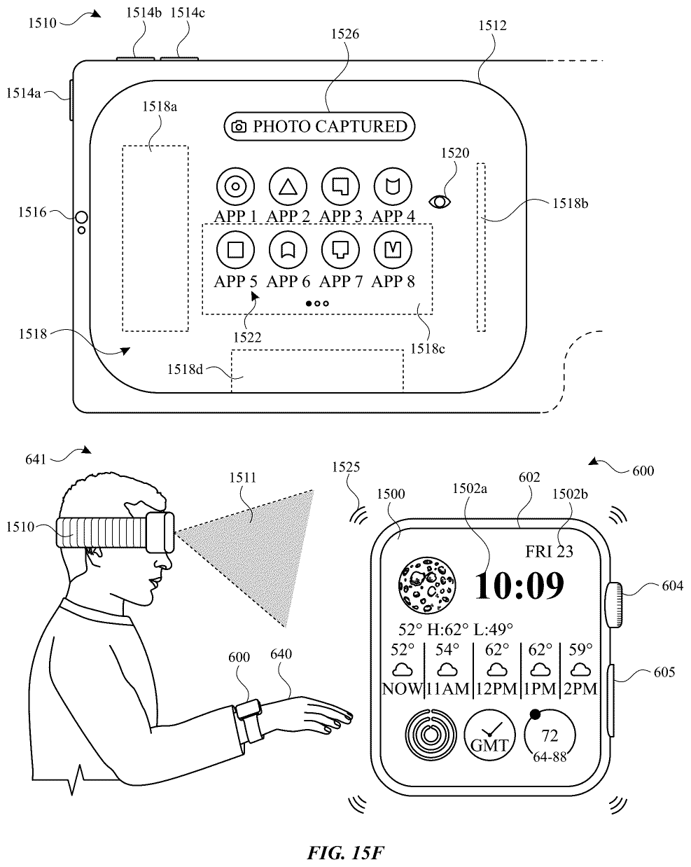

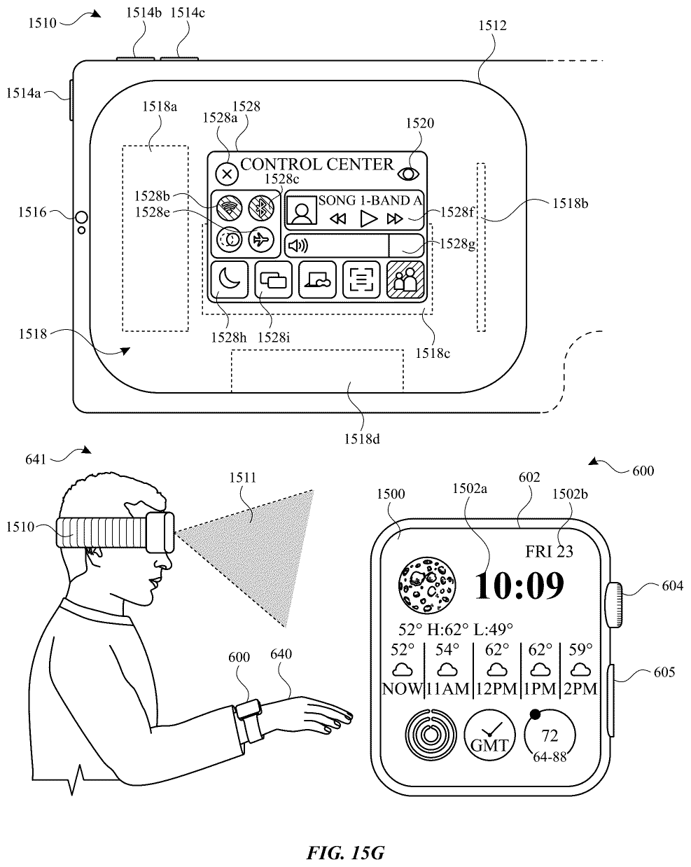

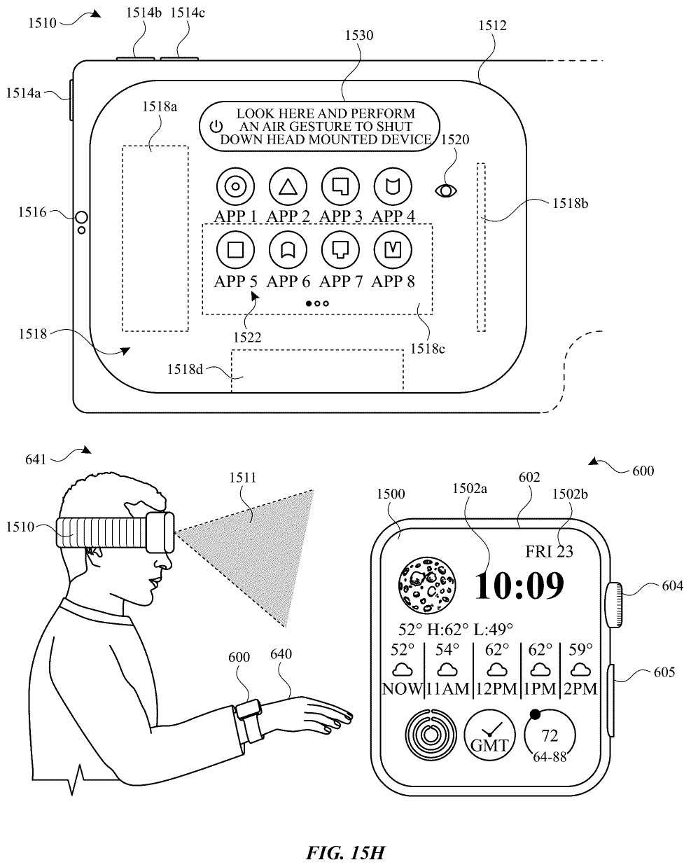

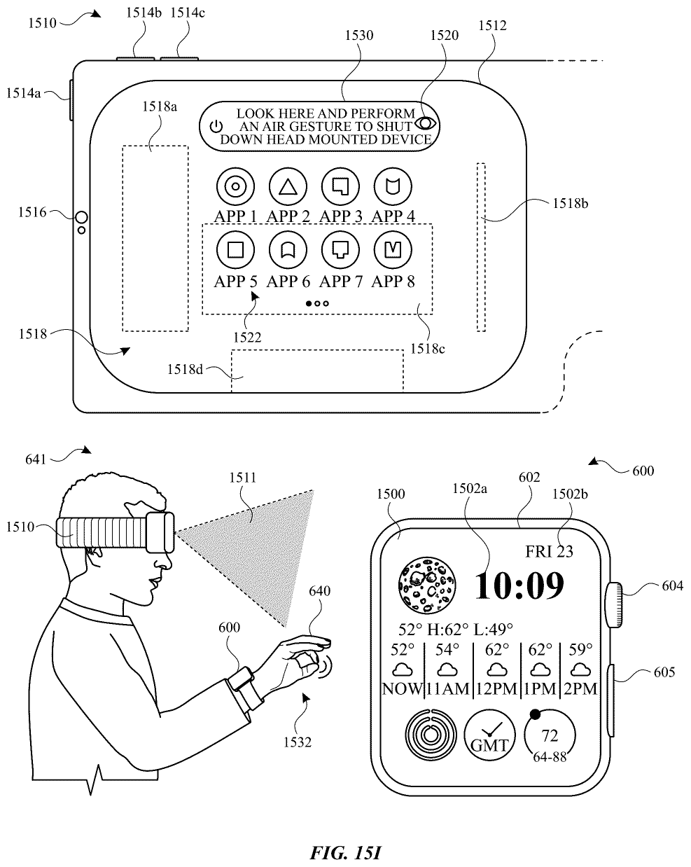

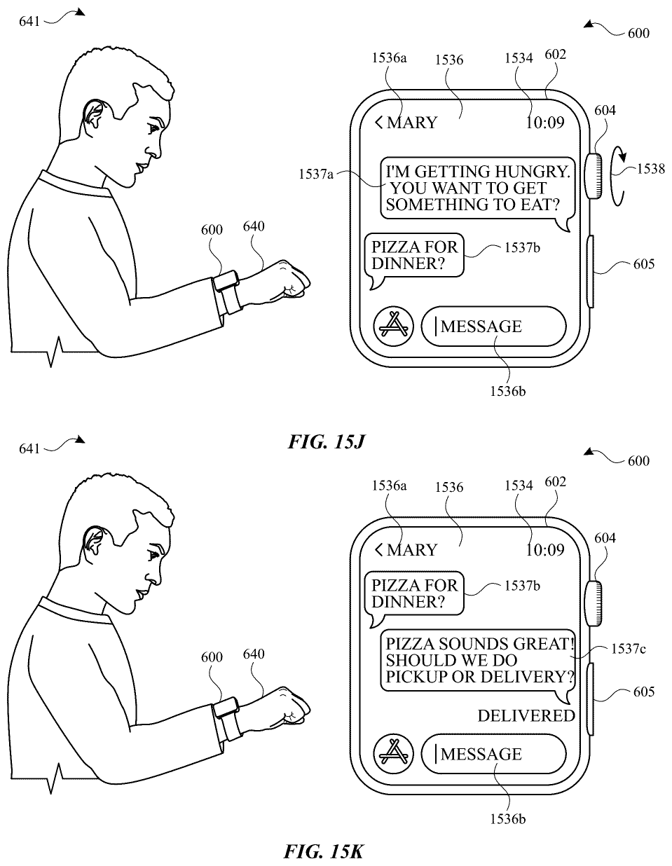

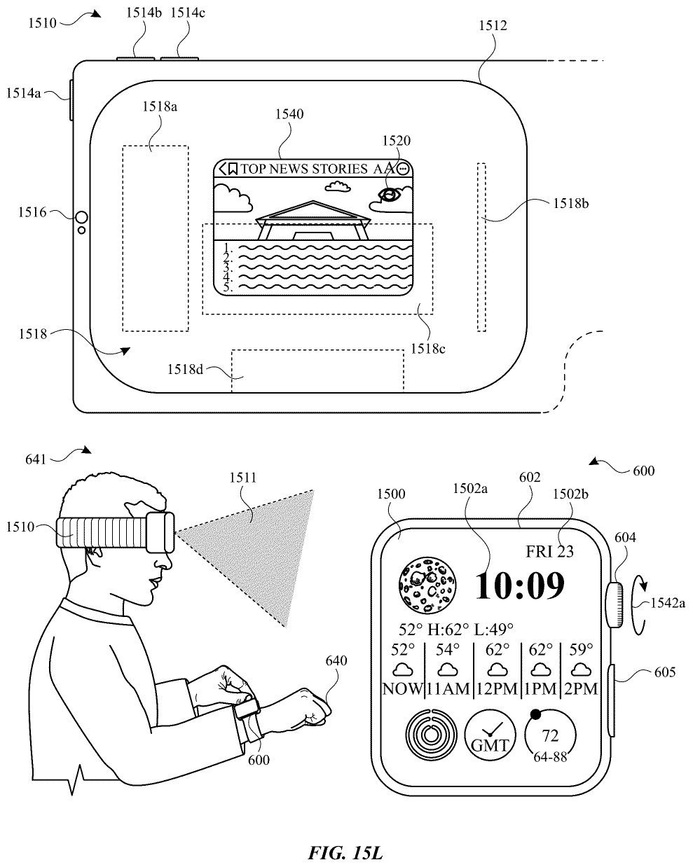

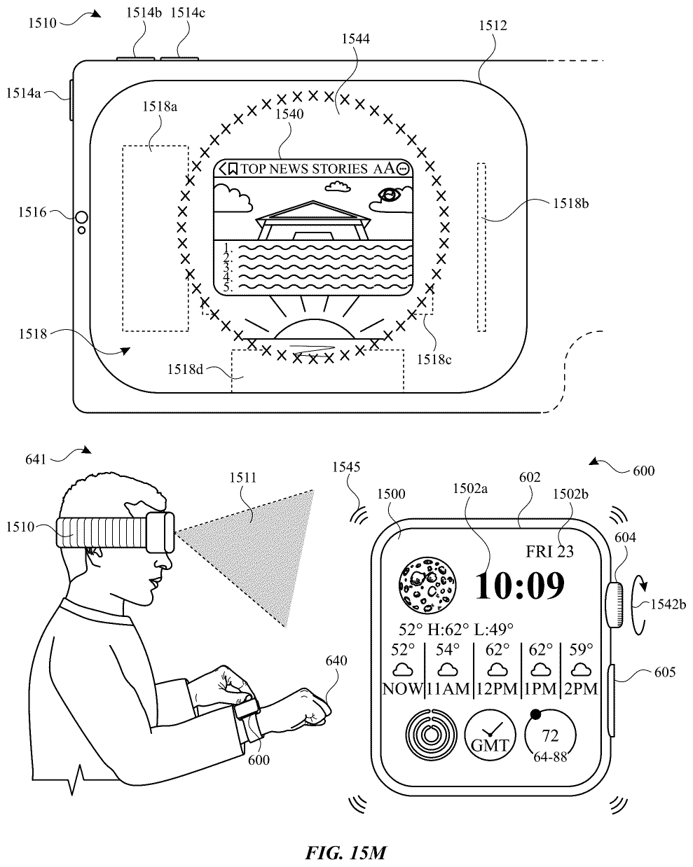

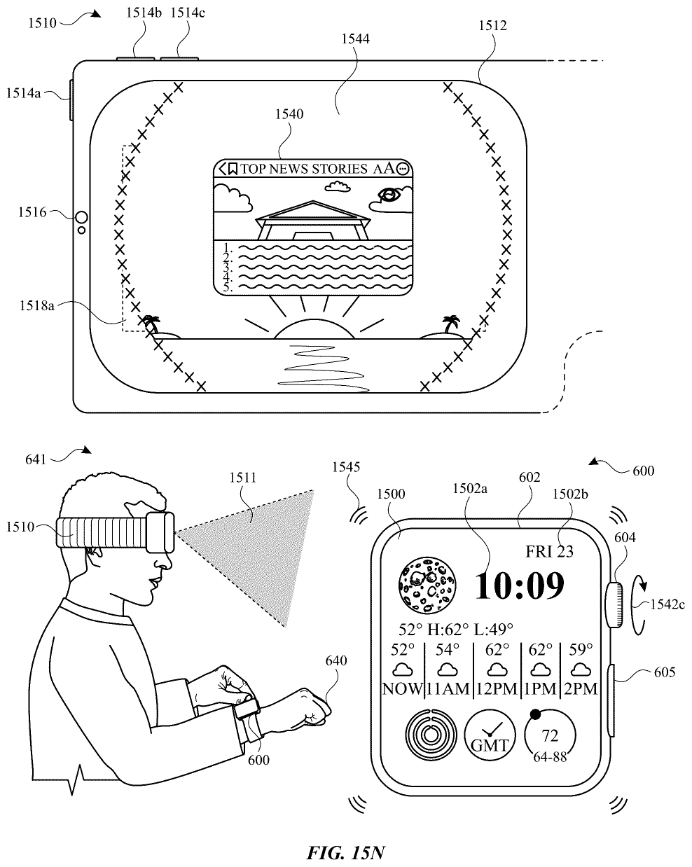

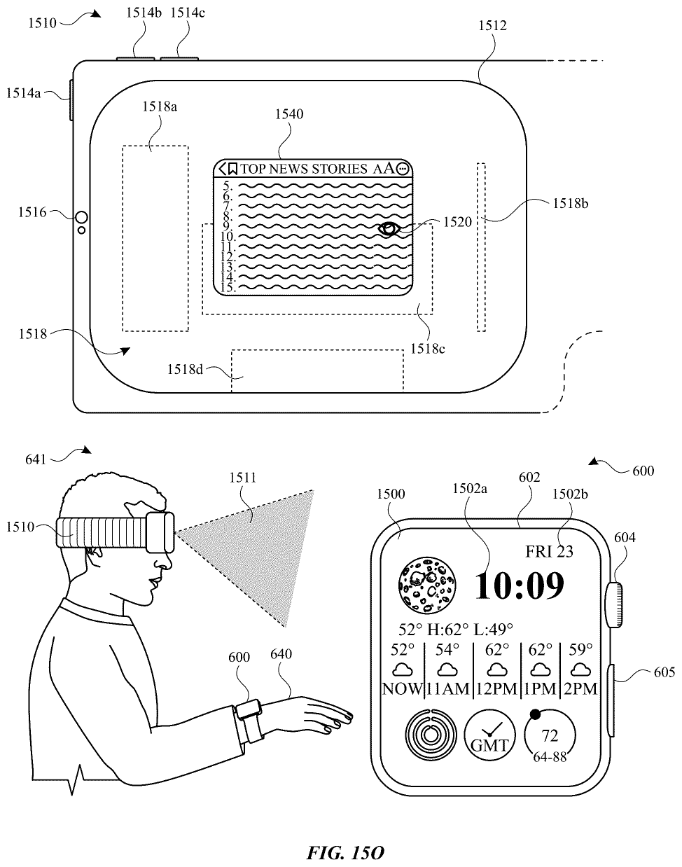

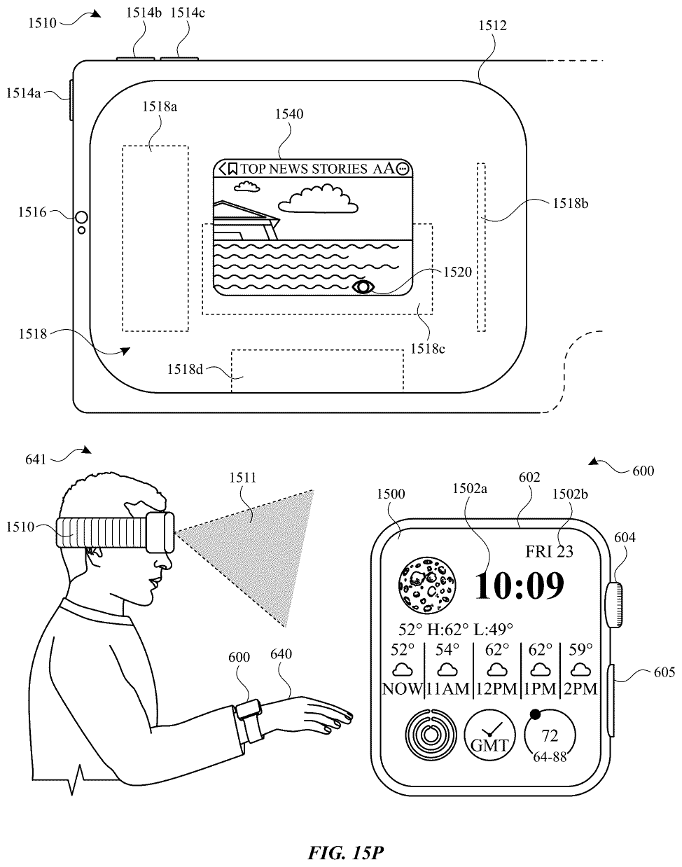

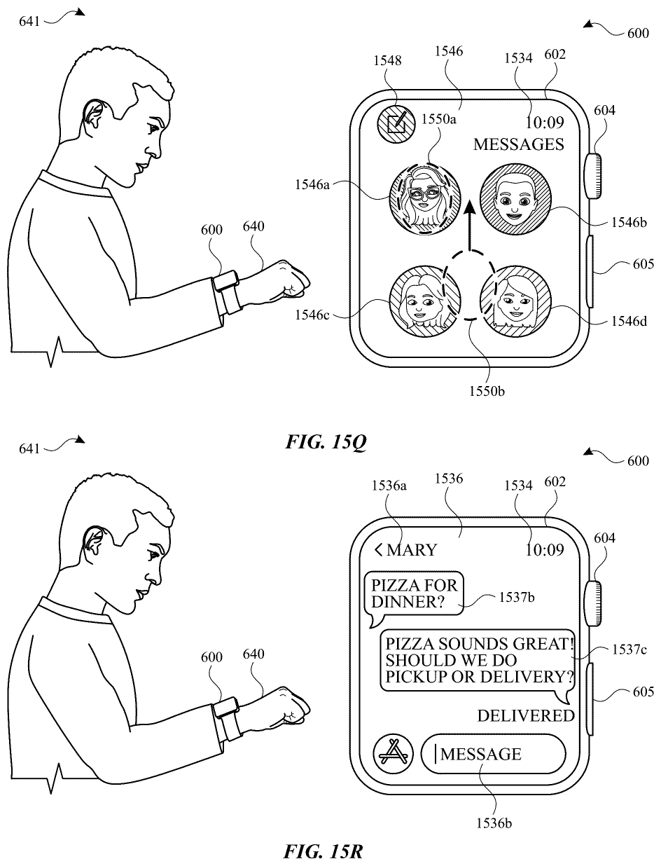

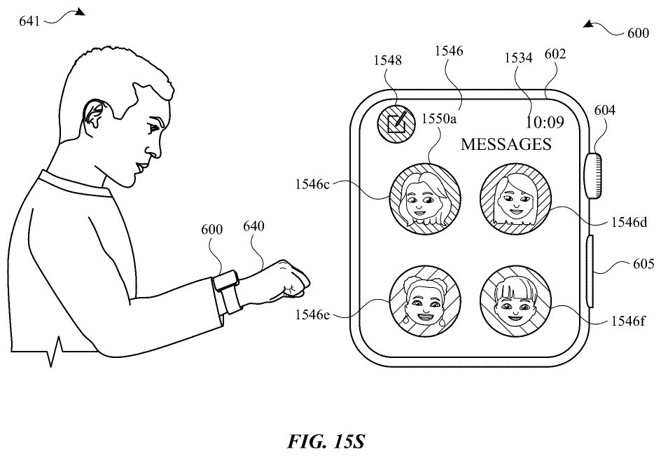

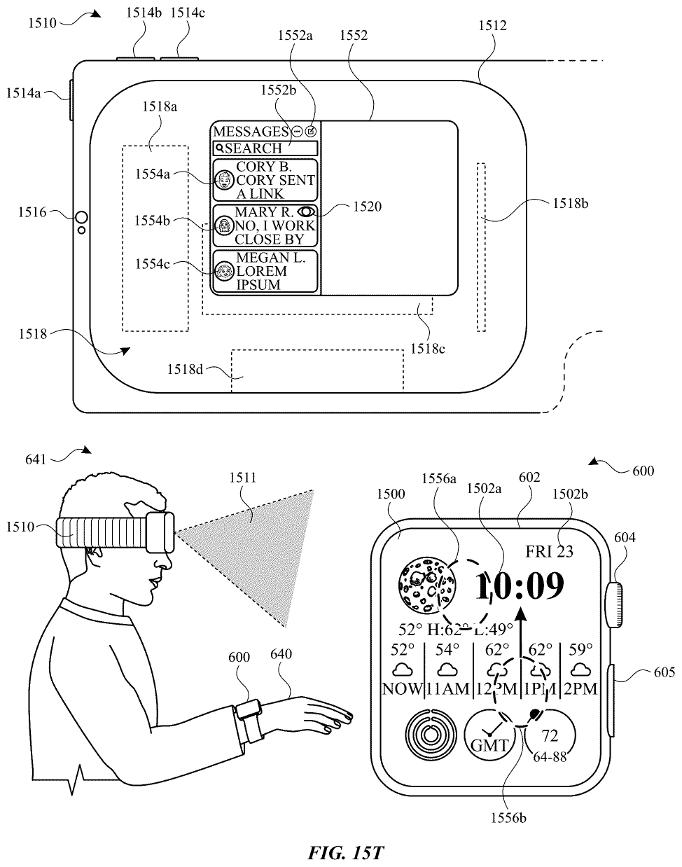

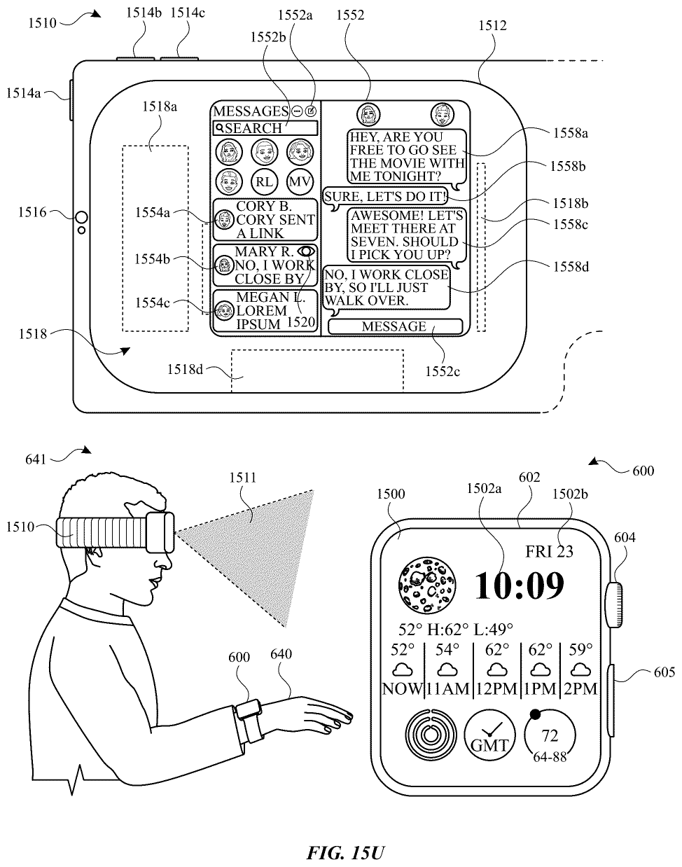

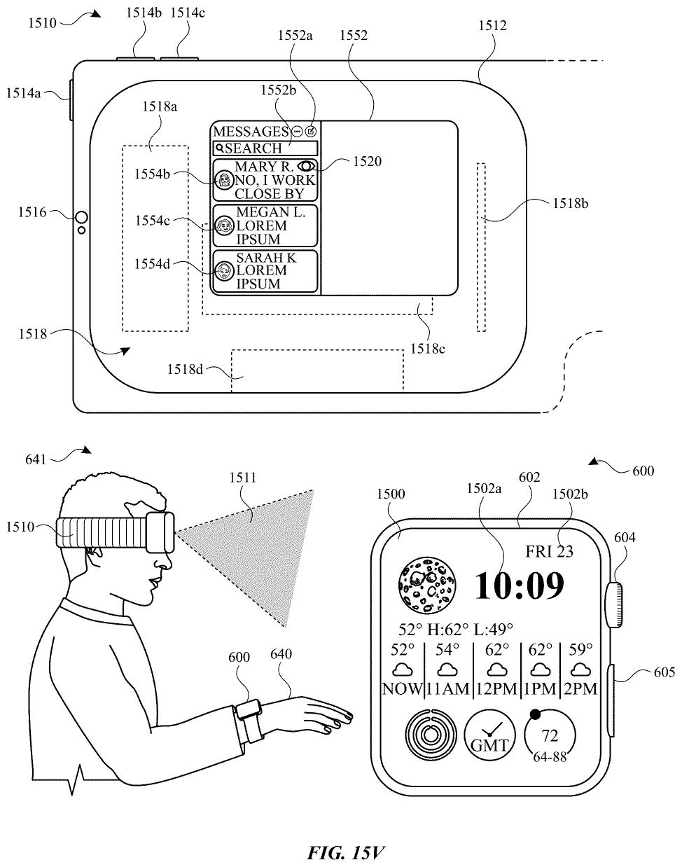

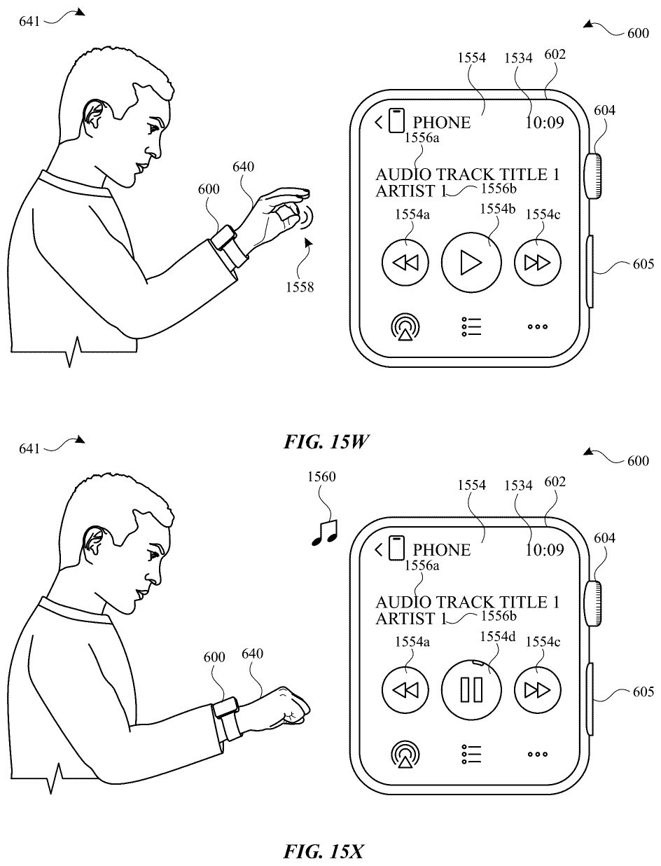

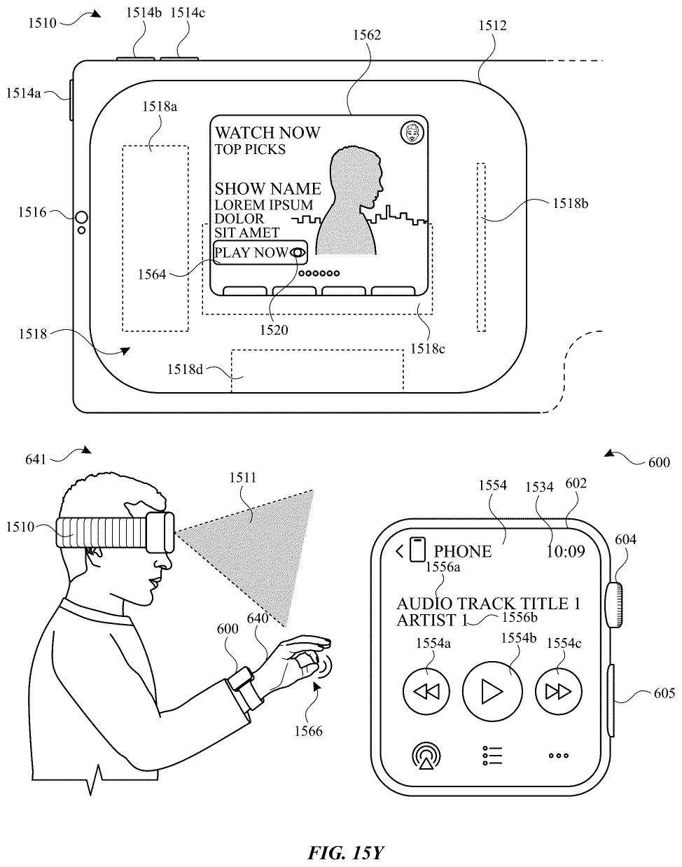

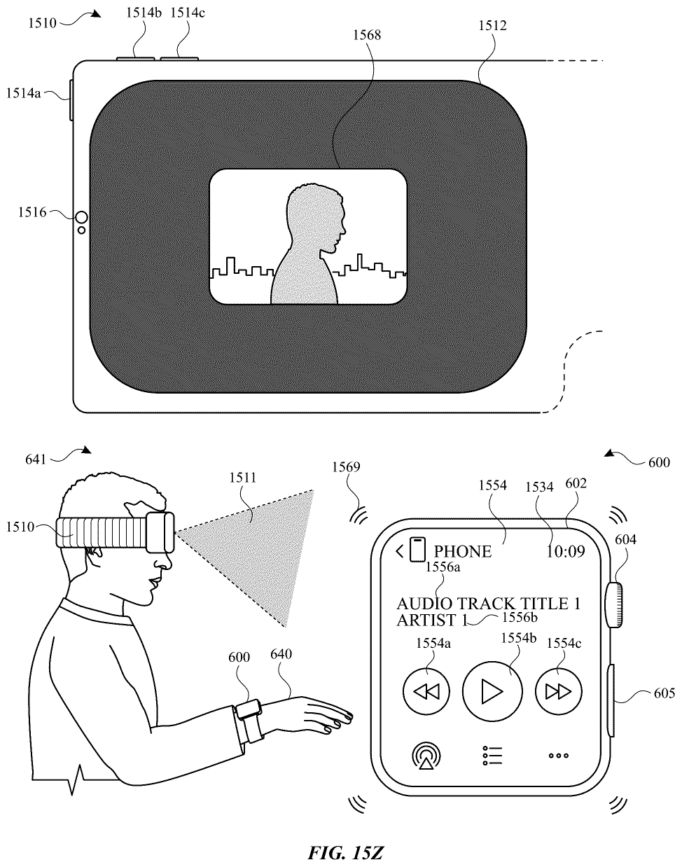

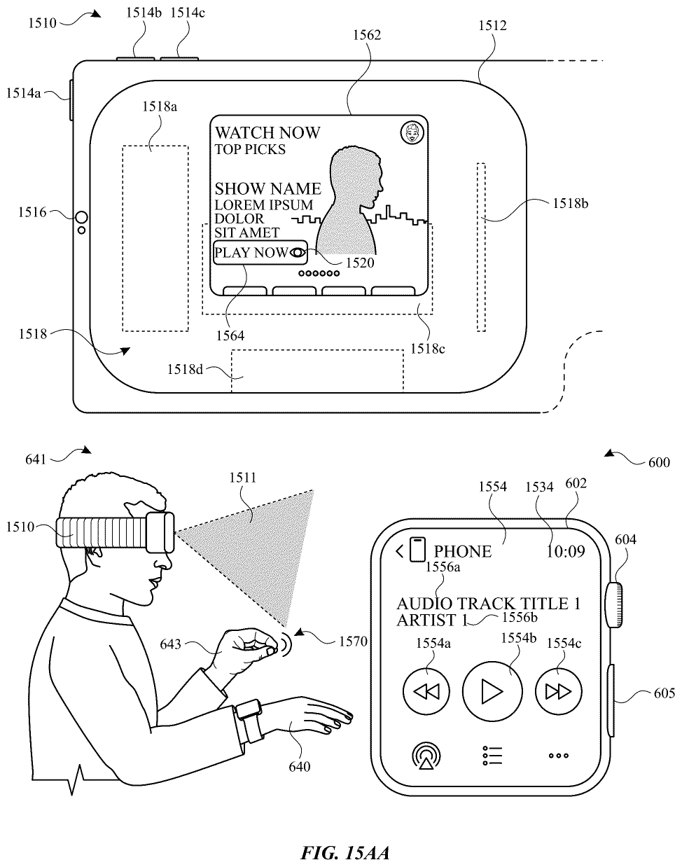

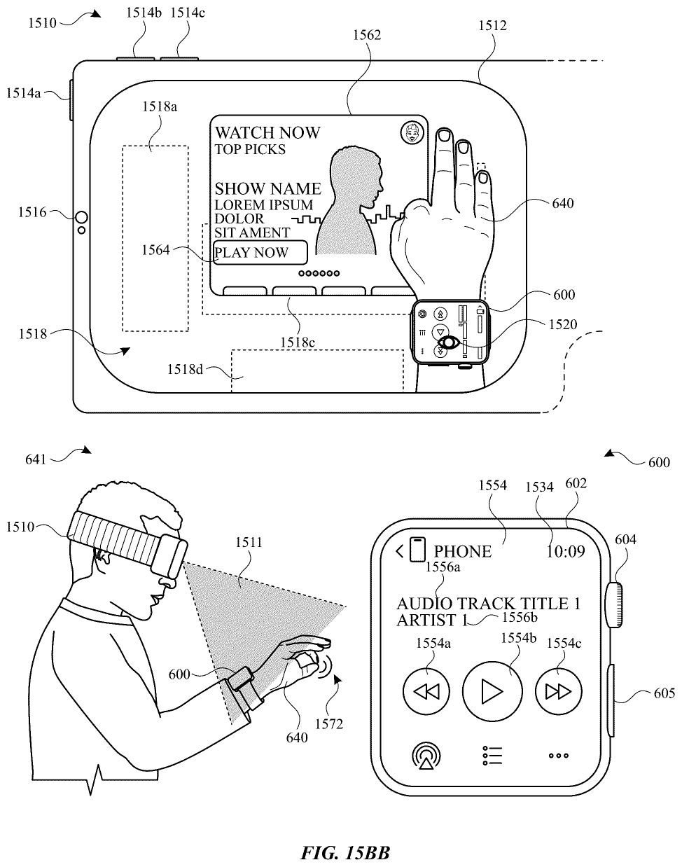

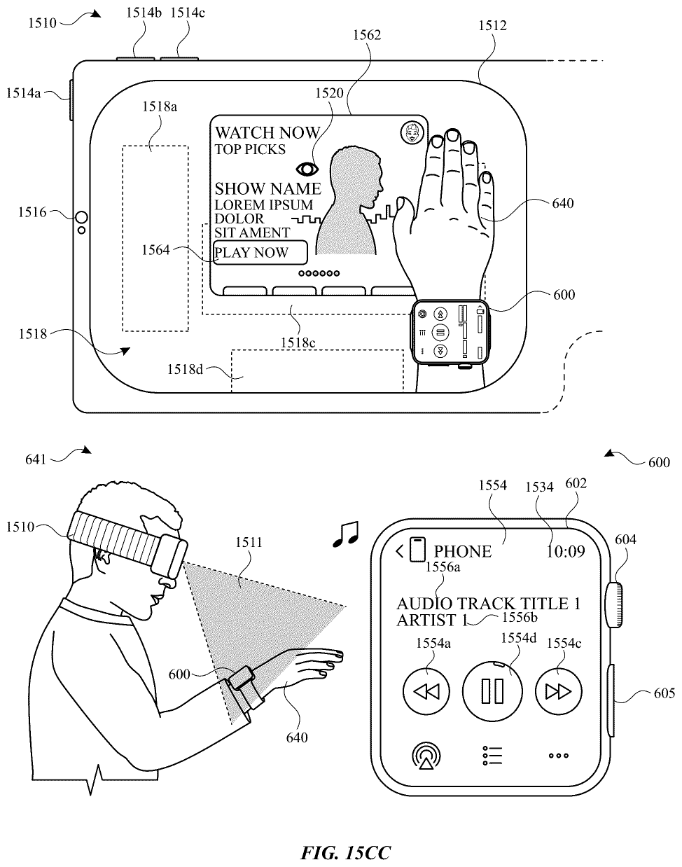

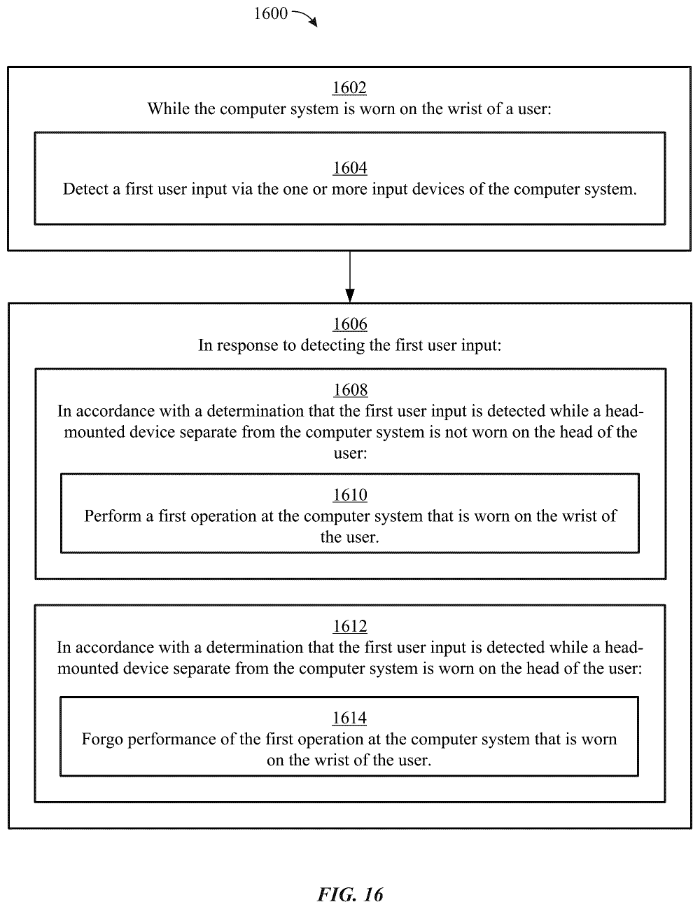

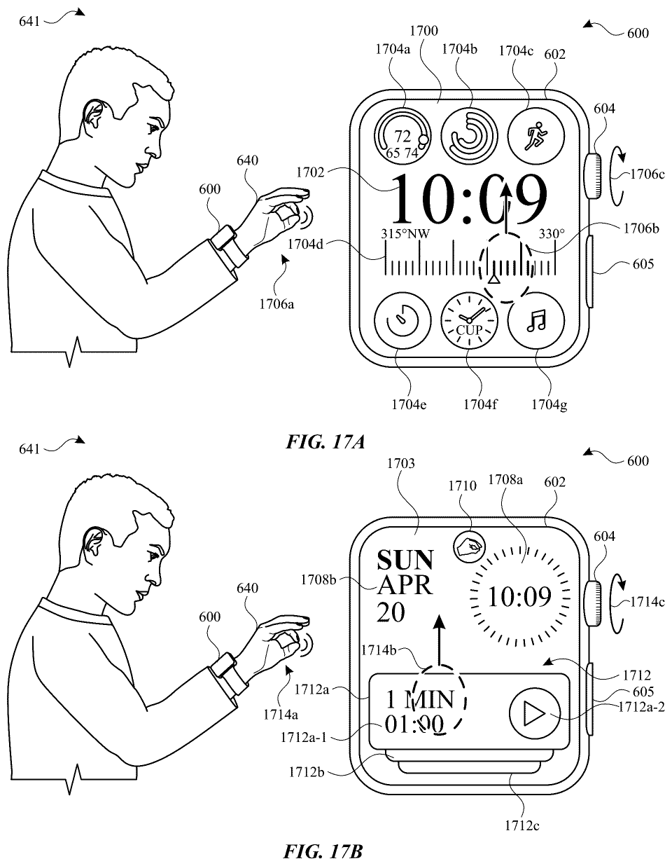

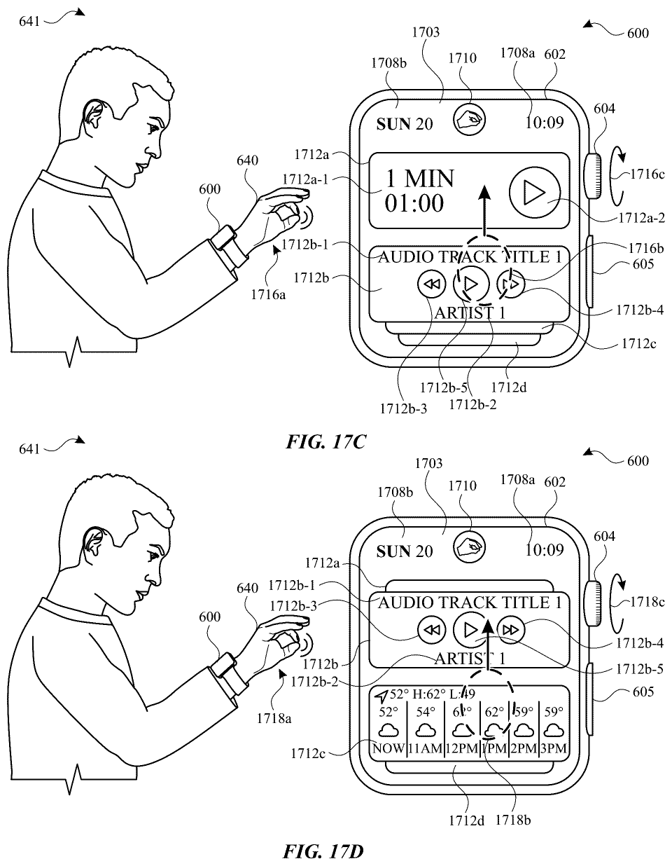

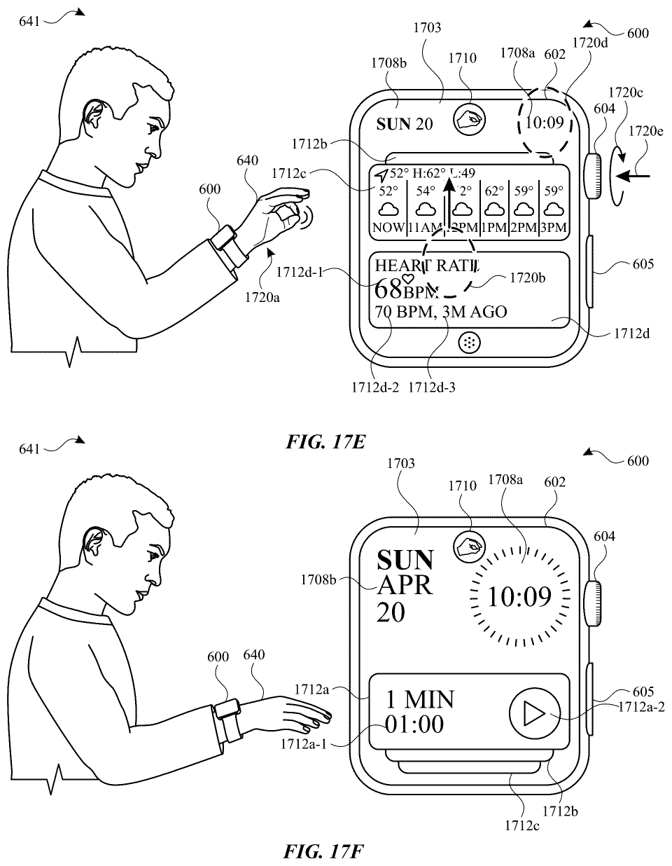

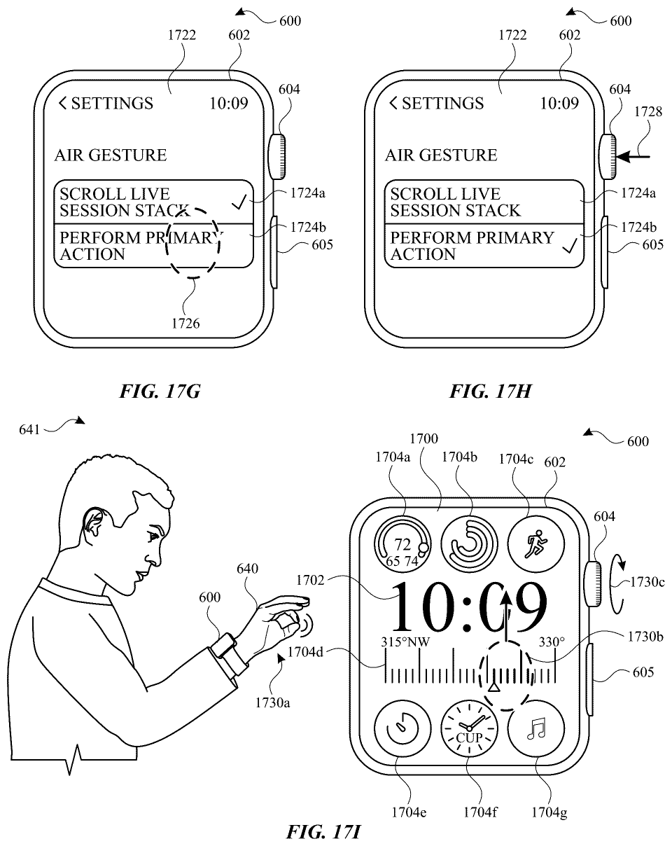

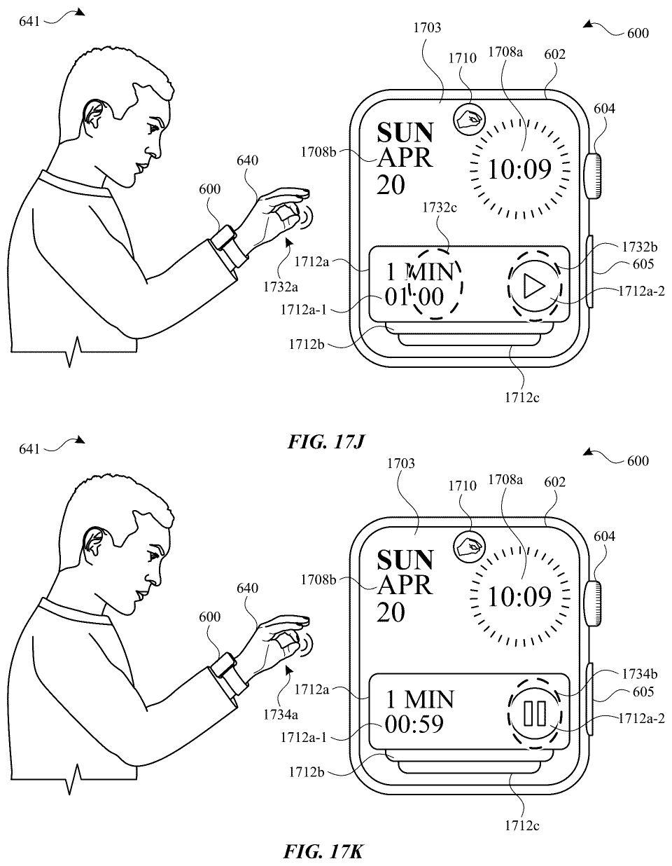

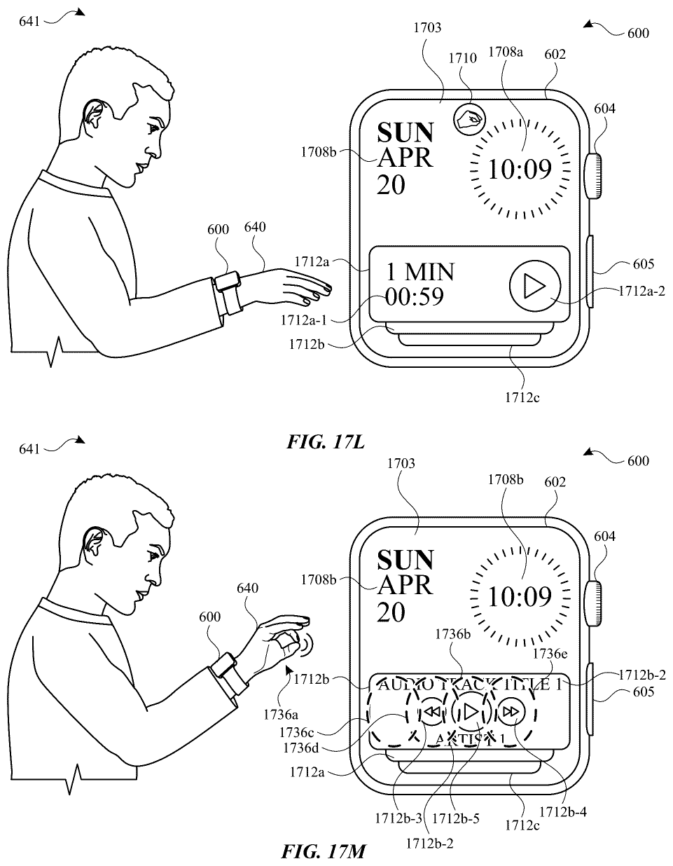

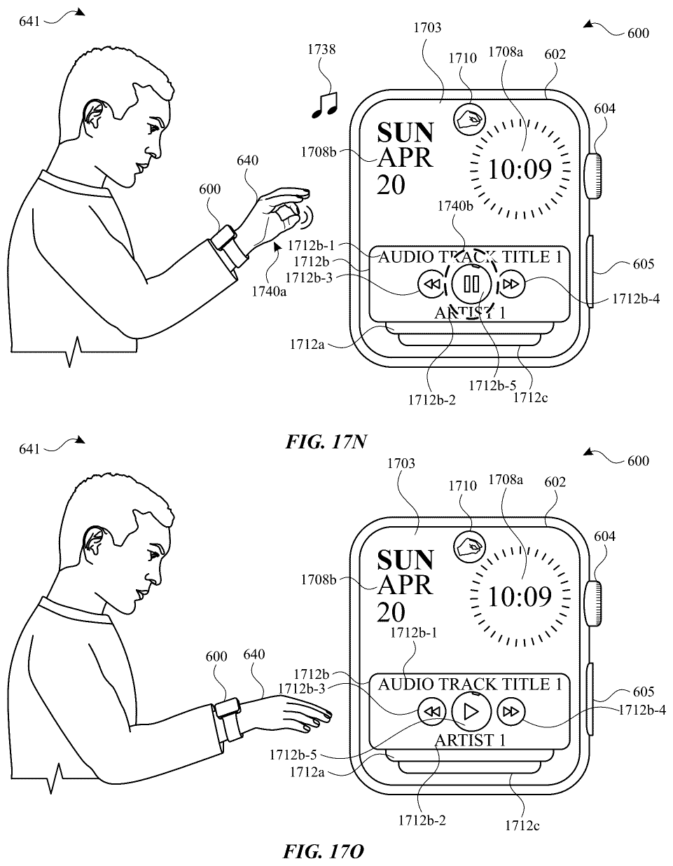

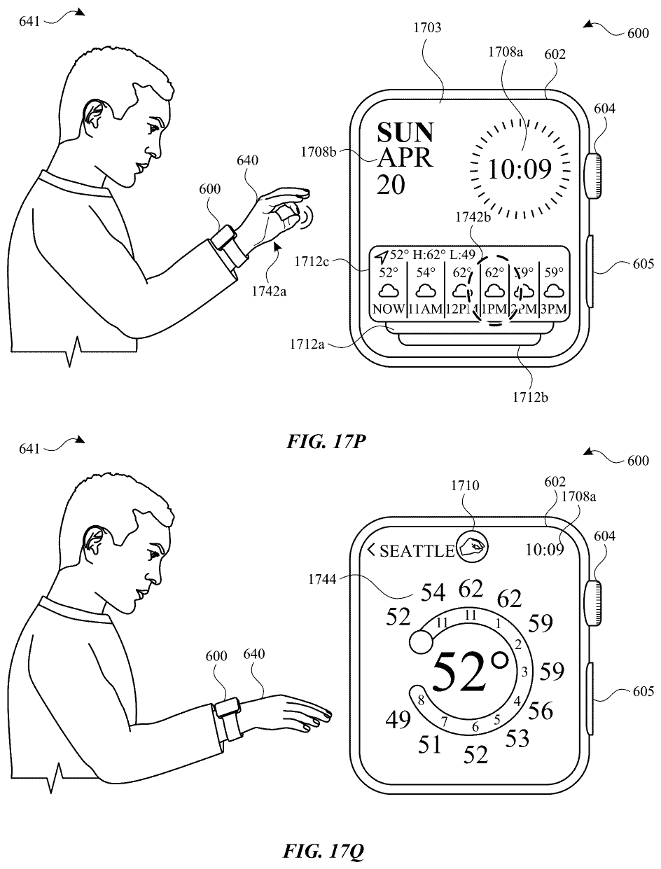

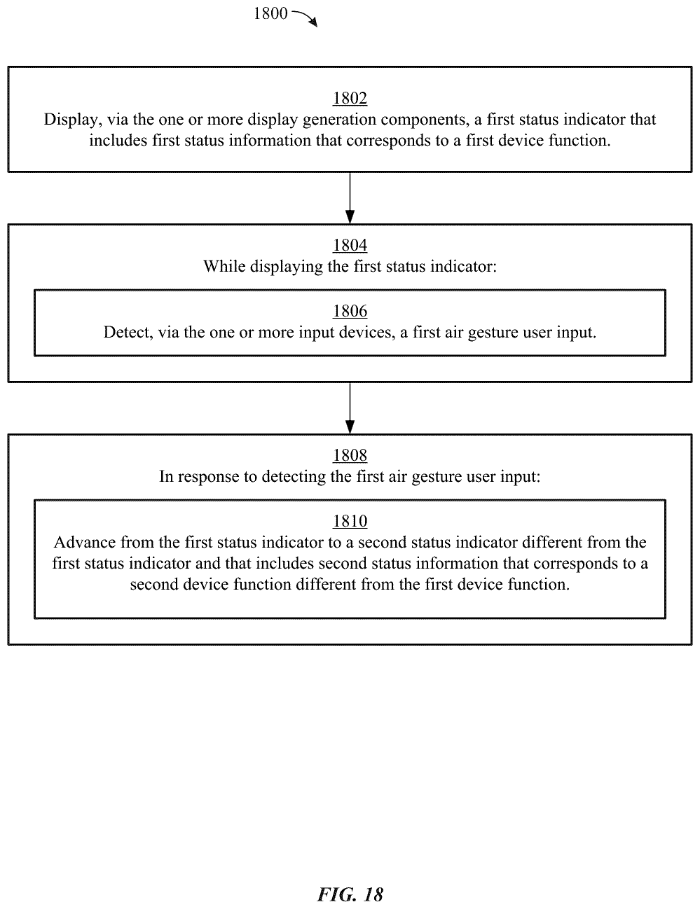

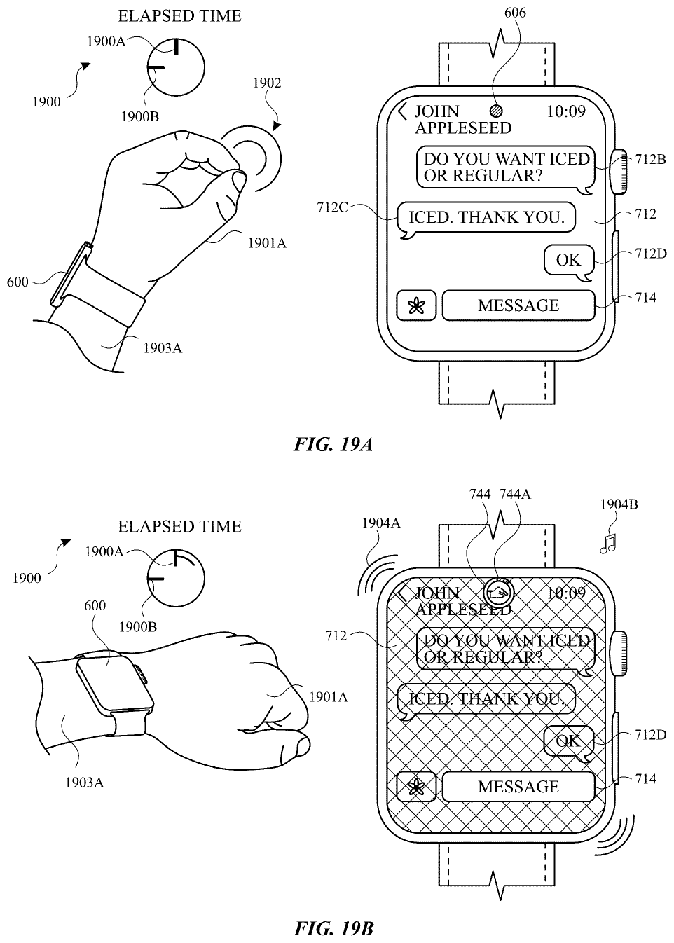

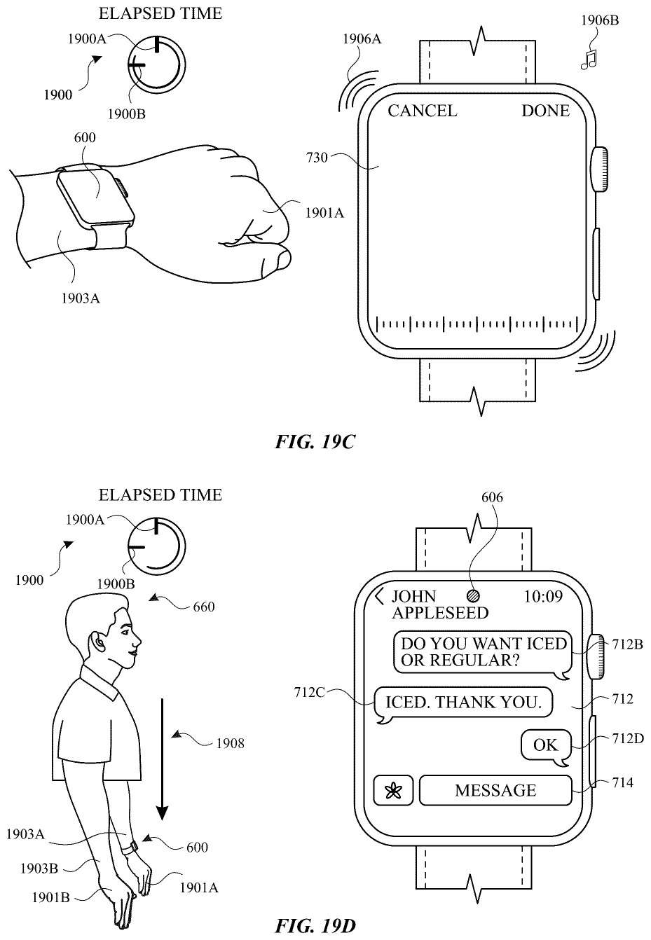

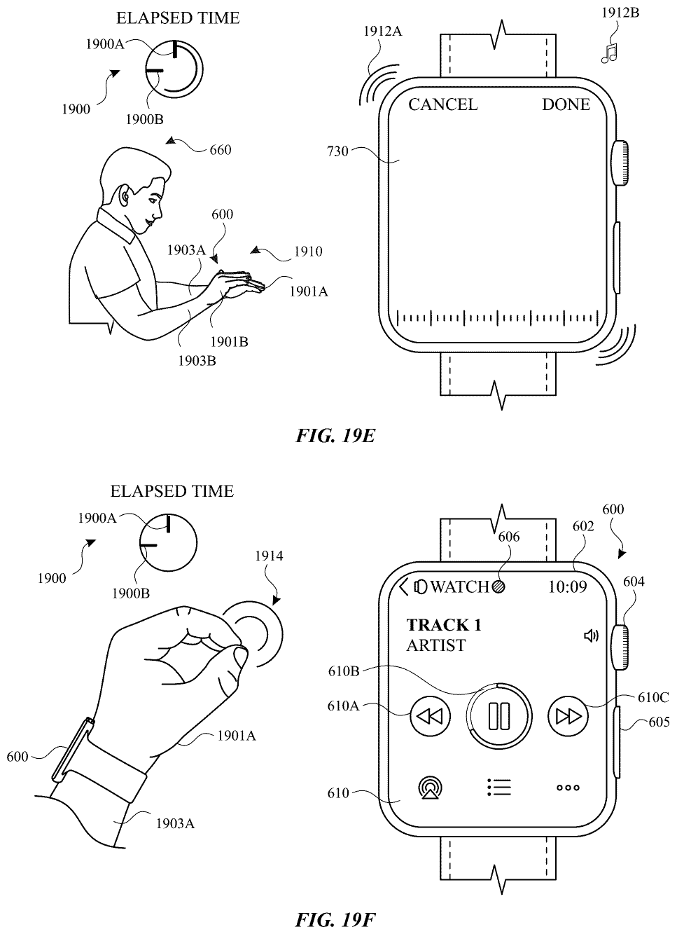

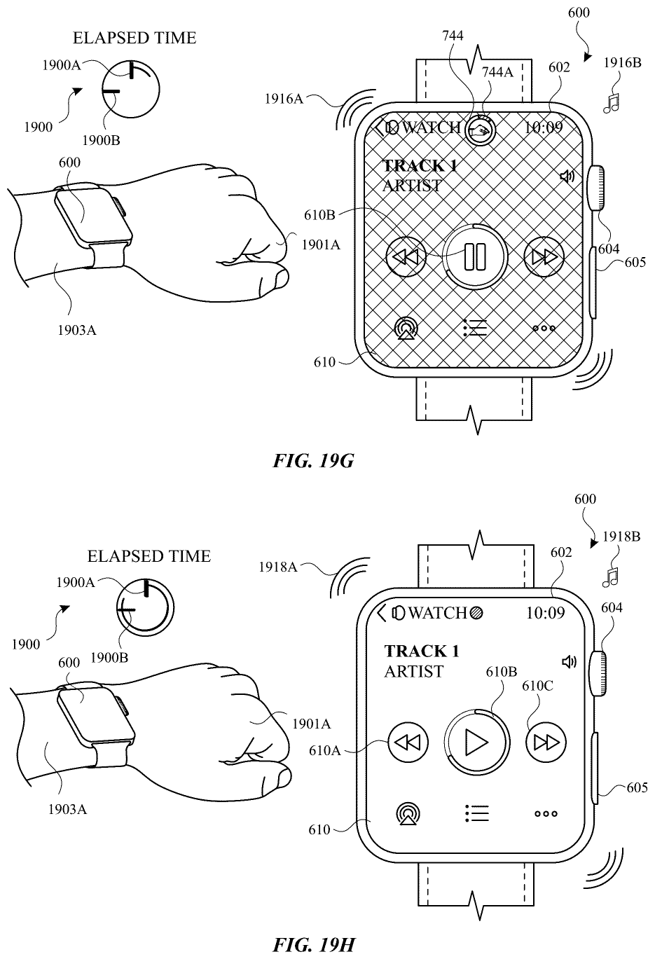

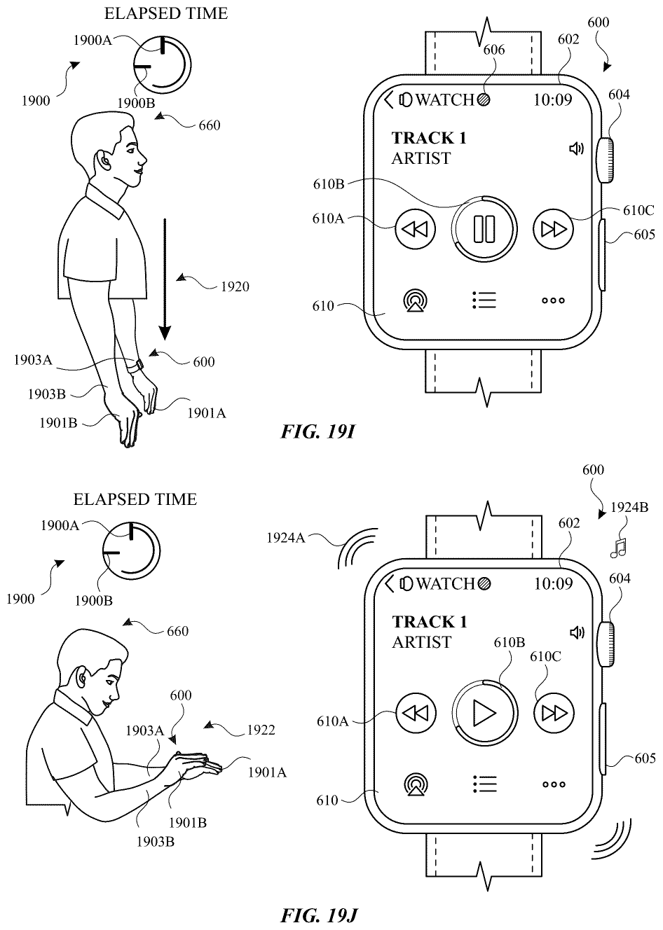

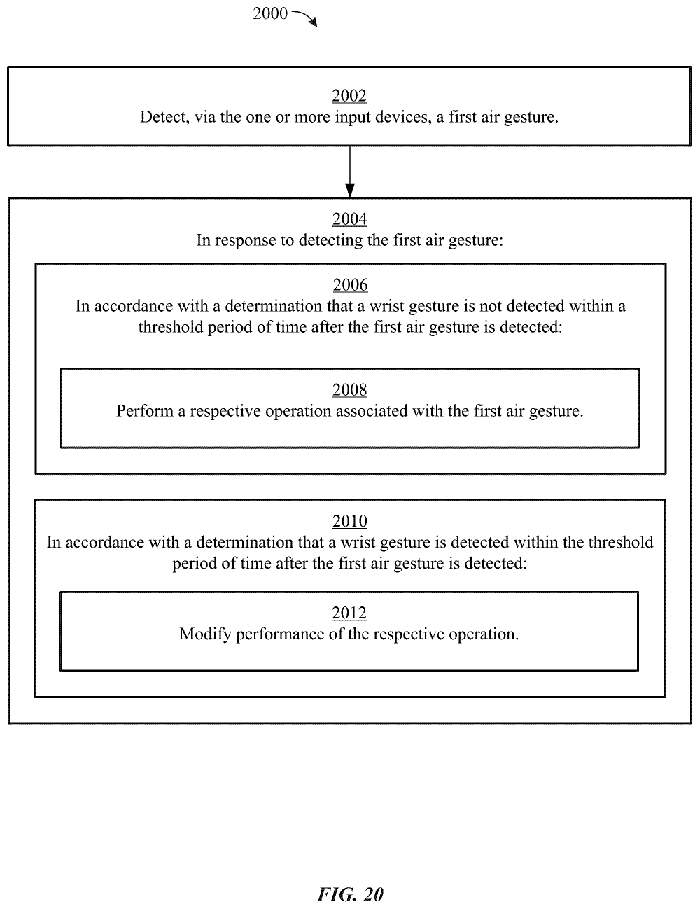

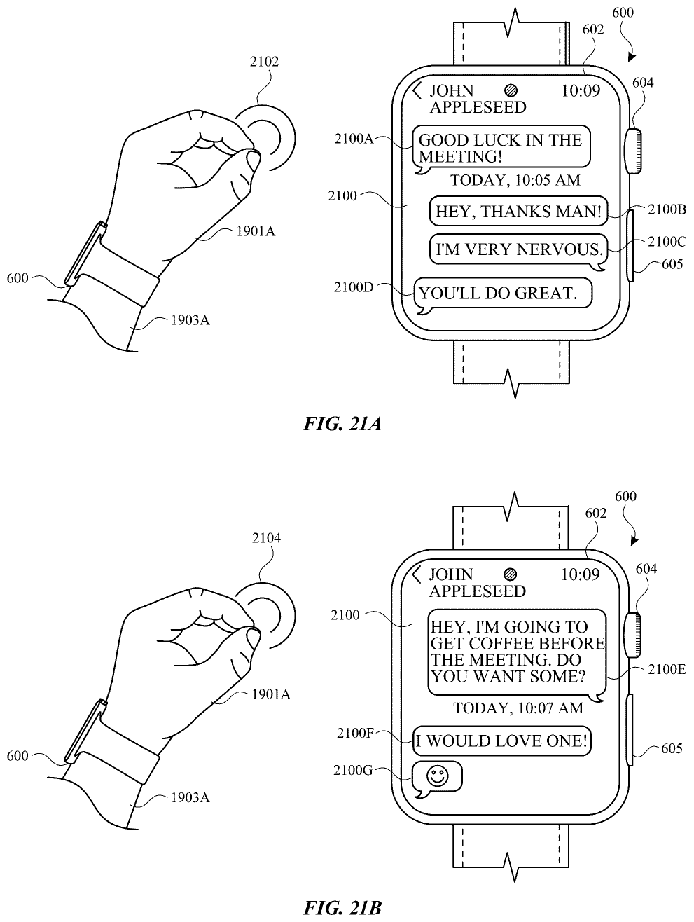

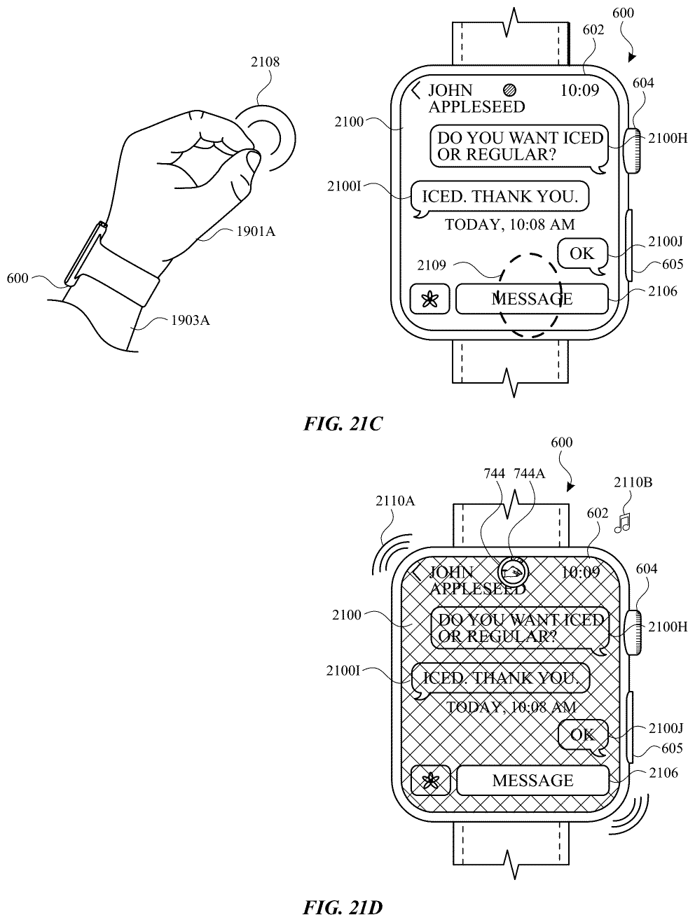

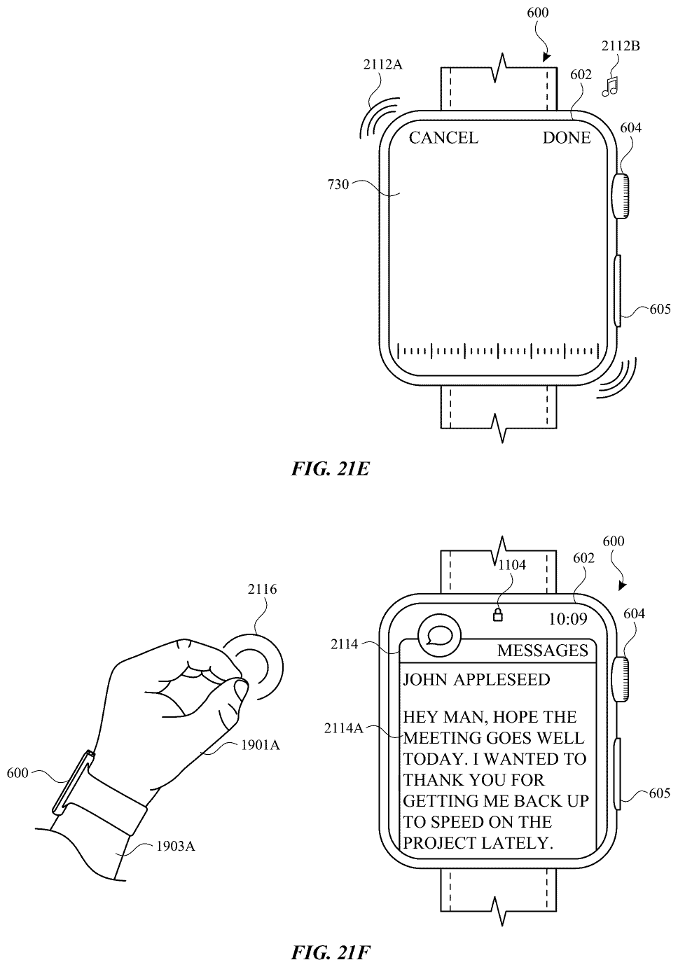

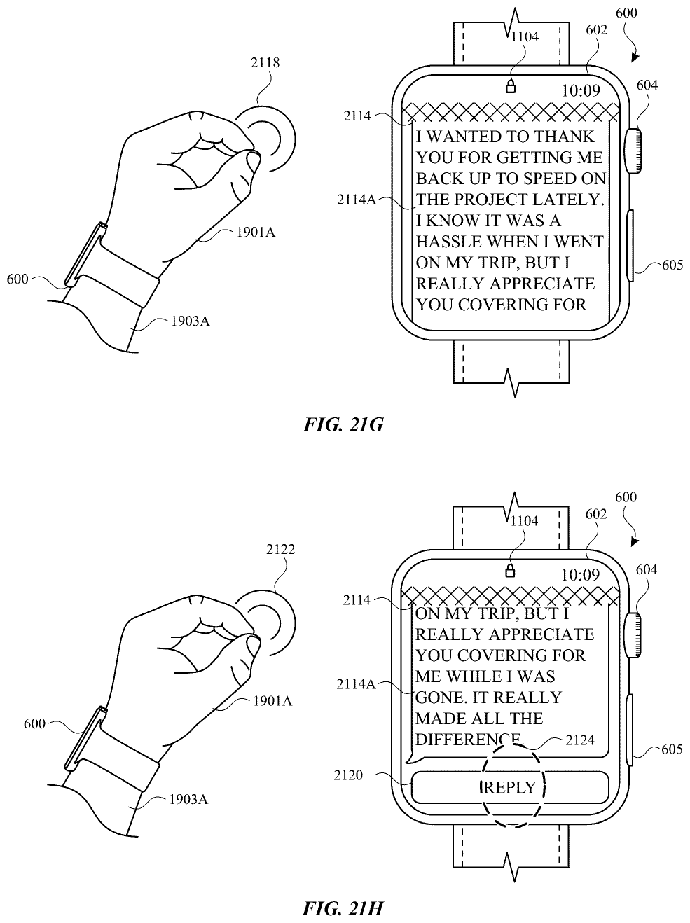

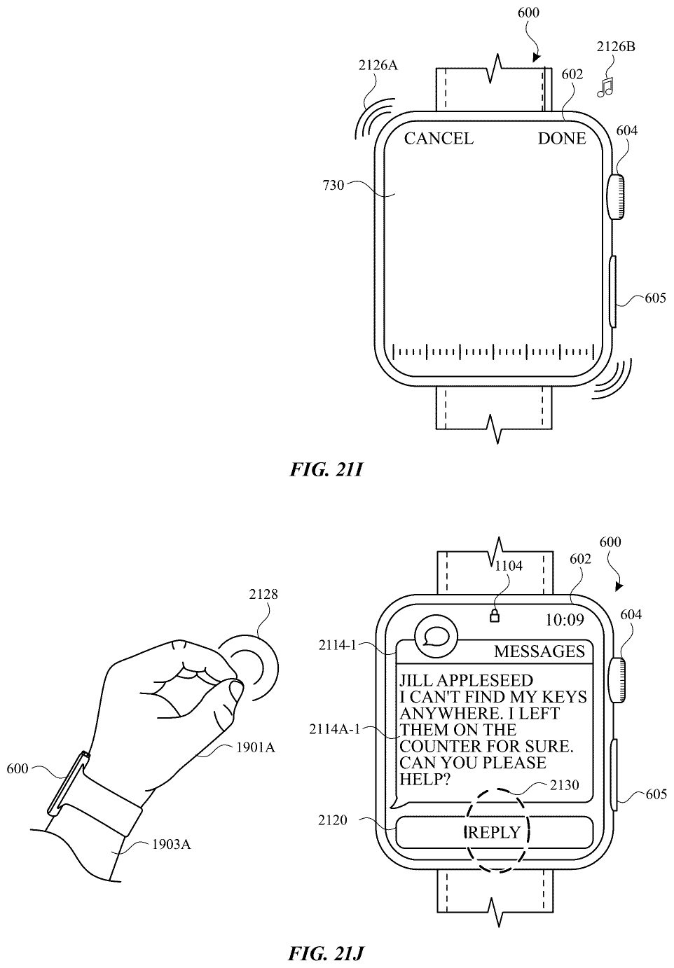

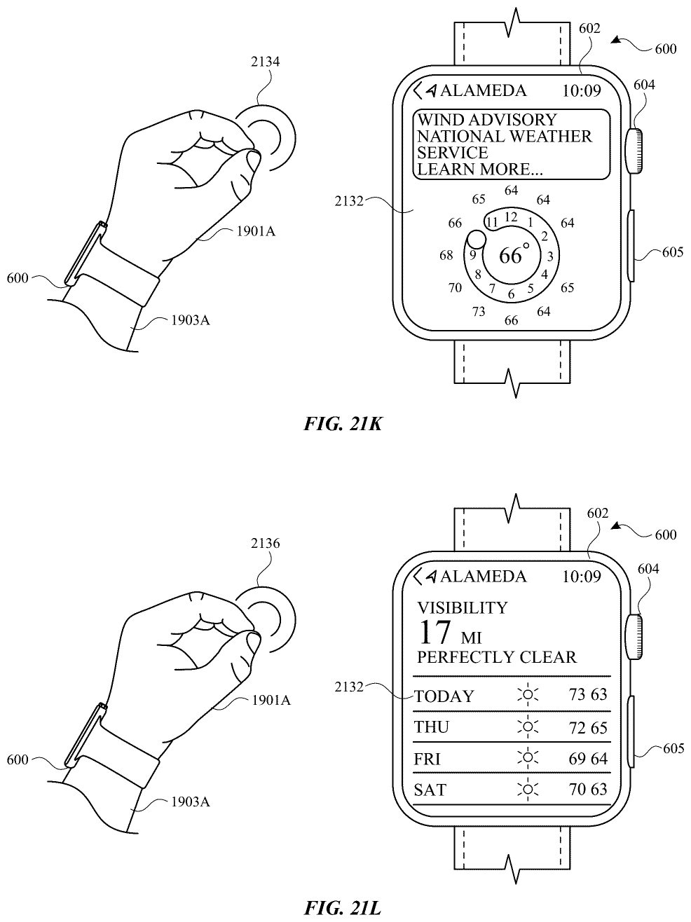

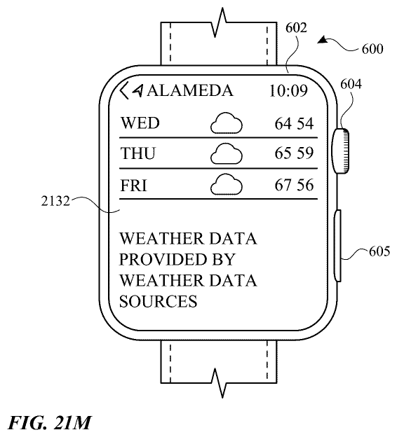

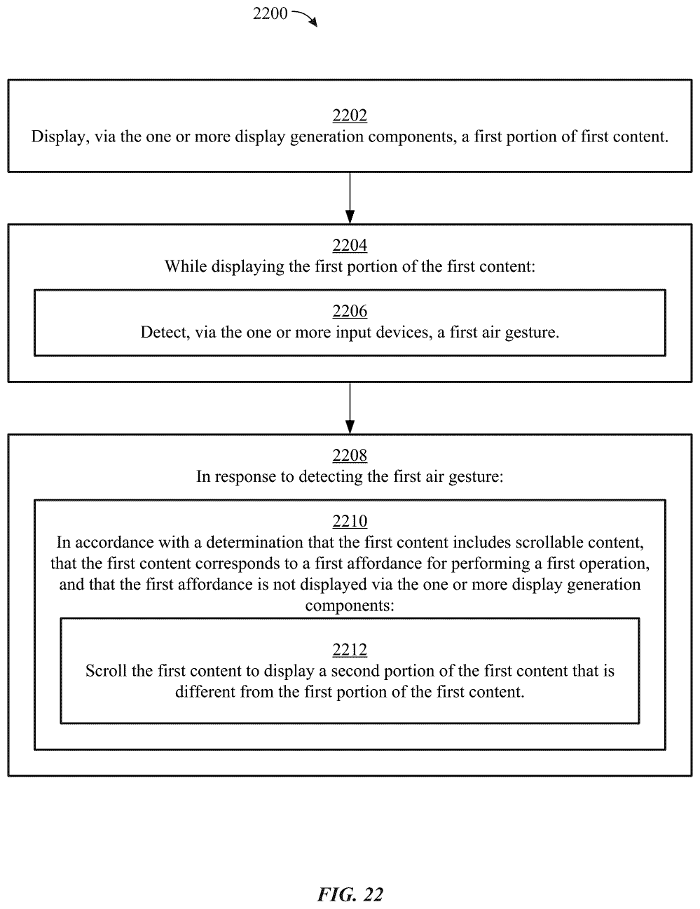

Below, FIGS. 1A-1B, 2, 3, 4A-4B, and 5A-5B provide a description of exemplary devices for performing the techniques for performing operations based on detected gestures. FIGS. 6A-6G illustrate exemplary devices and user interfaces for performing operations based on detected gestures in accordance with some embodiments. FIGS. 7A-7L illustrate exemplary devices and user interfaces for performing operations based on detected gestures in accordance with some embodiments. FIG. 8 is a flow diagram illustrating methods of navigating through options in accordance with some embodiments. FIG. 9 is a flow diagram illustrating methods of performing an operation in accordance with some embodiments. FIG. 10 is a flow diagram illustrating methods of outputting non-visual feedback in accordance with some embodiments. The user interfaces in FIGS. 6A-6G are used to illustrate the processes described below, including the processes in FIGS. 8-10. The user interfaces in FIGS. 7A-7L are used to illustrate the processes described below, including the processes in FIGS. 8-10. FIGS. 11A-11AE illustrate exemplary devices and user interfaces for performing operations based on detected gestures in accordance with some embodiments. FIG. 12 is a flow diagram illustrating methods of conditionally performing an operation corresponding to an air gesture in accordance with some embodiments. FIG. 13 is a flow diagram illustrating methods of navigating user interfaces to display a selectable option in accordance with some embodiments. FIG. 14 is a flow diagram illustrating methods of performing an operation based on an air gesture in accordance with some embodiments. The user interfaces in FIGS. 11A-11AE are used to illustrate the processes described below, including the processes in FIGS. 12-14. FIGS. 15A-15CC illustrate exemplary devices and user interfaces for performing operations at a computer system, in accordance with some embodiments. FIG. 16 is a flow diagram illustrating methods of performing operations at a computer system, in accordance with some embodiments. The user interfaces in FIGS. 15A-15CC are used to illustrate the processes described below, including the process in FIG. 16. FIGS. 17A-17Q illustrate exemplary devices and user interfaces for advancing status indicators in response to user input, in accordance with some embodiments. FIG. 18 is a flow diagram illustrating methods of advancing status indicators in response to user input, in accordance with some embodiments. The user interfaces in FIGS. 17A-17Q are used to illustrate the processes described below, including the process in FIG. 18. FIGS. 19A-19J illustrate exemplary devices and user interfaces for performing operations based on detected gestures in accordance with some embodiments. FIG. 20 is a flow diagram illustrating methods of performing operations based on detected gestures in accordance with some embodiments. The user interfaces in FIGS. 19A-19J are used to illustrate the processes described below, including the process in FIG. 20. FIGS. 21A-21M illustrate exemplary devices and user interfaces for performing operations based on detected gestures in accordance with some embodiments. FIG. 22 is a flow diagram illustrating methods of performing operations based on detected gestures in accordance with some embodiments. The user interfaces in FIGS. 21A-21M are used to illustrate the processes described below, including the process in FIG. 22.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

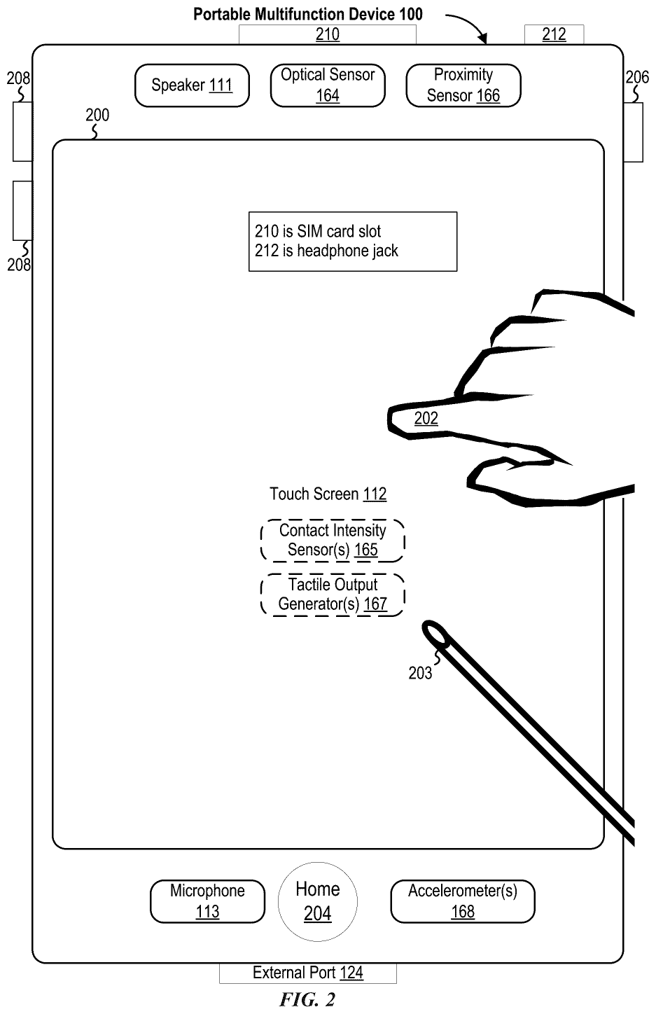

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system.

In some embodiments, a gesture (e.g., a motion gesture) includes an air gesture. In some embodiments, input gestures (e.g., motion gestures) used in the various examples and embodiments described herein include air gestures performed by movement of the user's finger(s) relative to other finger(s) (or part(s) of the user's hand) for interacting with a computer system, in some embodiments. In some embodiments, an air gesture is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the motion of the portion(s) of the user's body is not directly detected and is inferred from measurements/data from one or more sensors (e.g., one or more accelerometers, one or more gyroscopes, an inertial measurement unit (IMU), one or more visual sensors, one or more muscle sensors, one or more electromyography sensors, and/or one or more electrical impulse sensors).

In some embodiments, input gestures (e.g., air gestures) used in the various examples and embodiments described herein include pinch inputs and tap inputs, for interacting with a computer system, in some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture (optionally referred to as a pinch air gesture) includes movement of two or more fingers of a hand to make contact with one another, that is, optionally, followed by an immediate (e.g., within 0-1 seconds) break in contact from each other. In some embodiments, the contact of the portions of the user's body (e.g., two or more fingers) is not directly detected and is inferred from measurements/data from one or more sensors (one or more accelerometers, one or more gyroscopes, an inertial measurement unit (IMU), one or more visual sensors, one or more muscle sensors, one or more electromyography sensors, and/or one or more electrical impulse sensors). A long pinch gesture that is an air gesture (optionally referred to as a pinch-and-hold air gesture or a long pinch air gesture) includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture (optionally referred to as a double-pinch air gesture) comprises two (e.g., or more) pinch inputs (e.g., performed by the same hand) detected in immediate (e.g., within a predefined time period, such as 1 second or 2 seconds) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

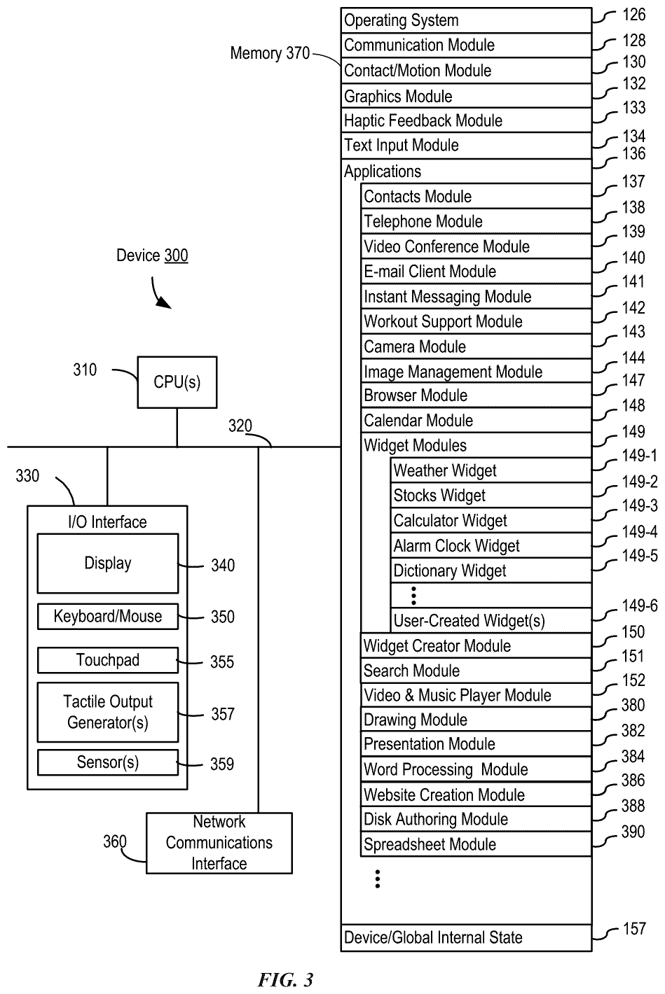

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H 0.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

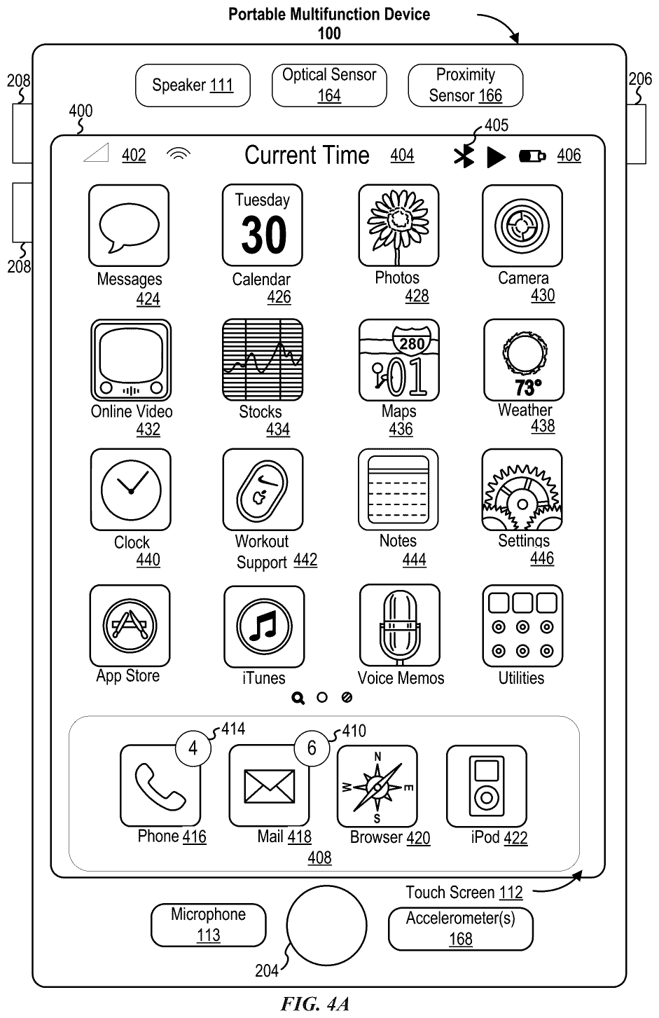

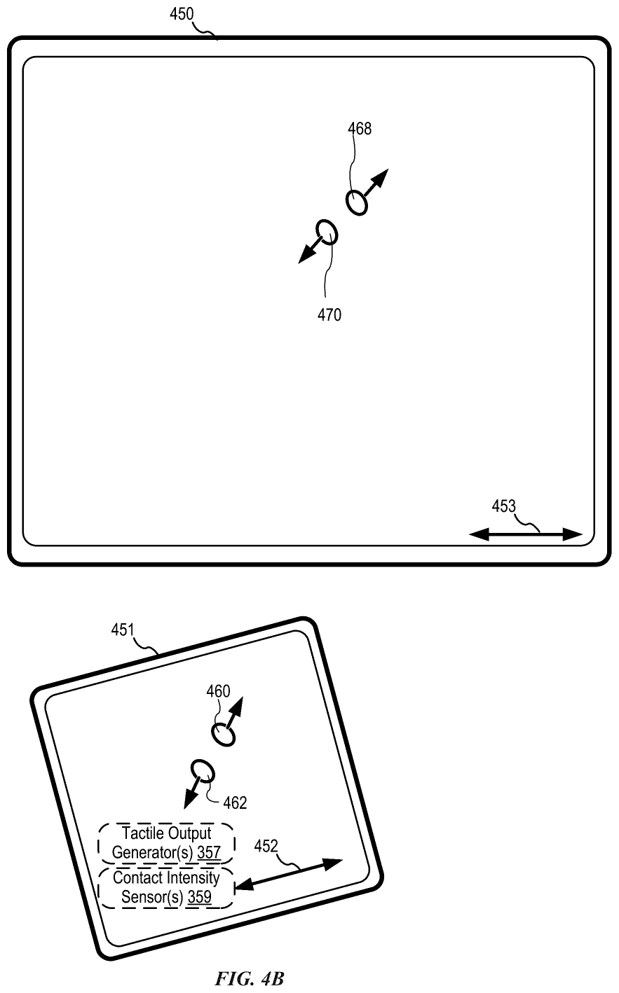

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

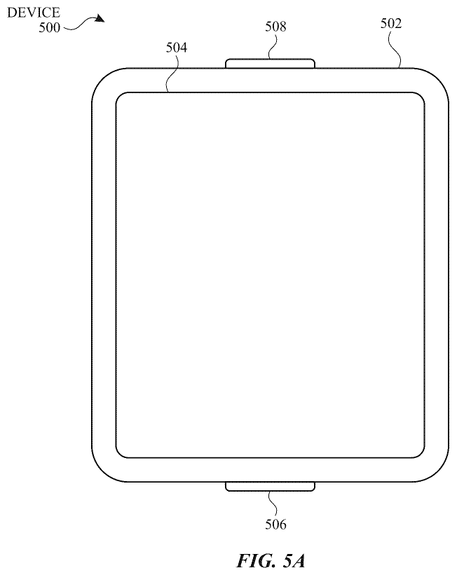

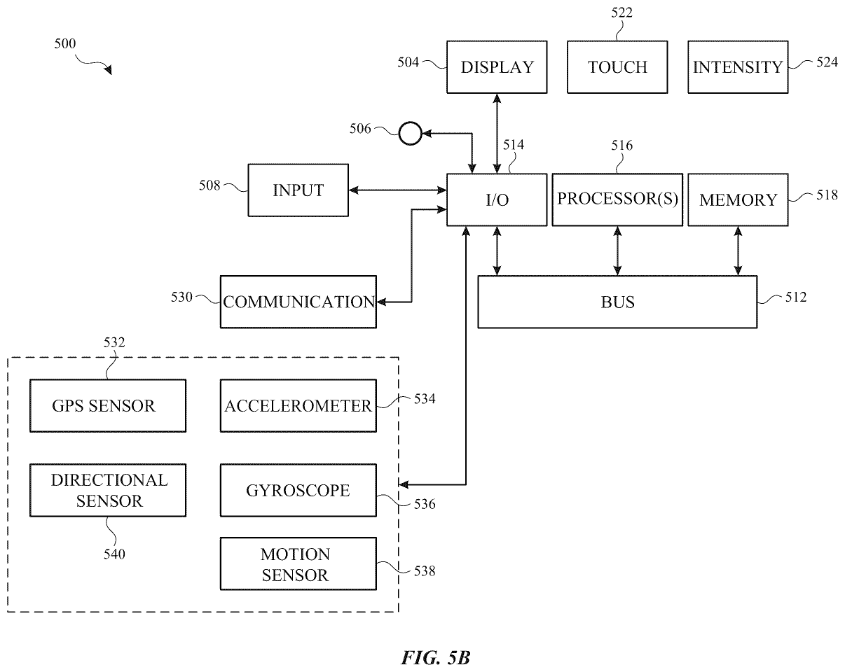

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 800-1000 and 1200-1400 (FIGS. 8-10 and 12-14). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIGS. 6A-6G illustrate exemplary user interfaces for performing operations based on detected gestures, in accordance with some embodiments. The user interfaces in these figures are used to illustrate the processes described below, including the processes in FIGS. 8-10.

FIG. 6A illustrates a user wearing wearable computer system 600 (e.g., a smart watch) on hand 640 of the user. Computer system 600 includes display 602 (e.g., a touchscreen display) and rotatable input mechanism 604 (e.g., a crown or a digital crown). Computer system 600 is displaying, via display 602, notification indication 606 (e.g., indicating that one or more unread notifications exist) and media user interface 610 for playing music. Media user interface 610 includes previous button 610A, play/pause button 610B, and next button 610C. At FIG. 6A, in some embodiments, computer system 600 detects an input (e.g., a touch input directed to media user interface 610 or a button press directed to rotatable input mechanism 604). For example, the user uses a hand different from hand 640 to provide the input. In some embodiments, the input is touch input 650A (e.g., a tap input) directed to previous button 610A and, in response to detecting touch input 650A, computer system 600 changes the track to a previous track. In some embodiments, the input is touch input 650B directed to play/pause button 610B and, in response to detecting touch input 650B, computer system 600 pauses playback of the currently playing track. In some embodiments, the input is touch input 650C directed to next button 610C and, in response to detecting touch input 650C, computer system 600 changes the track to a next track. In some embodiments, the input is press input 650D directed to pressing rotatable input mechanism 604 and, in response to detecting press input 650D, computer system 600 ceases to display media user interface 610 and displays watch face user interface 612, as shown in FIG. 6G. In some embodiments, the input is press input 650D directed to pressing rotatable input mechanism 604 and, in response to detecting press input 650D, computer system 600 ceases to display media user interface 610 and displays a home screen user interface with a plurality of icons, wherein selection of a respective icon causes display of an application corresponding to the respective icon.

At FIG. 6B, computer system 600 is displaying notification indication 606 and media user interface 610 (e.g., “Now Playing UI” in Table 1, below). While computer system 600 is displaying media user interface 610, computer system 600 detects air gesture 650E (e.g., an air gesture performed by hand 640). For example, the user may provide an air gesture because it is easier or more convenient to provide than a touch input and/or because the user is unable to use another hand to provide inputs at computer system 600 (e.g., the user is unable to provide inputs 650A-650D).

In some embodiments, at FIG. 6C, in response to detecting air gesture 650E (e.g., a pinch air gesture, a pinch-and-hold air gesture, and/or a swipe air gesture) (and, optionally, in accordance with a determination that play/pause button 610B is the primary, main, and/or default button of media user interface 610), computer system 600 highlights play/pause button 610B, as shown in FIG. 6C. FIG. 6C illustrates three alternative techniques for highlighting play/pause button 610B. At the top-right of FIG. 6C, computer system 600 highlights play/pause button 610B by dimming aspects of the user interface other than play/pause button 610B. At the bottom-right of FIG. 6C, computer system 600 highlights play/pause button 610B by enlarging play/pause button 610B without enlarging other aspects of the user interface. At the bottom-left of FIG. 6C, computer system 600 highlights play/pause button 610B by dimming aspects of the user interface other than play/pause button 610B and by enlarging play/pause button 610B without enlarging other aspects of the user interface. As shown in FIG. 6C, computer system 600 optionally outputs tactile output 620A to indicate that air gesture 650E has been detected and that computer system 600 has entered an air gesture mode (e.g., whereby play/pause button 610B is highlighted and air gestures can be used to navigate the user interface).

Returning to FIG. 6B, in some embodiments, in response to detecting air gesture 650E and in accordance with a determination that air gesture 650E is a pinch air gesture (for example, when computer system 600 is not in the air gesture mode), computer system 600 forgoes performing an operation (e.g., does not change user interfaces, does not cause audio output, and/or does not perform any operation).

At FIG. 6B, in some embodiments, in response to detecting air gesture 650E and in accordance with a determination that air gesture 650E is a double-pinch air gesture, computer system 600 ceases to display media user interface 610 (e.g., “Dismiss” operation of “Now Playing UI” in Table 1, below) and optionally displays a home screen user interface with a plurality of icons or displays watch face user interface 612, as shown in FIG. 6G. In some embodiments, the double-pinch air gesture performs the same operation as press input 650D, shown in FIG. 6A, of rotatable input mechanism 604.

At FIG. 6B, in some embodiments, in response to detecting air gesture 650E and in accordance with a determination that air gesture 650E is a pinch-and-hold air gesture (e.g., a pinch air gesture that is held for more than a threshold duration of time), computer system 600 performs a primary action (e.g., “Play/Pause” operation of “Now Playing UI” in Table 1, below) of the displayed user interface (e.g., media user interface 610). In this example, the primary action is pausing playback (e.g., based on pause/play button 610B being the most prominent button on media user interface 610) and playback is paused (e.g., as shown in media user interface 610 of FIG. 6F). In some embodiments, a visual indication that shows progress (e.g., same as or similar to 744 at FIGS. 7G and 7H) is displayed to show duration of the pinch-and-hold air gesture.

At FIG. 6C, computer system 600 detects air gesture 650F (e.g., an air gesture performed by hand 640). In response to detecting air gesture 650F and in accordance with a determination that air gesture 650F is a pinch air gesture, computer system 600 activates the highlighted play/pause button 610B and transitions to the user interface shown in FIG. 6F. At FIG. 6F, in response to detecting air gesture 650F that is a pinch air gesture, computer system 600 outputs tactile output 620B to indicate that the pinch air gesture was detected and that play/pause button 610B was activated. Further, computer system 600 pauses playback of the media and displays visual indication 622A that corresponds to the detected air gesture. In some embodiments, visual indication 622A visually indicates the type of air gesture detected (e.g., “pinch”). Visual indication 622A does not include a progress indicator (as compared to 744 of FIGS. 7G and 7H) because a pinch air gesture, rather than a pinch-and-hold air gesture (e.g., 750I), initiated the display of visual indication 622A. In some embodiments, visual indication 622A visually indicates the operation performed (e.g., “pause”) in response to detecting the air gesture. In some embodiments, visual indication 622A replaces notification indication 606 (e.g., even though one or more notifications remain unread). In some embodiments, visual indication 622A automatically ceases to be displayed after a duration of time (e.g., 0.5 seconds, 1 second, or 3 seconds) and notification indication 606 is redisplayed. As shown in FIG. 6F, play/pause button 610B of media user interface 610 is updated to reflect that media playback is paused and computer system 600 exits the air gesture mode (e.g., does not highlight any button of the user interface).

Returning to FIG. 6C, in response to detecting air gesture 650F and in accordance with a determination that air gesture 650F is a left-swipe air gesture, computer system 600 navigates media user interface 610 and highlights previous button 610A (e.g., by dimming other aspects of media user interface 610 and/or by enlarging previous button 610A), as shown in FIG. 6D. At FIG. 6C, in response to detecting air gesture 650F and in accordance with a determination that air gesture 650F is a right-swipe air gesture, computer system 600 navigates media user interface 610 highlights next button 610C (e.g., by dimming other aspects of media user interface 610 and/or by enlarging next button 610C), as shown in FIG. 6E. At FIG. 6C, in response to detecting air gesture 650F and in accordance with a determination that air gesture 650F is a double-pinch air gesture, computer system 600 exits the air gesture mode (e.g., returning to the user interface of FIG. 6B).

At FIG. 6D, in response to detecting air gesture 650F (at FIG. 6C) that is a left-swipe air gesture, computer system 600 outputs tactile output 620C to indicate that the left-swipe air gesture was detected and that previous button 610A is highlighted. At FIG. 6D, a right-swipe air gesture would highlight play/pause button 620B, a pinch air gesture changes the track to a previous track, and a double-pinch air gesture exits the air gesture mode (e.g., returning to the user interface of FIG. 6B).

At FIG. 6E, in response to detecting air gesture 650F (at FIG. 6C) that is a right-swipe air gesture, computer system 600 outputs tactile output 620D to indicate that the right-swipe air gesture was detected and that next button 610C is highlighted. At FIG. 6E, a left-swipe air gesture would highlight play/pause button 620B, a pinch air gesture changes the track to a next track, and a double-pinch air gesture exits the air gesture mode (e.g., returning to the user interface of FIG. 6B). As shown in FIGS. 6D-6E, in some embodiments, a visual indication (e.g., such as visual indication 622A) is not displayed and/or does not replace notification 606 for air gestures that navigate the user interface without activating a button of the user interface.

At FIG. 6F, computer system 600 detects air gesture 650G. When air gesture 650G is a pinch-and-hold air gesture, computer system 600 performs a primary action of the displayed user interface (e.g., media user interface 610). In this example, the primary action is starting playback (e.g., based on pause/play button 610B being the most prominent button on media user interface 610). When air gesture 650G is a pinch air gesture or a swipe air gesture, computer system 600 transitions to the air gesture mode and highlights the most prominent button, as shown in FIG. 6C.

At FIG. 6G, in response to computer system 600 detecting a press (e.g., 650D) of rotatable input mechanism 604 at FIG. 6A and/or detecting a double-pinch air gesture (e.g., 650E) at FIG. 6B, computer system 600 displays watch face user interface 612 and optionally outputs tactile output 620E. As shown in FIG. 6G, watch face user interface 612 includes indication of a current time 612A, indication of a current date 612B, current weather 612C, icons 612D and 612E that, when activated, cause display of a respective application. In some embodiments, in response to computer system 600 detecting a pinch-and-hold air gesture at FIG. 6G, computer system 600 forgoes performing an operation (e.g., “None” operation of “Any Clock Face” in Table 1, below). In some embodiments, in response to computer system 600 detecting a double-pinch air gesture at FIG. 6G, computer system 600 displays a widgets user interface and/or displays a user interface for launching applications (e.g., ‘Display widgets and/or display app launch user interface” operation for “Any Clock Face” in Table 1, below).

In some embodiments, tactile outputs 620A, 620B, 620C, 620D, and 620E are all different tactile outputs, thereby providing the user with feedback about the input received and/or the operation performed.

FIGS. 7A-7L illustrate exemplary user interfaces for performing operations based on detected gestures in accordance with some embodiments. For example, FIGS. 7A-7E illustrate sending a message using touch inputs and FIGS. 7A, 7F-7J illustrate sending a message using air gestures. The user interfaces in these figures are used to illustrate the processes described below, including the processes in FIGS. 8-10.

FIG. 7A illustrates a user wearing wearable computer system 600 (e.g., a smart watch) on hand 640 of the user. Computer system 600 includes display 602 (e.g., a touchscreen display) and rotatable input mechanism 604 (e.g., a crown or a digital crown). Computer system 600 is displaying, via display 602, message notification 710 (e.g., “Notification: Message” in Table 1, below) that indicates an instant message has been received from “John Appleseed” with message 710A that says “Iced. Thank you.” Message notification 710 also includes reply button 710B to initiate a process for replying to message 710A and canned response 710C for replying to message 710A with a suggested response (e.g., an emoji, as shown in FIG. 7A). Computer system 600 also displays notification indication 606, indicating that one or more unread notifications exist.

At FIG. 7A, computer system 600 detects a user input. In some embodiments, the user input is a tap input 750A on message 710A, detected via touchscreen display 602. In response to detecting tap input 750A directed to message 710A, computer system 600 displays message conversation 712, as shown in FIG. 7B. In some embodiments, the user input is a press input 750B of rotatable input mechanism 604. In response to detecting press input 750B, computer system 600 ceases to display message notification 710 and instead displays watch face user interface 612, as shown in FIG. 7K. In some embodiments, the user input is air gesture 750C that is a double-pinch air gesture. In response to detecting double-pinch air gesture 750C, computer system 600 ceases to display message notification 710 (e.g., “Dismiss” operation for “Notification: Message” in Table 1, below) and instead displays watch face user interface 612, as shown in FIG. 7K. In some embodiments, the user input is air gesture 750C that is a pinch air gesture. In response to detecting pinch air gesture 750C, computer system 600 displays message conversation 712 and outputs tactile output 740A, as shown in FIG. 7F. In some embodiments, the user input is air gesture 750C that is a pinch-and-hold air gesture. In response to detecting completion of the pinch-and-hold air gesture 750C, computer system 600 performs a primary action (e.g., “Trigger dictation” operation for “Notification: Message” in Table 1, below) of the displayed user interface and optionally outputs a success indication, such as success haptic output 740C and/or success audio output 742C. In this example, reply button 710B is the most prominent button of the displayed user interface and the primary action, therefore, is to initiate a reply to the message conversation, as shown in FIG. 7I.

Returning to FIG. 7B, computer system 600 is displaying message conversation 712, including prior messages 712A-712B and newly received message 712C (corresponding to message 710A). At FIG. 7B, computer system 600 detects, via touchscreen display 602, swipe up input 750D directed to message conversation 712. In response to detecting swipe up input 750D, computer system 600 scrolls up message conversation 712 to display (e.g., by scrolling onto the display from the bottom of the display) text entry field 714 and suggested response 716, as shown in FIG. 7C. In some embodiments, the magnitude (e.g., distance and/or speed) of scrolling of message conversation 712 is based on a magnitude (e.g., distance and/or speed) of swipe up input 750D. At FIG. 7B, computer system 600 optionally detects input 750M directed to rotatable input mechanism 604. In response to detecting input 750M and in accordance with a determination that input 750M is a press input, the computer system ceases to display user message conversation 712 and displays watch face user interface 612 as shown in FIG. 7K. In response to detecting input 750M and in accordance with a determination that input 750M is a rotational input, the computer system scrolls display user message conversation 712.

At FIG. 7C, computer system 600 detects, via touchscreen display 602, tap input 750E on text entry field 714. In response to detecting tap input 750E, computer system 600 displays keyboard user interface 720 for entering text to reply to message 710A as part of message conversation 712, as shown in FIG. 7D. At FIG. 7C, computer system 600 optionally detects input 750N directed to rotatable input mechanism 604. In response to detecting input 750N and in accordance with a determination that input 750N is a press input, the computer system ceases to display user message conversation 712 and displays watch face user interface 612 as shown in FIG. 7K. In response to detecting input 750N and in accordance with a determination that input 750N is a rotational input, the computer system scrolls display user message conversation 712.

At FIG. 7D, keyboard user interface 720 includes send button 720A for sending a draft reply message, voice dictation button 720B for drafting a reply message via voice dictation (e.g., by displaying and/or using dictation user interface 730), emoji keyboard button 720C for changing English keyboard 722 to an emoji keyboard, text entry field 724 for displaying a draft of a messaging being prepared, and keyboard 722 for entering text into text entry field 724. Keyboard 722 includes a plurality of character keys, where different character keys when activated, cause entry of a different corresponding character into text entry field 724. At FIG. 7D, computer system 600 has detected tap input 750F on “O” character key 722A followed by tap input 750G on “K” character key 722B, which has caused “OK” to be entered into text entry field 724. At FIG. 7D, computer system 600 detects, via touchscreen display 602, tap input 750H on send button 720A. In response to detecting tap input 750H on send button 720A, computer system 600 transmits the “OK” message as part of message conversation 712 and updates message conversation 712 to include newly sent message 712D, as shown in FIG. 7E.

At FIG. 7F, computer system 600 is displaying message conversation 712 (e.g., “Messaging Application: Reply, Inline Reply” in Table 1, below) in response to having detected pinch air gesture 750C at FIG. 7A. Further, computer system 600 is outputting tactile output 740A and audio output 742A in response to computer system 600 having detected pinch air gesture 750C. In some embodiments, tactile output 740A and audio output 742A are based on (e.g., correspond to) the pinch air gesture. In some embodiments, at FIG. 7F, air gesture 750I is a double-pinch air gesture (rather than a pinch-and-hold gesture, as illustrated) and, in response, computer system 600 ceases to display message conversation 712 (e.g., “Dismiss” operation for “Messaging Application: Reply, Inline reply” in Table 1, below) and displays watch user interface 612 of FIG. 7K.

At FIG. 7F, as illustrated, computer system 600 detects a portion of pinch-and-hold air gesture 750I. At FIG. 7G, in response to detecting the portion of pinch-and-hold air gesture 750I (and in accordance with a determination that the primary action corresponds to text entry field 714 that is not currently displayed), computer system 600 scrolls user interface 712 upward to display and highlight text entry field 714. In some embodiments, the scroll happens first followed by the highlighting of text entry field 714. In some embodiments, highlighting text entry field 714 includes dimming other aspects of the user interface (other than text entry field 714), as shown in FIG. 7G, and/or enlarging text entry field 714. This draws the user's attention to text entry field 714 and provides the user with feedback about the operation that will be performed once input of pinch-and-hold gesture 750I is completed. At FIG. 7G, in response to detecting the portion of pinch-and-hold air gesture 750I, computer system 600 also displays progress indicator 744. Progress indicator 744 indicates the amount of progress made towards completion of the pinch-and-hold air gesture. As shown in FIG. 7G, progress indicator 744 replaces display of notification indication 606. Progress indicator 744 includes progression portion 744A that increases in size and/or length, thereby providing feedback about how much progress has been made and/or how much more progress needs to be made. As shown in FIG. 7G, pinch-and-hold air gesture 750I has been detected for less than half of the duration required to complete the gesture. At FIG. 7G, in response to detecting the portion of pinch-and-hold air gesture 750I at FIG. 7F, computer system 600 provides tactile output 740B and/or audio output 742B to provide feedback to the user that the portion of pinch-and-hold air gesture 750I is detected. In some embodiments, the characteristics of tactile output 740B and/or audio output 742B change as progress is made towards completion of the pinch-and-hold air gesture (e.g., the pitch, frequency, and/or strength increases as time progress while pinch-and-hold air gesture 750I continues to be detected).

At FIGS. 7G and 7H, computer system 600 continues to detect pinch-and-hold air gesture 750I and, in response, computer system 600 continues to update progress indicator 744 progressing towards completion of the input (e.g., progression portion 744A fills more of the circle), tactile output 740B optionally continues to be output, and audio output 742B optionally continues to be output. In some embodiments, tactile output 740A and 740B are different tactile outputs (e.g., with different characteristics) thereby providing the user with tactile feedback (non-visual) about the type of input received. In some embodiments, audio output 742A and audio output 742B are different audio outputs (e.g., with different characteristics), thereby providing the user with audio feedback (non-visual) about the type of input received.

At FIG. 7H, computer system 600 detects that pinch-and-hold air gesture 750I has been held for more than the threshold duration and, in response, activates text entry field 714 to perform the primary action (e.g., “Trigger dictation” operation in Table 1, below) corresponding to user interface 712, thereby displaying (as shown in FIG. 7I) voice dictation user interface 730 and (optionally) visual indication 622B that corresponds to the detected air gesture. In some embodiments, visual indication 622B visually indicates the type of air gesture detected (e.g., “pinch and hold”) and the operation performed (e.g., “reply”). Dictation user interface 730 is different from keyboard user interface 720, although both user interfaces were displayed in response to activating text entry field 714. In particular, dictation user interface 730 is displayed when text entry field 714 is activated via an air gesture (e.g., pinch-and-hold air gesture 750I) and keyboard user interface 720 is displayed when text entry field 714 is activated via a touch input (e.g., tap input 750E), thereby providing the user with different appropriate user interfaces for entering text based on the input received.

At FIG. 7I, computer system 600 detects, via a microphone, utterance 750J of the user (while dictation user interface 730 is displayed) and transcribes the utterance into a draft message for replying as part of message conversation 712. At FIG. 7J, computer system 600 has sent (e.g., automatically without requiring further user input or based on user input) the message “OK” and displays the newly sent message 712D as part of message conversation 712.

At FIG. 7K, while displaying watch face user interface 612, computer system 600 detects, via touchscreen display 602, tap input 750K on current weather 612C. In response to detecting tap input 750K on current weather 612C, computer system 600 displays weather user interface 760, as shown in FIG. 7L.

At FIG. 7L, while displaying weather user interface 760 (e.g., “Other UI” in Table 1, below), computer system 600 detects a portion of pinch-and-hold air gesture 750L. In response to detecting the portion of pinch-and-hold air gesture 750L and in accordance with a determination that there is no primary action associated with the currently displayed user interface (e.g., there is no button to activate), computer system 600 displays indication 746 that the input has failed (e.g., “Negative Feedback” for “Other UI” in Table 1, below). In some embodiments, indication 746 does not include an indication of progress. In some embodiments, indication 746 shakes (e.g., repeatedly moves left and right, as indicated by the arrows in FIG. 7L) to indicate that the input has failed. In some embodiments, based on the input failing, computer system 600 outputs a failure indication, such as failure tactile output 740D and/or failure audio output 742D, that is different from the success indication (e.g., 740C and/or 742C). In some embodiments, when an input fails, computer system 600 outputs one or more non-visual failure indications (e.g., 740D and/or 742D). In some embodiments, when an input is successful, computer system 600 displays a visual indication indicative of success (e.g., 744 and/or 744A) without outputting one or more non-visual indications. In such embodiments, non-visual feedback indicates input failure.

In some embodiments, non-visual feedback (e.g., audio feedback; and/or haptic and/or tactile feedback) (e.g., 620A, 620B, 620C, 620D, 620E, 740, 740B, 740C, and/or 740D) is suppressed when computer system 600 is in a respective state. For example, in some embodiments, non-visual feedback is suppressed when computer system 600 is recording a biometric measurement (e.g., an ECG reading and/or a heartrate reading). For example, in some embodiments, non-visual feedback is suppressed so as not to disrupt an activity being performed by computer system 600 (e.g., so as not to disrupt and/or invalidate recording of a biometric measurement).

FIG. 8 is a flow diagram illustrating methods of navigating through options in accordance with some embodiments. Method 800 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with a display generation component (e.g., a display, a touch-sensitive display, and/or a display controller) and a plurality of input devices (e.g., one or more touch-sensitive surfaces (e.g., of the touch-sensitive display), visual input devices (e.g., one or more infrared cameras, depth cameras, visible light cameras, and/or gaze tracking cameras), accelerometers, and/or rotatable input mechanisms). Some operations in method 800 are, optionally, combined, the orders of some operations are, optionally, changed, and some operations are, optionally, omitted.

As described below, method 800 provides an intuitive way for navigating through options. The method reduces the cognitive burden on a user for navigating through options, thereby creating a more efficient human-machine interface. For battery-operated computing devices, enabling a user to navigate through options faster and more efficiently conserves power and increases the time between battery charges.

The computer system (e.g., 600) displays (802), via the display generation component, a user interface (e.g., 610) that includes a plurality of options (e.g., 610A-610C) (e.g., concurrently displaying a first option of the plurality of options and a second option of the plurality of options and/or the user interface includes the first option, a second option, and a third option (e.g., that is optionally not initially displayed)) that are selectable via a first type of input (e.g., 650A-650C) (e.g., a touch input on a touch-sensitive surface, a tap input on a touch-sensitive surface, and/or an audio input received via a microphone) received via a first input device (e.g., a touch-sensitive surface and/or a microphone) of the plurality of input devices.

While displaying the user interface (e.g., 610) that includes the plurality of options (e.g., 610A-610C), the computer system (e.g., 600) detects (804), via a second input device of the plurality of input devices that is different from the first input device, a second type of input (e.g., 650F) (e.g., an air gesture and/or motion inputs) that is different from the first type of input.

In response (806) to detecting the second type of input (e.g., 650F) and in accordance with a determination that the second type of input includes movement in a first input direction, the computer system (e.g., 600) navigates (808) through a subset of the plurality of options in a first navigation direction (e.g., as shown in FIG. 6D) (e.g., navigating from the first option to the second option, navigating from the first option to the third option, changing a focus from the first option to the second option, and/or changing a focus from the first option to the third option).

In response (806) to detecting the second type of input (e.g., 650F) and in accordance with a determination that the second type of input includes movement in a second input direction that is different from the first input direction, the computer system (e.g., 600) navigates (810) through the subset of the plurality of options in a second navigation direction (e.g., as shown in FIG. 6E) that is different from the first navigation direction.

Navigating through a subset of options using the second type of input detected via the second input device when the options are selectable via the first type of input enables the computer system to provide the user with multiple means of providing inputs directed to the same plurality of options, thereby improving the man-machine human interface. Using the second type of input to navigate enables the computer system to receive inputs from users who aren't able to use their hand to otherwise interact with the computer system because their hand is already occupied (e.g., holding something else) and/or because the computer system is a wrist-worn device and the user doesn't have a second hand with which to provide inputs at the computer system.

For computer systems that are wrist-worn, air gesture inputs enable users to provide inputs to the computer system without the need to use another hand. For example, when a user is holding an object in their other hand and the user is therefore not able to use that hand to touch the touchscreen of the computer system to initiate a process, the user can perform a respective air gesture (using the hand on which the computer system is worn) that is detected by the computer system and that initiates the process. Additionally, some air gestures do not include/require a targeting aspect, and users can therefore provide those air gestures without the need to look at content that is being displayed and, optionally, without the need to raise the hand on which the computer system is worn.

In some embodiments, the first type of input (e.g., 650A-650C) is a touch input. In some embodiments, the first input device is a touch-sensitive surface, such as one incorporated with a display to form a touchscreen or a touch-sensitive surface that is not incorporated with a display such as a touchpad or touch-sensitive button or other hardware control. In some embodiments, the first type of input includes a physical touch of a touch-sensitive surface by a user of the computer system. Navigating through a subset of options using the second type of input detected via the second input device when the options are selectable via touch input enables the computer system to provide the user with multiple means of providing inputs directed to the same plurality of options, thereby improving the man-machine human interface.

In some embodiments, the second type of input (e.g., 650F) includes a motion input. In some embodiments, the second input device optionally includes one or more accelerometers, one or more gyroscopes, an inertial measurement unit (IMU), one or more visual sensors, one or more muscle sensors, one or more electromyography sensors, and/or one or more electrical impulse sensors. In some embodiments, the second input device is not a touch-sensitive surface. In some embodiments, the second type of input does not include a physical touch of a touch-sensitive surface by a user of the computer system. Navigating through a subset of options using motion inputs detected via the second input device when the options are selectable via the first type of input enables the computer system to provide the user with multiple means of providing inputs directed to the same plurality of options, thereby improving the man-machine human interface.

In some embodiments, the computer system (e.g., 600) detects (e.g., prior to navigating through the subset of the plurality of options in the first or second navigation direction), via the second input device, a first input (e.g., 650E) (e.g., of the second type, an air gesture, and/or motion inputs). In response to detecting the first input (e.g., 650e), the computer system (e.g., 600) visually highlights (e.g., bolding, enlarging, underlining, increasing a brightness, increasing a saturation, increasing a contrast, and/or fully or partially surrounding the option) (e.g., as part of navigating the plurality of options) a first option (e.g., 610B as shown in FIG. 6C) of the plurality of options (e.g., 610A-610C). In some embodiments, prior to detecting the first input, no options of the plurality of options are visually highlighted. Subsequent to detecting the first input and while the first option (e.g., 610B in FIG. 6C) is visually highlighted, the computer system (e.g., 600) detects, via the second input device, a pinch gesture (e.g., 650F) (e.g., a pinch air gesture). In response to detecting the pinch gesture (e.g., pinch air gesture) while the first option is visually highlighted, the computer system (e.g., 600) activates (as shown in FIG. 6F) the first option (e.g., based on the first option being visually highlighted). In some embodiments, the first option accepts or rejects an incoming call. In some embodiments, the first option plays or pauses media. In some embodiments, the first object snoozes or cancels an alarm. In some embodiments, in order to activate an option, the computer system optionally requires the first input prior to the pinch gesture. The computer system visually highlighting an option that will be activated when the pinch gesture is detected provides the user with visual feedback about which option will be activated.

In some embodiments, the first input (e.g., 650E) is a swipe gesture (e.g., swipe air gesture). In some embodiments, the swipe air gesture includes movement of a thumb of a hand of a user with respect to (and along) a second finger (e.g., a forefinger) of the same hand of the user. The computer system visually highlighting, in response to a swipe gesture, an option that will be activated when the pinch gesture is detected provides the user with visual feedback about which option will be activated.

In some embodiments, the first input (e.g., 650E) is a pinch gesture (e.g., pinch air gesture). In some embodiments, the pinch air gesture includes movement of a thumb of a hand of a user with respect to a second finger (e.g., a forefinger) of the same hand of the user such that the tip of one finger touches the other and/or such that the tips of both fingers touch. The computer system visually highlighting, in response to a pinch gesture, an option that will be activated when the pinch gesture is detected provides the user with visual feedback about which option will be activated.

In some embodiments, in response to detecting the first input (e.g., 650E), the computer system (e.g., 600) scrolls, via the display generation component (e.g., 602), the user interface (e.g., 610) that includes the plurality of options (e.g., 610A-610C), wherein scrolling the plurality of options includes scrolling through the plurality of options to reach the first option. The computer system scrolling, in response to a first input, the user interface to display the first option provides the user with visual feedback about which option is being highlighted.

In some embodiments, prior to detecting the first input (e.g., 650F) (and, in some embodiments, while no options of the plurality of options are visually highlighted), the computer system (e.g., 600) detects, via the second input device, a second pinch gesture (e.g., second pinch air gesture). In response to detecting the second pinch gesture (e.g., second pinch air gesture), the computer system (e.g., 600) forgoes navigating the plurality of options (e.g., 610A-610C) and forgoing highlighting (and/or changing a highlighting of) an option (e.g., 610B) of the plurality of options. In some embodiments, the computer system does not detect and/or does not act on a pinch air gesture that is performed before the first input (e.g., a swipe gesture). Ignoring a pinch gesture when an option is not already highlighted prevents the system from unintentionally activating an option without providing the user with feedback about which option will be activated, thereby improving the man-machine interface.

In some embodiments, while displaying a respective user interface (e.g., 610 at FIG. 6B) (e.g., the user interface that includes the plurality of options and/or a notification user interface that corresponds to a received notification), the computer system (e.g., 600) detects, via the second input device, a double-pinch gesture (e.g., 650E) (e.g., double-pinch air gesture). In response to detecting the double-pinch gesture (e.g., 650E), the computer system (e.g., 600) dismisses (e.g., ceasing to display and/or reducing in display size) the respective user interface (e.g., as shown in FIG. 6G). In some embodiments, the double-pinch air gesture dismisses the currently displayed respective user interface independent of whether the respective user interface (or an element thereof) is currently selected and/or independent of whether the first input of the second type was detected prior to (e.g., immediately prior to) detecting the double-pinch air gesture. In some embodiments, the double-pinch air gesture includes movement of a thumb of a hand of a user with respect to a second finger (e.g., a forefinger) of the same hand of the user such that the tip of one finger touches the other finger twice within a threshold time and/or such that the tips of both fingers touch twice within the threshold time. Dismissing a currently displayed user interface (or option) in response to a double-pinch gesture enables to user to quickly and efficiently dismiss the user interface (or option) without having to traverse a multi-level hierarchy of menu options, thereby reducing the number of inputs required to perform the operation.

In some embodiments, while displaying the user interface (e.g., 610 and/or 712) that includes the plurality of options (e.g., 610A-610C, 712A-712C, and/or 714) (e.g., before or after detecting the second type of input and/or with or without an option of the plurality of options being visually highlighted), the computer system (e.g., 600) detects, via the second input device, a respective gesture (e.g., 650E and/or 750I) (e.g., respective air gesture). In response to detecting the respective gesture (e.g., 650E and/or 750I) and in accordance with a determination that the respective gesture is a pinch-and-hold gesture (e.g., pinch-and-hold air gesture), the computer system (e.g., 600) performs a primary operation (e.g., as shown in FIG. 6F and/or FIG. 7I). In some embodiments, the primary operation is the operation that is performed when a primary option of the plurality of options is selected/activated. In some embodiments, the primary operation is a default operation for the user interface that includes the plurality of options. In some embodiments, the pinch-and-hold air gesture includes movement of a thumb of a hand of a user with respect to a second finger (e.g., a forefinger) of the same hand of the user such that the tip of one finger touches the other finger and/or such that the tips of both fingers touch, and the touch is maintained for more than a threshold duration of time (e.g., a threshold hold duration of time, such as 0.3 seconds, 0.5 seconds, or 1 second). In some embodiments, the two fingers touching each other is not directly detected and is inferred from measurements/data from one or more sensors (e.g., second input device). In some embodiments, a pinch air gesture is detected based on the touch being maintained for less than a threshold duration of time (e.g., same as or different from the threshold hold duration of time; such as 0.1 second, 0.2 seconds, or 0.3 seconds). The computer system performing a primary (e.g., default) action in response to a pinch-and-hold gesture allows the computer system to quickly and easily perform an operation based on a specific user input without having to traverse a multi-level hierarchy of menu options, thereby reducing the number of inputs required to perform the operation.

In some embodiments, in response to detecting the respective gesture (e.g., respective air gesture) and in accordance with a determination that the respective gesture (e.g., respective air gesture) is a double-pinch gesture (e.g., double-pinch air gesture), the computer system (e.g., 600) dismisses the user interface that includes the plurality of options (e.g., by displaying FIG. 6G and/or FIG. 7K). In some embodiments, the double-pinch air gesture includes movement of a thumb of a hand of a user with respect to a second finger (e.g., a forefinger) of the same hand of the user such that the tip of one finger touches the other finger twice within a threshold time and/or such that the tips of both fingers touch twice within the threshold time. In some embodiments, the threshold time for the double-pinch gesture is the same or different from the threshold duration of time for a pinch gesture or a pinch-and-hold gesture. A double-pinch gesture, which optionally includes two pinch motions within threshold duration of time, reduces the likelihood of an unintended input, thereby improving the man-machine interface.

In some embodiments, in accordance with a determination that the user interface that includes the plurality of options is a first type of user interface (e.g., 610) (e.g., a user interface for an incoming call of a voice communication application), the primary operation is a first operation (e.g., play/pause operation) (e.g., accepting the incoming call). In some embodiments, in accordance with a determination that the user interface that includes the plurality of options is a second type of user interface (e.g., 712) (e.g., a user interface for composing a text message in a messaging application) that is different from the first type of user interface, the primary operation is a second operation (e.g., transmitting the text message and/or displaying a dictation user interface) that is different from the first operation. Performing respective operations as the primary operation based on the currently displayed user interface enables the computer system to perform operations based on context, thereby reducing the number of inputs the user must provide and improving the man-machine interface.

In some embodiments, the plurality of options includes a first option (e.g., 610B) that corresponds to the primary operation and a second option (and one, two, three, or more other options) (e.g., 610A and/or 610C) that does not correspond to the primary operation, and wherein the first option (e.g., 610B) is more visually prominent (e.g., bigger, bolder, brighter, more saturated, or surrounded fully or partially by a selection indicator) than the second option (e.g., 610A and/or 610C) (and the one, two, three, or more additional other options). Making the user-selectable option that corresponds to the primary operation more prominent enables the computer system to provide the user with feedback about what the operation that will be performed when the pinch-and-hold air gesture is detected.

In some embodiments, the user interface (e.g., 610) that includes the plurality of options is a media player user interface (e.g., 610) and the plurality of options includes an option (e.g., 610B) that initiates a process for playing or pausing media (e.g., plays media when no media is playing and pauses media when media is already playing). In some embodiments, the option that initiates the process for playing or pausing media is the most visually prominent option of the media player user interface. In some embodiments, the primary operation for the media player user interface is to initiate a process to play or pause media. Providing the user with multiple means of providing inputs directed to the same plurality of options in a media player user interface makes it easier to interact with the media player user interface and improves the man-machine human interface.

In some embodiments, the user interface that includes the plurality of options is an audio communication user interface (e.g., FIG. 6A, but where play/pause button 610B is an answer button, which when activated, answers an incoming call and, optionally, the user interface has been displayed in response to detecting an incoming call) (e.g., a phone user interface, a video call user interface, and/or a real-time audio communication interface) and the plurality of options includes an option (e.g., 610B) that initiates a process for accepting an incoming audio communication request (e.g., an incoming voice call, an incoming video call, and/or an incoming real-time audio communication request with another user). In some embodiments, the option (e.g., 610B) that initiates the process to accept the incoming audio communication request is the most visually prominent option of the audio communication user interface (e.g., as compared to 610A and/or 610C). In some embodiments, the primary operation for the audio communication user interface is to initiate a process to accept an incoming audio communication request. In some embodiments, the most prominent option (e.g., 610B if the play/pause button were changed to be a “decline” button that declines/rejects an incoming call) is an option that initiates a process to reject an incoming audio communication request and the primary operation for the audio communication user interface is to initiate a process to reject an incoming audio communication request. Providing the user with multiple means of providing inputs directed to the same plurality of options in an audio communication user interface makes it easier to interact with the audio communication user interface and improves the man-machine human interface.

In some embodiments, navigating through the subset of the plurality of options includes visually highlighting (e.g., bolding, enlarging, underlining, increasing a brightness, increasing a saturation, increasing a contrast, and/or fully or partially surrounding the option) a first option (e.g., 610A-610C in FIGS. 6C-6E) of the plurality of options to which the computer system navigates. Displaying a visual indication of the option that is focused provides the user with improved visual feedback about which option will be activated if an activation input is provided.

In some embodiments, while visually highlighting the first option the plurality of options, the computer system (e.g., 600) detects, via the second input device, a second input (e.g., 650F) of the second type (e.g., an air gesture, motion input, and/or swipe input). In response to detecting the second input (e.g., 650F) of the second type, the computer system (e.g., 600) navigates through a second subset of the plurality of options to visually highlight a second option (e.g., 610A-610C) of the plurality of options without visually highlighting the first option of the plurality of options. In some embodiments, the second input includes a directional component and the second subset of the plurality of options navigated through is based on the directional component. Updating the visual indication to reflect a new option that is focused provides the user with improved visual feedback about which option will be activated if an activation input is provided.

In some embodiments, the computer system (e.g., 600) displays, via the display generation component, a second user interface (e.g., 760) that includes a second plurality of options that are selectable via the first type of input (e.g., a touch input on a touch-sensitive surface, a tap input on a touch-sensitive surface, and/or an audio input received via a microphone) received via the first input device (e.g., a touch-sensitive surface and/or a microphone) of the plurality of input devices. While displaying the second user interface that includes the second plurality of options, the computer system (e.g., 600) detects, via the second input device, a third input (e.g., 750L) of the second type of input (e.g., an air gesture, motion input, and/or swipe gesture). In response to detecting the third input (e.g., 750L) of the second type, the computer system (e.g., 600) forgoes navigating (e.g., based on the second user interface being displayed when the third input is detected) through the second plurality of options. In some embodiments, some user interfaces have no options that can be navigated through and/or interacted with via the second type of input. Limiting some user interfaces such that motion gestures do not interact with the user interface helps the computer system avoid unintentionally navigating the user interface and/or activating an option of the user interface, thereby improving the man-machine interface.

In some embodiments, the second user interface (e.g., 720, but for numerals) is a number entry user interface (e.g., a numeric keyboard and/or a number pad) and the second plurality of options includes numeric keys (e.g., corresponding to a plurality of numerals in the range 0-9). Not using motion gestures to navigate a number entry user interface helps prevent the computer system from receiving unintentional motion inputs at the number entry user interface, thereby improving the man-machine interface.

In some embodiments, the computer system (e.g., 600) is a wearable device (e.g., wrist worn device (such as a smart watch) and/or a head mounted system). The computer system being a wearable device enables the computer system to monitor movements of the user as the computer system is worn.

In some embodiments, the second type of input (e.g., 650E and/or 650F) is an input provided by a first hand (e.g., 640) (e.g., of a user of the computer system) on which the computer system (e.g., 600) is being worn. In some embodiments, the computer system is worn on a left wrist of the user of the computer system and is not worn on the right wrist of the user. The computer system receiving movement gestures using the hand on which the computer system is worn enables the computer system to monitor movements of the user to be used as inputs.

In some embodiments, the first type of input (e.g., 650A-650C) is an input provided by a second hand (e.g., of the user of the computer system) that is different from the first hand (e.g., 640). In some embodiments, the first type of input is an input provided by a hand different from the hand on which the device is being worn. The computer system receiving the first type of input using a hand on which the computer system is not being worn enables the computer system to receive inputs from the user's second hand, thereby improving the man-machine interface.

Note that details of the processes described above with respect to method 800 (e.g., FIG. 8) are also applicable in an analogous manner to the methods described below. For example, method 800 optionally includes one or more of the characteristics of the various methods described above with reference to method 900, 1000, 1200, 1300, 1400, 1600, 1800, 2000, and/or 2200. For example, the motion gestures are the same motion gesture. For another example, the air gestures are the same air gestures. For brevity, these details are not repeated below.

FIG. 9 is a flow diagram illustrating methods of performing an operation in accordance with some embodiments. Method 900 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with a display generation component (e.g., a display, a touch-sensitive display, and/or a display controller) and a plurality of input devices (e.g., one or more touch-sensitive surfaces (e.g., of the touch-sensitive display), visual input devices (e.g., one or more infrared cameras, depth cameras, visible light cameras, and/or gaze tracking cameras), accelerometers, and/or rotatable input mechanisms). Some operations in method 900 are, optionally, combined, the orders of some operations are, optionally, changed, and some operations are, optionally, omitted.

As described below, method 900 provides an intuitive way for performing an operation. The method reduces the cognitive burden on a user for performing operations, thereby creating a more efficient human-machine interface. For battery-operated computing devices, enabling a user to perform operations faster and more efficiently conserves power and increases the time between battery charges.

The computer system (e.g., 600) displays (902), via the display generation component, a user interface (e.g., 610 at FIG. 6A, 710 at FIG. 7A, and/or 712 at FIG. 7C) (e.g., that includes a plurality of options (e.g., concurrently displaying a first option of the plurality of options and a second option of the plurality of options and/or the user interface includes the first option, a second option, and a third option (e.g., that is optionally not initially displayed)) that are selectable via a first type of input (e.g., a touch input on a touch-sensitive surface, a tap input on a touch-sensitive surface, and/or an audio input received via a microphone) received via a first input device (e.g., a touch-sensitive surface and/or a microphone) of the plurality of input devices).

While displaying the user interface (e.g., 610 at FIG. 6A, 710 at FIG. 7A, and/or 712 at FIG. 7C), computer system (e.g., 600) detects (904), via a first input device (e.g., 602), a first input (e.g., 650B, 750A, and/or 750E).

In response to detecting the first input via the first input device (e.g., 602) of the plurality of input devices, the computer system (e.g., 600) performs (906) a first operation (e.g., pause playback as in FIG. 6F, show message conversation as in FIG. 7B, and/or display 720) (e.g., selecting an option, scrolling the user interface, and/or without performing a second operation).

While displaying the user interface (e.g., 610 at FIG. 6A, 710 at FIG. 7A, and/or 712 at FIG. 7C), the computer system (e.g., 600) detects (908), via a second input device (e.g., 604), different from the first input device, of the plurality of input devices, a second input (e.g., 650D, 750B, and/or 750N).

In response to detecting the second input (e.g., 650D, 750B, and/or 750N) via the second input device (e.g., 604) of the plurality of input devices (e.g., a rotation of a rotatable input mechanism and/or a press of a button (e.g., a rotatable input mechanism and/or a button that is separate from a display of the computer system (e.g., a physical button, a mechanical button, and/or a capacitive button))) that is different from the first input device (e.g., 602), the computer system (e.g., 600) performs (910) a second operation (e.g., navigating to a parent user interface in a hierarchy of user interfaces, displaying a home screen, locking the computer system, and/or without performing the first operation) (e.g., as shown in FIG. 6G and/or as shown in FIG. 7K) that is different from the first operation.

While displaying the user interface (e.g., 610 at FIG. 6A, 710 at FIG. 7A, and/or 712 at FIG. 7F), the computer system (e.g., 600) detects (912) (e.g., via a third input device of the plurality of input devices) a third input (e.g., 650E, 750C, and/or 750I) that is detected separately from the first input device and the second input device.

In response (914) to detecting the third input (e.g., 650E, 750C, and/or 750I) and in accordance with a determination that the third input is a first type of input (e.g., 650E being a pinch-and-hold air gesture, 750C being a pinch gesture, 750I being a pinch-and-hold gesture) that is detected without detecting input directed to the first input device and the second input device, the computer system (e.g., 600) performs (916) the first operation (e.g., pause media as in FIG. 6F, display message conversation as in FIG. 7F, and/or display 730) (e.g., without detecting input via the first input device).

In response (914) to detecting the third input (e.g., 650E, 750C, and/or 750I) and in accordance with a determination that the third input is a second type of input (e.g., 650E, 750C, and/or 750I being a double-pinch air gesture) that is detected without detecting input directed to the first input device and the second input device, the computer system (e.g., 600) performs (918) the second operation (e.g., display 612 as in FIG. 6G and/or display 612 as in FIG. 7K) (e.g., without detecting input via the second input device).

Enabling the computer system to receive inputs via an input device other than the first input device and the second input device to perform the same operations as can be performed using the first input device and the second input device allows for easier inputs and more options for performing the operations, thereby reducing the number of inputs required to perform the operations and improving the man-machine interface.

For computer systems that are wrist-worn, air gesture inputs enable users to provide inputs to the computer system without the need to use another hand. For example, when a user is holding an object in their other hand and the user is therefore not able to use that hand to touch the touchscreen of the computer system to initiate a process, the user can perform a respective air gesture (using the hand on which the computer system is worn) that is detected by the computer system and that initiates the process. Additionally, some air gestures do not include/require a targeting aspect, and users can therefore provide those air gestures without the need to look at content that is being displayed and, optionally, without the need to raise the hand on which the computer system is worn. In some embodiments, the third input is detected using a third input device. In some embodiments, the third input device optionally includes one or more accelerometers, one or more gyroscopes, an inertial measurement unit (IMU), one or more visual sensors, one or more muscle sensors, one or more electromyography sensors, and/or one or more electrical impulse sensors.

In some embodiments, the first input (e.g., 650B, 750A, and/or 750E) is a touch input. In some embodiments, the first input device is a touch-sensitive surface, such as a touch-sensitive surface that is incorporated into a touchscreen or a touch-sensitive surface that is not incorporated with a display such as a touchpad or touch-sensitive button or other hardware control. Using a touch input to initiate the first operation reduces the need to navigate a multi-level hierarchy to initiate the operation, thereby reducing the number of inputs required and improving the man-machine interface.

In some embodiments, the second input (e.g., 650D, 750B, and/or 750N) is a button press input (e.g., a touch of a capacitive button, a press input on a solid state button that is activated based on a detected intensity of an input at the location of the solid state button, and/or a depression of a depressible button). In some embodiments, the second input device is a button (e.g., that is separate from a display of the computer system and/or that is not a display). Using a button press to initiate the second operation reduces the need to navigate a multi-level hierarchy to initiate the operation, thereby reducing the number of inputs required and improving the man-machine interface.

In some embodiments, the second input device (e.g., 604) is a rotatable input mechanism (e.g., rotatable crown). In some embodiments, the second input does not include rotation of the rotatable input mechanism. Using a button press on a rotational input mechanism to initiate the second operation reduces the need to navigate a multi-level hierarchy to initiate the operation, thereby reducing the number of inputs required and improving the man-machine interface.

In some embodiments, the third input (e.g., 650E, 750C, and/or 750I) is a motion gesture. In some embodiments, a motion gesture is a gesture that includes motion. In some embodiments, the third input is detected using a third input device. In some embodiments, the third input device optionally includes one or more accelerometers, one or more gyroscopes, an inertial measurement unit (IMU), one or more visual sensors, one or more muscle sensors, one or more electromyography sensors, and/or one or more electrical impulse sensors. Using motion gesture to initiate the first and/or second operation reduces the need to navigate a multi-level hierarchy to initiate the operation, thereby reducing the number of inputs required and improving the man-machine interface.

In some embodiments, the first input device (e.g., 602) is a touch-sensitive surface and the second input device (e.g., 604) is a hardware input device (e.g., a button or a rotatable and depressible input device such as a digital crown) and the motion gesture is detected without use of the touch-sensitive surface and the hardware input device. Detecting the motion gesture without using the touch-sensitive surface and the hardware input device reduces the need to provide multiple inputs to initiate the operation, thereby reducing the number of inputs required and improving the man-machine interface.

In some embodiments, the first type of input (e.g., 650E being a pinch-and-hold air gesture, 750C being a pinch gesture, 750I being a pinch-and-hold gesture) is a pinch gesture (e.g., a pinch air gesture) and the first operation is a select operation (e.g., to select a displayed option). In some embodiments, the second type of input is a pinch gesture and the second operation is a selection operation. Using a pinch gesture to perform a selection operation reduces the need to navigate a multi-level hierarchy to initiate the operation, thereby reducing the number of inputs required and improving the man-machine interface.

In some embodiments, the second type of input (e.g., 650F) is a swipe gesture (e.g., a swipe air gesture) and the second operation is an operation to navigate among a plurality of options of the user interface. In some embodiments, the first type of input is a swipe gesture and the second operation is an operation to navigate among a plurality of options of the user interface. Using a swipe gesture to navigate among options reduces the need to navigate a multi-level hierarchy to navigate the options, thereby reducing the number of inputs required and improving the man-machine interface.

In some embodiments, the first type of input (e.g., 650E being a double-pinch air gesture, 750C being a double-pinch air gesture, 750I being a double-pinch air gesture) is a double-pinch gesture (e.g., a double-pinch air gesture) and the first operation is a back operation (e.g., to return to a previous user interface and/or option). In some embodiments, the second type of input is a double-pinch gesture, and the second operation is a back operation. Using a double-ping gesture to perform a back operation reduces the need to navigate a multi-level hierarchy to go back, thereby reducing the number of inputs required and improving the man-machine interface.

In some embodiments, the second type of input (e.g., 650E, 750C, and/or 750I being a double-pinch air gesture) is a double-pinch gesture (e.g., a double-pinch air gesture) and the second operation is an operation to navigate to a home screen user interface (e.g., a current time user interface and/or a user interface with a plurality of options for launching applications). In some embodiments, the first type of input is a double-pinch gesture and the first operation is an operation to navigate to a home screen user interface. Using a double-ping gesture to navigate to a home screen user interface reduces the need to navigate a multi-level hierarchy to access the home screen, thereby reducing the number of inputs required and improving the man-machine interface.

In some embodiments, the second type of input (e.g., 650E, 750C, and/or 750I being a double-pinch air gesture) is a double-pinch gesture (e.g., a double-pinch air gesture) and the second operation is an operation to dismiss an option or a respective user interface. In some embodiments, the first type of input is a double-pinch gesture and the first operation is an operation to dismiss the option of the respective user interface. Using a double-ping gesture to perform a dismiss operation reduces the need to navigate a multi-level hierarchy to perform the dismiss operation, thereby reducing the number of inputs required and improving the man-machine interface.

In some embodiments, the first type of input (e.g., 650E, 750C, and/or 750I) is a pinch-and-hold gesture (e.g., a long-pinch gesture, a pinch-and-hold air gesture, and/or a pinch gesture held for more than a threshold duration) and the first operation is a primary operation (e.g., a default operation). In some embodiments, the second type of input is a pinch-and-hold gesture, and the second operation is a primary operation. Using a pinch-and-hold gesture to perform a primary operation reduces the need to navigate a multi-level hierarchy to perform the primary operation, thereby reducing the number of inputs required and improving the man-machine interface.

In some embodiments, in response to detecting the third input, the computer system (e.g., 600) displays, via the display generation component, an indication (e.g., 622A, 622B, and/or 744) corresponding to the third input, wherein: in accordance with the determination that the third input is the first type of input that is detected without detecting input directed to the first input device and the second input device, displaying the indication of third input includes displaying a first indication (e.g., 744) that corresponds to the first type of input (e.g., that indicates the first type of input was received) without displaying a second indication that corresponds to the second type of input; and in accordance with the determination that the third input is the second type of input that is detected without detecting input directed to the first input device and the second input device, displaying the indication of third input includes displaying the second indication (e.g., 622A and/or 622B) that corresponds to the second type of input (e.g., that indicates the second type of input was received) without displaying the indication that corresponds to the first type of input. Displaying an indication of the detected third input (e.g., which motion gesture) provides the user with visual feedback about what input the computer system detected.

In some embodiments, displaying the indication (e.g., 622A, 622B, and/or 744) corresponding to the third input includes replacing a notification indication (e.g., 606) (e.g., that one or more unread notifications exist) with the indication corresponding to the third input. In some embodiments, a notification indication is being displayed when the third input is detected and, in response to detecting the third input, the computer system replaces display of the notification indication with display of the indication corresponding to the third input. In some embodiments, the notification indication is a conditionally displayed indicator that indicates the existence of one or more new/unread notifications. In some embodiments, the notification indication is not displayed when there are no new/unread notifications. Replacing a notification indication with the indication of the detected third input provides the user with visual feedback about what input the computer system detected.

In some embodiments, the first indication (e.g., 744) that corresponds to the first type of input includes a progress indicator (e.g., that shows progress (e.g., over time) towards completing the input of the first type of input, such as for a pinch-and-hold gesture, such as a pinch-and-hold air gesture). In some embodiments, the first type of input is a pinch-and-hold gesture (e.g., a pinch-and-hold air gesture) and the progress indicator (e.g., a progress bar) progresses over time along (e.g., moves and/or fills) a path (e.g., a straight path or a curved path) based on the duration that the pinch-and-hold gesture continues to be detected, such that the progress indicator provides visual feedback (e.g., via the amount of progress along the path) to the user about the amount of time that the pinch-and-hold gesture has been detected (e.g., a filled portion of the path) and how much longer the pinch-and-hold gesture should be held (e.g., an unfilled portion of the path) to perform an operation. In some embodiments, the progress indicator progress over time with a constant speed while the first type of input continues to be detected (until the first type of input is detected for a threshold amount of time). In some embodiments, the progress indicator (or a portion thereof) increases in length, width, and/or size to indicate progress over time. The progress indicator provides the user with improved visual feedback about the amount of progress made towards completion of the first type of input.

In some embodiments, the second indication (e.g., 622A and/or 622B) that corresponds to the second type of input does not include the progress indicator (and/or any indicator that progresses over time). Not including a progress indicator for the second type of input provides the user with feedback that the second type of input does not need to progress before the input is complete, thereby providing improved visual feedback.

In some embodiments, in response to detecting the first input (e.g., 750E) via the first input device of the plurality of input devices, the computer system (e.g., 600) displays, via the display generation component, a first user interface (e.g., 720) associated with the first operation (e.g., that includes a first set of options, a virtual keyboard and/or without including a second set of options). In some embodiments, in response to detecting the third input (e.g., 750I) and in accordance with a determination that the third input is a first type of input that is detected without detecting input directed to the first input device and the second input device, the computer system (e.g., 600) displays, via the display generation component, a second user interface (e.g., 730) associated with the first operation (e.g., that includes a second set of options different from the first set of options, a voice dictation user interface and/or without including the first set of options) that is different from the first user interface. Displaying varying options corresponding to the first operation based on whether the first input device or the third input device was used to initiate the first operation enables the computer system to provide the user with a user interface that is tailored to how that user is likely to interact with the computer system (e.g., via the first input device or the third input device), thereby reducing the number of inputs required to use the system and improving the man-machine interface.

In some embodiments, the first user interface (e.g., 720) is a virtual keyboard user interface for text entry (e.g., using touch inputs) and the second user interface (e.g., 730) is a voice dictation user interface for text entry (e.g., using voice input). In some embodiments, the virtual keyboard user interface includes a QWERTY or other keyboard that enables touch inputs to select individual keys to cause inputs of individual corresponding characters. In some embodiments, the computer system detects a touch input (e.g., a tap or tap-and-hold) at a location that corresponds to a character (e.g., at a location of a keyboard key of that character) and, in response, enters (displays) the character into a text entry field. Multiple entered characters are optionally concurrently displayed to enable the user to read the entered text. In some embodiments, voice dictation user interface optionally does not include a QUERTY or other keyboard and, instead, the computer system detects utterances and enters text into a text entry field based on (e.g., transcribed using) the utterances. In some embodiments, the characters/words entered into the text entry field are displayed to enable the user to read the entered text. In some embodiments, the virtual keyboard user interface (e.g., which optionally includes a full or partial alphabetical or alphanumeric keyboard) includes more (e.g., significantly more and/or more than double) character entry keys than the voice dictation user interface (e.g., which optionally includes a backspace, a space key, and/or an enter key). Providing a virtual keyboard or a voice dictation interface based on whether the first input device or the third input device was used to initiate the first operation enables the computer system to provide the user with a user interface that is tailored to how that user is likely to interact with the computer system (e.g., via the first input device or the third input device), thereby reducing the number of inputs required to use the system and improving the man-machine interface.

In some embodiments, the first user interface (e.g., 720) associated with the first operation is a text entry user interface (e.g., for replying to a message, such as an instant message or email message) and the second user interface (e.g., 730) associated with the first operation is a text entry user interface (e.g., for replying to a message, such as an instant message or email message). The first user interface and/or the second user interface being text entry user interfaces enables entry of textual information, thereby reducing the inputs required to access the text entry interface.

In some embodiments, in response to detecting the third input, the computer system (e.g., 600) visually highlights (e.g., as in FIGS. 6D-6E) (e.g., enlarging, underlining, bolding increasing a brightness, increasing a saturation, increasing a contrast, and/or fully or partially surrounding the option) a respective selectable option of the user interface. Visually highlighting the option that will be activated provides the user with visual feedback about which option will be activated when appropriate input is received.

In some embodiments, the third input is the first type of input (e.g., 750I) that is detected without detecting input directed to the first input device and the second input device and the respective selectable option corresponds to the first type of input. Visually highlighting the option corresponding to the type of input provides the user with visual feedback about what input was received and which option will be activated when appropriate input is received.

In some embodiments, in response to detecting the third input and in accordance with a determination that the respective selectable option of the user interface is not displayed (e.g., as in FIGS. 7F-7G), the computer system (e.g., 600) updates display of (e.g., scrolling and/or navigating) the user interface, via the display generation component, to display the respective selectable option. In some embodiments, in response to detecting the third input and in accordance with a determination that the respective selectable option of the user interface is displayed, forgoing scrolling the display of the user interface. Updating the display to display the respective selectable option provides the user with visual feedback about the option that will be activated when appropriate input is received.

In some embodiments, in response to detecting the third input, the computer system (e.g., 600) updates an appearance of (e.g., highlighting, bolding, underlining, emphasizing a boundary of, increasing a brightness, increasing a saturation, increasing a contrast, and/or fully or partially surrounding the option) the respective selectable option (e.g., as in FIG. 7C). Changing an appearance of the respective selectable option provides visual feedback to the user about which option will be activated when appropriate input is received.

In some embodiments, in response to detecting the third input, deemphasize (e.g., dimming, blurring, and/or darkening) one or more portions of the user interface that are different from the respective selectable option (as in top-right and bottom-left of FIG. 6C). Deemphasizing aspects of the user interface other than the respective selectable option provides visual feedback to the user about which option will be activated when appropriate input is received.

In some embodiments, the computer system (e.g., 600) is a wearable device (e.g., a wrist-worn device (such as a smart watch) and/or a head mounted system). The computer system being a wearable device enables the computer system to monitor movements of the user as the computer system is worn.

In some embodiments, the third input is an input provided by a first hand (e.g., 640) (e.g., of a user of the computer system) on which the computer system is being worn. In some embodiments, the computer system is worn on a left wrist of the user of the computer system and is not worn on the right wrist of the user. The computer system receiving movement gestures using the hand on which the computer system is worn enables the computer system to monitor movements of the user to be used as inputs.

In some embodiments, the first input is an input provided by a second hand (e.g., of the user of the computer system) that is different from the first hand (e.g., 640). In some embodiments, the first type of input is an input provided by a hand different from the hand on which the device is being worn. The computer system receiving the first input using a hand on which the computer system is not being worn enables the computer system to receive inputs from the user's second hand, thereby improving the man-machine interface.

Note that details of the processes described above with respect to method 900 (e.g., FIG. 9) are also applicable in an analogous manner to the methods described below/above. For example, method 900 optionally includes one or more of the characteristics of the various methods described above with reference to method 800, 1000, 1200, 1300, 1400, 1600, 1800, 2000, and/or 2200. For example, the motion gestures are the same motion gesture. For another example, the air gestures are the same air gestures. For brevity, these details are not repeated below.

FIG. 10 is a flow diagram illustrating methods of outputting non-visual feedback in accordance with some embodiments. Method 1000 is performed at a computer system (e.g., 100, 300, 500, and/or wearable computer system 600 (e.g., a smart watch, wrist-worn device, and/or head-mounted device)) that is in communication with an input device (e.g., visual input devices (e.g., one or more infrared cameras, depth cameras, visible light cameras, and/or gaze tracking cameras), accelerometers, and/or rotatable input mechanisms) and one or more non-visual output devices (e.g., a tactile output device and/or an audio output device). In some embodiments, the input device is a part of the wearable computer system. In some embodiments, the one or more non-visual output devices are part of the wearable computer system. Some operations in method 1000 are, optionally, combined, the orders of some operations are, optionally, changed, and some operations are, optionally, omitted.

As described below, method 1000 provides an intuitive way for outputting non-visual feedback. The method reduces the cognitive burden on a user for receiving feedback, thereby creating a more efficient human-machine interface. For battery-operated computing devices, enabling a user to provide inputs faster and more efficiently conserves power and increases the time between battery charges.

The computer system (e.g., 600) detects (1002), via the input device, at least a portion of a motion gesture (e.g., 750I) that includes movement of a first portion (e.g., thumb in FIG. 7F) of a hand (e.g., 640) of a user relative to a second portion (e.g., forefinger in FIG. 7F) of the hand (e.g., 640) of the user (e.g., a gesture performed in the air and/or a gesture performed using a hand on which the wearable computer system is worn).

In response to detecting at least the portion of the motion gesture (e.g., 750I), outputting (1004) (e.g., in conjunction with detecting the motion gesture and/or based on detecting completion of the motion gesture), via the one or more non-visual output devices, a non-visual indication (e.g., 740B and/or 742B) that the portion of the motion gesture has been detected.

Providing a non-visual indication that the portion of the motion gesture has been detected provides the user with feedback that the computer system has detected the portion of the motion gesture.

For computer systems that are wrist-worn, air gesture inputs enable users to provide inputs to the computer system without the need to use another hand. For example, when a user is holding an object in their other hand and the user is therefore not able to use that hand to touch the touchscreen of the computer system to initiate a process, the user can perform a respective air gesture (using the hand on which the computer system is worn) that is detected by the computer system and that initiates the process. Additionally, some air gestures do not include/require a targeting aspect, and users can therefore provide those air gestures without the need to look at content that is being displayed and, optionally, without the need to raise the hand on which the computer system is worn.

In some embodiments, the input device optionally includes one or more accelerometers, one or more gyroscopes, an inertial measurement unit (IMU), one or more visual sensors, one or more muscle sensors, one or more electromyography sensors, and/or one or more electrical impulse sensors.

In some embodiments, outputting the non-visual indication that the portion of the motion gesture has been detected includes outputting, via a tactile output device, tactile output (e.g., 740B) (e.g., haptic feedback). Providing tactile feedback that the portion of the motion gesture has been detected provides the user with feedback that the computer system has detected the portion of the motion gesture.

In some embodiments, outputting the non-visual indication that the portion of the motion gesture has been detected includes outputting, via an audio output device (e.g., a speaker and/or headphones), audio output (e.g., 742B) (e.g., audio feedback). Providing audio feedback that the portion of the motion gesture has been detected provides the user with feedback that the computer system has detected the portion of the motion gesture.

In some embodiments, the wearable computer system (e.g., 600) is a wrist-worn device (e.g., a wearable smart watch as shown in FIGS. 6A and 7A). The computer system being a wearable smart watch enables the computer system to provide the non-visual feedback to the user without the user needing to pick up or hold the system, thereby providing an improved man-machine interface.

In some embodiments, the computer system (e.g., 600) detects, via the input device, at least a portion of a second motion gesture (e.g., 750C) that includes movement of a third portion (e.g., same or different from first portion) of a hand of a user relative to a fourth portion (e.g., same or different from second portion) of the hand of the user (e.g., a gesture performed in the air and/or a gesture performed using a hand on which the wearable computer system is worn), wherein the second motion gesture (e.g., 750C) is different from the motion gesture. In response to detecting at least the portion of the second motion gesture, the computer system (e.g., 600) outputs (e.g., in conjunction with detecting the motion gesture and/or based on detecting completion of the motion gesture), via the one or more non-visual output devices, a second non-visual indication (e.g., 740A and/or 742A) (e.g., an audio and/or tactile/haptic indication), different from the non-visual indication, that the portion of the second motion gesture has been detected. Providing different non-visual feedback for different types of motion gestures provides the user with feedback about which type of motion gesture the computer system detected, thereby providing improved feedback.

In some embodiments, the motion gesture (e.g., 750C) is a double-pinch gesture (e.g., a double-pinch air gesture) and the second motion gesture is a pinch-and-hold gesture (e.g., a long-pinch gesture, a pinch-and-hold air gesture, and/or a pinch gesture held for more than a threshold duration). In some embodiments, the motion gesture is a pinch-and-hold air gesture (e.g., 750I) and the second motion gesture (e.g., 750C) is a double-pinch gesture. Providing different non-visual feedback for different types of motion gestures provides the user with feedback about which type of motion gesture the computer system detected, thereby providing improved feedback.

In some embodiments, the computer system (e.g., 600) detects, via the input device, at least a portion of a third motion gesture (e.g., 650E, 650F, 650G, 750C, 750L, and/or 750I) (e.g., same or different from the motion gesture) that includes movement of a first respective portion (e.g., same or different from first portion) of a hand of a user relative to a second respective portion (e.g., same or different from second portion) of the hand of the user (e.g., a gesture performed in the air and/or a gesture performed using a hand on which the wearable computer system is worn). In response to detecting the third motion gesture: in accordance with a determination that the computer system (e.g., 600) is not successful in performing an operation corresponding to the third motion gesture (e.g., the computer system failed to identify an operation corresponding to the third motion gesture; and/or the computer system identified an operation corresponding to the third motion gesture but failed to perform the operation corresponding to the third motion gesture), the computer system outputs, via the one or more non-visual output devices, a first respective non-visual indication (e.g., haptic and/or audio indication) (e.g., 740D and/or 742D) that the computer system did not perform an operation corresponding to the third motion gesture; and in accordance with a determination that the computer system (e.g., 600) successfully performed an operation corresponding to the third motion gesture (e.g., the computer system successfully identified an operation corresponding to the third motion gesture and performed the operation), the computer system displays (e.g., via one or more display generation components) a visual indication (e.g., 744) that the operation corresponding to the third motion gesture was successfully performed without outputting the first respective non-visual indication (e.g., without outputting a haptic indication, without outputting an audio indication, or without outputting either a haptic or audio indication). In some embodiments, the visual indication (e.g., 744) that the operation corresponding to the third motion gesture was successfully performed is generated without outputting any non-visual indication that the operation corresponding to the third motion gesture was successfully performed. Displaying a visual indication when an operation is successfully performed, and outputting a non-visual indication when the operation is not successfully performed, provides the user with feedback about whether the operation was successfully performed, thereby providing improved feedback.

In some embodiments, outputting the non-visual indication that the portion of the motion gesture has been detected includes: in accordance with a determination that an operation corresponding to the motion gesture is successful, the non-visual indication includes a success indication (e.g., 740C and/or 742C) (e.g., to indicate the operation was completed) and in accordance with a determination that the operation corresponding to the motion gesture is not successful, the non-visual indication includes a failure indication (e.g., 740D and/or 742D) that is different from the success indication (e.g., the failure indication has a different audio and/or haptic feedback than the audio and/or haptic feedback for the success indication to indicate the operation was not completed). Providing different non-visual feedback based on whether the operation was successful or not provides the user with feedback about the state of the computer system and the operation, thereby providing improved feedback.

In some embodiments, outputting the non-visual indication that the portion of the motion gesture has been detected includes: in accordance with a determination that initiation of the motion gesture has been detected, the non-visual indication includes an initiation indication (e.g., 740B and/or 742B) (e.g., to indicate start of the motion gesture has been detected) and in accordance with a determination that completion of the motion gesture has been detected, the non-visual indication includes a completion indication (e.g., 740C and/or 742C) (e.g., to indicate completion of the motion gesture has been detected). Providing non-visual feedback at the start and completion of the motion gesture provides the user with feedback about how much of the motion gesture the computer system has detected, thereby providing improved feedback.

In some embodiments, the initiation indication (e.g., 740B and/or 742B) is different from the completion indication (e.g., 740C and/or 742C) (e.g., the initiation indication includes one or more audio and/or haptic components that are different from the one or more audio and/or haptic components included in the completion indication). In some embodiments, the initiation indication is the same as the completion indication. Providing different non-visual feedback at the start and completion of the motion gesture provides the user with feedback about how much of the motion gesture the computer system has detected, thereby providing improved feedback.

In some embodiments, the completion indication includes: in accordance with a determination that an operation corresponding to the motion gesture is successful, a gesture succeeded indication (e.g., 740C and/or 742C) (e.g., to indicate the operation was completed and/or without including the gesture failed indication) and in accordance with a determination that the operation corresponding to the motion gesture is not successful, the non-visual indication includes a gesture failed indication (e.g., 740D and/or 742D) that is different from the gesture succeeded indication (e.g., the gesture succeeded indication includes one or more audio and/or haptic components that are different from the one or more audio and/or haptic components included in the gesture failed indication indication) (e.g., to indicate the operation was not completed and/or without including the feature succeeded indication). Providing different non-visual feedback at the end of the motion gesture based on whether the motion gesture (and/or the operation) was successful or not provides the user with feedback about the state of the computer system, thereby providing improved feedback.

In some embodiments, outputting the non-visual indication that the portion of the motion gesture has been detected includes in accordance with a determination that the motion gesture does not correspond to an available operation, the non-visual indication (e.g., 740D and/or 742D) includes an indication that an operation is not available. In some embodiments, the indication that the operation is not available is different from the initiation indication and/or the completion indication. In some embodiments, the indication that the operation is not available is a tactile output that includes a tactile pattern specific to unavailable operations, thereby alerting the user that the operation is not available. In some embodiments, in accordance with a determination that completion of the motion gesture corresponds to an available operation, the non-visual indication includes an indication that the operation is available. Providing the user with non-visual feedback that an operation corresponding to the gesture is not available provides the user with improved feedback about the state of the computer system.

In some embodiments, a pinch-and-hold gesture (e.g., a long-pinch gesture and/or a pinch-and-hold air gesture) is determined based on exceeding a threshold hold duration and the non-visual indication (e.g., 740B and/or 742B) that the portion of the motion gesture has been detected is output prior to the threshold hold duration being reached. In some embodiments, the computer system starts detecting the motion gesture and determines that no operations corresponding to gestures are available and thus outputs the indication that an operation is not available prior to the threshold hold duration being reached. Providing the non-visual feedback prior to the threshold hold duration being reached enables the computer system to more quickly provide the user with feedback about the state of the computer system.

In some embodiments, in response to detecting at least the portion of the motion gesture, the computer system (e.g., 600) displays (e.g., in conjunction with detecting the motion gesture and/or based on detecting completion of the motion gesture), via a display generation component, a visual indication (e.g., 744) that a portion of the motion gesture has been detected. Providing visual feedback that the portion of the motion gesture has been detected provides the user with improved feedback.

In some embodiments, displaying the visual indication (e.g., 744) that the portion of the motion gesture has been detected includes highlighting (e.g., bolding, underlining, enlarging, increasing a brightness, increasing a saturation, increasing a contrast, and/or fully or partially surrounding the option) (e.g., when start of motion gesture is detected and/or when motion gesture is completed) an option (e.g., 714) that corresponds to an operation corresponding to the motion gesture. Highlighting the option that corresponds to the operation that will be performed provides the user with visual feedback about the operation that will be performed when the appropriate input is provided, thereby providing improved feedback.

In some embodiments, displaying the visual indication (e.g., 744) that the portion of the motion gesture has been detected includes displaying a visual element (e.g., 744) that corresponds to the motion gesture. Displaying a visual element that corresponds to the detected motion gesture provides the user with visual feedback about the motion gesture that was detected, thereby providing improved feedback.

In some embodiments, displaying the visual element that corresponds to the motion gesture includes: in accordance with a determination that the motion gesture is a first motion gesture (e.g., a pinch gesture, a pinch air gesture, and/or a pinch-and-hold air gesture), displaying a first visual element (e.g., 744) that corresponds to the first motion gesture and in accordance with a determination that the motion gesture is a second motion gesture (e.g., a double-pinch gesture and/or a double-pinch air gesture) that is different from the first motion gesture, displaying a second visual element (e.g., 622B), different from the first visual element, that corresponds to the second motion gesture. In some embodiments, the first visual element that corresponds to the first motion gesture includes a progress indicator (e.g., because completion of the gesture requires the gesture (e.g., pinch-and-hold) to be performed for a threshold duration of time). In some embodiments, the progress indicator shows progress (e.g., over time) towards completing the input of the gesture, such as for a pinch-and-hold air gesture. In some embodiments, the progress indicator (e.g., a progress bar) progresses over time along (e.g., moves and/or fills) a path (e.g., a straight path or a curved path) based on the duration that the pinch-and-hold gesture continues to be detected, such that the progress indicator provides visual feedback (e.g., via the amount of progress along the path) to the user about the amount of time that the pinch-and-hold gesture has been detected (e.g., a filled portion of the path) and how much longer the pinch-and-hold gesture should be held (e.g., an unfilled portion of the path) to perform an operation. In some embodiments, the progress indicator progress over time with a constant speed while the gesture continues to be detected (until the gesture is detected for a threshold amount of time). In some embodiments, the progress indicator (or a portion thereof) increases in length, width, and/or size to indicate progress over time. In some embodiments, the second visual element does not include a progress indicator (e.g., because completion of the gesture does not require that the gesture be performed for a threshold duration of time). Displaying different visual elements that correspond to different detected motion gestures provides the user with visual feedback about which motion gesture was detected, thereby providing improved feedback.

In some embodiments, in response to detecting that the motion gesture failed (e.g., that the motion gesture does not correspond to an operation and/or that the corresponding operation is currently unavailable), the computer system (e.g., 600) updates display of the visual element that corresponds to the motion gesture (e.g., 746) based on the motion gesture failing. Updating the visual element to indicate that the motion gesture failed provides the user with visual feedback about the state of the computer system and that the motion gesture was not successful (e.g., does not correspond to an available operation).

In some embodiments, updating display of the visual element that corresponds to the motion gesture (e.g., 746) based on the motion gesture failing includes updating an appearance (e.g., color, size, brightness, contrast, saturation, an included glyph or graphical indication, and/or shape) of the visual element. Updating an appearance of the visual element to indicate that the motion gesture failed provides the user with visual feedback about the state of the computer system and that the motion gesture was not successful (e.g., does not correspond to an available operation).

In some embodiments, updating display of the visual element that corresponds to the motion gesture (e.g., 746) based on the motion gesture failing includes animating movement (e.g., shaking left-to-right and/or shaking up-and-down) of the visual element. Animating movement of the visual element to indicate that the motion gesture failed provides the user with visual feedback about the state of the computer system and that the motion gesture was not successful (e.g., does not correspond to an available operation).

In some embodiments, the computer system (e.g., 600) detects, via the input device, a fourth motion gesture (e.g., 650E, 650F, 650G, 750C, 750I, and/or 750L) (e.g., same or different from the motion gesture) that includes movement of a third respective portion (e.g., same or different from first portion) of a hand of a user (e.g., 640) relative to a fourth respective portion (e.g., same or different from second portion) of the hand of the user (e.g., a gesture performed in the air and/or a gesture performed using a hand on which the wearable computer system is worn). In response to detecting the fourth motion gesture: in accordance with a determination that the computer system (e.g., 600) is not in a first respective state when the fourth motion gesture is detected (e.g., the computer system is not engaged in a first activity; the computer system is not performing a first function; and/or the computer system is not running a first application), the computer system outputs, via the one or more non-visual output devices, a second respective non-visual indication (e.g., 620A, 620B, 620C, 620D, 620E, 740A and/or 742A) that the fourth motion gesture has been detected; and in accordance with a determination that the computer system (e.g., 600) is in the first respective state when the fourth motion gesture is detected (e.g., the computer system is engaged in a first activity; the computer system is performing a first function; and/or the computer system is running a first application), the computer system forgoes output of the second respective non-visual indication (e.g., 740A and/or 742A) (in some embodiments, forgoing output of any non-visual indication). Forgoing output of non-visual indications when the computer system is in a particular state enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the determination that the computer system (e.g., 600) is in the first respective state comprises a determination that the computer system is actively recording a biometric measurement (e.g., an ECG reading and/or a heartrate reading). In some embodiments, the determination that the computer system (e.g., 600) is not in the first respective state comprises a determination that the computer system is not actively recording a biometric measurement. Forgoing output of non-visual indications when the computer system is actively recording a biometric measurement enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

Note that details of the processes described above with respect to method 1000 (e.g., FIG. 10) are also applicable in an analogous manner to the methods described above. For example, method 1000 optionally includes one or more of the characteristics of the various methods described above with reference to methods 800, 900, 1200, 1300, 1400, 1600, 1800, 2000, and/or 2200. For example, the motion gestures are the same motion gesture. For another example, the air gestures are the same air gestures. For brevity, these details are not repeated below.

In some embodiments, different air gestures cause different operations to be performed based on the user interface currently displayed, the user interface element/button that is prominent in the user interface, and/or the state of the computer system. The below table provides exemplary user interfaces and the corresponding action(s) performed by the computer system in response to detecting different air gestures in different device contexts and/or when different user interface are displayed.

TABLE 1

| | | Exemplary operation to |
|---|---|---|
| | Exemplary operation to perform | perform in response to |
| | in response to detecting a first | detecting a second type of |
| | type of gesture (e.g., a pinch- | gesture (e.g., a single |
| Displayed User Interface/ | and-hold air gesture or a swipe | pinch air gesture or a |
| Device Context/Device State | air gesture) | double pinch air gesture) |
| Notification: Message (e.g., 710 | Trigger dictation (optionally with | Dismiss (without marking |
| at FIG. 7A) | scrolling) (e.g., 730 at FIG. 7I) | as read) (e.g., 612 at FIG. |
| | | 7K) |
| Messaging Application: Reply, | Trigger dictation (optionally with | Dismiss (e.g., 612 at FIG. |
| Inline reply (e.g., 712 at FIG. 7F) | scrolling) (e.g., 730 at FIG. 7I) | 7K) |
| Notification: Voice Mail | First button: | Dismiss (without marking |
| | Play Voicemail | as read) |
| Notification: Home Door Bell | Mic Button | Dismiss (without marking |
| | | as read) |
| Notification: Others | First button: If it's reply, go | Dismiss (without marking |
| | straight into dictation | as read) |
| Notification: Banner | Pinch-Hold does not interact | Dismiss |
| | with the banner but it does | |
| | interact with the application | |
| Notification: While in Do-Not- | Clear | Dismiss |
| Disturb | | |
| Workout: Prediction Alert | First Button | Dismiss |
| Workout: Fitness Plan Alert | First Button | Dismiss |
| Workout: Active Session (e.g., | Pause/Resume (e.g., 1152A in | Dismiss |
| 1140B in FIG. 11AC) | FIGS. 11AC-11AE) | |
| Meditation: Active Meditation | Pause/Resume | Dismiss |
| Meditation: Begin | Begin | Dismiss |
| Meditation: Start Paired | Start | Dismiss |
| Workout: Start Alert | Start | Dismiss |
| Workout: Summary | None | Dismiss |
| Timer: Active Timer | Pause/Resume | Dismiss |
| Timer: Timer Fired | restart | Dismiss |
| Phone: Incoming Call (e.g., FIG. | Answer | Silence (if Ringing)/ |
| 11E) | | Hangup (if Silenced) (e.g., |
| | | 1114A in FIG. 11E) |
| Phone: Active Call | hangup | No Action |
| Alarm: Alarm Fired | Stop | Snooze |
| Stopwatch: Session | Stop/Resume | Dismiss |
| Keyboard | Send | Dismiss |
| Now Playing UI (e.g., 610 at | Play/Pause (e.g., 610 at FIG. 6F) | Dismiss (e.g., 612 at FIG. |
| FIG. 6B) | | 6G) |
| Camera Remote | Shutter | Dismiss |
| Workout Alert: All workout | First Button | Dismiss |
| related alerts(Sharing, | Reply | Dismiss |
| competition, goals, rewards) | | |
| Workout Alert | Invite | Dismiss |
| Notification Reply Button | TextField | Dismiss |
| Stand Alert | Dismiss | Dismiss |
| Low Battery Alert | First Button | Dismiss |
| Compass | Switch between the compass dial | Dismiss |
| | and the elevation dial | |
| Real-time audio: Send message | Record message while holding | Dismiss |
| Voice Assistant: Send Message | Send button | Dismiss and Send |
| Any Clock Face (e.g., 612 at | None | Display widgets or Display |
| FIG. 6G and/or 7K) | | app launch user interface |
| Voice Memos: List View (e.g., | Record (e.g., 1150L in FIG. 11H) | Dismiss |
| 1118 in FIG. 11G) | | |
| Voice Memos: Recording | Stop | Dismiss |
| Voice Memos: Playback | Pause | Dismiss |
| Flashlight | Toggle Modes | Dismiss |
| System Alerts and Actions | First Action | Dismiss |
| Low Power Mode Alert | First Button: Turn On | Dismiss |
| Fitness: All machine paring alerts | OK | Dismiss |
| Cycle Tracking: All alerts | Open App | Dismiss |
| Shortcuts: Run Confirmation | Run | Dismiss |
| Shortcuts: Smart Prompts | First Button: Allow | Dismiss |
| Shortcuts: All Alerts | First Button: Cancel | Dismiss |
| Shortcuts: Record Audio | Start/stop recording | Dismiss |
| Tips: Tip View | Next Tip | Dismiss |
| Workouts: Choose Goal | Start Workout | Dismiss |
| Activity: Change Goal | Set | Dismiss |
| Workout: Choose Lane | Choose Lane | Dismiss |
| Other UI (e.g., 760 at FIG. 7L) | Negative Feedback (e.g., display | Dismiss (e.g., 612 at FIG. |
| | 744A with shake, as in FIG. 7L) | 6G) |
| Maps Navigation | End | Dismiss |
| SOS: Fall Detected | None | None |
| SOS: Crash Detected | None | None |
| SOS: Emergency Call | None | None |
| SOS: Location Sharing | None | Dismiss |
| Location Permission Dialogs | None | Dismiss |

In some embodiments, computer system 600 is configured to detect a single type of air gesture (e.g., in some embodiments, only a single type of air gesture). In some embodiments, the single type of air gesture causes different operations to be performed based on the user interface currently displayed, the user interface element/button that is prominent in the user interface, and/or the state of the computer system. The below table provides an example set of exemplary user interfaces and the corresponding action(s) performed by the computer system in response to detecting air gestures in different device contexts and/or when different user interfaces are displayed. It should be understood that the examples provided in Table 2 below could be implemented concurrently or separately and individual groups or subsets of interactions from Table 2 could be implemented without implementing other groups or subsets from Table 2. Additionally, the examples provided in Table 2 could be combined with other operations that are performed in response to a different type of gesture (e.g., a second type of gesture). For example when a gesture is detected in a respective device context (e.g., from the left column), if the gesture is a first type of gesture (e.g., a pinch air gesture, a double pinch air gesture, a pinch-and-hold air gesture, or a swipe air gesture), the device performs the corresponding operation (e.g., from the right column), and if the gesture is a second type of gesture (e.g., a pinch air gesture, a double pinch air gesture, a pinch-and-hold air gesture, or a swipe air gesture), the device performs a different operation (e.g., one of the operations listed in Table 1).

TABLE 2

| | Example operation to perform in response to |
|---|---|
| | detecting a first type of gesture (e.g., a pinch air |
| Displayed User Interface/Device | gesture, a double pinch air gesture, a pinch-and- |
| Context/Device State | hold air gesture, or a swipe air gesture) |
| Notification: Message (e.g., 710 at FIG. | Trigger dictation (optionally with scrolling) (e.g., 730 |
| 7A) | at FIG. 7I) |
| Messaging Application: Reply, Inline | Trigger dictation (optionally with scrolling) (e.g., 730 |
| reply (e.g., 712 at FIG. 7F) | at FIG. 7I) |
| Notification: Voice Mail | First button: |
| | Play Voicemail |
| Notification: Home Door Bell | Mute/unmute button |
| Notification: 3rd Party Support | First button |
| Notification: Others | First button: If it's reply, go straight into dictation |
| Notification: Banner | Pinch-Hold does not interact with the banner but it |
| | does interact with the application |
| Notification: While in Do-Not-Disturb | Negative feedback (e.g., visual, haptic, and/or audio |
| | feedback) (e.g., indicating that the air gesture does not |
| | result in any further action) |
| Workout: Prediction Alert | Start Workout |
| Workout: Fitness+ Alert | Connect |
| Mindfulness: Begin Reflect/Breathe | Begin |
| Mindfulness: Start Paired Meditation | Start |
| Workout: Start Alert | Start |
| Workout: Summary | Negative feedback (e.g., visual, haptic, and/or audio |
| | feedback) (e.g., indicating that the air gesture does not |
| | result in any further action) |
| Timer: Active Timer | Pause/Resume |
| Timer: Timer Fired | End timer |
| Phone: Incoming Call (e.g., FIG. 11E) | Answer (e.g., 1114B in FIG. 11E) |
| Phone: Active Call | Hangup |
| Alarm: Alarm Fired | Snooze |
| Stopwatch: Session | Stop/Resume |
| Keyboard | Send |
| Now Playing UI (Now Playing, Music, | Default: Play/Pause (e.g., 610 at FIG. 6F)/Alternative: |
| AudioBooks, Podcast, or other Persistent | FFWD, next song, skip 30 seconds |
| Audio) (e.g., 610 at FIG. 6B) | |
| Camera Remote | Shutter |
| Activity Alert with dismiss option | Dismiss |
| Activity Alert with reply option | Reply via Dictation |
| Activity Alert | Invite |
| Notification Reply Button | Text Field (Start Dictation) |
| Stand Alert | Dismiss |
| Low Battery Alert | First button (Enter low power mode) |
| Compass | Switch between the compass dial and the elevation dial |
| Siri: Send Message | Send button |
| Any Clock Face | Smart Stack |
| Voice Memos: List View (e.g., 1118 in | Record (e.g., 1150L in FIG. 11H) |
| FIG. 11G) | |
| Voice Memos: Recording | Stop |
| Voice Memos: Playback | Pause/Resume |
| Flash Light | Toggle Modes (toggle through three states) |
| Any Dialogs | First button |
| Water Lock | None |
| Low Power Mode Alert | First Button: Turn On |
| Fitness+: All machine paring alerts | OK |
| Cycle Tracking: All alerts | Open App |
| Shortcuts: Run Confirmation | Run |
| Shortcuts: Smart Prompts | Allow |
| Shortcuts: All Alerts | OK |
| Shortcuts: Record Audio | Start/stop recording |
| Tips: Tip View | Try It |
| Workouts: Choose Goal | Start Workout |
| Activity: Change Goal | Set |
| Workout: Choose Lane | Choose Lane |
| Smart Stack (e.g., 1712, 1712a-d in | Default: Advance to next card (then wrap to first card |
| FIGS. 17B-17Q) | at end) (e.g., FIGS. 17B-17F)/Optional User setting: |
| | Act on first card (see below) (e.g., FIGS. 17H-17Q)/ |
| | Optionally single tap to select |
| Live Activity: Active Timer (e.g., 1712a | Default: Advance to next card (e.g., 1712a in FIGS. |
| in FIGS. 17B-17Q) | 17B-17C)/Optional User setting: Pause/Resume |
| | Timer (e.g., 1712a in FIGS. 17J-17L) |
| Live Activity: Active Stopwatch | Default: Advance to next card/Optional User setting: |
| | Stop/Resume Stopwatch |
| Live Activity: Now Playing (e.g., 1712b | Default: Advance to next card (e.g., 1712b in FIGS. |
| in FIGS. 17B-17Q) | 17C-17D)/Optional User setting: Pause/Resume |
| | (e.g., 1712b in FIGS. 17M-17O) |
| Live Activity: Active Workout | Default: Advance to next card/Optional User setting: |
| | Pause/Resume |
| Live Activity: Active Meditation | Default: Advance to next card/Optional User setting: |
| | Pause/Resume |
| Live Activity: 3rd Party Live Sessions | Default: Advance to next card (e.g., FIGS. 17B-17F)/ |
| (e.g., 1712a-d in FIGS. 17B-17Q) | User setting: Primary action or negative feedback (e.g., |
| | FIGS. 17H-17Q) |
| Live Activity: Card without interactive | Default: Advance to next card (e.g., 1712c in FIGS. |
| element (e.g., 1712c in FIGS. 17B-17Q) | 17D-17E)/Optional User setting: Launch App (e.g., |
| | 1712c in FIGS. 17P-17Q) |
| Other user interfaces where an action | Negative feedback (e.g., visual, haptic, and/or audio |
| does not occur in response to the first | feedback) (e.g., indicating that the air gesture does not |
| type of gesture | result in any further action) |
| Tab View Apps (Weather, Stocks, News, | Option 1: Negative Feedback/Option 2: Advance to |
| Activity, Heart Rate) | next page (unless there is a primary action). Cycle back |
| | to first page |
| Walkie-Talkie: Send message | Negative feedback (e.g., visual, haptic, and/or audio |
| | feedback) (e.g., indicating that the air gesture does not |
| | result in any further action) |
| Workout: Active Session | Negative feedback (e.g., visual, haptic, and/or audio |
| | feedback) (e.g., indicating that the air gesture does not |
| | result in any further action) |
| Mindfulness: Active Meditation | Negative feedback (e.g., visual, haptic, and/or audio |
| | feedback) (e.g., indicating that the air gesture does not |
| | result in any further action) |
| Maps Navigation | Negative feedback (e.g., visual, haptic, and/or audio |
| | feedback) (e.g., indicating that the air gesture does not |
| | result in any further action) |
| “Double Click Side Button to Approve” | Negative feedback (e.g., visual, haptic, and/or audio |
| flows | feedback) (e.g., indicating that the air gesture does not |
| | result in any further action) |
| ECG App with finger not touching | Negative feedback (e.g., visual, haptic, and/or audio |
| crown | feedback) (e.g., indicating that the air gesture does not |
| | result in any further action) |
| ECG App with finger touching crown | Negative feedback (e.g., visual, haptic, and/or audio |
| | feedback) (e.g., indicating that the air gesture does not |
| | result in any further action) |
| HeartRate App | Negative feedback (e.g., visual, haptic, and/or audio |
| | feedback) (e.g., indicating that the air gesture does not |
| | result in any further action) |
| SOS: Fall Detected | Negative feedback (e.g., visual, haptic, and/or audio |
| | feedback) (e.g., indicating that the air gesture does not |
| | result in any further action) |
| SOS: Crash Detected | Negative feedback (e.g., visual, haptic, and/or audio |
| | feedback) (e.g., indicating that the air gesture does not |
| | result in any further action) |
| SOS: Emergency Call | Negative feedback (e.g., visual, haptic, and/or audio |
| | feedback) (e.g., indicating that the air gesture does not |
| | result in any further action) |
| SOS: Location Sharing Notification | Negative feedback (e.g., visual, haptic, and/or audio |
| | feedback) (e.g., indicating that the air gesture does not |
| | result in any further action) |
| Location Permission Dialogs | Negative feedback (e.g., visual, haptic, and/or audio |
| | feedback) (e.g., indicating that the air gesture does not |
| | result in any further action) |

FIGS. 11A-11AE illustrate exemplary devices and user interfaces for performing operations based on detected gestures in accordance with some embodiments. The user interfaces in these figures are used to illustrate the processes described below, including the processes in FIGS. 12-14.

FIG. 11A illustrates a user wearing wearable computer system 600 (e.g., a smart watch) on hand 640 of the user. Computer system 600 includes display 602 (e.g., a touchscreen display) and rotatable input mechanism 604 (e.g., a crown or a digital crown). Computer system 600 is in a locked state, as indicated by lock icon 1104. Computer system 600 is displaying, via display 602, notification 1110, which includes contents 1110A of a received instant message and reply option 1110B for replying to the received instant message. In some embodiments, while computer system 600 is in the locked state, computer system 600 does not display the contents and/or the sender of received instant message 1110 (until computer system 600 is unlocked). In some embodiments, while computer system 600 is locked and displaying a notification (e.g., notification 1110), air gestures (e.g., a pinch-and-hold air gesture and/or a double-pinch air gesture) (e.g., that are detected by computer system 600) do not cause computer system 600 to perform an operation. For example, pinch-and-hold air gesture 1150A does not activate reply button 1110B and does not dismiss notification 1110. In some embodiments, while computer system 600 is locked and displaying a notification (e.g., notification 1110), touch inputs (e.g., a tap input and/or a tap-and-hold input) (e.g., that are detected by a touchscreen of computer system 600) do not cause computer system 600 to perform an operation. For example, tap input 1150B on reply option 1110B does not activate reply button 1110B and does not dismiss notification 1110. In some embodiments, while computer system 600 is locked and displaying a notification (e.g., notification 1110), a press of rotatable input mechanism 604 causes the computer system to display a watch face, such as tachymeter watch face 1112, as shown in FIG. 11B.

At FIG. 11B, in some embodiments, while computer system 600 is locked and displaying a watch face (e.g., tachymeter watch face 1112), air gestures (e.g., a pinch-and-hold air gesture and/or a double-pinch air gesture) (e.g., that are detected by computer system 600) optionally do perform one or more operations. For example, pinch-and-hold air gesture 1150D optionally causes computer system 600 to display a keyboard or keypad for entering unlock information (e.g., passcode and/or password) to unlock computer system 600. In some embodiments, while computer system 600 is locked and displaying a watch face (e.g., tachymeter watch face 1112), touch inputs (e.g., a tap input and/or a tap-and-hold input) (e.g., that are detected by a touchscreen of computer system 600) optionally cause computer system 600 to perform one or more operations. For example, tap input 1150E on weather complication 1112A optionally causes computer system 600 to display a user interface of a weather application that corresponds to weather complication 1112A. In some embodiments, air gestures and/or touch inputs while computer system 600 is locked and displaying a watch face optionally do not cause any operations to be performed.

At FIG. 11C, computer system 600 is in an inactive state and/or display 602 is in a low power state (e.g., disabled, off, dimmed, and/or using reduced colors) (while unlocked). In some embodiments, while computer system 600 is in the inactive state and/or while display 602 is in the low power state, air gestures (e.g., a pinch-and-hold air gesture and/or a double-pinch air gesture) (e.g., that are detected by computer system 600) do not cause computer system 600 to perform an operation. For example, pinch-and-hold air gesture 1150E does not activate play/pause button 610B.

At FIG. 11D, computer system 600 is in an inactive state based on the orientation of computer system 600 (e.g., being worn on hand 640 and down by the user's side, rather than raised up in a position for viewing display 602) (while unlocked). In some embodiments, while computer system 600 is in the inactive state, air gestures (e.g., a pinch-and-hold air gesture and/or a double-pinch air gesture) (e.g., that are detected by computer system 600) do not cause computer system 600 to perform an operation. For example, pinch-and-hold air gesture 1150F does not activate play/pause button 610B.

At FIG. 11E, computer system 600 is in the locked state, as indicated by lock icon 1104. Computer system 600 is outputting an ongoing alert of an incoming real-time communication, such as a phone call. At FIG. 11E, the ongoing alert includes alert user interface 1114, which includes dismiss option 1114A to decline the call and answer option 1114B to answer the call. The ongoing alert also includes audio output 1160A and tactile (e.g., haptic) output 1160B to alert the user of the incoming real-time communication. At FIG. 11E, in some embodiments, because there is an ongoing alert (e.g., of an incoming real-time communication) (even though computer system 600 is locked), air gestures (e.g., a pinch-and-hold air gesture and/or a double-pinch air gesture) that are detected by computer system 600 cause computer system 600 to perform an operation. For example, at FIG. 11E, double-pinch air gesture 1150G declines the call and/or activates dismiss option 1114A. At FIG. 11E, in some embodiments, although there is an ongoing alert (e.g., of an incoming real-time communication), air gestures (e.g., a pinch-and-hold air gesture and/or a double-pinch air gesture) (e.g., that are detected by computer system 600) do not cause computer system 600 to perform an operation because computer system 600 is in the locked state. For example, at FIG. 11E, double-pinch air gesture 1150E does not decline the call or activate dismiss option 1114A. At FIG. 11E, while the computer system is in the locked mode and outputs the ongoing alert (e.g., displays alert user interface 1114 and/or outputs 1160A/1160B), tap input 1150H on dismiss option 1114A and/or press input 1150I of button 604 dismiss the ongoing alert and/or decline the incoming call.

At FIG. 11F, computer system 600 displays location sharing user interface 1116 that includes prompt 1116A for sharing a current location (e.g., one time or for a period of time (e.g., 1 hour, 3 hours, or 12 hours)) of computer system 600. Location sharing user interface 1116 is a privacy-based user interface because selections on this user interface change a user's privacy options (e.g., enables location sharing, in this example). In some embodiments, while computer system 600 is displaying a privacy-based user interface, air gestures (e.g., a pinch-and-hold air gesture and/or a double-pinch air gesture) (e.g., that are detected by computer system 600) do not cause computer system 600 to perform an operation. For example, pinch-and-hold air gesture 1150J does not activate prompt 1116A for sharing a current location of computer system 600. At FIG. 11F, computer system 600 detects tap input 1150K on prompt 1116A and, in response, begins sharing a current location of computer system 600. Thus, while displaying privacy-based user interface, computer system 600 performs operations based on touch inputs (and, optionally, inputs at rotatable input mechanism 604) and does not perform operations based on air gestures.

At FIG. 11G, computer system 600 displays voice memo user interface 1118 for recording and playing voice memos. Voice memo user interface 1118 includes record button 1118A for initiating recording a voice memo and first recorded memo option 1118B for playing back a first previously recorded memo. In some embodiments, a tap input on record button 1118A starts a voice memo recording (e.g., which optionally continues without the need to continue pressing record button 1118A). In some embodiments, a tap input on first recorded memo option 1118B initiates playback of the first previously recorded memo.

At FIG. 11H, while displaying voice memo user interface 1118 includes record button 1118A (e.g., the prominent option of the user interface, as further described with respective to FIG. 8), computer system 600 detects pinch-and-hold air gesture 1150L. In response to detecting pinch-and-hold air gesture 1150L, computer system 600 starts recording a voice memo, displays recording indication 1118D, and continues to record the voice memo while computer system 600 continues to detect pinch-and-hold air gesture 1150L, as shown in FIG. 11H.

At FIG. 11I, computer system 600 detects that pinch-and-hold air gesture 1150L is no longer being provided and, in response, has stopped recording the voice memo and is displaying voice memo user interface 1118. As shown in FIG. 11I, voice memo user interface 1118 includes second recorded memo option 1118C for playing back the newly recorded memo. For example, a tap input on second recorded memo option 1118C optionally initiates playback of the newly recorded memo.

At FIG. 11J, computer system 600 is not in a water lock mode (water lock mode is off) and is displaying, via display 602, notification indication 606 (e.g., indicating that one or more unread notifications exist) and media user interface 610 for playing music (same as in FIG. 6A). Media user interface 610 includes previous button 610A, play/pause button 610B, and next button 610C. At FIG. 11J, in some embodiments, computer system 600 detects an input (e.g., a touch input directed to media user interface 610). For example, the user uses a hand different from hand 640 to provide the input. In some embodiments, the input is touch input 1150M directed to play/pause button 610B and, in response to detecting touch input 1150M, computer system 600 pauses playback of the currently playing track, as shown in FIG. 11K.

At FIG. 11K, computer system 600 is not in the water lock mode (water lock mode is off) and is displaying, via display 602, media user interface 610 with playback paused. At FIG. 11K, in computer system 600 detects touch input 1150N directed to play/pause button 610B and, in response to detecting touch input 1150N, computer system 600 re-starts playback of the track.

At FIG. 11L, computer system 600 has received a request (e.g., via touch inputs) to enable water lock mode and, in response, computer system 600 has turned water lock mode on, as indicated by water lock notification 1120A. After displaying water lock notification 1120A indicating that water lock mode is on, computer system 600 returns to displaying media user interface 610 with playback continuing, as shown in FIG. 11M. As shown in FIG. 11M, computer system 600 also displays water lock indicator 1120B at the top of the user interface to indicate that the water lock mode for computer system 600 is turned on. While in the water lock mode, computer system 600 optionally restricts some inputs. For example, computer system 600 optionally disables one or more input devices (e.g., stops monitoring for touch inputs via touchscreen 602) and/or does not perform a corresponding operation for other types of inputs.

At FIG. 11M, while computer system 600 is in the water lock mode and is displaying media user interface 610, computer system 600 detects one or more inputs. In some embodiments, computer system 600 detects tap input 1150O on play/pause button 610B and, in response, does not change the playback state (e.g., does not pause playback of the currently playing track) and optionally displays indication 1120C that water lock mode is enabled (without performing any other operation), as shown in FIG. 11N. In some embodiments, computer system 600 detects press 1150P of hardware button 605 and, in response, does not change the playback state (e.g., does not pause playback of the currently playing track or skip tracks) and optionally displays indication 1120C that water lock mode is enabled (without performing any other operation), as shown in FIG. 11N. In some embodiments, computer system 600 detects rotational input 1150Q of rotatable input mechanism 604 and, in response, does not change the playback state (e.g., does not pause playback of the currently playing track or skip tracks) and optionally displays indication 1120C that water lock mode is enabled (without performing any other operation), as shown in FIG. 11N. In some embodiments, computer system 600 detects press input 1150R (e.g., a short press) of rotatable input mechanism 604 and, in response, does not change the playback state (e.g., does not pause playback of the currently playing track or skip tracks) and optionally displays indication 1120C that water lock mode is enabled (without performing any other operation), as shown in FIG. 11N. Thus, when the water lock mode is on, certain types of inputs are restricted.

At FIG. 11O, while computer system 600 is in the water lock mode and is displaying media user interface 610, computer system 600 begins to detect pinch-and-hold air gesture 1150S. At FIG. 11P, in response to detecting the beginning of pinch-and-hold air gesture 1150S (and, optionally, in accordance with a determination that play/pause button 610B is the primary, main, and/or default button of media user interface 610), computer system 600 highlights play/pause button 610B, as shown in FIG. 11P. FIG. 6C, described with further detail above, illustrates three alternative techniques for highlighting play/pause button 610B. As shown in FIG. 11P, computer system 600 optionally outputs tactile output 1130A to indicate that pinch-and-hold air gesture 1150S has been (or is being) detected. Because play/pause button 610B was already displayed (e.g., was not on a portion of the user interface that was off of the display), computer system 600 did not need to navigate the user interfaces to display play/pause button 610B. At FIG. 11P (similar to FIG. 7G), in response to detecting a portion of pinch-and-hold air gesture 1150S, computer system 600 also displays progress indicator 744. Progress indicator 744 indicates the amount of progress made towards completion of the pinch-and-hold air gesture. As shown in FIG. 11P, progress indicator 744 is displayed alongside water lock indicator 1120B (or alternatively, replaces display of water lock indicator 1120B). Progress indicator 744 includes progression portion 744A that increases in size and/or length, thereby providing feedback about how much progress has been made and/or how much more progress needs to be made toward completion of the pinch-and-hold air gesture.

At FIG. 11Q, computer system 600 continues to detect pinch-and-hold air gesture 1150S and, in response, computer system 600 continues to update progress indicator 744 progressing towards completion of the input (e.g., progression portion 744A fills more of the circle), tactile output 1130A optionally continues to be output, and an audio output optionally is output.

At FIG. 11R, computer system 600 detects that pinch-and-hold air gesture 1150S has been held for more than the threshold duration and, in response, activates play/pause button 610B and (optionally) displays visual indication 730A that corresponds to the detected air gesture. In some embodiments, visual indication 730A visually indicates the type of air gesture detected (e.g., “pinch” or “pinch-and-hold”) and the operation performed (e.g., “pause”). Accordingly, while the water lock mode is on and certain types of input are restricted at computer system 600, the user can still provide air gestures to perform one or more operations, such as a pinch-and-hold air gesture to perform an operation corresponding to a prominent option (e.g., 610B) of the user interface.

At FIG. 11S, while computer system 600 is in the water lock mode and is displaying media user interface 610, computer system 600 begins to detect pinch-and-hold air gesture 1150T. As shown in FIG. 11S, in response to detecting the beginning of pinch-and-hold air gesture 1150T (and, optionally, in accordance with a determination that play/pause button 610B is the primary, main, and/or default button of media user interface 610), computer system 600 highlights play/pause button 610B. Computer system 600 also displays progress indicator 744 and outputs tactile output 1130A.

At FIG. 11T, computer system 600 detects that pinch-and-hold air gesture 1150T has been held for more than the threshold duration and, in response, activates play/pause button 610B and (optionally) displays visual indication 730B that corresponds to the detected air gesture. In some embodiments, visual indication 730B visually indicates the type of air gesture detected (e.g., “pinch” or “pinch-and-hold”) and the operation performed (e.g., “play”). Accordingly, while the water lock mode is on and certain types of input are restricted at computer system 600, the user can still provide air gestures to perform one or more operations, such as a pinch-and-hold air gesture to perform an operation corresponding to a prominent option (e.g., 610B) of the user interface.

FIGS. 11U-11Y illustrate another example of using air gestures while computer system 600 is in the water lock mode. At FIG. 11U, while computer system 600 is in the water lock mode and is displaying workout user interface 1140A, computer system 600 detects one or more inputs. In some embodiments, becomes computer system 600 is in the water lock mode, computer system 600 does not perform operations in response to some inputs. For example, computer system 600 does not perform operations (e.g., change a page of the user interface, pause the workout, display additional workout information, and/or change a volume of audio output) in response to right swipe gesture 1150U on touchscreen 602, press 1150V of button 605, rotational input 1150W of rotatable input mechanism 604, and/or press 1150X of rotatable input mechanism 604. In some embodiments, in response to one or more of inputs 1150U-1150X, computer system 600 displays indication 1120C that water lock mode is enabled (without performing any other operation), as shown in FIG. 11N. In some embodiments, computer system 600 does perform operations in response to air gestures detected while computer system 600 is in the water lock mode. For example, while computer system 600 is in the water lock mode and is displaying workout user interface 1140A, computer system 600 begins to detect pinch-and-hold air gesture 1150Y.

At FIG. 11V, in response to detecting the beginning of pinch-and-hold air gesture 1150Y (and, optionally, in accordance with a determination that the primary, main, and/or default button of the workout user interface is on a different page of the user interface), computer system 600 navigates user interface to workout control user interface 1140B, as shown in FIGS. 11V-11W (e.g., be paging over to a different page (e.g., 1140B) that includes pause option 1142). After navigating to workout control user interface 1140B, computer system 600 highlights pause button 1140B, as shown in FIG. 11X. FIG. 6C, described with further detail above, illustrates three alternative techniques for highlighting a button. Computer system 600 optionally outputs a tactile output to indicate that pinch-and-hold air gesture 1150Y has been (or is being) detected.

At FIG. 11X, in response to detecting a portion of pinch-and-hold air gesture 1150Y and after navigating to workout control user interface 1140B, computer system 600 displays progress indicator 744. Progress indicator 744 indicates the amount of progress made towards completion of the pinch-and-hold air gesture. As shown in FIG. 11X, progress indicator 744 is displayed alongside water lock indicator 1120B (or alternatively, replaces display of water lock indicator 1120B). Progress indicator 744 includes progression portion 744A that increases in size and/or length, thereby providing feedback about how much progress has been made and/or how much more progress needs to be made toward completion of the pinch-and-hold air gesture. If the user stops providing pinch-and-hold air gesture 1150Y before the gesture is completed (before the threshold duration is reached), computer system 600 will not activate pause button 1142 and will, optionally, navigate back to user interface 1140A. Thus, computer system 600 provides the user with feedback that an operation will be performed based on the air gestures and gives the user an opportunity to cease providing the air gesture to avoid the operation from being performed.

At FIG. 11Y, computer system 600 detects that pinch-and-hold air gesture 1150Y has been held for more than the threshold duration and, in response, activates pause button 1142, optionally displays visual indication 730C that corresponds to the detected air gesture, and optionally navigates back to workout user interface 1140A. In some embodiments, visual indication 730C visually indicates the type of air gesture detected (e.g., “pinch” or “pinch-and-hold”) and the operation performed (e.g., “pause”). Accordingly, while the water lock mode is on and certain types of input are restricted at computer system 600, the user can still provide air gestures to perform one or more operations, such as a pinch-and-hold air gesture to perform an operation corresponding to a prominent option (e.g., 610B) of the user interface. When the button that corresponds to a primary operation of a user interface is not displayed and the pinch-and-hold air gesture is detected, computer system 600 navigates the user interfaces to display the button that corresponds to the primary operation. Another example of navigating a user interface to display a button that corresponds to the primary operation of a user interface is illustrated in FIGS. 7F-7H, where in response to pinch-and-hold air gesture 750I, computer system 600 scrolls user interface 712 up to display text entry field 714. User interface 712 is described in detail above.

At FIG. 11Z, computer system 600 detects long press 1150Z of rotatable input mechanism 604 (e.g., longer than a threshold duration of time) and, in response, computer system 600 turns off the water lock mode (re-enabling touch inputs and other types of inputs).

FIGS. 11AA-11AE illustrates computer system 600 detecting pinch-and-hold air gesture 1152A while computer system 600 is not in the water lock mode (e.g., tap inputs on displayed objects causes computer system 600 to perform the operations corresponding to those objects). At FIG. 11AA, computer system 600 detects the start of pinch-and-hold air gesture 1152A. At FIGS. 11AB-11AC, computer system 600 navigates to workout control user interface 1140B. At FIG. 11AD, computer system 600 highlights pause button 1142 and displays progress indicator 744. At FIG. 11AE, computer system 600 detects that pinch-and-hold air gesture 1152A has been held for more than the threshold duration and, in response, activates pause button 1142, optionally displays visual indication 730D that corresponds to the detected air gesture, and optionally navigates back to workout user interface 1140C.

FIG. 12 is a flow diagram illustrating methods of conditionally performing an operation corresponding to an air gesture in accordance with some embodiments. Method 1200 is performed at a computer system (e.g., 100, 300, 500, and/or wearable computer system 600) (e.g., a smart phone, a smart watch, a tablet, a laptop, a desktop, a wearable device, wrist-worn device, and/or head-mounted device) that is in communication with a display generation component (e.g., a display, a touch-sensitive display, and/or a display controller) and one or more input devices (e.g., an accelerometer, an inertial measurement unit (IMU), a blood flow sensor, a photoplethysmography sensor (PPG), an electromyography sensor (EMG), and/or a touch-sensitive surface). Some operations in method 1200 are, optionally, combined, the orders of some operations are, optionally, changed, and some operations are, optionally, omitted.

As described below, method 1200 provides an intuitive way for conditionally performing an operation corresponding to an air gesture. The method reduces the cognitive burden on a user for performing operations, thereby creating a more efficient human-machine interface. For battery-operated computing devices, enabling a user to performing an operation faster and more efficiently conserves power and increases the time between battery charges.

The computer system (e.g., 600) detects (1202), via the one or more input devices, an air gesture (e.g., 1150A, 1150D, 1150E, 1150F, 1150G, 1150J, 1150L, and/or 1150S).

In response to detecting the air gesture and in accordance with a determination that a set of one or more gesture detection criteria is met, the computer system (e.g., 600) performs (1204) an operation (e.g., as described with respect to FIG. 11E, memo recording in FIG. 11H, pausing in FIGS. 11Q-11R) that corresponds to the air gesture, wherein the operation that corresponds to the air gesture is not performed by the computer system (e.g., as described with respect to FIGS. 11A, 11C, 11D, and 11F) when the air gesture occurs while the set of one or more gesture detection criteria is not met. In some embodiments, while the set of one or more gesture detection criteria is not met, the computer system does not monitor for air gestures and, therefore, does not perform operations that correspond to those air gestures. In some embodiments, while the set of one or more gesture detection criteria is not met, the computer system monitors for a first air gesture and does not monitor for a second air gesture and, therefore, does not perform operations that correspond to the second air gesture. In some embodiments, while the set of one or more gesture criteria is not met, the computer system monitors for air gestures but does not perform the operations that correspond to the detected air gestures. In some embodiments, in response to detecting the air gesture, in accordance with a determination that the set of one or more gesture detection criteria is not met, forgoing performing an operation that corresponds to the air gesture. Conditionally performing operations when an air gesture occurs based on whether the set of one or more gesture detection criteria is met enables the computer system to not perform operations corresponding to air gestures when the user may be unaware of inputs they are providing, thereby reducing the likelihood of false positives and accidental inputs that do not correspond to intentional user inputs, thereby making the computer system more secure and improving the man-machine interface. Additionally, not performing the corresponding operation when an air gesture occurs when the set of one or more gesture detection criteria is not met enables the computer system to save power by avoiding or limiting accidental user inputs that cause the computer system to perform (unnecessary and/or unwanted) operations.

In some embodiments, performing the operation that corresponds to the air gesture includes: in accordance with a determination that the air gesture is a first air gesture (e.g., a double pinch air gesture or a pinch air gesture) that corresponds to a first operation, performing the first operation (e.g., without performing a second operation) (e.g., double-pinch air gesture 1150G to dismiss a call at FIG. 11E) and in accordance with a determination that the air gesture is a second air gesture (e.g., pinch-and-hold gesture 1150L to record a voice memo at FIG. 11H) (e.g., a pinch-and-hold air gesture or a triple-pinch air gesture), different from the first air gesture, that corresponds to a second operation that is different from the first operation, performing the second operation (e.g., without performing the first operation). Performing different operations based on receiving different types of gestures enables the computer system to quickly perform various operations in response to various air gestures that the user provides, thereby improving the efficiency of the computer system and extending battery life.

In some embodiments, the first air gesture (e.g., 1150G) is detected with a first subset (e.g., with the accelerometer, the blood flow sensor, and the electromyography sensor (EMG) and without the photoplethysmography sensor (PPG), and the inertial measurement unit (IMU)) of the one or more input devices and the second air gesture (e.g., 1150L) is detected with a second subset (e.g., with the accelerometer and blood flow sensor and without the electromyography sensor (EMG), the photoplethysmography sensor (PPG), and the inertial measurement unit (IMU)), different from the first subset, of the one or more input devices. In some embodiments, different combinations of input devices are used to detect different types of air gestures. In some embodiments, the computer system can detect a pinch air gesture without using an electromyography sensor (EMG) whereas the computer system uses the electromyography sensor (EMG) to detect a pinch-and-hold gesture. Using different hardware sensors to detect different types of air gestures helps to conserve energy and, for battery operation devices, prolong battery life. For example, powering down certain sensors and not relying on those sensors when particular air gestures are not supported for a user interface reduces the power usage of the device, thereby improving performance.

In some embodiments, performing the operation (or performing the first operation) that corresponds to the air gesture includes: in accordance with a determination that the computer system (e.g., 600) is operating in a first context (e.g., audio playing) (e.g., displaying a user interface of a first application without displaying the user interface of a second application), performing a third operation (e.g., pausing playback, as in FIG. 11Q) (e.g., without performing a fourth operation) and in accordance with a determination that the computer system is operating in a second context (e.g., playing audio) (e.g., displaying a user interface of the second application without displaying the user interface of the first application), different from the first context, performing a fourth operation (e.g., initiating playback, as in FIG. 11S) that is different from the third operation (e.g., without performing the third operation). In some embodiments, the same air gesture causes the computer system to perform a different operation based on the context of the computer system at the time that the air gesture is detected. Performing different operations for the same air gesture based the context of the computer system provides additional control options without cluttering the user interface with additional displayed controls.

In some embodiments, the set of one or more gesture detection criteria includes a device worn criterion that is met when the computer system (e.g., 600) is currently being worn by a user (e.g., on hand 640) (e.g., is currently worn on a hand or wrist of the user). In some embodiments, the set of one or more gesture detection criteria includes a criterion that is based on the computer system detecting that the computer system is currently worn on a portion (e.g., a hand or wrist) of a body of a user.

In some embodiments, the set of one or more gesture detection criteria includes a device unlocked criterion that is met when the computer system (e.g., 600) is in an unlocked state (e.g., as in FIGS. 11G-11AE). In some embodiments, the set of one or more gesture detection criteria includes a criterion that is based on the computer system detecting that the computer system is currently unlocked. In some embodiments, the operation that corresponds to the air gesture is optionally not performed by the computer system when the computer system is in a locked state and optionally is performed by the computer system when the computer system is in the unlocked state. In some embodiments, while the computer system is in the locked state, the computer system optionally does not monitor for the air gesture (e.g., disables one or a plurality of the one or more input devices used to detect the air gesture) to save power, except for when certain conditions are met (e.g., when there is an ongoing alert and/or when there is an incoming (audio and/or video) call). In some embodiments, while the computer system is in the unlocked state, the computer system monitors for the air gesture (e.g., using the one or more input devices). Not performing operations when an air gesture occurs based on the computer system being locked enables the computer system to not perform operations corresponding to air gestures when the user may be unaware of inputs they are providing, thereby reducing the likelihood of false positives and accidental inputs that do not correspond to intentional user inputs, thereby making the computer system more secure and improving the man-machine interface.

In some embodiments, the set of one or more gesture detection criteria includes a device active criterion that is met when the computer system (e.g., 600) is in an active state (e.g., as in FIGS. 11G-11I) (e.g., a display of the computer system is active based on the computer system having detected a touch input, a button press and/or movement of the computer system (e.g., such as a wrist raise)). In some embodiments, the computer system is in an active state when the display is not in a low power display mode (e.g., an off state or a low-power consumption state). In some embodiments, the set of one or more gesture detection criteria includes a criterion that is based on the computer system detecting that the computer system is in an active state. In some embodiments, while the computer system is not in the active state (e.g., is in the inactive state), the computer system optionally does not monitor for the air gesture (e.g., disables one or a plurality of the one or more input devices used to detect the air gesture) to save power, except for when certain conditions are met (e.g., when there is an ongoing alert and/or when there is an incoming (audio and/or video) call). Not performing operations when an air gesture occurs based on the computer system not being in an active state enables the computer system to not perform operations corresponding to air gestures when the user may be unaware of inputs they are providing, thereby reducing the likelihood of false positives and accidental inputs that do not correspond to intentional user inputs, thereby making the computer system more secure and improving the man-machine interface.

In some embodiments, the set of one or more gesture detection criteria includes an active alert criterion that is met when the computer system (e.g., 600) is outputting (e.g., via the display generation component, via a tactile output device, and/or via an audio output device) an ongoing alert (e.g., as in FIG. 11E). In some embodiments, the alert is a non-visual alert. In some embodiments, the alert is based on reaching a configured time via an alarm application, reaching the end of a timer, and/or detecting an incoming invitation to a real-time communication session (e.g., a voice call and/or video call). In some embodiments, the set of one or more gesture detection criteria includes a criterion that is based on the computer system outputting an ongoing alert. In some embodiments, the set of one or more gesture detection criteria is met when an ongoing alert is being output, even if the computer system is inactive and/or the display of the computer system is dimmed. Performing a corresponding operation when an air gesture occurs based on an ongoing alert enables the computer system to perform operations corresponding to air gestures when the user may be addressing an alert, thereby improving the man-machine interface. Not performing the corresponding operation when an air gesture occurs when an ongoing alert is not occurring enables the computer system to save power by avoiding or limiting accidental user inputs that cause the computer system to perform (unnecessary and/or unwanted) operations.

In some embodiments, the set of one or more gesture detection criteria includes a device mode criterion that is met when a sleep mode of the computer system (e.g., 600) is not active. In some embodiments, the computer system operates in the sleep mode (the sleep mode is active) when the computer system detects that a user wearing the computer system is sleeping and/or that sleep characteristics of the user are being tracked. In some embodiments, the set of one or more gesture detection criteria includes a criterion that is based on the computer system not being in the sleep mode. Not performing operations when an air gesture occurs based on a sleep mode of the computer system being active enables the computer system to not perform operations corresponding to air gestures when the user may be unaware of inputs they are providing, thereby reducing the likelihood of false positives and accidental inputs that do not correspond to intentional user inputs, thereby making the computer system more secure and improving the man-machine interface.

In some embodiments, the set of one or more gesture detection criteria includes a power mode criterion that is met when the computer system is not in a low power mode (e.g., as compared to FIG. 11C, where computer system 600 is in a low power mode). In some embodiments, the set of one or more gesture detection criteria includes a criterion that is based on the computer system not being in a low power mode. In some embodiments, in the low power mode a display of the computer system is dimmed and/or turned off/completely dark. In some embodiments, the display of the computer system is not dimmed or turned off when not in the low power mode (e.g., when in a normal power mode). In some embodiments, the low power mode is a mode in which the computer system consumes a reduced amount of power as compared to the normal power mode. Not performing operations when an air gesture occurs based the computer system being in a low power mode enables the computer system to not perform operations corresponding to air gestures when the user may be unaware of inputs they are providing, thereby reducing the likelihood of false positives and accidental inputs that do not correspond to intentional user inputs, thereby making the computer system more secure and improving the man-machine interface.

In some embodiments, the set of one or more gesture detection criteria includes an access mode criterion (or an accessibility mode criterion) that is met when the computer system (e.g., 600) is not in an accessibility mode. In some embodiments, the accessibility mode is a mode in which users with limited or reduced physical abilities can use alternative input techniques to control the computer system. In some embodiments, while the computer system is in the accessibility mode, the computer system performs functions based on detected air gestures as the alternative input technique. In some embodiments, the air gestures used as the alternative input technique overlap with and/or compete with air gestures that can be used while the set of one or more gesture detection criteria is met (e.g., a particular air gesture performs a first command when the set of one or more gesture detection criteria is met, but performs a second (different) command when accessibility mode is enabled). In some embodiments, the set of one or more gesture detection criteria includes a criterion that is based on the computer system not being in the accessibility mode. Not performing operations that correspond to a detected air gesture when an air gesture occurs based the computer system being in an accessibility mode enables the computer system to not perform operations corresponding to air gestures that may otherwise conflict with the accessibility mode features, thereby improving the man-machine interface.

In some embodiments, the set of one or more gesture detection criteria includes a submersion state criterion that is met when the computer system (e.g., 600) is in a water input mode (e.g., the computer system is not in a water lock input mode and/or is not submerged in water) (e.g., is not below a threshold depth of water/liquid as detected by one or more sensors of the device such as an atmospheric pressure sensor or other pressure sensor). In some embodiments, the set of one or more gesture detection criteria includes a criterion that is based on the computer system not being submerged in water. Not performing operations when an air gesture occurs based on the computer system being submerged enables the computer system to not perform operations corresponding to air gestures when the user may be unaware of inputs they are providing, thereby reducing the likelihood of false positives and accidental inputs that do not correspond to intentional user inputs, thereby making the computer system more secure and improving the man-machine interface.

In some embodiments, while the set of one or more gesture detection criteria is not met (e.g., while the computer system displays content (via the display generation component and/or on a display), such as in a low power display mode (e.g., wherein the display is dimmed)), the computer system (e.g., 600) receives a notification and/or outputting an alert (e.g., 1110) (e.g., in response to receiving the notification). In some embodiments, the notification corresponds to an application of the computer system. In some embodiments, the computer system transitions between different modes of operating a display of the computer system, such as a normal display mode of operation, a low power display mode of operation that is dimmed as compared to the normal mode, and a dark display mode of operation that is dimmed (e.g., turned off and/or completely dark) as compared to the low power mode. In some embodiments, the alert is a visual alert (e.g., on a display), a tactile alert (e.g., haptic), and/or an audio alert. Continuing to receive alerts and provide notifications (based on the alerts) while the set of one or more gesture detection criteria is not met enables the computer system to continue operating and providing the user with feedback about received notifications, thereby providing an improved man-machine interface.

In some embodiments, a progress of the air gesture (e.g., 1150S) towards completion of the air gesture (e.g., detecting that the air gesture has been completed) is based on a progress toward (e.g., includes the computer system detecting that) the air gesture meeting (e.g., reaches and/or exceeds) one or more input thresholds (e.g., as shown in 744 of FIGS. 11P-11Q). Completion of the air gesture being detected once one or more input thresholds are met helps the computer system to not misinterpret hand movements as air gestures, thereby reducing the likelihood of false positives and accidental inputs that do not correspond to intentional user inputs, and also allows the user to change their mind while providing the input, thereby making the computer system more secure and improving the man-machine interface.

In some embodiments, the air gesture (e.g., 1150S) includes an input duration and the one or more input thresholds include an input duration threshold (e.g., as shown in 744 of FIGS. 11P-11Q) (e.g., a threshold amount of time that a specific gesture is provided or maintained). In some embodiments, the air gesture is a pinch-and-hold air gesture and the pinch is maintained for more than the input duration threshold (e.g., 0.01, 0.05, 0.1 seconds, 0.5 seconds, 1 second, 5 seconds, 10 seconds, 15 seconds, or 45 seconds). In some embodiments, the computer system displays a progress indicator that indicates progress towards meeting the input duration threshold, thereby providing the user with visual feedback of the user's input. Completion of the air gesture being detected once an input duration threshold is met helps the computer system to not misinterpret hand movements as air gestures, thereby reducing the likelihood of false positives and accidental inputs that do not correspond to intentional user inputs, and also allows the user to change their mind while providing the input (and before the input duration threshold is met), thereby making the computer system more secure and improving the man-machine interface.

In some embodiments, the air gesture includes an input intensity (e.g., a characteristic intensity) and the one or more input thresholds include an input intensity threshold. In some embodiments, the air gesture includes a characteristic intensity (e.g., how hard the user is pinching for a pinch air gesture and/or pinch-and-hold air gesture) that exceeds the input intensity threshold. In some embodiments, the input intensity is detected by the computer system using, for example, a blood flow sensor, a photoplethysmography sensor (PPG), and/or an electromyography sensor (EMG). In some embodiments, the computer system displays a progress indicator that indicates progress towards meeting the intensity threshold, thereby providing the user with visual feedback of the user's input. In some embodiments, the computer system relying on the intensity threshold (rather than an input duration threshold) enables the user to perform the operation more quickly than the computer system relying on an input duration threshold. Completion of the air gesture being detected once an input intensity threshold is met helps the computer system to not misinterpret hand movements as air gestures, thereby reducing the likelihood of false positives and accidental inputs that do not correspond to intentional user inputs, and also allows the user to change their mind while providing the input (and before the input intensity threshold is met), thereby making the computer system more secure and improving the man-machine interface.

In some embodiments, the progress of the air gesture (e.g., 1150S) towards completion of the air gesture regresses based on detecting that the input intensity has reduced below the input intensity threshold (e.g., while continuing to detect the air gesture). In some embodiments, while the input intensity of the air gesture is above the input intensity threshold, a timer indicating how long the air gesture has been held progresses towards the input duration threshold and while the input intensity of the air gesture is not above the input intensity threshold, the timer indicating how long the air gesture has been held regresses. In some embodiments, the computer system displays a progress indicator that indicates progress towards meeting the intensity threshold, and the progress of the progress indicator regresses based on detecting that the input intensity has reduced. Completion of the air gesture being detected once an input intensity threshold is met helps the computer system to not misinterpret hand movements as air gestures, thereby reducing the likelihood of false positives and accidental inputs that do not correspond to intentional user inputs, and also allows the user to change their mind while providing the input (and before the input intensity threshold is met), thereby making the computer system more secure and improving the man-machine interface.

In some embodiments, the computer system (e.g., 600) displays (e.g., in response to detecting a portion of (such as a start of) the air gesture), via the display generation component (e.g., 602), an indication (e.g., 744) (e.g., a progress indicator, a change in color/brightness of an affordance in a user interface that corresponds to the operation that corresponds to the air gesture, and/or a deemphasis of a background of the user interface) of the progress of the air gesture towards completion of the air gesture (e.g., 1150S) (e.g., towards meeting the (e.g., reaches and/or exceeds) one or more input thresholds). In some embodiments, the indication of progress (e.g., a progress indicator) updates through intermediate values over time to indicate the progress. In some embodiments, the user can avoid completing the air gesture by ceasing to provide the input before the air gesture is completed (and therefore before the progress indicator indicates completion of the air gesture). Displaying an indication of progress towards meeting the one or more input thresholds provides the user with feedback about the progress made towards completing the air gesture and what/how much more input is required to complete the air gesture, thereby providing improved visual feedback.

In some embodiments, the computer system is configured to communicate with a touch sensitive surface (e.g., 602). Subsequent to detecting the air gesture, the computer system (e.g., 600) displays a respective user interface (e.g., 1116) (e.g., different from a user interface that was displayed when the air gesture was detected) (e.g., that includes one or more selectable options), wherein no operations of the respective user interface correspond to air gestures (e.g., the one or more selectable options cannot be activated via air gestures). While displaying the respective user interface, the computer system (e.g., 600) detects, via the one or more input devices, an input (e.g., 1150K) (e.g., a touch input (such as a tap input) detected via a touch-sensitive surface and/or a press of a button) that is not an air gesture. In response to detecting the input (e.g., 1150K) that is not an air gesture, the computer system (e.g., 600) performs an operation of the respective user interface. In some embodiments, some user interfaces do not have any operations that are selectable/activatable via an air gesture, even though one or more operations of the user interfaces are selectable/activatable via other inputs, such as touch inputs or button presses. Some user interfaces not having operations that correspond to air gestures helps the computer system avoid taking actions based on false positives and accidental inputs that do not correspond to intentional user inputs, thereby making the computer system more secure and improving the man-machine interface.

In some embodiments, the respective user interface is a safety alert user interface (e.g., like 1116, but related to safety rather than privacy). In some embodiments, the safety alert user interface includes an option that, when activated, starts an emergency call or ends/cancels an emergency call. In some embodiments, the safety alert user interface includes provides the user with feedback with user safety information, such as medical conditions, fall detection, and/or car accident detection. Safety alert user interfaces not having operations that correspond to air gestures helps the computer system avoid taking actions based on false positives and accidental inputs that do not correspond to intentional user inputs, thereby making the computer system more secure and improving the man-machine interface.

In some embodiments, the respective user interface is a privacy user interface (e.g., 1116). In some embodiments, the privacy user interface includes an option that, when activated, selects and/or changes a privacy setting of the user and/or computer system, such as enabling sharing a location of the computer system with a service and/or other users. User interfaces relevant to privacy decisions not having operations that correspond to air gestures helps the computer system avoid taking actions based on false positives and accidental inputs that do not correspond to intentional user inputs, thereby making the computer system more secure and improving the man-machine interface.

In some embodiments, performing the operation that corresponds to the air gesture (e.g., 1150G) includes dismissing an alert (e.g., as in FIG. 11E) (e.g., a visual alert, a tactile alert, and/or an audio alert). Dismissing an alert using an air gesture enables the computer system to quickly dismiss the alert without the need for the user to provide touch or other inputs, thereby improving the man-machine interface.

In some embodiments, performing the operation that corresponds to the air gesture (e.g., 1150S and/or 1150T) includes changing a playback state of media content (e.g., starting to play or pausing playing media content) (e.g., audio and/or video). Playing and/or pausing media using an air gesture enables the computer system to quickly manage media playback without the need for the user to provide touch or other inputs, thereby improving the man-machine interface.

In some embodiments, performing the operation that corresponds to the air gesture (e.g., 1150L) includes: initiating a function (as in FIG. 11H) that is performed while the air gesture (e.g., pinch-and-hold air gesture or double-pinch-and-hold air gesture) is detected. While the function is being performed, the computer system (e.g., 600) detects an end of the air gesture (e.g., as in FIG. 11I). In response to detecting the end of the air gesture, the computer system (e.g., 600) ceases to perform the function (e.g., as in FIG. 11I). In some embodiments, the air gesture is a pinch-and-hold air gesture and the computer system begins performing the function when the pinch-and-hold air gesture is held for the threshold duration of time and the function continues until the computer system detects that the pinch-and-hold air gesture is no longer being held. In some embodiments, the function is recording audio (e.g., an audio memo), opening an audio channel to a remote computer system (e.g., a watch and/or a doorbell (such as a smart doorbell and/or an audio-enabled doorbell)). Performing a function for the duration of the air gesture enables the computer system to provide the user with additional control (about how long the function should be performed) without the need for the user to provide touch or other inputs, thereby improving the man-machine interface.

In some embodiments, subsequent to performing the operation (e.g., pause as in FIGS. 11Q-11R) (e.g., playing media, switching to a first flashlight mode, or answering an incoming real-time communication session (such as a phone call)) that corresponds to the air gesture (e.g., 1150S), the computer system (e.g., 600) detects, via the one or more input devices, a second air gesture (e.g., 1150T) (e.g., a pinch air gesture, a double-pinch air gesture, or a pinch-and-hold air gesture) that is the same as the air gesture. In response to detecting the second air gesture, in accordance with a determination that the set of one or more gesture detection criteria is met, the computer system (e.g., 600) performs a second operation (e.g., play media as in FIGS. 11S-11T) (e.g., pausing media, switching to a second flashlight mode, or ending the active real-time communication session), different from the operation, that corresponds to the second air gesture, wherein the second operation that corresponds to the second air gesture is not performed by the computer system when the second air gesture occurs while the set of one or more gesture detection criteria is not met. In some embodiments, in response to detecting the second air gesture and in accordance with a determination that the set of one or more gesture detection criteria is not met, the computer system forgoes performing the second operation. In some embodiments, the computer system performs different operations in response to detecting the same air gesture (e.g., based on the state of the computer system, based on the frequency of the air gesture, and/or based on the repetition of the air gesture) within a threshold time limit. Performing different operations using the same air gesture enables the computer system to quickly perform an operation that is relevant for the current context of the computer system without the need for the user to provide touch or other inputs, thereby improving the man-machine interface.

Note that details of the processes described above with respect to method 1200 (e.g., FIG. 12) are also applicable in an analogous manner to the methods described above. For example, method 1200 optionally includes one or more of the characteristics of the various methods described above with reference to methods 800, 900, 1000, 1300, 1400, 1600, 1800, 2000, and/or 2200. For example, the motion gestures are the same motion gesture. For another example, the air gestures are the same air gestures. For brevity, these details are not repeated below.

FIG. 13 is a flow diagram illustrating methods of navigating user interfaces to display a selectable option in accordance with some embodiments. Method 1300 is performed at a computer system (e.g., 100, 300, 500, and/or wearable computer system 600) (e.g., a smart phone, a smart watch, a tablet, a laptop, a desktop, a wearable device, wrist-worn device, and/or head-mounted device) that is in communication with a display generation component (e.g., a display, a touch-sensitive display, and/or a display controller) and one or more input devices (e.g., an accelerometer, an inertial measurement unit (IMU), a blood flow sensor, a photoplethysmography sensor (PPG), an electromyography sensor (EMG), and/or a touch-sensitive surface). Some operations in method 1300 are, optionally, combined, the orders of some operations are, optionally, changed, and some operations are, optionally, omitted.

As described below, method 1300 provides an intuitive way for navigating user interfaces to display a selectable option. The method reduces the cognitive burden on a user for activating selectable options, thereby creating a more efficient human-machine interface. For battery-operated computing devices, enabling a user to navigate user interfaces to display a selectable option faster and more efficiently conserves power and increases the time between battery charges.

The computer system (e.g., 600) detects (1302), via the one or more input devices, an input (e.g., 1150Y at FIG. 11U, 750 at FIG. 7F, and/or 1150S at FIG. 11O) that includes a portion of (e.g., a start of, a completion of, and/or all of) an air gesture (e.g., a pinch-and-hold air gesture).

In response to detecting the input that includes the portion of the air gesture and in accordance with a determination that the air gesture corresponds to a selectable option (e.g., 1142 and/or 714 at FIG. 7G) that is not displayed in a current view of a user interface, the computer system (e.g., 600) navigates (1304) (e.g., scrolling a current user interface, changing to a different page of the current application, and/or otherwise navigating) one or more user interfaces (e.g., from 1140A to 1140B at FIGS. 11U-11W and/or scrolling 714 at FIGS. 7F-7G) to display, via the display generation component, a respective view of a respective user interface (e.g., 1140B at FIG. 11W and/or 714 at FIG. 7G) that includes the selectable option (e.g., 1142 and/or 714). Navigating one or more user interfaces to display the selectable option provides the user with visual feedback about the option that corresponds to the air gesture and optionally allows the user to stop providing the air gesture to not perform a corresponding operation or to continue providing the air gesture to perform the corresponding operation, thereby providing improved visual feedback.

In some embodiments, in response to detecting the input (e.g., 1150S at FIG. 11O) that includes the portion of the air gesture and in accordance with a determination that the air gesture corresponds to a selectable option (e.g., 610B) that is displayed in the current view of the user interface (e.g., 610), the computer system (e.g., 600) maintains display, via the display generation component (e.g., 602), of the selectable option (e.g., 610B) (e.g., without navigating (e.g., scrolling a current user interface, changing to a different page of the current application, and/or otherwise navigating) one or more user interfaces). Maintaining display of the selectable option provides the user with visual feedback about the option that corresponds to the air gesture and optionally allows the user to stop providing the air gesture to not perform a corresponding operation or to continue providing the air gesture to perform the corresponding operation, thereby providing improved visual feedback.

In some embodiments, the computer system (e.g., 600) detects (e.g., while displaying the selectable option), via the one or more input devices, that the input proceeds to completion of the air gesture. In response to detecting that the input proceeds to completion of the air gesture and in accordance with a determination that the selectable option (e.g., 1114A) corresponds to a cancel operation (e.g., to go back to a previous user interface or setting, to cancel a current process, and/or to stop an ongoing alert), the computer system (e.g., 600) performs the cancel operation (e.g., going back to a previous user interface or setting, canceling a current process, and/or stopping an ongoing alert). Performing a cancel operation in response to detecting completion of the air gesture enables the computer system to quickly cancel an operation (such as an ongoing alert) based on the air gesture without requiring additional inputs from the user, thereby reducing the number of inputs needed to perform the cancel operation and improving the man-machine interface.

In some embodiments, navigating one or more user interfaces to display, via the display generation component (e.g., 602), the respective view of the respective user interface (e.g., 712 at FIG. 7G) that includes the selectable option (e.g., 714 at FIG. 7G) includes scrolling the user interface (e.g., as in FIGS. 7F-7G). In some embodiments, the currently displayed user interface includes the selectable option, but that portion of the user interface that includes the selectable option is not displayed; the computer system scrolls the user interface to display the portion of the user interface that includes the selectable option.

In some embodiments, scrolling the user interface (e.g., 712 at FIGS. 7F-7G) includes: in accordance with a determination that the selectable option is located a first distance in the user interface from the current view of the user interface, scrolling the user interface (e.g., 712 at FIGS. 7F-7G) a first amount that is based on the first distance (and not the second distance); and in accordance with a determination that the selectable option is located a second distance, different from the first distance, in the user interface from the current view of the user interface, scrolling the user interface a second amount, different from the first amount, that is based on the second distance (and not the first distance). In some embodiments, the computer system scrolls the user interface different amounts (and, optionally at different speeds) based on how far away from the current view the selectable option is located. Scrolling one or more user interfaces to display the selectable option provides the user with visual feedback about the option that corresponds to the air gesture and optionally allows the user to stop providing the air gesture to not perform a corresponding operation or to continue providing the air gesture to perform the corresponding operation, thereby providing improved visual feedback.

In some embodiments, navigating one or more user interfaces to display, via the display generation component (e.g., 602), the respective view of the respective user interface (e.g., 1140B at FIG. 11W) that includes the selectable option (e.g., 1142) includes changing from a current page (e.g., 1140A) of the user interface to a respective page (e.g., 1140B) of the user interface. In some embodiments, the user interface (when the start of the air gesture is detected) includes the selectable option on a page that is not currently displayed and the computer system pages over to the page that includes the selectable option (e.g., in response to detecting the input that includes the portion of the air gesture). Paging through one or more user interfaces to display the selectable option provides the user with visual feedback about the option that corresponds to the air gesture and optionally allows the user to stop providing the air gesture to not perform a corresponding operation or to continue providing the air gesture to perform the corresponding operation, thereby providing improved visual feedback.

In some embodiments, the computer system (e.g., 600) starts navigating (in response to detecting the input that includes the portion of the air gesture) the one or more user interfaces to display the respective view of the respective user interface that includes the selectable option (e.g., as in FIGS. 11V-11W) before an operation that corresponds to the selectable option (and, therefore, corresponds to the air gesture) is performed (e.g., at FIG. 11Y) (e.g., by the computer system). In some embodiments, the operation that corresponds to the selectable option is performed after navigation ends. Navigating the one or more user interfaces to display the selectable option before the operation corresponding to the selectable option is performed provides the user with visual feedback about the option that corresponds to the air gesture and optionally allows the user to stop providing the air gesture to not perform the corresponding operation or to continue providing the air gesture to perform the corresponding operation, thereby providing improved visual feedback.

In some embodiments, in response to detecting the input (e.g., 1150Y at FIG. 11U) that includes the portion of the air gesture and in accordance with a determination that the air gesture corresponds to a selectable option (e.g., 1142) that is not displayed in a current view of a user interface: after starting navigating (in response to detecting the portion of the air gesture) the one or more user interfaces to display the respective view of the respective user interface (e.g., after navigating from 1140A to 1140B) that includes the selectable option, the computer system (e.g., 600) displays, via the display generation component (e.g., 602), an indication (e.g., 744A at FIG. 11X) (e.g., a progress indicator, a change in color/brightness of an affordance in a user interface that corresponds to the operation that corresponds to the air gesture, and/or a deemphasis of a background of the user interface) of a progress of the input towards completion of the air gesture (e.g., towards meeting the (e.g., reaches and/or exceeds) one or more input thresholds). Navigating the one or more user interfaces to display the selectable option before displaying the indication of progress of the input towards completion of the air gesture provides the user with visual feedback about the option that corresponds to the air gesture and optionally allows the user to stop providing the air gesture to not perform the corresponding operation or to continue providing the air gesture to perform the corresponding operation, thereby providing improved visual feedback.

In some embodiments, in response to detecting the input (e.g., 1150Y at FIG. 11U) that includes the portion of the air gesture and in accordance with a determination that the air gesture corresponds to a selectable option (e.g., 1142) that is not displayed in a current view of a user interface: before starting navigating (in response to detecting the portion of the air gesture) the one or more user interfaces to display the respective view of the respective user interface that includes the selectable option, displaying, via the display generation component, an indication (e.g., a progress indicator, a change in color/brightness of an affordance in a user interface that corresponds to the operation that corresponds to the air gesture, and/or a deemphasis of a background of the user interface) of a progress of the input towards completion of the air gesture (e.g., if 744 were displayed at FIG. 11U) (e.g., towards meeting the (e.g., reaches and/or exceeds) one or more input thresholds). In some embodiments, the indication of progress (e.g., a progress indicator) updates through intermediate values over time to indicate the progress towards completion of the air gesture. In some embodiments, the user can avoid completing the air gesture by ceasing to provide the input before the air gesture is completed (and therefore before the progress indicator indicates completion of the air gesture). Navigating the one or more user interfaces to display the selectable option after displaying the indication of progress of the input towards completion of the air gesture provides the user with visual feedback that navigation of the user interfaces will occur and optionally allows the user to stop providing the air gesture to not navigate the user interfaces and to not perform the corresponding operation, thereby providing improved visual feedback.

In some embodiments, after navigating the one or more user interfaces (e.g., from FIG. 11U to FIG. 11W and/or FIG. 7F to FIG. 7G) to display the respective view of the respective user interface (e.g., 1140B and/or 712 at FIG. 7G) that includes the selectable option (e.g., 1142), the computer system (e.g., 600) visual highlights (e.g., as shown in FIGS. 11X and/or 7G) (e.g., bolding, enlarging, underlining, increasing a brightness, increasing a saturation, increasing a contrast, fully or partially surrounding the option, and/or changing an appearance of the selectable option and/or a background of the selectable option), via the display generation component, the selectable option (e.g., 1142 in FIG. 11X and/or 714 at FIG. 7G). Highlighting the selectable option after navigating the one or more user interfaces to display the selectable option provides the user with visual feedback about the option that corresponds to the air gesture and optionally allows the user to stop providing the air gesture to not perform the corresponding operation or to continue providing the air gesture to perform the corresponding operation, thereby providing improved visual feedback.

In some embodiments, while the selectable option (e.g., 1142 in FIG. 11X and/or 714 at FIG. 7G) is visually highlighted, the computer system (e.g., 600) detects, via the one or more input devices, an end of the input without detecting completion of the air gesture (e.g., the pinch-and-hold gesture hasn't been held for long enough). In response to detecting the end of the input without detecting completion of the air gesture, the computer system (e.g., 600) forgoes performing an operation that corresponds to the selectable option (and, therefore, corresponds to the air gesture). In some embodiments, in response to ceasing to detect the input before completion of the air gesture, the computer system reduces the visual highlighting or ceases visually highlighting the selectable option. Highlighting the selectable option after navigating the one or more user interfaces to display the selectable option provides the user with visual feedback about the option that corresponds to the air gesture and optionally allows the user to stop providing the air gesture to not perform the corresponding operation or to continue providing the air gesture to perform the corresponding operation, thereby providing improved visual feedback.

In some embodiments, an amount of visual highlighting of the selectable option (e.g., highlighting of 714 changes between FIGS. 7G and 7H) indicates a progress of the input towards meeting one or more input thresholds (e.g., same as or different from the one or more input thresholds described with respect to FIG. 12) of the air gesture (e.g., an input duration threshold and/or an input intensity threshold). In some embodiments, the amount of visual highlighting updates through intermediate amounts of highlighting over time to indicate the progress towards completion of the air gesture. In some embodiments, the user can avoid completing the air gesture by ceasing to provide the input before the air gesture is completed (and therefore before the progress indicator indicates completion of the air gesture). Providing an amount of highlighting of the selectable option that is based on the progress towards completion of the air gesture provides the user with visual feedback about the progress made towards completion of the air gesture and optionally allows the user to stop providing the air gesture to not perform the corresponding operation or to continue providing the air gesture to perform the corresponding operation, thereby providing improved visual feedback.

In some embodiments, after the computer system (e.g., 600) navigates (in response to detecting the input that includes the portion of the air gesture) the one or more user interfaces to display the respective view of the respective user interface (e.g., 1140B of FIG. 11W) that includes the selectable option (e.g., 1142), the computer system (e.g., 600) performs (e.g., in response to detecting completion of the air gesture) an operation (e.g., pause, as in FIG. 11Y) that corresponds to the selectable option (and, therefore, corresponds to the air gesture). In some embodiments, the operation that corresponds to the selectable option is performed after navigation ends. Performing the operation that corresponds to the selectable option after navigating the one or more user interfaces to display the selectable option enables the user to perform the operation with reduced inputs, thereby reducing the number of inputs needed to perform the operation.

In some embodiments, after navigating (in response to detecting the input that includes the portion of the air gesture) the one or more user interfaces to display the respective view of the respective user interface (e.g., 1140B at FIG. 11W) that includes the selectable option (e.g., 1142): in accordance with a determination that the input meets (e.g., reaches and/or exceeds) one or more input thresholds (e.g., an input duration threshold and/or an input intensity threshold) of the air gesture, the computer system (e.g., 600) performs an operation (e.g., pause operation at FIG. 11Y) that corresponds to the selectable option (and, therefore, corresponds to the air gesture) and in accordance with a determination that the input does not (e.g., yet) meet the one or more input thresholds of the air gesture (e.g., at FIG. 11W and/or if the user stops providing input 1150Y at FIG. 11X), the computer system forgoes performing the operation that corresponds to the selectable option (and, therefore, corresponds to the air gesture). Performing a corresponding operation when the input meets an input threshold for the air gesture and not performing the corresponding operation when the input does not meet the input threshold for the air gesture enables the computer system to not perform operations corresponding to air gestures when the threshold is not met, thereby reducing the likelihood of false positives and accidental inputs that do not correspond to intentional user inputs, thereby making the computer system more secure and improving the man-machine interface.

In some embodiments, while displaying the respective view of the respective user interface that includes the selectable option (e.g., 1140B at 11 W), the computer system (e.g., 600) detects, via the one or more input devices, a second input (e.g., a tap input on 1142) (e.g., a touch input (such as a tap input) detected via a touch-sensitive surface and/or a press of a button) that is not an air gesture (e.g., does not include any portion of an air gesture). In response to detecting the second input that is not an air gesture, the computer system (e.g., 600) performs the operation (e.g., pause operation) that corresponds to the selectable option. In some embodiments, the input is directed to (e.g., is a tap input on) the selectable option. The computer system receiving an input that is not an air gesture and, in response, performing the corresponding operation enables the user to provide different types of input to perform the operation, thereby improving the man-machine interface.

In some embodiments, a first view (e.g., 1140A at FIG. 11U) of the user interface is displayed when the input (e.g., 1150Y at FIG. 11U) that includes the portion of the air gesture is detected. While displaying the respective view (e.g., 1140B at FIG. 11W) of the respective user interface that includes the selectable option (e.g., 1142), the computer system (e.g., 600) detects an end of the input (e.g., of input 1150Y). After detecting the end of the input, the computer system (e.g., 600) navigates one or more user interfaces back to the first view (e.g., 1140A at FIG. 11Y). In some embodiments, after detecting an end of the input, the computer system reverses the navigation of the user interfaces to return to the view of the user interface that was being displayed when the input (beginning of the air gesture) was first detected. Reversing the animation/navigation of the one or more user interfaces provides the user with visual feedback that the input has ceased to be detected and reduces the need for the user to provide inputs to get back to the user interface the user was accessing when the input was provided, thereby providing improved feedback and reducing the number of inputs required to navigate the user interface.

In some embodiments, detecting the end of the input includes detecting the end of the input after the input has progressed to completion of the air gesture (e.g., as in FIGS. 11X-11Y). Reversing the animation/navigation of the one or more user interfaces provides the user with visual feedback that the input has been successful and reduces the need for the user to provide inputs to get back to the user interface the user was accessing when the input was provided, thereby providing improved feedback and reducing the number of inputs required to navigate the user interface.

In some embodiments, detecting the end of the input includes detecting the end of the input without the input having progressed to completion of the air gesture (e.g., the input fails and/or the input is canceled before the one or more input thresholds of the air gesture is met). Reversing the animation/navigation of the one or more user interfaces provides the user with visual feedback that the input has failed and reduces the need for the user to provide inputs to get back to the user interface the user was accessing when the input was provided, thereby providing improved feedback and reducing the number of inputs required to navigate the user interface.

In some embodiments, the computer system (e.g., 600) detects, via the one or more input devices, a third input (e.g., 1150S at FIGS. 110 and/or 1150G at FIG. 11E) that includes a portion of (e.g., a start of, a completion of, and/or all of) a second air gesture (e.g., a double pinch air gesture, a double-pinch-and-hold air gesture) that is different from the air gesture. In response to detecting the third input that includes the portion of the second air gesture (and, optionally, in accordance with a determination that the second air gesture corresponds to a second selectable option that is not displayed in a current view of a user interface), the computer system (e.g., 600) forgoes navigating (e.g., not scrolling the current user interface, not changing to a different page of the current application, and not otherwise navigating) one or more user interfaces to display, via the display generation component. In some embodiments, the computer system does not navigate user interfaces with the second air gesture (different from the air gesture) is detected. Not all types of inputs requiring navigation enables the computer system to perform different operations that relate to different types of inputs without needing to navigate away from the current user interface, thereby reducing the processing (and therefore power and battery life) required and improving the man-machine interface.

Note that details of the processes described above with respect to method 1300 (e.g., FIG. 13) are also applicable in an analogous manner to the methods described above. For example, method 1300 optionally includes one or more of the characteristics of the various methods described above with reference to methods 800, 900, 1000, 1200, 1400, 1600, 1800, 2000, and/or 2200. For example, the motion gestures are the same motion gesture. For another example, the air gestures are the same air gestures. For brevity, these details are not repeated below.

FIG. 14 is a flow diagram illustrating methods of performing an operation based on an air gesture in accordance with some embodiments. Method 1400 is performed at a computer system (e.g., 100, 300, 500, and/or wearable computer system 600) (e.g., a smart phone, a smart watch, a tablet, a laptop, a desktop, a wearable device, wrist-worn device, and/or head-mounted device) that is in communication with (optionally, one or more output devices (e.g., an audio generation component, a haptic output component, a display generation component, a display, a touch-sensitive display, and/or a display controller) and) one or more input devices (e.g., an accelerometer, an inertial measurement unit (IMU), a blood flow sensor, a photoplethysmography sensor (PPG), an electromyography sensor (EMG), and/or a touch-sensitive surface). Some operations in method 1400 are, optionally, combined, the orders of some operations are, optionally, changed, and some operations are, optionally, omitted.

As described below, method 1400 provides an intuitive way for performing an operation based on an air gesture. The method reduces the cognitive burden on a user for activating selectable options, thereby creating a more efficient human-machine interface. For battery-operated computing devices, enabling a user to performing an operation based on an air gesture faster and more efficiently conserves power and increases the time between battery charges.

While (1402) the computer system (e.g., 600) is operating in a first mode (e.g., as in FIGS. 11J-11K) (e.g., a normal mode and/or a non-restricted mode), the computer system detects (1404), via a respective input device (e.g., a touch-sensitive surface and/or a rotatable input mechanism) of the one or more input devices, an input (e.g., 1150M and/or 1150N) (e.g., a tap touch gesture or a tap-and-hold touch gesture) directed to the respective input device (e.g., display 602) and in response to detecting the input (e.g., 1150M and/or 1150N) directed to the respective input device (e.g., 602), the computer system (e.g., 600) performs (1406) a first operation (pause and/or play, as in FIGS. 11J-11L) that corresponds to the input directed to the respective input device (e.g., generating an output via at least one of the one or more output devices that corresponds to the input directed to the respective input device).

While (1408) the computer system (e.g., 600) is operating in a second mode (e.g., as in FIGS. 11M-11Y) (e.g., a restricted mode) in which use of the respective input device (e.g., touchscreen 602) is restricted and inputs directed to the respective input device do not cause the computer system to perform the first operation, wherein the second mode is different from the first mode: the computer system (e.g., 600) detects (1410), via the one or more input devices (e.g., input device(s) that are different from the respective input device), an air gesture (e.g., 1150S at FIG. 11O) (e.g., that corresponds to the first operation) and in response to detecting the air gesture, the computer system (e.g., 600) performs (1412) the first operation (e.g., pause and/or play, as in FIGS. 11Q-11T) (e.g., without detecting input via the respective input device). In some embodiments, the first operation corresponds to the air gesture. Using air gestures to perform an operation when in the second (restricted) mode (where use of the respective input device is restricted) enables the user to provide inputs to perform the operation without need to transition the computer system back to the first (normal) mode, thereby improving the efficiency of performing operations and reducing battery use. For example, when the second mode is a water lock mode where the computer system can be submerged in water, a touchscreen of the computer system can be disabled and/or inputs at the touchscreen can be ignored while still enabling the user to provide air gestures to perform desired operations.

In some embodiments, performing the first operation in response to detecting the air gesture includes: in accordance with a determination that the computer system (e.g., 600) is operating in a first context (e.g., media playing as in FIGS. 110-11Q) (e.g., displaying a user interface of a first application without displaying the user interface of a second application), performing a second operation (e.g., pause operation at FIGS. 110-11R) (e.g., without performing a third operation) and in accordance with a determination that the computer system is operating in a second context (e.g., media paused as in FIG. 11S) (e.g., displaying a user interface of the second application without displaying the user interface of the first application), different from the first context, performing a third operation (e.g., play operation) that is different from the second operation (e.g., without performing the second operation). In some embodiments, the same air gesture causes the computer system to perform a different operation based on the context of the computer system (e.g., based on what is displayed) at the time that the air gesture is detected. Performing different operations based on different contexts of the computer system enables the computer system to quickly perform various operations that are relevant to the current context of the computer system in response to an air gesture that the user provides, thereby improving the efficiency of the computer system and extending battery life.

In some embodiments, performing the first operation in response to detecting the air gesture includes: in accordance with a determination that the air gesture is a first air gesture (e.g., a pinch air gesture or a pinch-and-hold air gesture) that corresponds to a fourth operation, performing the fourth operation (e.g., play/pause at FIGS. 110-11T) (e.g., without performing a fifth operation) and in accordance with a determination that the air gesture is a second air gesture (e.g., 1150G at FIG. 11E) (e.g., a double-pinch air gesture or a triple-pinch air gesture), different from the first air gesture, that corresponds to a fifth operation that is different from the fourth operation, performing the fifth operation (e.g., decline call as in FIG. 11E) (e.g., without performing the fourth operation). Performing different operations based on receiving different types of gestures enables the computer system to quickly perform various operations in response to various air gestures that the user provides, thereby improving the efficiency of the computer system and extending battery life.

In some embodiments, while the computer system is not operating in the second mode (e.g., is operating in the first mode, such as in FIGS. 11J-11K), the computer system (e.g., 600) detects, via the one or more input devices (e.g., via respective input device), user input (e.g., after FIG. 11K and before FIG. 11L). In response to detecting the user input, the computer system (e.g., 600) transitions the computer system to operate in the second mode (e.g., as in FIGS. 11L-11Y) (e.g., a restricted mode) (and not in the first mode). In some embodiments, the restricted mode is enabled based on user inputs detected at the computer system, such as touch inputs on a touch-sensitive surface and/or inputs directed to a rotatable and/or pressable button. The computer system receiving user inputs to place the computer system in the second mode enables the computer system to not perform operations corresponding to inputs via the respective input device, thereby reducing the likelihood of false positives and accidental inputs that do not correspond to intentional user inputs, thereby making the computer system more secure and improving the man-machine interface.

In some embodiments, while the computer system (e.g., 600) is not operating in the second mode (e.g., at FIG. 11K) (e.g., is in the first mode of operation), the computer system (e.g., 600) detects that a set of one or more protected mode conditions is met (e.g., that do not include user input and/or that includes detecting water on the computer system) (e.g., user dives into water while wearing the watch between FIGS. 11K and 11L). In response to detecting that the set of one or more protected mode conditions is met, the computer system (e.g., 600) (automatically) transitions the computer system to operate in the second mode (e.g., as in FIGS. 11L-11Y) (e.g., a restricted mode). In some embodiments, the restricted mode is enabled based on detected conditions of the computer system, rather than based on user inputs detected at the computer system. Automatically placing the computer system in the second mode based on detected conditions enables the computer system to not perform operations corresponding to inputs via the respective input device, thereby reducing the likelihood of false positives and accidental inputs that do not correspond to intentional user inputs, thereby making the computer system more secure and improving the man-machine interface.

In some embodiments, the second mode is a water-lock mode (e.g., as shown in FIGS. 11L-11Y) for using the computer system (e.g., 600) in a first environment (e.g., while a user is wearing the computer system on a wrist and the user is in a swimming pool or is taking a shower) where the computer system (e.g., 600) will be exposed to one or more conditions (e.g., hot, cold, and/or wet conditions) in which the accuracy of the respective input device (e.g., 602) in the first environment is less than the accuracy of the respective input device (e.g., 602) is a second environment (e.g., a temperate and/or dry conditions) (e.g., the respective device is more likely to fail to detect inputs and/or is more likely to detect false positives or accidental inputs that do not correspond to intentional user inputs). When the second mode is a water lock mode where the computer system can be submerged in water, a touchscreen of the computer system can be disabled and/or inputs at the touchscreen can be ignored while still enabling the user to provide air gestures to perform desired operations, thereby improving the man-machine interface and reducing the likelihood of false positives and accidental inputs that do not correspond to intentional user inputs.

In some embodiments, the respective input device is a touch-sensitive surface (e.g., 602) (e.g., a touch-sensitive display or a trackpad). For submersible devices, a touch-sensitive surface can be unintentionally activated by water. Thus, restricting the touch-sensitive surface enables the computer system to ignore inputs at the touchscreen while still enabling the user to provide air gestures to perform desired operations, thereby improving the man-machine interface and reducing the likelihood of false positives and accidental inputs that do not correspond to intentional user inputs.

In some embodiments, the respective input device is a rotatable input mechanism (e.g., 604) (e.g., a crown of a smart watch, a click wheel, a mouse wheel, a trackball, and/or a scroll wheel). Restricting the rotatable input mechanism enables the computer system to ignore some inputs at the rotatable input mechanism while still enabling the user to provide air gestures to perform desired operations, thereby improving the man-machine interface and reducing the likelihood of false positives and accidental inputs that do not correspond to intentional user inputs.

In some embodiments, the respective input device is a button (e.g., 605) (e.g., that is not configured to display content, a mechanical button, a solid-state button, and/or a capacitive button). In some embodiments, the solid-state button detects pressure and is activated when the detected pressure exceeds an intensity threshold (e.g., a characteristic intensity threshold). In some embodiments, the solid-state button and/or capacitive button doesn't physically move when activated. In some embodiments, the computer system provides tactile/haptic feedback to simulate (e.g., using a tactile output generator such as a mass that moves mechanically (e.g., using a motor or other actuator) to create a vibration to provide tactile feedback) the feedback sensation of a press of the solid-state button and/or capacitive button (e.g., when the respective button is activated). Restricting a button of the computer system enables the computer system to ignore some inputs at the button while still enabling the user to provide air gestures to perform desired operations, thereby improving the man-machine interface and reducing the likelihood of false positives and accidental inputs that do not correspond to intentional user inputs.

In some embodiments, the computer system (e.g., 600) is in communication with a display generation component (e.g., 602) (e.g., a display, a touch-sensitive display, and/or a display controller). While the computer system (e.g., 602) is operating in the second mode (e.g., the restricted mode) (e.g., as in FIGS. 11L-11Y): the computer system (e.g., 600) detects, via the respective input device (e.g., a touch-sensitive surface and/or a rotatable input mechanism) of the one or more input devices, a second input (e.g., 11500 at FIG. 11M) (e.g., a tap touch gesture or a tap-and-hold touch gesture) directed to the respective input device and in response to detecting the second input (e.g., 11500) directed to the respective input device, the computer system (e.g., 600) displays, via the display generation component, directions (e.g., 1120C) (e.g., what inputs the user should provide) for exiting the second mode (e.g., without performing the first operation). Displaying instructions for how to exist the second mode provides the user with visual feedback that the input via the respective input device was received and provides instructions on how to exit the second mode, thereby providing improved feedback.

In some embodiments, while the computer system (e.g., 600) is operating in the second mode (e.g., at FIG. 11Z) (e.g., the restricted mode), the computer system (e.g., 600) detects, via a second respective input device (e.g., 604) (e.g., a rotatable input mechanism and/or a button) of the one or more input devices, a third input (e.g., 1150Z) (e.g., rotation of more than a threshold amount of the rotatable input mechanism, press of the rotatable input mechanism for more than a threshold time, and/or press of the button for more than a threshold time) directed to the second respective input device, wherein the second respective input device is different from the respective input device. In response to detecting the third input directed to the second respective input device, the computer system (e.g., 600) exits the second mode (e.g., as shown in FIG. 11Z) (e.g., transitioning to operating in the first mode). Using a different input device (as compared to the respective input device that is restricted) to exit the second mode provides the computer system with the ability to receive inputs to exit the second mode, thereby providing an improved man-machine interface.

In some embodiments, the respective input device is a touch-sensitive surface (e.g., 602) and wherein the computer system (e.g., 602) is in communication with a display generation component (e.g., 602) (e.g., a display, a touch-sensitive display, and/or a display controller). While the computer system (e.g., 600) is operating in the first mode (e.g., a normal mode and/or a non-restricted mode), the computer system (e.g., 600) displays, via the display generation component, a user interface object (e.g., 610B at FIGS. 11J-11K), wherein the input (e.g., 1150M and/or 1150N) (e.g., a tap touch gesture or a tap-and-hold touch gesture) directed to the respective input device is an input (e.g., a touch input) directed to (e.g., on) the user interface object. In some embodiments, while the computer system is operating in the second mode (e.g., restricted mode), the computer system displays, via the display generation component, the user interface object. While in the second mode, the computer system does not activate the user interface object (and/or does not perform the first operation) in response to detecting an input (e.g., a touch input) directed to (e.g., on) the user interface object. For submersible devices, a touch-sensitive surface can be unintentionally activated by water. Thus, restricting the touch-sensitive surface enables the computer system to ignore inputs at the touchscreen while still enabling the user to provide air gestures to perform desired operations, thereby improving the man-machine interface and reducing the likelihood of false positives and accidental inputs that do not correspond to intentional user inputs.

Note that details of the processes described above with respect to method 1400 (e.g., FIG. 14) are also applicable in an analogous manner to the methods described above. For example, method 1400 optionally includes one or more of the characteristics of the various methods described above with reference to methods 800, 900, 1000, 1200, 1300, 1600, 1800, 2000, and/or 2200. For example, the motion gestures are the same motion gesture. For another example, the air gestures are the same air gestures. For brevity, these details are not repeated below.

FIGS. 15A-15CC illustrate exemplary devices and user interfaces for performing operations at a computer system, in accordance with some embodiments. In some embodiments, different actions are taken by a computer system in response to the same user inputs based on whether a user is wearing a head-mounted device or the user is not wearing a head-mounted device. The user interfaces in these figures are used to illustrate the processes described below, including the process in FIG. 16.

FIG. 15A illustrates a user 641 wearing wearable computer system 600 (e.g., a smart watch) on hand 640 of the user. Computer system 600 includes display 602 (e.g., a touchscreen display), rotatable input mechanism 604 (e.g., a crown or a digital crown), and button 605. In FIG. 15A, user 641 is not wearing a head-mounted device, which will be described in greater detail below. At FIG. 15A, computer system 600 displays watch face user interface 1500, which includes current time indication 1502a, which identifies the current time (e.g., in a particular time zone) and current date indication 1502b, which identifies the current date (e.g., in the particular time zone). Watch face user interface 1500 also includes watch face complications 1502c-1502f. Complication 1502c displays weather forecast information, and is selectable to display and/or open a weather application. Complication 1502d displays physical activity information for a user (e.g., calories burned, exercise minutes, and/or stand hours) and is selectable to open a fitness and/or physical activity application. Complication 1502e displays the current time in a different time zone, and is selectable to display the current time in one or more other time zones. Complication 1502f displays temperature information, and is selectable to open and/or display a weather application. At FIG. 15A, computer system 600 detects user input 1504a, which is a press of rotatable input mechanism 604, and user input 1504b, which is a press of button 605.

At FIG. 15B, in response to user input 1504a and/or user input 1504b (e.g., individually, in sequence, and/or in combination), and based on a determination that user 641 is not wearing a head-mounted device, computer system 600 displays control center user interface 1506. Control center user interface 1506 includes options 1506a-1506h that are selectable to modify one or more system settings of computer system 600. Option 1506a is selectable to enable and/or disable a silent mode of computer system 600. Option 1506b is selectable to enable and/or disable a theater mode of computer system 600. Option 1506c is selectable to enable and/or disable a walkie-talkie feature of computer system 600. Option 1506d is selectable to enable and/or disable a do not disturb mode of computer system 600. Option 1506e is selectable to turn on and/or turn off a flashlight feature of computer system 600. Option 1506f is selectable to enable and/or disable an airplane mode of computer system 600. Option 1506g is selectable to enable and/or disable a water lock feature of computer system 600. Option 1506h is selectable to control one or more audio output devices using computer system 600.

FIG. 15C depicts an example scenario in which, in response to user input 1504a and/or user input 1504b (e.g., individually, in sequence, and/or in combination), and based on a determination that user 641 is not wearing a head-mounted device, computer system 600 displays user interface 1508. User interface 1508 includes power icon 1508a that is selectable by a user to cause computer system 600 to turn off and/or enter a low power mode. User interface 1508 also includes options 1508c-1508e which pertain to emergency response services. A user can interact with option 1508c to display medical ID information pertaining to the user (e.g., for emergency response personnel to view). A user can interact with option 1508d to engage a backtracking feature of computer system 600 in which computer system 600 tracks the movements of the user so that the user can retrace their path at a later time. A user can interact with option 1508e to contact emergency personnel (e.g., police department, fire department, and/or emergency medical personnel). At FIG. 15C, computer system 600 detects user input 1510a, which is a press of rotatable input mechanism 604, and user input 1510b, which is a press of button 605. In some embodiments, user input 1510a is a continuation of user input 1504a (e.g., a continuous press and/or press and hold of rotatable input mechanism 604), and/or user input 1510b is a continuation of user input 1504b (e.g., a continuous press and/or press and hold of button 605).

At FIG. 15D, in response to user input 1510a and/or user input 1510b (e.g., individually, in sequence, and/or in combination), and based on a determination that user 641 is not wearing a head-mounted device, computer system 600 outputs haptic output 1509b and audio output 1509a, and also initiates countdown timer 1508e to indicate that once countdown timer 1508e counts down to zero (e.g., if the user continues to press and hold rotatable input mechanism 604 and/or button 605 until countdown timer 1508e counts down to zero), computer system 600 will contact emergency personnel.

FIGS. 15A-15D depicted example scenarios in which computer system 600 responded to one or more button press inputs while user 641 was not wearing a head-mounted device. FIGS. 15E-15I depict example scenarios in which computer system 600 responds to one or more button press inputs while user 641 is wearing head-mounted device 1510.

In FIG. 15E, user 641 continues to wear computer system 600 on his hand 640, and also wears head-mounted device (HMD) 1510 on his head. HMD 1510 includes display module 1512, one or more input sensors 1516 (e.g., one or more cameras, eye gaze trackers, hand movement trackers, and/or head movement trackers), and physical input devices 1514a-1514c. In some embodiments, HMD 1510 includes a pair of display modules that provide stereoscopic content to different eyes of the same user. For example, HMD 1510 includes display module 1512 (e.g., which provides content to a left eye of the user) and a second display module (e.g., which provides content to a right eye of the user). In some embodiments, the second display module displays a slightly different image than display module 1512 to generate the illusion of stereoscopic depth. In some embodiments, HMD 1510 includes one or more outward-facing cameras and/or sensors for detecting the physical environment that surrounds HMD 1510 and also for detecting gestures (e.g., air gestures) performed by user 641. The field of view of HMD 1510 and/or the field of view of one or more cameras and/or sensors of HMD 1510 is depicted via area 1511.

At FIG. 15E, HMD 1510 displays user interface 1522 overlaid on three-dimensional environment 1518, which includes objects 1518a-1518d. User interface 1522 includes a plurality of selectable objects 1522a-1522h corresponding to different applications (and, for example, are selectable to open a corresponding application). In some embodiments, three-dimensional environment 1518 is displayed by a display (e.g., display 1502). In some embodiments, three-dimensional environment 1518 includes a virtual environment or an image (or video) of a physical environment captured by one or more cameras (e.g., one or more cameras that are part of input sensors 1516 and/or one or more external cameras). For example, in some embodiments, object 1518a is a virtual object that is representative of a physical object that has been captured by one or more cameras and/or detected by one or more sensors; and object 1518b is a virtual object that is representative of a second physical object that has been captured by one or more cameras and/or detected by one or more sensors, and so forth. In some embodiments, three-dimensional environment 1518 is visible to a user through display 1512 but is not displayed by a display. For example, in some embodiments, three-dimensional environment 1518 is a physical environment (and, for example, objects 1518a-1518d are physical objects) that is visible to a user (e.g., through one or more transparent displays (e.g., 1512)) without being displayed by a display. In some embodiments, three-dimensional environment 1518 is part of an extended reality experience. At FIG. 15E, HMD 1510 detects (e.g., via one or more gaze tracking sensors), that the user is looking to the right of selectable object 1522d, as indicated by gaze indication 1520. Gaze indication 1520 will be used throughout to indicate the position of the user's gaze as detected by HMD 1510.

At FIG. 15E, computer system 600 displays watch face user interface 1500. While displaying watch face user interface 1500, computer system 600 detects that user 641 is wearing and/or using HMD 1510, and also detects user input 1524a, which is a press of rotatable input mechanism 604, and user input 1524b, which is a press of button 605.

At FIG. 15F, in response to user input 1524a and/or user input 1524b (e.g., individually, in sequence, and/or in combination), and based on a determination that user 641 is wearing HMD 1510, computer system 600 maintains display of watch face user interface 1500 and causes HMD 1510 to capture a media item (e.g., capture a photo) using one or more cameras of HMD 1510, as indicated by indication 1526. As such, it can be seen that the same user input (e.g., a button press of rotatable input mechanism 604 and/or a button press of button 605) results in different outcomes based on whether or not computer system 600 detects that user 641 is wearing and/or using HMD 1510. Such features allow a user to interact with computer system 600 with one or more types of inputs when the user is not wearing a head-mounted device, and also allows the user to use computer system 600 to provide inputs to HMD 1510 when the user is wearing and/or using HMD 1510.

FIG. 15G depicts an example scenario in which, in response to user input 1524a and/or user input 1524b (e.g., individually, in sequence, and/or in combination), and based on a determination that user 641 is wearing HMD 1510, computer system 600 maintains display of watch face user interface 1500 and causes HMD 1510 to display HMD control center user interface 1528. HMD control center user interface 1528 includes option 1528a that is selectable to close and/or cease display of control center user interface 1528. HMD control center user interface 1528 also includes options 1528b-1528l that a user can interact with to modify one or more system settings of HMD 1510. For example, option 1528b is selectable to enable and/or disable wifi on HMD 1510. Option 1528c is selectable to enable and/or disable Bluetooth on HMD 1510. Option 1528e is selectable to enable and/or disable an airplane mode feature of HMD 1510. Option 1528f can be interacted with by a user to play, pause, and/or change audio playback of HMD 1510. Option 1528g can be interacted with by a user to adjust a volume setting of HMD 1510. Option 1528h is selectable to enable and/or disable a do not disturb mode of HMD 1510. Option 1528i is selectable to initiate a process for screen sharing content displayed by HMD 1510.

FIG. 15H depicts an example scenario in which, in response to user input 1524a and/or user input 1524b (e.g., individually, in sequence, and/or in combination), and based on a determination that user 641 is wearing HMD 1510, computer system 600 maintains display of watch face user interface 1500 and causes HMD 1510 to initiate a process for powering down HMD 1510 and/or transitioning HMD 1510 to a low power mode. In response to user input 1524a and/or user input 1524b (e.g., individually, in sequence, and/or in combination), and based on a determination that user 641 is wearing HMD 1510, computer system 600 causes HMD 1510 to display prompt 1530, which prompts the user to look at prompt 1530 and perform an air gesture to shut down HMD 1510. At FIG. 15I, HMD 1510 detects that user 641 is looking at prompt 1530 (e.g., as indicated by gaze indication 1520), and also detects air gesture user input 1532. In some embodiments, in response to detecting the user gaze at prompt 1530 and user input 1532, HMD 1510 shuts down and/or enters a low power mode.

While FIGS. 15A-15H depicted exemplary responses by computer system 600 and/or HMD 1510 to one or more button press inputs, FIGS. 15J-15P depict example scenarios in which computer system 600 and/or HMD 1510 respond to one or more rotational inputs (e.g., rotation of rotatable input mechanism 604) receive at computer system 600. At FIG. 15J, user 641 is wearing computer system 600 on his wrist, but is not wearing HMD 1510. At FIG. 15J, computer system 600 displays current time indication 1534, and message user interface 1536, which includes representations of one or more messages 1537a, 1537b exchanged between user 641 and another person (e.g., Mary). Message user interface 1536 also includes option 1536a that is selectable to display a different user interface, and message field 1536b is selectable by a user to enter text for a new message. At FIG. 15J, while displaying message user interface 1536, computer system 600 detects user input 1538, which is a rotation of rotatable input mechanism 604.

At FIG. 15K, in response to detecting user input 1538, and based on a determination that user 641 is not wearing a head-mounted device, computer system 600 displays scrolling of message user interface 1536, in which message 1537a moves off screen and message 1537c is now displayed. In some embodiments, a direction and/or magnitude of scrolling of user interface 1536 is determined based on a direction and or magnitude of the rotation of rotatable input mechanism 604.

At FIG. 15L, user 641 is wearing computer system 600 on his wrist and is also wearing HMD 1510 on his head. Computer system 600 displays watch face user interface 1500, and HMD 1510 displays user interface 1540 overlaid on three-dimensional environment 1518. At FIG. 15L, computer system 600 detects user input 1542a, which is a rotation of rotatable input mechanism 604.

At FIG. 15M, in response to detecting user input 1542a, and based on a determination that user 641 is wearing HMD 1510, computer system 600 causes HMD 1510 to modify an immersion level setting of HMD 1510. In some embodiments a representation of a physical environment (e.g., displayed via virtual passthrough or optical passthrough), such as three-dimensional environment 1518, can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the head-mounted device (e.g., HMD 1510) (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background (e.g., three-dimensional environment 1518) over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

At FIG. 15M, in response to detecting user input 1542a, and based on a determination that user 641 is wearing HMD 1510, computer system 600 increases the immersion level of HMD 1510 by, for example, expanding virtual background 1544, which covers and/or obscures three-dimensional environment 1518. Computer system 600 also outputs haptic feedback 1545 (e.g., one or more vibrations) to indicate that user input 1542a is detected and/or to indicate the increasing immersion level of HMD 1510. At FIG. 15M, computer system 600 detects user input 1542b, which represents further rotation of rotatable input mechanism 604. At FIG. 15N, in response to detecting user input 1542b, and based on a determination that user 641 is wearing HMD 1510, computer system 600 further increases the immersion level of HMD 1510 by, for example, further expanding virtual background 1544, and also continues to output haptic feedback 1545. At FIG. 15N, computer system 600 detects user input 1542c, which represents further rotation of rotatable input mechanism 604. In some embodiments, with continued rotation of rotatable input mechanism 604, computer system 600 causes HMD 1510 to continue increasing the immersion level of HMD 1510 until virtual background environment 1544 completely covers and/or obscures three-dimensional environment 1518 (e.g., 100% immersion). In some embodiments, a user can decrease the immersion level of HMD 1510 by rotating rotatable input mechanism in the opposite direction.

While FIGS. 15L-15N depicted an example scenario in which rotational input at computer system 600 causes adjustment of the immersion level of HMD 1510, FIGS. 150-15P depict an example scenario in which rotational input at computer system 600 causes scrolling of content displayed by HMD 1510. At FIG. 15O, in response to detecting user input 1542a (in FIG. 15L), and based on a determination that user 641 is wearing HMD 1510, and computer system 600 causes HMD 1510 to scroll content displayed in user interface 1540. In some embodiments, in FIG. 15O, based on a determination that the user was looking at a left edge or right edge of user interface 1540 while providing user input 1542a, HMD 1510 scrolls user interface 1540 in a vertical direction. At FIG. 15L, in response to detecting user input 1542a (in FIG. 15L), and based on a determination that user 641 is wearing HMD 1510, and based on a determination that the user was looking at a top edge or bottom edge of user interface 1540 while providing user input 1542a, HMD 1510 scrolls user interface 1540 in a horizontal direction. In some embodiments, the direction and/or magnitude of scrolling of user interface 1540 is dependent on the direction and/or magnitude of rotation of rotatable input mechanism 604.

FIGS. 15Q-15V depict example scenarios in which computer system 600 and/or HMD 1510 respond to one or more touch inputs on touch-sensitive display 602 of computer system 600. At FIG. 15Q, user 641 is wearing computer system 600 on his wrist, but is not wearing HMD 1510. At FIG. 15Q, computer system 600 displays contact selection user interface 1546, which includes representations 1546a-1546d of a plurality of contacts. Each representation 1546a-1546d is selectable to display a message user interface (e.g., similar to message user interface 1536) that includes one or more messages exchanged between user 641 and the respective contact. Contact selection user interface 1546 also includes option 1548 that is selectable to initiate a process for sending a message to a phone number and/or a contact. At FIG. 15Q, computer system 600 detects user input 1550a (e.g., a tap input corresponding to selection of representation 1546a), and user input 1550b (e.g., an upward swipe input).

At FIG. 15R, in response to detecting user input 1550a, and based on a determination that user 641 is not wearing a head-mounted device, computer system 600 ceases display of contacts user interface 1546, and displays message user interface 1536, which was discussed above and includes representations of one or more messages 1537b-1537c that have been exchanged between user 641 and a contact, Mary (e.g., a contact that corresponds to representation 1546a of FIG. 15Q).

At FIG. 15S, in response to detecting user input 1550b, and based on a determination that user 641 is not wearing a head-mounted device, computer system 600 displays scrolling of contact selection user interface 1546.

At FIG. 15T, user 641 is wearing computer system 600 on his wrist and is also wearing HMD 1510 on his head. Computer system 600 displays watch face user interface 1500, and HMD 1510 displays user interface 1552 overlaid on three-dimensional environment 1518. User interface 1552 includes representations 1554a-1554c of one or more messaging sessions between user 641 and one or more other people. At FIG. 15T, computer system 600 detects user input 1556a (e.g., a tap input) and user input 1556b (e.g., a swipe up input).

At FIG. 15U, in response to detecting user input 1556a, and based on a determination that user 641 is wearing HMD 1510, computer system 600 causes HMD 1510 to perform a selection operation. Furthermore, based on a determination that user 614 was looking at representation 1554b when user input 1556a was received, HMD 1510 performs a selection operation corresponding to selection of representation 1554b. In this way, a user is able to select a particular object displayed by HMD 1510 by looking at the object, and providing a touch input on computer system 600. At FIG. 15U, HMD 1510 performs the selection operation corresponding to selection of representation 1554b by displaying messages 1558a-1558d, and message entry field 1552c, which correspond to the messaging session represented by representation 1554b.

At FIG. 15V, in response to detecting user input 1556b, and based on a determination that user 641 is wearing HMD 1510, computer system 600 causes HMD 1510 to perform a scroll operation. Furthermore, based on a determination that user 614 was looking at representation 1554b when user input 1556b was received, HMD 1510 performs a scroll operation of a region in which representation 1554b was displayed, by scrolling representations 1554a-1554c upward such that representation 1554a is no longer displayed and representation 1554d is now visible in user interface 1552. In this way, a user can perform a scroll operation on a particular user interface and/or a particular portion of a user interface displayed by HMD 1510 by looking at the particular user interface and/or the particular portion of the user interface and providing a touch input on computer system 600.

FIGS. 15W-15CC depict example scenarios in which computer system 600 and/or HMD 1510 respond to one or more air gesture user inputs. At FIG. 15W, user 641 is wearing computer system 600 on his wrist, but is not wearing HMD 1510. At FIG. 15W, computer system 600 displays audio playback user interface 1554. Audio playback user interface 1554 includes audio track information 1556a, artist information 1556b, rewind button (or previous track button) 1554a, play button 1554b, and fast forward button (or next track button) 1554c. At FIG. 15W, computer system 600 detects user input 1558, which is an air gesture user input (e.g., a pinch air gesture, a double pinch air gesture, and/or a pinch and hold air gesture).

At FIG. 15X, in response to detecting user input 1558, and based on a determination that user 641 is not wearing a head-mounted device, computer system 600 performs a primary action associated with audio playback user interface 1554, which is selecting play button 1554b and/or initiating playback of audio media. At FIG. 15X, computer system outputs audio output 1560, and replaces play button 1554b with pause button 1554d to indicate that audio playback has started.

At FIG. 15Y, user 641 is wearing computer system 600 on his wrist and is also wearing HMD 1510 on his head. Computer system 600 displays audio playback user interface 1554, while HMD 1510 displays media playback user interface 1562 overlaid on three-dimensional environment 1518. Media playback user interface 1562 includes play now button 1564 that is selectable to initiate playback of video media. At FIG. 15Y, computer system 600 detects user input 1566, which is an air gesture user input (e.g., a pinch air gesture, a double pinch air gesture, and/or a pinch and hold air gesture). HMD 1510 also determines that the user is looking at button 1564 when user input 1566 is detected, as indicated by gaze indication 1520.

At FIG. 15Z, in response to detecting user input 1566, and based on a determination that user 641 is wearing HMD 1510, computer system 600 causes HMD 1510 to perform a selection operation corresponding to selection of button 1564 (e.g., based on HMD 1510 determining that the user was looking at button 1564 when user input 1566 was received). In response, HMD 1510 initiates playback of video media 1568, and displays video media 1568 in an immersive experience in which three-dimensional environment 1518 is partially and/or completely obscured; and/or partially and/or completely hidden from view. In some embodiments, in response to detecting user input 1566, and based on a determination that user 641 is wearing HMD 1510, computer system 600 also outputs haptic feedback 1569 (e.g., haptic feedback 1569 that is indicative of an operation being performed at HMD 1510). In some embodiments, rather than computer system 600 detecting user input 1566 and causing HMD 1510 to perform a selection operation, HMD 1510 detects user input 1566, responds to user input 1566 by performing a selection operation corresponding to selection of button 1564, and causes computer system 600 to not react and/or respond to user input 1566, and/or causes computer system 600 to forgo initiating audio playback of audio track title 1 based on the user wearing HMD 1510 when user input 1566 was received.

FIG. 15AA depicts an example scenario in which user 641 provides air gesture user input 1570 with his left hand while wearing computer system 640 on his right wrist. In some embodiments, computer system 600 detects user input 1570, and responds to user input 1570 in the same way as was described above with reference to FIG. 15Z and user input 1566. In some embodiments, HMD 1510 detects user input 1570, and response to user input 1570 in the same way as was described above with reference to FIG. 15Z (e.g., detects user input 1570, responds to user input 1570 by performing a selection operation corresponding to selection of button 1564, and causes computer system 600 to not react and/or respond to user input 1570, and/or causes computer system 600 to forgo initiating audio playback of audio track title 1 based on the user wearing HMD 1510 when user input 1570 was received).

FIGS. 15BB-15CC depict an example scenario in which computer system 600 is visible within the field of view of HMD 1510, as indicated by region 1511. In FIG. 15BB, HMD 1510 detects that computer system 600 is within the field of view of HMD 1510. Furthermore, while computer system 600 is within the field of view of HMD 1510, HMD 1510 and/or computer system 600 detect user input 1572, which is an air gesture user input (e.g., a pinch air gesture, a double pinch air gesture, and/or a pinch and hold air gesture). At FIG. 15CC, in response to user input 1572, and based on a determination that computer system 600 is within the field of view of HMD 1510, HMD 1510 does not perform a selection operation (e.g., a selection operation of button 1564), and computer system 600 performs the primary operation corresponding to user interface 1554, which is selecting play button 1554b and/or initiating playback of audio media, as was described above with reference to FIGS. 15W-15X. In this way, when a user is wearing HMD 1510, and the user is not looking at computer system 600, an air gesture user input causes HMD 1510 to perform a first operation, but when the user is wearing HMD 1510 and the user is looking at computer system 600, the same air gesture user input causes computer system 600 to perform a particular operation (e.g., based on a user interface that is displayed on computer system 600 and/or based on a context of computer system 600) without HMD 1510 performing the first operation.

FIG. 16 is a flow diagram illustrating methods of performing operations at a computer system in accordance with some embodiments. Method 1600 is performed at a computer system (e.g., 100, 300, 500, 600, and/or 1510) (e.g., a smart phone, a smart watch, a tablet, a laptop, a desktop, a wearable device, wrist-worn device, and/or head-mounted device) that is in communication with one or more display generation components (e.g., a display, a touch-sensitive display, and/or a display controller) and one or more input devices (e.g., a touch-sensitive surface, a touch-sensitive display, a button, a rotatable input mechanism, a depressible and rotatable input mechanism, a camera, an accelerometer, an inertial measurement unit (IMU), a blood flow sensor, a photoplethysmography sensor (PPG), and/or an electromyography sensor (EMG)). Some operations in method 1600 are, optionally, combined, the orders of some operations are, optionally, changed, and some operations are, optionally, omitted.

In some embodiments, while the computer system (e.g., 600) is worn on the wrist of a user (e.g., 641) (1602) (e.g., in some embodiments, while the computer system detects that the computer system is worn on the wrist of the user; and/or while the computer system detects that the computer system is worn on the body of a user), the computer system detects (1604) a first user input (e.g., 1504a, 1504b, 1524a, 1524b, 1538, 1542a, 1542b, 1542c, 1550a, 1550b, 1556a, 1556b, 1558, 1566, 1570, and/or 1572) via the one or more input devices of the computer system (e.g., one or more touch inputs, one or more mechanical inputs (e.g., one or more button presses and/or one or more rotations of a rotatable input mechanism), one or more gesture inputs, and/or one or more air gesture inputs). In response to detecting the first user input (1606) (e.g., 1504a, 1504b, 1524a, 1524b, 1538, 1542a, 1542b, 1542c, 1550a, 1550b, 1556a, 1556b, 1558, 1566, 1570, and/or 1572): in accordance with a determination that the first user input is detected while a head-mounted device (e.g., 1510) (e.g., a head-mounted computer system and/or a computer system that is configured to be worn on the head of a user that includes one or more head-mounted displays and/or one or more headphones or earbuds; a head-mounted computer system that is in communication with one or more display generation components (e.g., one or more display generation components separate from the one or more display generation components that are in communication with the computer system) and/or one or more input devices (e.g., one or more input devices that are separate from the one or more input devices that are in communication with the computer system)) separate from the computer system (e.g., 600) (e.g., a head-mounted device that corresponds to the computer system, a head-mounted device that corresponds to the same user as the computer system (e.g., is logged into the same user account as the computer system and/or is associated with the same user as the computer system), and/or a head-mounted device that is in communication with (e.g., wireless and/or wired communication) the computer system) is not worn on the head of the user (e.g., 641) (1608) (e.g., in accordance with a determination that the computer system does not detect and/or is not connected to a head-mounted device separate from the computer system when the first user input is detected), the computer system performs (1610) a first operation at the computer system (e.g., 600) that is worn on the wrist of the user (e.g., a first operation that corresponds to the first user input and/or a first operation that is associated with the first user input) (e.g., FIGS. 15B, 15C, 15D, 15K, 15R, 15S, and/or 15X); and in accordance with a determination that the first user input is detected while a head-mounted device (e.g., 1510) separate from the computer system (600) (e.g., a head-mounted device that corresponds to the computer system, a head-mounted device that corresponds to the same user as the computer system (e.g., is logged into the same user account as the computer system and/or is associated with the same user as the computer system), and/or a head-mounted device that is in communication with (e.g., wireless and/or wired communication) the computer system) is worn on the head of the user (e.g., 641) (1612) (e.g., in accordance with a determination that the computer system detects and/or is connected to a head-mounted device separate from the computer system when the first user input is detected), the computer system forgoes performance (1614) of the first operation at the computer system that is worn on the wrist of the user (and, optionally, performs a second operation different from the first operation (e.g., a second operation that corresponds to the first user input and/or a second operation that is associated with the first user input (e.g., a second operation that corresponds to the first user input and/or is associated with the first user input when a head-mounted device is detected and/or when a head-mounted device is worn on the head of the user)) without performing the first operation; and/or forgoes performing any operation in response to the first user input) (e.g., FIGS. 15E, 15F, 15G, 15H, 15I, 15L, 15M, 150, 15P, 15T, 15U, 15V, 15Y, 15Z, and/or 15AA). Responding differently to a user input based on whether the user is wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, performing the first operation comprises displaying, via the one or more display generation components (e.g., 602), visual modification of a first user interface (e.g., 1500, 1536, 1546, and/or 1554) (e.g., a first user interface that was displayed when the first user input was received) (e.g., displaying modification of one or more elements of the first user interface; ceasing display of the first user interface; and/or displaying replacement of the first user interface with a second user interface different from the first user interface). In some embodiments, forgoing performance of the first operation comprises forgoing display of visual modification of the first user interface (e.g., maintaining display of the first user interface without modification) (e.g., in FIGS. 15A-15D, user input 1504a and/or user input 1504b results in modification of user interface 1500, but in FIGS. 15E-15F, user input 1524a and/or user input 1524b does not result in modification of user interface 1500). In some embodiments, displaying visual modification of the first user interface comprises displaying visual modification of the first user interface in a first manner (e.g., a first predefined manner and/or a first manner associated with the first user input). In some embodiments, forgoing performance of the first operation comprises forgoing displaying visual modification of the first user interface in the first manner. Selectively modifying and/or forgoing modifying a user interface in response to a user input based on whether the user is wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to the first user input (e.g., 1504a, 1504b, 1524a, 1524b, 1538, 1542a, 1542b, 1542c, 1550a, 1550b, 1556a, 1556b, 1558, 1566, 1570, and/or 1572), and in accordance with a determination that the first user input is detected while the head-mounted device (e.g., 1510) separate from the computer system (e.g., 600) is worn on the head of the user (e.g., 641), the head-mounted device (e.g., 1510) displays visual modification of a second user interface that is displayed by the head-mounted device (e.g., FIGS. 15E-15H; FIGS. 15L-15P, FIGS. 15T-15V, and/or FIGS. 15Y-15Z) (e.g., via one or more HMD display generation components (e.g., 1512) associated with the head-mounted device (e.g., 1510) (e.g., one or more HMD display generation components different from one or more display generation components)) (e.g., displays visual modification of one or more elements of the second user interface; ceases display of the second user interface; and/or replaces display of the second user interface with a third user interface different from the second user interface) (e.g., in some embodiments, the head-mounted device displays visual modification of the second user interface in a second manner (e.g., a predetermined and/or prescribed manner) that corresponds to and/or is associated with the first user input). In some embodiments, the computer system (e.g., 600) causes the head-mounted device (e.g., 1510) to display visual modification of the second user interface in response to detecting the first user input. In some embodiments, the head-mounted device (e.g., 1510) detects the first user input and displays visual modification of the second user interface in response to the head-mounted device detecting the first user input. Causing visual modification of a user interface displayed by the head-mounted device in response to the first user input when the user is wearing the head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, performing the first operation comprises outputting non-visual feedback (e.g., audio feedback and/or haptic feedback) (e.g., 1509a, 1509b, and/or 1560). In some embodiments, the non-visual feedback is indicative of and/or associated with an operation performed by the computer system (e.g., an operation performed by the computer system in response to the first user input). Responding differently to a user input based on whether the user is wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments in response to detecting the first user input (e.g., 1504a, 1504b, 1524a, 1524b, 1538, 1542a, 1542b, 1542c, 1550a, 1550b, 1556a, 1556b, 1558, 1566, 1570, and/or 1572): in accordance with a determination that the first user input is detected while the head-mounted device (e.g., 1510) separate from the computer system (e.g., 600) is worn on the head of the user (e.g., 641), the computer system outputs second non-visual feedback (e.g., 1525 and/or 1545) (e.g., audio feedback and/or haptic feedback) indicative of (e.g., associated with and/or corresponding to) an operation performed by the head-mounted device (e.g., 1500) in response to the first user input (e.g., performed by the head-mounted device in response to the head-mounted device detecting the first user input and/or performed by the head-mounted device in response to the head-mounted device receiving an indication of the first user input (e.g., from the computer system)). Outputting non-visual feedback indicative of an operation performed by the head-mounted device in response to the first user input makes the user-system interface more efficient (e.g., by helping the user to provide proper inputs and reducing errors) which, additionally, reduces power usage and improves battery life of the device by enabling the user to use the system more quickly and efficiently. Doing so also provides the user with feedback about a state of the head-mounted device.

In some embodiments, the second non-visual feedback comprises haptic feedback (e.g., 1525 and/or 1545). Outputting haptic feedback indicative of an operation performed by the head-mounted device in response to the first user input makes the user-system interface more efficient (e.g., by helping the user to provide proper inputs and reducing errors) which, additionally, reduces power usage and improves battery life of the device by enabling the user to use the system more quickly and efficiently. Doing so also provides the user with feedback about a state of the head-mounted device.

In some embodiments, outputting the second non-visual feedback (e.g., 1525 and/or 1545) indicative of an operation performed by the head-mounted device (e.g., 1510) in response to the first user input comprises: in accordance with a determination that the head-mounted device (e.g., 1510) performed a first HMD operation in response to the first user input, outputting third non-visual feedback (e.g., third audio feedback and/or third haptic feedback) (e.g., third non-visual feedback indicative of and/or corresponding to the first HMD operation); and in accordance with a determination that the head-mounted device (e.g., 1510) performed a second HMD operation different from the first HMD operation in response to the first user input, outputting fourth non-visual feedback (e.g., fourth audio feedback and/or fourth haptic feedback) (e.g., fourth non-visual feedback indicative of and/or corresponding to the second HMD operation) different from the third non-visual feedback (e.g., in some embodiments, 1525 is different from 1545 (e.g., in some embodiments, haptic output 1525 has a different duration, intensity, and/or pattern from haptic output 1545)). Outputting different non-visual feedback based on different operations performed by the head-mounted device in response to the first user input makes the user-system interface more efficient (e.g., by helping the user to provide proper inputs and reducing errors) which, additionally, reduces power usage and improves battery life of the device by enabling the user to use the system more quickly and efficiently. Doing so also provides the user with feedback about a state of the head-mounted device.

In some embodiments, while the computer system (e.g., 600) is worn on the wrist of the user (e.g., 641), the computer system detects, via the one or more input devices, a second user input (e.g., 1566) that includes a second air gesture performed using a first hand (e.g., 640) of the user (e.g., a left hand, a right hand, a hand connected to the wrist on which the computer system is worn, and/or a hand that is connected to the wrist on which the computer system is not worn). In response to detecting the second user input (e.g., 1566): in accordance with a determination that the second user input is detected while the head-mounted device (e.g., 1510) separate from the computer system (e.g., 600) is worn on the head of the user (e.g., 641), the computer system outputs the second non-visual feedback (e.g., 1569) to indicate an operation performed by the head-mounted device (e.g., 1510) in response to the second user input (e.g., 1566). The computer system (e.g., 600) detects, via the one or more input devices, a third user input (e.g., 1570) that includes a third air gesture performed using a second hand (e.g., 643) of the user different from the first hand. In response to detecting the third user input (e.g., 1570): in accordance with a determination that the third user input (e.g., 1570) is detected while the head-mounted device (e.g., 1510) separate from the computer system (e.g., 600) is worn on the head of the user (e.g., 641), the computer system (e.g., 600) outputs the second non-visual feedback (e.g., 1569) to indicate an operation performed by the head-mounted device (e.g., 1510) in response to the third user input (e.g., 1570). In some embodiments, in response to detecting the second user input: in accordance with a determination that the second user input is detected while the head-mounted device (e.g., 1510) separate from the computer system (e.g., 600) is not worn on the head of the user (e.g., 641), the computer system (e.g., 600) forgoes outputting the second non-visual feedback (in some embodiments, the computer system performs a second operation at the computer system that is worn on the wrist of the user without outputting the second non-visual feedback). In some embodiments, in response to detecting the third user input: in accordance with a determination that the third user input is detected while the head-mounted device (e.g., 1510) separate from the computer system (e.g., 600) is not worn on the head of the user (e.g., 641), the computer system (e.g., 600) forgoes outputting the second non-visual feedback (in some embodiments, the computer system performs a third operation at the computer system that is worn on the wrist of the user without outputting the second non-visual feedback). In some embodiments, the second non-visual feedback (e.g., 1569) is output by the computer system (e.g., 600) regardless of whether an air gesture is performed using the user's left hand (e.g., 643), the user's right hand (e.g., 640), the hand corresponding to the wrist on which the computer system (e.g., 600) is worn (e.g., 640), or the hand corresponding to the wrist on which the computer system (e.g., 600) is not worn (e.g., 643). Outputting non-visual feedback indicative of an operation performed by the head-mounted device in response to the first user input makes the user-system interface more efficient (e.g., by helping the user to provide proper inputs and reducing errors) which, additionally, reduces power usage and improves battery life of the device by enabling the user to use the system more quickly and efficiently. Doing so also provides the user with feedback about a state of the head-mounted device.

In some embodiments, while the computer system (e.g., 600) is worn on the wrist of the user (e.g., 641): the computer system (e.g., 600) detects, via the one or more input devices, a fourth user input (e.g., 1566 and/or 1570) that includes a fourth air gesture. In response to detecting the fourth user input (e.g., 1566 and/or 1570): in accordance with a determination that the fourth user input is detected while the head-mounted device (e.g., 1500) separate from the computer system (e.g., 600) is worn on the head of the user (e.g., 641), and the fourth air gesture (e.g., 1566) is performed using a first respective hand of the user (e.g., 640) (e.g., the left hand of the user; the right hand of the user; the hand of the user that corresponds to the wrist on which the computer system is worn; and/or the hand of the user that corresponds to the wrist on which the computer system is not worn), the computer system outputs the second non-visual feedback (e.g., 1569) to indicate an operation performed by the head-mounted device (e.g., 1500) in response to the fourth user input (e.g., 1566); and in accordance with a determination that the fourth user input (e.g., 1570) is detected while the head-mounted device (e.g., 1510) separate from the computer system (e.g., 600) is worn on the head of the user (e.g., 641), and the fourth air gesture is performed using a second respective hand (e.g., 643) of the user different from the first respective hand of the user (e.g., the left hand of the user; the right hand of the user; the hand of the user that corresponds to the wrist on which the computer system is worn; and/or the hand of the user that corresponds to the wrist on which the computer system is not worn), the computer system forgoes outputting the second non-visual feedback (e.g., 1569). In some embodiments, the second non-visual feedback is output when an air gesture is performed using a first hand of the user (e.g., 640 and/or 643) (e.g., the left hand of the user; the right hand of the user; the hand of the user that corresponds to the wrist on which the computer system is worn; and/or the hand of the user that corresponds to the wrist on which the computer system is not worn), and is not output when the air gesture is performed using the other hand (e.g., 640 and/or 643) of the user. For example, in some embodiments, in FIGS. 15Y-15AA, user input 1566 (performed with hand 600) results in computer system 600 outputting haptic output 1569, but user input 1570 (performed with hand 643) does not result in computer system 600 outputting haptic output 1569. Outputting non-visual feedback when the user performs an air gesture with one hand, and forgoing outputting the non-visual feedback when the user performs the air gesture with the other hand, makes the user-system interface more efficient (e.g., by helping the user to provide proper inputs and reducing errors) which, additionally, reduces power usage and improves battery life of the device by enabling the user to use the system more quickly and efficiently.

In some embodiments, the first user input comprises a first press (e.g., 1504a, 1504b, 1524a, and/or 1524b) (e.g., a depression and/or pressure applied to) of a first button (e.g., 604 and/or 605) (e.g., a physical button, a capacitive button, and/or a mechanical button) that is in communication with (e.g., wired communication, physical communication, and/or wireless communication) the computer system (e.g., 600). Responding differently to a user input based on whether the user is wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is worn on the head of the user (e.g., 641), the computer system (e.g., 600) causes the head-mounted device (e.g., 1510) (e.g., via one or more communications and/or messages transmitted to the head-mounted device) to capture media content (e.g., FIG. 15G) (e.g., causes the head-mounted device to capture and/or record visual media content (e.g., one or more images and/or videos) (e.g., using one or more cameras of the head-mounted device); and/or causes the head-mounted device to capture and/or record audio content (e.g., using one or more microphones of the head-mounted device)). In some embodiments, the media content includes still media, one or more live photos, and/or video. In some embodiments, the media content includes spatial media. In some embodiments, spatial media includes a first visual component corresponding to a viewpoint of a right eye (e.g., a first still image component that corresponds to an image from a viewpoint of the right eye and/or a first video component that corresponds to a sequence of images that corresponds to a sequence of images from a viewpoint of the right eye) and a second visual component different from the first visual component and that corresponds to a viewpoint of a left eye (e.g., a second still image component that corresponds to an image from a viewpoint of the left eye and/or a second video component that corresponds to a sequence of images that corresponds to a sequence of images from a viewpoint of the left eye) that, when viewed concurrently, create an illusion of a spatial representation of captured visual content (e.g., concurrently viewing the first visual component and the second visual component creates an illusion of a three-dimensional representation of the media; e.g., viewing different images with the left and right eye creates the illusion of depth by simulating parallax of the image contents). In some embodiments, the first visual component is captured by a first camera of one or more cameras, and the second visual component is captured (e.g., in some embodiments, concurrently captured) by a second camera of the one or more cameras different from the first camera. In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is not worn on the head of the user, the computer system performs the first operation without causing the head-mounted device to capture media content (e.g., FIGS. 15A-15D). Causing the head-mounted device to capture media content in response to a button press on the computer system when the button press is received by the computer system while the user is wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is worn on the head of the user (e.g., 641), the computer system (e.g., 600) causes the head-mounted device (e.g., 1510) (e.g., via one or more communications and/or messages transmitted to the head-mounted device) to display (e.g., via one or more HMD display generation components of the head-mounted device (e.g., one or more HMD display generation components different from and/or separate from the one or more display generation components of the computer system)) an HMD system user interface (e.g., 1528), wherein the HMD system user interface includes one or more selectable options (e.g., 1528a-1528I) that are selectable to modify one or more system settings of the head-mounted device (e.g., a volume option that can be used to modify a volume setting of the head-mounted device, a brightness option that can be used to modify a brightness setting of the head-mounted device, a wi-fi option that can be used to enable or disable a wi-fi setting of the head-mounted device, and/or a Bluetooth option that can be used to enable or disable a Bluetooth setting of the head-mounted device). In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is not worn on the head of the user, the computer system performs the first operation without causing the head-mounted device to display the HMD system user interface (e.g., FIGS. 15A-15D). Causing the head-mounted device to display the HMD system user interface in response to a button press on the computer system when the button press is received by the computer system while the user is wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, performing the first operation comprises: displaying, via the one or more display generation components (e.g., 602), a system user interface (e.g., 1506), wherein the system user interface includes one or more selectable options (e.g., 1506a-1506h) that are selectable to modify one or more system settings of the computer system (e.g., 600) (e.g., a volume option that can be used to modify a volume setting of the computer system, a brightness option that can be used to modify a brightness setting of the computer system, a wi-fi option that can be used to enable or disable a wi-fi setting of the computer system, and/or a Bluetooth option that can be used to enable or disable a Bluetooth setting of the computer system). In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is worn on the head of the user (e.g., 641), the computer system forgoes displaying the system user interface (e.g., 1506). Displaying the system user interface in response to a button press on the computer system based on a determination that the user is not wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is worn on the head of the user (e.g., 641), the computer system (e.g., 600) causes the head-mounted device (e.g., 1510) (e.g., via one or more communications and/or messages transmitted to the head-mounted device) to start a transition of the head-mounted device to a lower power state (e.g., FIG. 15H) (e.g., shutting down the head-mounted device and/or transitioning the head-mounted device from a powered on state into a low power or powered off state). In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is not worn on the head of the user (e.g., 641), the computer system (e.g., 600) performs the first operation without causing the head-mounted device to start a transition of the head-mounted device to a lower power state (e.g., FIGS. 15A-15D). Causing the head-mounted device to power down in response to a button press on the computer system when the button press is received by the computer system while the user is wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, performing the first operation comprises: starting a transition of the computer system (e.g., 600) (e.g., that is separate from the head-mounted device) to a low power state (e.g., shutting down the computer system and/or transitioning the computer system from a powered on state into a low power or powered off state) (e.g., FIG. 15C, displaying power button 1508a). In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is worn on the head of the user (e.g., 641), the computer system (e.g., 600) forgoes starting the transition of the computer system to the low power state (e.g., in FIGS. 15E-15I, computer system 600 does not display power button 1508a in response to user input 1524a and/or user input 1524b). Powering down the computer system in response to a button press on the computer system based on a determination that the user is not wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, performing the first operation comprises: initiating an emergency communication mode of the computer system for contacting one or more emergency response services (e.g., police department, fire department, health services, and/or ambulance) (e.g., displaying user interface 1508). In some embodiments, initiating the emergency communication mode comprises displaying an emergency user interface (e.g., 1508) that indicates that one or more emergency response services will be contacted and/or are being contacted. In some embodiments, initiating the emergency communication mode comprises displaying an emergency user interface (e.g., 1508) that provides instructions for contacting one or more emergency response services (e.g., instructs the user to interact with one or more user interface elements to contact emergency services, and/or instructs the user to provide one or more user inputs to contact emergency services). In some embodiments, initiating the emergency communication mode comprises contacting one or more emergency response services (e.g., FIG. 15D). In some embodiments, in response to detecting the first user input (e.g., 1504a, 1504b, 1524a, and/or 1524b): in accordance with a determination that the first user input is detected while the head-mounted device (e.g., 1510) separate from the computer system (e.g., 600) is worn on the head of the user (e.g., 641), the computer system (e.g., 600) forgoes initiating the emergency communication mode of the computer system (e.g., in FIGS. 15E-15I, computer system 600 does not display user interface 1508). Initiating the emergency communication mode of the computer system in response to a button press on the computer system based on a determination that the user is not wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, the first user input comprises a first rotation (e.g., 1538, 1542a, 1542b, and/or 1542c) (e.g., physical rotation) of a first rotatable input mechanism (e.g., 604) (e.g., a physically rotatable input mechanism, and/or a rotatable crown). Responding differently to a user input based on whether the user is wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to detecting the first user input (e.g., 1538, 1542a, 1542b, and/or 1542c): in accordance with a determination that the first user input is detected while the head-mounted device (e.g., 1510) separate from the computer system (e.g., 600) is worn on the head of the user (e.g., 641), the computer system (e.g., 600) causes the head-mounted device (e.g., 1510) (e.g., via one or more communications and/or messages transmitted to the head-mounted device) to modify an immersion level setting of the head-mounted device (e.g., FIGS. 15L-15N) (e.g., increase the immersion level setting to obscure, blur and/or darken a physical environment (e.g., a physical passthrough environment) and/or a representation of a physical environment that is visible to a user of the head-mounted device; increase the immersion level setting to brighten, saturate, and/or visually emphasize one or more virtual elements that are displayed by the head-mounted device; decrease the immersion level setting to unobscure, unblur, and/or brighten a physical environment (e.g., a physical passthrough environment) and/or a representation of a physical environment that is visible to a user of the head-mounted device; and/or decrease the immersion level setting to darken, de-saturate, and/or visually de-emphasize one or more virtual elements that are displayed by the head-mounted device). In some embodiments, in response to detecting the first user input (e.g., 1538, 1542a, 1542b, and/or 1542c): in accordance with a determination that the first user input is detected while the head-mounted device (e.g., 1510) separate from the computer system (e.g., 600) is not worn on the head of the user (e.g., 641), the computer system (e.g., 600) performs the first operation without causing the head-mounted device to modify an immersion level setting of the head-mounted device (e.g., FIGS. 15J-15K). Causing the head-mounted device to modify an immersion level setting of the head-mounted device in response to a rotational user input on the computer system when the rotational user input is received by the computer system while the user is wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, in response to detecting the first user input (e.g., 1538, 1542a, 1542b, and/or 1542c): in accordance with a determination that the first user input is detected while the head-mounted device (e.g., 1510) separate from the computer system (e.g., 600) is worn on the head of the user (e.g., 641), the computer system (e.g., 600) causes the head-mounted device (e.g., 1510) (e.g., via one or more communications and/or messages transmitted to the head-mounted device) to scroll content displayed by the head-mounted device (e.g., based on the magnitude and/or direction of the first rotation) (e.g., FIGS. 15L, 150, and 15P, scrolling user interface 1540). In some embodiments, the direction, magnitude, and/or speed of scrolling the content displayed by the head-mounted device is dependent on the direction, magnitude, and/or speed of the first user input. In some embodiments, in response to detecting the first user input (e.g., 1538, 1542a, 1542b, and/or 1542c): in accordance with a determination that the first user input is detected while the head-mounted device (e.g., 1510) separate from the computer system (e.g., 600) is not worn on the head of the user (e.g., 641), the computer system (e.g., 600) performs the first operation without causing the head-mounted device to scroll content displayed by the head-mounted device (e.g., FIGS. 15J-15K). Causing the head-mounted device to scroll content displayed by the head-mounted device in response to a rotational user input on the computer system when the rotational user input is received by the computer system while the user is wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, causing the head-mounted device (e.g., 1510) to scroll content displayed by the head-mounted device includes: in accordance with a determination (e.g., a determination made by the head-mounted device and/or by the computer system) that the user is looking at a side edge region (e.g., a region that includes a left edge or a right edge and/or is adjacent to the left edge or the right edge) of a viewport boundary of the head-mounted device (e.g., gaze indication 1520 in FIG. 15O), causing the head-mounted device to vertically scroll (e.g., up and/or down (e.g., based on the direction of rotation of the first user input)) the content displayed by the head-mounted device (e.g., in some embodiments, without horizontally scrolling the content displayed by the head-mounted device) (e.g., from FIG. 15L to FIG. 15O, user interface 1540 is scrolled vertically). Causing the head-mounted device to scroll content vertically when the user is looking at a side edge of the viewport boundary makes the user-system interface more efficient (e.g., by helping the user to provide proper inputs and reducing errors) which, additionally, reduces power usage and improves battery life of the device by enabling the user to use the system more quickly and efficiently.

In some embodiments, causing the head-mounted device (e.g., 1510) to scroll content displayed by the head-mounted device includes: in accordance with a determination (e.g., a determination made by the head-mounted device and/or by the computer system) that the user is looking at a top edge region (e.g., a region that includes and/or is adjacent to a top edge) or a bottom edge region (e.g., a region that includes and/or is adjacent to a bottom edge) of a viewport boundary of the head-mounted device (e.g., gaze indication 1520 in FIG. 1520), causing the head-mounted device to horizontally scroll (e.g., left and/or down (e.g., based on the direction of rotation of the first user input)) the content displayed by the head-mounted device (e.g., in some embodiments, without vertically scrolling the content displayed by the head-mounted device) (e.g., from FIG. 15L to FIG. 15P, user interface 1540 is scrolled horizontally). Causing the head-mounted device to scroll content horizontally when the user is looking at a top edge or bottom edge of the viewport boundary makes the user-system interface more efficient (e.g., by helping the user to provide proper inputs and reducing errors) which, additionally, reduces power usage and improves battery life of the device by enabling the user to use the system more quickly and efficiently.

In some embodiments, the first user input comprises a touch input (e.g., 1550a, 1550b, 1556a, and/or 1556b) on a touch-sensitive surface (e.g., 602) (e.g., a touch-sensitive surface that is in communication with the computer system; a touch sensitive display; and/or a touch-sensitive non-display surface) (e.g., a tap input (e.g., a single tap input and/or a multi-tap input), a tap and hold input, and/or a swipe input). Responding differently to a user input based on whether the user is wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, performing the first operation comprises: selecting a first selectable option of one or more selectable options displayed by the computer system via the one or more display generation components (e.g., displaying visual content indicative of user selection of the first selectable option and/or performing an operation indicative of user selection of the first selectable option) (e.g., selecting option 1546a in FIG. 15R). Responding to the first user input by performing a selection operation on the computer system when the user is not wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, performing the first operation comprises: displaying, via the one or more display generation components, navigation of a first respective user interface (e.g., 1546) (e.g., displaying scrolling and/or paging of the first respective user interface) that is displayed by the computer system via the one or more display generation components (e.g., FIG. 15Q and FIG. 15S, displaying scrolling of user interface 1546). Responding to the first user input by navigating a user interface on the computer system when the user is not wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments in response to detecting the first user input (e.g., 1550a, 1550b, 1556a, and/or 1556b): in accordance with a determination that the first user input is detected while the head-mounted device (e.g., 1510) separate from the computer system (e.g., 600) is worn on the head of the user, the computer system (e.g., 600) causes the head-mounted device (e.g., 1510) (e.g., via one or more communications and/or messages transmitted to the head-mounted device) to scroll visual content displayed by the head-mounted device (e.g., based on direction and/or magnitude of the first user input) (e.g., in FIG. 15T and FIG. 15V, head-mounted device 1510 displays scrolling of user interface 1552 in response to user input 1556b). In some embodiments, in response to detecting the first user input (e.g., 1550a, 1550b, 1556a, and/or 1556b): in accordance with a determination that the first user input is detected while the head-mounted device (e.g., 1510) separate from the computer system (e.g., 600) is not worn on the head of the user, the computer system performs the first operation without causing the head-mounted device to scroll visual content displayed by the head-mounted device (e.g., FIGS. 15Q-15S). Causing the head-mounted device to scroll content displayed by the head-mounted device in response to a user input on the computer system when the user input is received by the computer system while the user is wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, the first user input comprises a tap input (e.g., 1550a and/or 1556a) on the touch-sensitive surface (e.g., 602). In response to detecting the tap input (e.g., 1550a and/or 1556a) of the first user input: in accordance with a determination that the first user input is detected while the head-mounted device (e.g., 1510) separate from the computer system (e.g., 600) is worn on the head of the user, the computer system (e.g., 600) causes the head-mounted device (e.g., 1510) (e.g., via one or more communications and/or messages transmitted to the head-mounted device) to select a first respective selectable option (e.g., 1554b) of one or more selectable options (e.g., 1554a-1554c) displayed by the head-mounted device (e.g., via one or more HMD display generation components that are in communication with the head-mounted device and are different from the one or more display generation components) (e.g., causing the head-mounted device to display visual content indicative of user selection of the first respective selectable option and/or perform an operation indicative of user selection of the first respective selectable option) (e.g., in FIGS. 15T-15U, head-mounted device 1510 selects (e.g., computer system 600 causes head-mounted device 1510 to select) option 1554b in response to user input 1556a on computer system 600). Causing the head-mounted device to perform a selection operation in response to a user input on the computer system when the user input is received by the computer system while the user is wearing the head-mounted device makes the user-system interface more efficient (e.g., by helping the user to provide proper inputs and reducing errors) which, additionally, reduces power usage and improves battery life of the device by enabling the user to use the system more quickly and efficiently.

In some embodiments, while the computer system (e.g., 600) is worn on the wrist of the user (e.g., 641): in accordance with a determination that the head-mounted device (e.g., 1510) is not worn on the head of the user (e.g., 641), the computer system displays, via the one or more display generation components (e.g., 602), a third user interface; and in accordance with a determination that the head-mounted device (e.g., 1510) is worn on the head of the user, the computer system forgoes display of the third user interface (e.g., forgoes display of any user interface on the computer system, and/or displays a different user interface on the computer system (e.g., displaying a user interface that is indicative of the user wearing the head-mounted device)). In some embodiments, while head-mounted device 1510 is worn by a user, computer system 600 does not display a user interface, and/or displays a user interface that is indicative of head-mounted device 1510 being worn by the user. Displaying a user interface on the computer system when the user is not wearing the head-mounted device, and forgoing display of the user interface on the computer system when the user is wearing the head-mounted device, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently. Doing so also provides the user with feedback about a state of the system (e.g., the system has detected and/or determined that the user is wearing the head-mounted device).

In some embodiments, the first user input includes an air gesture (e.g., 1558, 1566, 1570, and/or 1572) performed by a respective hand of the user (e.g., 640 and/or 643); the computer system (e.g., 600) is worn on a respective wrist of the user; and the respective wrist is directly connected to the respective hand (e.g., 640 and/or 643) (e.g., the respective hand is the left hand and the respective wrist is the left wrist; or the respective hand is the right hand, and the respective wrist is the right wrist). Responding differently to a user input based on whether the user is wearing a head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, while the computer system (e.g., 600) is worn on the wrist of the user, the computer system detects, via the one or more input devices, a fifth user input (e.g., one or more touch inputs, one or more mechanical inputs (e.g., one or more button presses and/or one or more rotations of a rotatable input mechanism), one or more gesture inputs, and/or one or more air gesture inputs). In response to detecting the fifth user input: in accordance with a determination that the fifth user input is detected while the head-mounted device (e.g., 1510) separate from the computer system (e.g., 600) is not worn on the head of the user (e.g., 641), the computer system performs a second operation at the computer system that is worn on the wrist of the user (e.g., a second operation that corresponds to the second user input and/or a second operation that is associated with the second user input); in accordance with a determination that the fifth user input is detected while the head-mounted device (e.g., 1510) separate from the computer system is worn on the head of the user (e.g., 641) and passthrough criteria (e.g., one or more criteria pertaining to content that is displayed by the head-mounted device and/or is visible via the head-mounted device; one or more criteria pertaining to a passthrough environment (e.g., a physical passthrough environment and/or a virtual passthrough environment) that is visible via the head-mounted device (e.g., displayed by the head-mounted device and/or that is visible through one or more transparent display generation components of the head-mounted device); one or more criteria pertaining to a three-dimensional environment that is visible via the head mounted device (e.g., displayed by the head-mounted device and/or that is visible through one or more transparent display generation components of the head-mounted device); and/or one or more criteria pertaining to a virtual environment that is displayed by the head-mounted device) are satisfied, the computer system performs the second operation at the computer system that is worn on the wrist of the user (e.g., FIGS. 15BB-15CC); and in accordance with a determination that the second user input is detected while the head-mounted device (e.g., 1510) separate from the computer system (e.g., 600) is worn on the head of the user and passthrough criteria are not satisfied, the computer system forgoes performance of the second operation at the computer system that is worn on the wrist of the user (e.g., FIGS. 15Y-15Z) (e.g., in FIGS. 15BB-15CC, based on a determination that computer system 600 is within the field of view of head-mounted device 1510, air gesture user input 1572 results in an operation being performed at computer system 600 (similar to FIGS. 15W-15X); and in FIGS. 15Y-15Z, based on a determination that computer system 600 is not within the field of view of head-mounted device 1510, air gesture user input 1566 results in the operation not being performed at computer system 600 (and, optionally, results in an operation being performed at head-mounted device 1510)). In some embodiments, the passthrough criteria includes one or more criteria pertaining to how much of a passthrough environment is visible (e.g., a first criterion that is met when the passthrough environment is obscured (e.g., hidden, darkened, and/or blurred) by less than a threshold amount). In some embodiments, the passthrough environment is a virtual passthrough environment that is a virtual representation of a physical environment that surrounds the head-mounted device (e.g., as captured by one or more cameras and/or sensors of the head-mounted device) and is displayed by the one or more display generation components. In some embodiments, the passthrough environment is a physical passthrough or optical passthrough environment that is visible through one or more transparent display generation components but is not displayed by the one or more display generation components. Responding differently to a user input based on whether the user is wearing a head-mounted device and based on whether passthrough criteria are satisfied enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the passthrough criteria includes a first criterion that is satisfied based on whether the computer system (e.g., 600) that is worn on the wrist of the user is positioned within a viewport of the head-mounted device (e.g., 1510) (e.g., FIGS. 15BB-15CC) (e.g., based on a position of the computer system relative to the head-mounted device and/or one or more sensors of the head-mounted device; based on a position of the computer system relative to a face of the user; and/or based on the computer system being within a field of view of one or more cameras and/or one or more sensors of the head-mounted device). In some embodiments, the first criterion is satisfied when the computer system (e.g., 600) is positioned within the viewport of the head-mounted device (e.g., 1510) (e.g., when the computer system is within a field of view of one or more cameras of the head-mounted device; and/or when the computer system is positioned in an area that is in front of the face of the user and/or positioned in an area that is in front of the head-mounted device) (e.g., FIGS. 15BB-15CC). In some embodiments, the first criterion is not satisfied when the computer system (e.g., 600) is positioned outside the viewport of the head-mounted device (e.g., 1510) (e.g., when the computer system is not within the field of view of one or more cameras of the head-mounted device; and/or when the computer system is not positioned in an area that is in front of the face of the user and/or positioned in an area that is in front of the head-mounted device) (e.g., FIGS. 15Y-15AA). In some embodiments, a user is able to interact with the computer system when the user is looking at the computer system (e.g., 600) (e.g., the computer system is visible to the user and/or the head-mounted system) (e.g., FIGS. 15BB-15CC), and interactions with the computer system are disabled when the user is not looking at the computer system (e.g., FIGS. 15Y-15AA). In some embodiments, the first criterion is not satisfied when the computer system (e.g., 600) is positioned within the viewport of the head-mounted device (e.g., 1510) (e.g., when the computer system is within a field of view of one or more cameras of the head-mounted device; and/or when the computer system is positioned in an area that is in front of the face of the user and/or positioned in an area that is in front of the head-mounted device). In some embodiments, the first criterion is satisfied when the computer system (e.g., 600) is positioned outside the viewport of the head-mounted device (e.g., when the computer system is not within the field of view of one or more cameras of the head-mounted device; and/or when the computer system is not positioned in an area that is in front of the face of the user and/or positioned in an area that is in front of the head-mounted device). Responding differently to a user input based on the position of the computer system relative to the head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the passthrough criteria includes a second criterion that is satisfied based on an immersion level setting of the head-mounted device. In some embodiments, the second criterion is satisfied when an immersion level setting of the head-mounted device is above a threshold level of immersion (e.g., resulting in the physical environment surrounding the head-mounted device being obscured) (e.g., above 60% immersion, above 70% immersion, above 80% immersion, above 90% immersion, or 100% immersion) and/or when the physical environment surrounding the head-mounted device and/or a representation of the physical environment surrounding the head-mounted device is obscured by a threshold amount (e.g., above a threshold brightness level, above a threshold blur level, and/or below a threshold color saturation level) (e.g., FIG. 15N). In some embodiments, the second criterion is satisfied when the physical environment surrounding the head-mounted device and/or a representation of the physical environment surrounding the head-mounted device is not visible and/or is substantially and/or completely hidden (e.g., a fully immersive experience) (e.g., FIG. 15N). In some embodiments, the second criterion is not satisfied when the immersion level setting of the head-mounted device is below a threshold level of immersion and/or the physical environment surrounding the head-mounted device and/or a representation of the physical environment surrounding the head-mounted device is obscured by less than a threshold amount (e.g., below a threshold brightness level, below a threshold blur level, and/or above a threshold color saturation level) (e.g., FIG. 15L and/or FIG. 15M). In some embodiments, user interactions with the computer system are disabled when the physical environment surrounding the head-mounted device and/or a representation of the physical environment surrounding the head-mounted device is visually obscured and/or when the user is in an immersive virtual experience (e.g., FIG. 15N and/or FIG. 15Z). In some embodiments, user interactions with the computer system are enabled when the physical environment surrounding the head-mounted device and/or a representation of the physical environment surrounding the head-mounted device is not visually obscured and/or when the user is not in an immersive experience. Responding differently to a user input based on the immersion level of the head-mounted device enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

Note that details of the processes described above with respect to method 1600 (e.g., FIG. 16) are also applicable in an analogous manner to the methods described above and/or below. For example, method 1600 optionally includes one or more of the characteristics of the various methods described above with reference to method 900, 1000, 1200, 1300, 1400, 1800, 2000, and/or 2200. For example, in some embodiments, the motion gestures are the same motion gesture. For another example, in some embodiments, the air gestures are the same air gestures. For brevity, these details are not repeated below.

FIGS. 17A-17Q exemplary devices and user interfaces for advancing status indicators in response to user input, in accordance with some embodiments. The user interfaces in these figures are used to illustrate the processes described below, including the process in FIG. 18.

FIG. 17A illustrates a user 641 wearing wearable computer system 600 (e.g., a smart watch) on hand 640 of the user. Computer system 600 includes display 602 (e.g., a touchscreen display), rotatable input mechanism 604 (e.g., a crown or a digital crown), and button 605. At FIG. 17A, computer system 600 displays watch face user interface 1700, which includes current time indication 1702, which identifies the current time (e.g., in a particular time zone). Watch face user interface 1700 also includes watch face complications 1704a-1704g. Complication 1704a displays temperature information, and is selectable to open and/or display a weather application. Complication 1704b displays physical activity information for a user (e.g., calories burned, exercise minutes, and/or stand hours) and is selectable to open a fitness and/or physical activity application. Complication 1704c is selectable to open a workout application. Complication 1704d displays compass and/or bearing information, and is selectable to open a compass application and/or a compass function. Complication 1704e is selectable to open a timer application and/or a timer function. Complication 1704f displays the current time in a different time zone, and is selectable to display the current time in one or more other time zones. Complication 1704g is selectable to open a music application. FIG. 17A depicts various scenarios in which computer system 600 detects various user inputs, including user input 1706a, which is an air gesture user input (e.g., a pinch air gesture, a double pinch air gesture, and/or a pinch and hold air gesture); user input 1706b, which is a swipe up touch input; and user input 1706c, which is rotation of rotatable input mechanism 604.

At FIG. 17B, in response to user input 1706a, 1706b, and/or 1706c (e.g., individually, in combination, and/or in sequence), computer system 600 displays widget user interface 1703. In some embodiments, any one of user input 1706a, user input 1706b, or user input 1706c can be used to transition from watch face user interface 1700 to widget user interface 1703. In FIG. 17B, in response to user input 1706a, computer system 600 displays indication 1710 indicating that computer system 600 detected and acted on an air gesture user input. In some embodiments, user input 1706b and/or user input 1706c would not result in display of indication 1710. Widget user interface 1703 includes current time indication 1708a, which identifies the current time (e.g., in a particular time zone), and current date indication 1708b, which identifies the current date (e.g., in a particular time zone). Widget user interface 1703 also includes widget stack 1712, which includes widgets 1712a-1712c. Computer system 600 display widgets 1712a-1712c in a stack 1712 such that widget 1712a is fully visible, widget 1712b is under widget 1712a and is partially visible, and widget 1712c is under widgets 1712a and 1712b and is partially visible. In some embodiments, computer system 600 displays the respective widgets from the set of widgets with a consistent (e.g., same and/uniform) size. In some embodiments, computer system 600 varies the size(s) (e.g., horizontal and/or vertical) of the respective widget(s) (e.g., one and/or a plurality of widgets within the set of widgets are displayed with different sizes) in the set of widgets based on predetermined criteria (e.g., frequency of access, widget status (e.g., pinned and/or unpinned), context criteria (e.g., time, location, battery health, and/or notification from an application corresponding to computer system 600), and/or user selected preference). In FIG. 17B, widget 1712a corresponds to a countdown timer function, and includes timer duration information 1712a-1 as well as timer start button 1712a-2 that is selectable to initiate and/or start the countdown timer.

In some embodiments, in FIG. 17B, widget 1712a is a contextual widget selected for inclusion in the set of widgets by computer system 600. In some embodiments and/or scenarios, widgets 1712b-1712c are non-contextual widgets (e.g., user selected) that were not selected (e.g., automatically) by computer system 600. In some embodiments, computer system 600 selects widget 1712a to be included in the set of widgets, because data corresponding to widget 1712a meets a predetermined criteria (e.g., the countdown timer function corresponding to widget 1712a was the most recent function used by the user prior to user input 1706a, 1706b, and/or 1706c). In some embodiments, widget 1712a is a non-contextual widget. In some embodiments, widget 1712a was added to the set of widgets via user input (e.g., not a contextual widget selected by computer system 600). In some embodiments, widgets 1712b and 1712c are contextual widgets. In some embodiments, contextual widgets are added to a set of widgets automatically (e.g., without user input) based on a predetermined criteria (e.g., location of the computer system 600, current time, network connectivity status, status of ongoing live session, status of one or more applications and/or features that are being used and/or were most recently used by a user, and/or battery charge). In some embodiments, computer system 600 changes a status of a non-contextual widget in the set of widgets to a contextual widget based on a predetermined criteria (e.g., location of the computer system 600, current time, network connectivity status, status of ongoing live session, status of one or more applications and/or features that are being used and/or were most recently used by a user, and/or battery charge). In some embodiments, changing a non-contextual widget to a contextual widget causes the order of the respective widget to change within the set of widgets. In some embodiments, computer system 600 changes a contextual widget in the set of widgets to a non-contextual widget (e.g., via a pinning process and/or other user input). In some embodiments, changing a contextual widget to a non-contextual widget causes the order of the respective widget to change within the set of widgets. FIG. 17B depicts various example scenarios in which computer system 600 detects different user inputs, including user input 1714a, which is an air gesture user input (e.g., a pinch air gesture, a double pinch air gesture, and/or a pinch and hold air gesture); user input 1714b, which is a swipe up touch input; and user input 1714c, which is rotation of rotatable input mechanism 604.

At FIG. 17C, in response to user input 1714a, 1714b, and/or 1714c (e.g., individually, in combination, and/or in sequence), computer system 600 displays scrolling of widget stack 1712 to transition from widget 1712a to widget 1712b. In some embodiments, a user can perform any one of user input 1714a, user input 1714b, or user input 1714c to perform scrolling of widget stack 1712. Widget 1712b corresponds to a music application, and includes audio track information 1712b-1 and artist information 1712b-2. Widget 1712b also includes rewind (or previous track) button 1712b-3 that is selectable to rewind an audio track (or go to a previous audio track), play button 1712b-5 that is selectable to initiate playback of an audio track, and fast forward (or next track) button 1712b-4 that is selectable to move forward in an audio track (or go to a next audio track). FIG. 17C depicts various example scenarios in which computer system 600 detects different user inputs, including user input 1716a, which is an air gesture user input (e.g., a pinch air gesture, a double pinch air gesture, and/or a pinch and hold air gesture); user input 1716b, which is a swipe up touch input; and user input 1716c, which is rotation of rotatable input mechanism 604.

At FIG. 17D, in response to user input 1716a, 1716b, and/or 1716c (e.g., individually, in combination, and/or in sequence), computer system 600 displays scrolling of widget stack 1712 to transition from widget 1712b to widget 1712c. In some embodiments, a user can perform any one of user input 1716a, user input 1716b, or user input 1716c to perform scrolling of widget stack 1712. Widget 1712c corresponds to a weather application, and displays weather forecast information, and is selectable to open a weather application. FIG. 17D depicts various example scenarios in which computer system 600 detects different user inputs, including user input 1718a, which is an air gesture user input (e.g., a pinch air gesture, a double pinch air gesture, and/or a pinch and hold air gesture); user input 1718b, which is a swipe up touch input; and user input 1718c, which is rotation of rotatable input mechanism 604.

At FIG. 17E, in response to user input 1718a, 1718b, and/or 1718c (e.g., individually, in combination, and/or in sequence), computer system 600 displays scrolling of widget stack 1712 to transition from widget 1712c to widget 1712d. In some embodiments, a user can perform any one of user input 1718a, user input 1718b, or user input 1718c to perform scrolling of widget stack 1712. Widget 1712d corresponds to a heart rate function, and displays current heart rate information 1712d-1 (e.g., heart rate information that updates as the heart rate of the user changes); previous heart rate information 1712d-2 which provides a previous heart rate reading for the user; and time information 1712d-3 that indicates how long ago the previous heart rate reading was taken. In the depicted scenario, widget 1712d is the last widget in the stack. FIG. 17E depicts various example scenarios in which computer system 600 detects different user inputs, including user input 1720a, which is an air gesture user input (e.g., a pinch air gesture, a double pinch air gesture, and/or a pinch and hold air gesture); user input 1720b, which is a swipe up touch input; user input 1720c, which is rotation of rotatable input mechanism 604; user input 1720d, which is a tap input corresponding to selection of current time indication 1708a; and user input 1720e, which is a press of rotatable input mechanism 604.

At FIG. 17F, in response to user input 1720a, 1720b, 1720c, 1720d, and/or 1720e (e.g., individually, in combination, and/or in sequence), computer system 600 returns to the first widget in the stack, widget 1712a. In some embodiments, a user can perform any one of user input 1720a, user input 1720b, user input 1720c, user input 1720d, or user input 1720e to perform scrolling of widget stack 1712.

In some embodiments, as depicted above in FIGS. 17A-17F, an air gesture user input (e.g., air gesture user inputs 1714a, 1716a, 1718a, and/or 1720a) causes scrolling of widget stack 1712. In some embodiments, a user is able to select whether an air gesture user input causes scrolling of widget stack 1712 or causes computer system 600 to perform a different operation. At FIG. 17G, computer system 600 displays settings user interface 1722. Setting user interface 1722 includes option 1724a and option 1724b. In some embodiments, when option 1724a is selected, an air gesture user input causes scrolling of widget stack 1712, as described above with reference to FIGS. 17A-17F. In some embodiments, when option 1724b is selected, an air gesture user input causes computer system 600 to perform a primary action that is associated with a currently displayed and/or currently selected widget, as will be described in greater detail below. At FIG. 17G, computer system 600 detects user input 1726, which is a tap input corresponding to selection of option 1724b. At FIG. 17H, in response to user input 1726, computer system 600 displays option 1724b as being selected and/or enabled.

At FIG. 17I, computer system 600 displays watch face user interface 1700. FIG. 17I depicts various example scenarios in which computer system 600 detects different user inputs, including user input 1730a, which is an air gesture user input (e.g., a pinch air gesture, a double pinch air gesture, and/or a pinch and hold air gesture); user input 1730b, which is a swipe up touch input; and user input 1730c, which is rotation of rotatable input mechanism 604.

At FIG. 17J, in response to user input 1730a, 1730b, and/or 1730c (e.g., individually, in combination, and/or in sequence), computer system 600 displays widget user interface 1703, including widgets 1712a-1712c. In some embodiments, any one of user input 1730a, user input 1730b, or user input 1730c can be used to transition from watch face user interface 1700 to widget user interface 1703. In FIG. 17J, widget 1712a is at the top of the stack and is the displayed and/or selected widget. In some embodiments, a user is able to interact with widget 1712a via one or more touch inputs. For example, touch input 1732c causes computer system 600 to display a countdown timer user interface and/or a countdown timer application; and touch input 1732b, corresponding to selection of button 1712a-2, causes computer system 600 to initiate the countdown timer (similar to what is shown in FIG. 17K, described in greater detail below). At FIG. 17J, while option 1724b is enabled, and while widget 1712a is displayed and/or selected, computer system 600 detects user input 1732a, which is an air gesture user input.

At FIG. 17K, in response to detecting user input 1732a, and based on a determination that option 1724b is enabled, computer system 600 performs a primary action corresponding to widget 1712a, which is selection of play button 1712a-2. Accordingly, at FIG. 17K, in response to detecting user input 1732a, and based on a determination that option 1724b is enabled, computer system 600 initiates the countdown timer, and displays timer information 1712a-1 counting down, as well as displays button 1712a-2 change from a play button to a pause button. As such, it can be seen that, in some embodiments, the result of user input 1732b is the same as the result of user input 1732a. FIG. 17K depicts various example scenarios in which computer system 600 detects different user inputs, including user input 1734a, which is an air gesture user input (e.g., a pinch air gesture, a double pinch air gesture, and/or a pinch and hold air gesture); and user input 1734b, which is a tap input corresponding to selection of button 1712a-2.

At FIG. 17L, in response to user input 1734a and/or user input 1734b (e.g., individually, in combination, and/or sequentially), computer system 600 pauses the countdown timer, and displays button 1712a-2 change from a pause button back to the play button. As such, it can be seen that, in some embodiments, the result of user input 1734a is the same as the result of user input 1734b.

In the depicted embodiments, computer system 600 is configured (optionally, only configured) to detect one type of air gesture input (e.g., a pinch air gesture, a double pinch air gesture, or a pinch and hold air gesture). In such embodiments, when option 1724a of FIG. 17G is selected, a user can scroll through the stack of widgets using an air gesture, and when option 1724b of FIG. 17G is selected, a user can perform a primary action for a top widget using an air gesture. FIGS. 17M-17Q below show different example scenarios in which option 1724b is selected, but different widgets are at the top of the stack such that different actions are taken in response to an air gesture user input (e.g., due to a different widget being displayed and/or selected when the air gesture user input is received).

At FIG. 17M, computer system 600 displays widget 1712b at the top of the widget stack. FIG. 17M depicts various example scenarios in which computer system 600 detects different user inputs. At FIG. 17M, computer system 600 detects user input 1736c, which is a tap input on a left portion of widget 1712b, and causes computer system 600 to open a music application. At FIG. 17M, computer system 600 detects user input 1736c, which is a tap input corresponding to selection of button 1712b-3, and causes computer system 600 to rewind an audio track and/or skip to a previous audio track. At FIG. 17M, computer system 600 detects user input 1736e, which is a tap input corresponding to selection of button 1712b-4, and causes computer system 600 to fast forward an audio track and/or skip to a next audio track. At FIG. 17M, computer system 600 detects user input 1736b, which is a tap input corresponding to selection of button 1712b-5, which causes computer system 600 to initiate playback of an audio track. At FIG. 17M, computer system 600 also detects user input 1736a, which is an air gesture user input.

At FIG. 17N, in response to user input 1736a, computer system 600 performs a primary action corresponding to widget 1712b, which is selection of button 1712b-5 (e.g., a play button). Accordingly, in response to user input 1736a, computer system 600 initiates playback of an audio track and outputs audio output 1738, and changes button 1712b-5 from a play button to a pause button. It can be seen that, in the depicted embodiments, the result of user input 1736b is the same as the result of user input 1736a. At FIG. 17N, computer system 600 detects user input 1740b, which is a tap input corresponding to selection of button 1712b-5, which causes computer system 600 to pause playback of the audio track. At FIG. 17N, computer system 600 also detects user input 1740a, which is an air gesture user input.

At FIG. 17O, in response to user input 1740a, computer system 600 performs a primary action corresponding to widget 1712b, which is selection of button 1712b-5 (e.g., a pause button). Accordingly, in response to user input 1740a, computer system pauses playback of the audio track, and changes button 1712b-5 back to a play button. It can be seen that, in the depicted embodiments, the result of user input 1740b is the same as the result of user input 1740a.

At FIG. 17P, computer system 600 displays widget 1712c at the top of the widget stack. At FIG. 17P, computer system 600 detects user input 1742b, which is a tap input on widget 1712c. At FIG. 17P, computer system 600 also detects user input 1742a, which is an air gesture user input. At FIG. 17Q, in response to user input 1742a, computer system 600 displays user interface 1744 corresponding to a weather application. Similarly, in response to user input 1742b, computer system 600 also displays user interface 1744. As such, it can be seen that the result of user input 1742a is the same as the result of user input 1742b.

As discussed above, in the depicted embodiments, computer system 600 is only configured to detect one type of air gesture input (e.g., a pinch air gesture, a double pinch air gesture, or a pinch and hold air gesture). In such embodiments, when option 1724a of FIG. 17G is selected, a user can scroll through the stack of widgets using an air gesture, and when option 1724b of FIG. 17G is selected, a user can perform a primary action for a top widget using an air gesture. However, in some embodiments, computer system 600 is able to distinguish between multiple different types of air gestures, and is able to perform a different option based on which air gesture is detected. For example, in some such embodiments, when computer system 600 detects a first type of air gesture (e.g., a pinch air gesture, a double pinch air gesture, a swipe air gesture, and/or a pinch and hold air gesture), computer system 600 scrolls the stack of widgets, and when computer system 600 detects a second type of air gesture (e.g., a pinch air gesture, a double pinch air gesture, a swipe air gesture, and/or a pinch and hold air gesture), computer system 600 performs a primary action corresponding to the currently displayed and/or currently selected widget. In this way, a user can both navigate widgets and perform actions corresponding to widgets using air gesture inputs.

FIG. 18 is a flow diagram illustrating methods for advancing status indicators in response to user input, in accordance with some embodiments. Method 1800 is performed at a computer system (e.g., 100, 300, 500, 600, and/or 1510) (e.g., a smart phone, a smart watch, a tablet, a laptop, a desktop, a wearable device, wrist-worn device, and/or head-mounted device) that is in communication with one or more display generation components (e.g., a display, a touch-sensitive display, and/or a display controller) and one or more input devices (e.g., a touch-sensitive surface, a touch-sensitive display, a button, a rotatable input mechanism, a depressible and rotatable input mechanism, a camera, an accelerometer, an inertial measurement unit (IMU), a blood flow sensor, a photoplethysmography sensor (PPG), and/or an electromyography sensor (EMG)). Some operations in method 1800 are, optionally, combined, the orders of some operations are, optionally, changed, and some operations are, optionally, omitted.

In some embodiments, the computer system (e.g., 600) displays (1802), via the one or more display generation components (e.g., 602), a first status indicator (e.g., 1712a, 1712b, 1712c, and/or 1712d) (e.g., a widget that includes status information and/or a first live session (e.g., a graphical user interface object that has status information for an ongoing event that is updated periodically with more current information about the ongoing event such as updated information about a timer, an alarm, a score for a sport event, an ongoing weather event, an ongoing media playback operation, a delivery or transportation event, navigation directions, and/or stocks)) that includes first status information that corresponds to a first device function (e.g., a timer, an alarm, a score for a sport event, an ongoing weather event, an ongoing media playback operation, a delivery or transportation event, navigation directions, and/or stocks). While displaying the first status indicator (e.g., 1712a-1712d) (1804), the computer system detects (1806), via the one or more input devices, a first air gesture user input (e.g., 1714a, 1716a, and/or 1718a) (e.g., a pinch air gesture, a double pinch air gesture, a tap air gesture, a double tap air gesture, and/or a swipe air gesture). In response to detecting the first air gesture user input (1808), the computer system advances (1810) from the first status indicator to a second status indicator (e.g., 1712a, 1712b, 1712c, and/or 1712d) (e.g., FIGS. 17B-17E) (e.g., displays, via the one or more display generation components, a transition from the first status indicator to the second status indicator; and/or displays movement of the second status indicator from a second display position to a first display position that was previously occupied by the first status indicator prior to detecting the first air gesture user input (e.g., a first display position that is indicative of a currently selected status indicator)) (e.g., a widget that includes status information and/or a second live session (e.g., a graphical user interface object that has status information for an ongoing event that is updated periodically with more current information about the ongoing event such as updated information about a timer, an alarm, a score for a sport event, an ongoing weather event, an ongoing media playback operation, a delivery or transportation event, navigation directions, and/or stocks)) different from the first status indicator and that includes second status information (e.g., second status information different from the first status information) (and, in some embodiments, does not include the first status information) that corresponds to a second device function (e.g., a timer, an alarm, a score for a sport event, an ongoing weather event, an ongoing media playback operation, a delivery or transportation event, navigation directions, and/or stocks) different from the first device function. Allowing a user to provide an air gesture to transition between different status indicators allows for quicker selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first device function corresponds to a first application (e.g., the first status indicator is displayed by the first application; the first device function is performed (e.g., completely and/or at least in part) by the first application; and/or the first device function is performed using information from the first application) (e.g., a first application installed on the computer system and/or a first application running on the computer system) (e.g., a timer application, an alarm application, a sports score application, a weather application, a media playback application, a navigation application, and/or a stock application) (e.g., 1712b corresponds to a media playback application); and the second device function corresponds to a second application (e.g., 1712c corresponds to a weather application) (e.g., the second status indicator is displayed by the second application; the second device function is performed (e.g., completely and/or at least in part) by the second application; and/or the second device function is performed using information from the second application) (e.g., a second application installed on the computer system and/or a second application running on the computer system) (e.g., a timer application, an alarm application, a sports score application, a weather application, a media playback application, a navigation application, and/or a stock application) different from the first application. Allowing a user to provide an air gesture to transition between different status indicators corresponding to different applications allows for quicker selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first device function corresponds to a first operating system function (e.g., 1712a corresponds to a countdown timer function) (e.g., a function that is provided by the operating system and/or performed by the operating system) (e.g., a timer function, an alarm function, a weather function, a sports score function, a media playback function, a navigation function, and/or a stock ticker function); and the second device function corresponds to a second operating system function (e.g., 1712b corresponds to a media playback function) (e.g., a second function that is provided by the operating system and/or performed by the operating system) (e.g., a timer function, an alarm function, a weather function, a sports score function, a media playback function, a navigation function, and/or a stock ticker function) different from the first operating system function. Allowing a user to provide an air gesture to transition between different status indicators corresponding to different operating system functions allows for quicker selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first device function corresponds to a first respective application (e.g., 1712b corresponds to a media playback application) (e.g., the first status indicator is displayed by the first respective application; the first device function is performed (e.g., completely and/or at least in part) by the first respective application; and/or the first device function is performed using information from the first respective application) (e.g., a first respective application installed on the computer system and/or a first respective application running on the computer system) (e.g., a timer application, an alarm application, a sports score application, a weather application, a media playback application, a navigation application, and/or a stock application); and the second device function corresponds to a first respective operating system function (e.g., 1712a corresponds to a countdown timer function) (e.g., a function that is provided by the operating system and/or performed by the operating system) (e.g., a timer function, an alarm function, a weather function, a sports score function, a media playback function, a navigation function, and/or a stock ticker function) (e.g., an operating system function that is not performed by the first respective application and/or without involvement by the first respective application). Allowing a user to provide an air gesture to transition between different status indicators allows for quicker selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, while displaying the second status indicator (e.g., 1712a, 1712b, 1712c, and/or 1712d), the computer system detects, via the one or more input devices, a second air gesture user input (e.g., 1714a, 1716a, and/or 1718a) (e.g., a pinch air gesture, a double pinch air gesture, a tap air gesture, a double tap air gesture, and/or a swipe air gesture) (e.g., a second air gesture user input that is the same as or different from the first air gesture user input); and in response to detecting the second air gesture user input, the computer system advances from the second status indicator to a third status indicator (e.g., FIGS. 17B-17E) (e.g., displays, via the one or more display generation components, a transition from the second status indicator to the third status indicator; and/or displays movement of the third status indicator from a second display position to a first display position that was previously occupied by the second status indicator prior to detecting the second air gesture user input (e.g., a first display position that is indicative of a currently selected status indicator)) (e.g., a widget that includes status information and/or a third live session (e.g., a graphical user interface object that has status information for an ongoing event that is updated periodically with more current information about the ongoing event such as updated information about a timer, an alarm, a score for a sport event, an ongoing weather event, an ongoing media playback operation, a delivery or transportation event, navigation directions, and/or stocks)) different from the second status indicator and the first status indicator and that includes third status information (e.g., third status information different from the first status information and/or the second status information) that corresponds to a third device function (e.g., a timer, an alarm, a score for a sport event, an ongoing weather event, an ongoing media playback operation, a delivery or transportation event, navigation directions, and/or stocks) different from the second device function and the first device function. Allowing a user to provide an air gesture to transition between different status indicators allows for quicker selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, while displaying the third status indicator (e.g., 1712a, 1712b, 1712c, and/or 1712d), the computer system detects, via the one or more input devices, a third air gesture user input (e.g., 1714a, 1716a, 1718a, and/or 1720a) (e.g., a pinch air gesture, a double pinch air gesture, a tap air gesture, a double tap air gesture, and/or a swipe air gesture) (e.g., a third air gesture user input that is the same as or different from the first air gesture user input and/or the second air gesture user input). In response to detecting the third air gesture user input: in accordance with a determination that there is a fourth status indicator (e.g., 1712a, 1712b, 1712c, and/or 1712d) (e.g., FIG. 17D) (e.g., a fourth status indicator that is different from the first status indicator, the second status indicator, and the third status indicator) that follows (e.g., succeeds and/or that is positioned after) the third status indicator (e.g., 1712a, 1712b, 1712c, and/or 1712d) in an ordered set of status indicators (e.g., in some embodiments, the first status indicator, the second status indicator, and the third status indicator are part of an ordered set of status indicators (e.g., an ordered set of status indicators in which the second status indicator follows the first status indicator, and the third status indicator follows the first status indicator)), the computer system advances from the third status indicator to the fourth status indicator (e.g., FIG. 17D to FIG. 17E) (e.g., displays, via the one or more display generation components, a transition from the third status indicator to the fourth status indicator; and/or displays movement of the fourth status indicator from a second display position to a first display position that was previously occupied by the third status indicator prior to detecting the third air gesture user input (e.g., a first display position that is indicative of a currently selected status indicator)) (e.g., a widget that includes status information and/or a fourth live session (e.g., a graphical user interface object that has status information for an ongoing event that is updated periodically with more current information about the ongoing event such as updated information about a timer, an alarm, a score for a sport event, an ongoing weather event, an ongoing media playback operation, a delivery or transportation event, navigation directions, and/or stocks)), wherein the fourth status indicator includes fourth status information (e.g., fourth status information different from the first status information, the second status information, and/or the third status information) that corresponds to a fourth device function (e.g., a timer, an alarm, a score for a sport event, an ongoing weather event, an ongoing media playback operation, a delivery or transportation event, navigation directions, and/or stocks) different from the third device function, the second device function, and the first device function; and in accordance with a determination that there is no status indicator that follows the third status indicator (e.g., 1712a, 1712b, 1712c, and/or 1712d) in the ordered set of status indicators (e.g., the third status indicator is the last and/or final status indicator in the ordered set of status indicators) (e.g., FIG. 17E), the computer system advances from the third status indicator to the first status indicator (e.g., FIG. 17E to FIG. 17F) (e.g., returns to the first status indicator, and/or returns to the first status indicator in the ordered set of status indicators) (e.g., displays, via the one or more display generation components, a transition from the third status indicator to the first status indicator; and/or displays movement of the first status indicator to a first display position that was previously occupied by the third status indicator prior to detecting the third air gesture user input (e.g., a first display position that is indicative of a currently selected status indicator)). Allowing a user to provide an air gesture to transition between different status indicators, and looping back to a first status indicator when a final status indicator is reached, allows for quicker selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the computer system (e.g., 600) displays, via the one or more display generation components (e.g., 602), a time user interface (e.g., 1700) (e.g., a watch face; a user interface that includes a watch face; a user interface that includes an indication of the current time; and/or a user interface that includes a digital or analog representation of a current time that updates as time progresses) (e.g., without displaying the first status indicator and/or the second status indicator; without displaying any status indicators; without displaying any status indicators of a set of status indicators; and/or without displaying any live session). While displaying the time user interface, the computer system detects, via the one or more input devices, a fifth air gesture user input (e.g., 1706a) (e.g., a pinch air gesture, a double pinch air gesture, a tap air gesture, a double tap air gesture, and/or a swipe air gesture). In response to detecting the fifth air gesture user input, the computer system displays, via the one or more display generation components, a first respective status indicator (e.g., 1712a) (e.g., FIG. 17A to FIG. 17B) of a set of status indicators (e.g., a widget that includes status information and/or a first respective live session (e.g., a graphical user interface object that has status information for an ongoing event that is updated periodically with more current information about the ongoing event such as updated information about a timer, an alarm, a score for a sport event, an ongoing weather event, an ongoing media playback operation, a delivery or transportation event, navigation directions, and/or stocks)). Allowing a user to provide an air gesture to display a status indicator allows for quicker selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in accordance with a determination that a first set of computer system context criteria (e.g., based on location of the computer system, current time, network connectivity status, currently running applications, one or more active and/or ongoing functions and/or actions of one or more applications, status of one or more applications on the computer system, and/or battery charge) is met, the first respective status indicator is a fifth status indicator (e.g., 1712a, 1712b, 1712c, and/or 1712d) of the set of status indicators; and in accordance with a determination that the set of computer system context criteria (e.g., based on location of the computer system, current time, network connectivity status, currently running applications, one or more active and/or ongoing functions and/or actions of one or more applications, status of one or more applications on the computer system, and/or battery charge) is not met, the first respective status indicator is a sixth status indicator (e.g., 1712a, 1712b, 1712c, and/or 1712d) of the set of status indicators, wherein the sixth status indicator is different from the fifth status indicator. In some embodiments, a particular status indicator is selected from a plurality of possible status indicators based on the context of the computer system (e.g., based on location of the computer system, current time, network connectivity status, currently running applications, one or more active and/or ongoing functions and/or actions of one or more applications, status of one or more applications on the computer system, and/or battery charge). Accordingly, in some embodiments, different status indicators are selected for display at different times based on changing context of the computer system. In some embodiments, a set of status indicators are displayed (e.g., in a stack). In some embodiments, the set of status indicators is selected based on the context of the computer system. In some embodiments, the order in which status indicators are ordered in the set (e.g., in the stack) is determined based on the context of the computer system. Selecting a status indicator to display based on a determined device context (e.g., automatically and/or without additional user input) allows for quicker selection of relevant widgets without additional user input by performing an operation when a set of conditions has been met without requiring further inputs.

In some embodiments, in response to detecting the fifth air gesture user input (e.g., 1706a), the computer system displays, via the one or more display generation components, a first plurality of status indicators (e.g., a stack of status indicators and/or a stack of live sessions) (e.g., 1712a, 1712b, and 1712c in FIG. 17B), wherein the first plurality of status indicators includes the first respective status indicator. In some embodiments, the computer system displays a stack of status indicators. In some embodiments, displaying a stack of status indicators includes displaying a first status indicator (e.g., 1712a in FIG. 17B) (e.g., the entirety of the first status indicator or substantially all of the first status indicator), and displaying a portion of a second status indicator (e.g., 1712b in FIG. 17B) (e.g., extending from an edge of the first status indicator, and/or positioned behind the first status indicator) to provide a visual indication that there are one or more additional status indicators available to view. In some embodiments, displaying the stack of status indicator further comprises displaying a portion of a third status indicator (e.g., 1712c in FIG. 17B) (e.g., extending from an edge of the first and/or second status indicators, and/or positioned behind the first and/or second status indicators) to provide a visual indication that there are more than one additional status indicators available to view. Allowing a user to provide an air gesture to display a set of status indicators allows for quicker selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, while displaying the first status indicator (e.g., 1712a) that includes the first status information that corresponds to the first device function, the computer system detects, via the one or more input devices, a fourth air gesture user input (e.g., 1714a and/or 1732a) (e.g., a pinch air gesture, a double pinch air gesture, a tap air gesture, a double tap air gesture, and/or a swipe air gesture). In response to detecting the fourth air gesture user input (e.g., 1714a and/or 1732a): in accordance with a determination that a first device setting (e.g., 1724b) is enabled, the computer system performs a first action that corresponds to the first device function (e.g., FIGS. 17J-17K); and in accordance with a determination that the first device setting (e.g., 1724b) is not enabled (optionally, in some embodiments, a second device setting (e.g., 1724a) different from the first device setting is enabled), the computer system advances from the first status indicator (e.g., 1712a) to the second status indicator (e.g., 1712b) that is different from the first status indicator and that includes the second status information that corresponds to the second device function (e.g., FIGS. 17B-17C) (e.g., in some embodiments, without performing the first action that corresponds to the first device function). In some embodiments, the computer system displays, via the one or more display generation components, a first status indicator (e.g., 1712a) (e.g., a widget that includes status information and/or a first live session (e.g., a graphical user interface object that has status information for an ongoing event that is updated periodically with more current information about the ongoing event such as updated information about a timer, an alarm, a score for a sport event, an ongoing weather event, an ongoing media playback operation, a delivery or transportation event, navigation directions, and/or stocks)) that includes first status information that corresponds to a first device function (e.g., a timer, an alarm, a score for a sport event, an ongoing weather event, an ongoing media playback operation, a delivery or transportation event, navigation directions, and/or stocks). While displaying the first status indicator, the computer system detects, via the one or more input devices, an air gesture user input (e.g., 1714a and/or 1732a) (e.g., a pinch air gesture, a double pinch air gesture, a tap air gesture, a double tap air gesture, and/or a swipe air gesture). In response to detecting the air gesture user input (e.g., 1714a and/or 1732a): in accordance with a determination that a first device setting (e.g., 1724b) is enabled, the computer system performs a first action that corresponds to the first device function (and, in some embodiments, does not correspond to the second device function) (e.g., FIGS. 17J-17K); and in accordance with a determination that the first device setting (e.g., 1724b) is not enabled (and/or, optionally, in some embodiments, a second device setting (e.g., 1724a) different from the first device setting is enabled), the computer system advances from the first status indicator (e.g., 1712a) to a second status indicator (e.g., 1712b) that is different from the first status indicator and that includes second status information (e.g., second status information different from the first status information) that corresponds to a second device function (e.g., in some embodiments, without performing the first action that corresponds to the first device function) (e.g., FIGS. 17B-17C). Allowing a user to set a device setting such that when the device setting is enabled, an air gesture causes performance of an action pertaining to a currently displayed status indicator, and when the device setting is not enabled, the air gesture causes transitioning to a different status indicator, allows for faster performance of relevant actions and/or selection of relevant status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, while displaying a respective status indicator (e.g., 1712a, 1712b, 1712c, and/or 1712d) (e.g., the first status indicator, the second status indicator, and/or a different status indicator), the computer system detects, via the one or more input devices, a fifth air gesture user input (e.g., 1732a, 1736a, and/or 1742a) (e.g., a pinch air gesture, a double pinch air gesture, a tap air gesture, a double tap air gesture, and/or a swipe air gesture). In response to detecting the fifth air gesture user input: in accordance with a determination that the first device setting (e.g., 1724b) is enabled and the respective status indicator is the first status indicator (e.g., 1712a), performing the first action that corresponds to the first device function (e.g., FIGS. 17J-17K); and in accordance with a determination that the first device setting (e.g., 1724b) is enabled and the respective status indicator is the second status indicator (e.g., 1712b), performing a second action different from the first action and that corresponds to the second device function (e.g., FIGS. 17M-17N) (in some embodiments, without performing the first action) (see, e.g., Table 2 above for examples of displayed status indicators and associated actions and/or operations). In some embodiments, in response to detecting the fifth air gesture user input: in accordance with a determination that the first device setting (e.g., 1724b) is not enabled, the computer system transitions from the respective status indicator to a second respective status indicator different from the respective status indicator. Allowing a user to provide an air gesture to perform different actions based on which status indicator is currently displayed allows for quicker performance of relevant actions without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, performing the first action comprises pausing or resuming an ongoing activity corresponding to the first device function (e.g., FIGS. 17J-17O) (e.g., pausing and/or resuming a timer; pausing and/or resuming a stopwatch; pausing and/or resuming media playback; pausing and/or resuming a workout; and/or pausing and/or resuming a meditation). Allowing a user to provide an air gesture to perform various actions corresponding to displayed status indicators allows for quicker performance of relevant actions without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, performing the first action comprises launching a respective application that corresponds to the first status indicator (and/or, in some embodiments, corresponds to the first device function) (e.g., FIGS. 17P-17Q). Allowing a user to provide an air gesture to launch an application that corresponds to a displayed status indicator allows for quicker performance of relevant actions without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, while displaying the first status indicator (e.g., 1712a, 1712b, 1712c, and/or 1712d), the computer system detects, via the one or more input devices, a first rotation input (e.g., 1714c, 1716c, and/or 1718c) that comprises rotation of a rotatable input mechanism (e.g., 604) (e.g., a physically rotatable input mechanism; and/or a rotatable crown). In response to detecting the first rotation input, the computer system advances from the first status indicator (e.g., 1712a, 1712b, 1712c, and/or 1712d) to the second status indicator (e.g., 1712a, 1712b, 1712c, and/or 1712d). In some embodiments, in response to detecting the first rotation input (e.g., 1714c, 1716c, and/or 1718c), the computer system displays navigation through a plurality of status indicators (e.g., displays scrolling and/or translation of the plurality of status indicators). In some embodiments, navigation of the plurality of status indicators is performed based on a magnitude, speed, and/or direction of the first rotation input. In some embodiments, while displaying the first status indicator (e.g., 1712a, 1712b, 1712c, and/or 1712d), the computer system detects a first rotation input (e.g., 1714c, 1716c, and/or 1718c) that comprises rotation of a rotatable input mechanism (e.g., 604). In response to detecting the first rotation input: in accordance with a determination that the first rotation input includes rotation in a first direction, the computer system advances from the first status indicator (e.g., 1712a, 1712b, 1712c, and/or 1712d) to the second status indicator (e.g., 1712a, 1712b, 1712c, and/or 1712d); and in accordance with a determination that the first rotation input includes rotation in a second direction different from the first direction, the computer system advances from the first status indicator (e.g., 1712a, 1712b, 1712c, and/or 1712d) to a third status indicator (e.g., 1712a, 1712b, 1712c, and/or 1712d) different from the second status indicator and that includes third status information (e.g., different from the first status information and/or the second status information) that corresponds to a third device function different from the first and second device functions. In some embodiments, while displaying the first status indicator (e.g., 1712a, 1712b, 1712c, and/or 1712d), the computer system detects a first rotation input (e.g., 1714c, 1716c, and/or 1718c that comprises rotation of a rotatable input mechanism (e.g., 604). In response to detecting the first rotation input: in accordance with a determination that the first rotation input includes rotation having a first magnitude, the computer system advances from the first status indicator to the second status indicator; and in accordance with a determination that the first rotation input includes rotation having a second magnitude different from the first magnitude, the computer system advances from the first status indicator to a third status indicator different from the second status indicator and that includes third status information (e.g., different from the first status information and/or the second status information) that corresponds to a third device function different from the first and second device functions. Allowing a user to provide a rotation input to navigate through different status indicators allows for quicker navigation of status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, while displaying the first status indicator (e.g., 1712a, 1712b, 1712c, and/or 1712d), the computer system detects, via the one or more input devices, a swipe input (e.g., 1714b, 1716b, and/or 1718b) (e.g., a swipe input on a touch-sensitive surface and/or touch-sensitive display; and/or a swipe input that includes movement in a first direction and/or movement having a first magnitude); and in response to detecting the swipe input, the computer system advances from the first status indicator (e.g., 1712a, 1712b, 1712c, and/or 1712d) to the second status indicator (e.g., 1712a, 1712b, 1712c, and/or 1712d). In some embodiments, in response to detecting the swipe input (e.g., 1714b, 1716b, and/or 1718b), the computer system displays navigation through a plurality of status indicators (e.g., 1712a, 1712b, 1712c, and/or 1712d) (e.g., displays scrolling and/or translation of the plurality of status indicators). In some embodiments, navigation of the plurality of status indicators is performed based on a magnitude, speed, and/or direction of the swipe input. In some embodiments, while displaying the first status indicator (e.g., 1712a, 1712b, 1712c, and/or 1712d), the computer system detects a swipe input (e.g., 1714b, 1716b, and/or 1718b). In response to detecting the swipe input: in accordance with a determination that the swipe input includes movement in a first direction, the computer system advances from the first status indicator to the second status indicator; and in accordance with a determination that the swipe input includes movement in a second direction different from the first direction, the computer system advances from the first status indicator to a third status indicator different from the second status indicator and that includes third status information (e.g., different from the first status information and/or the second status information) that corresponds to a third device function different from the first and second device functions. In some embodiments, while displaying the first status indicator (e.g., 1712a, 1712b, 1712c, and/or 1712d), the computer system detects a swipe input (e.g., 1714b, 1716b, and/or 1718b). In response to detecting the swipe input: in accordance with a determination that the swipe input includes movement having a first magnitude, the computer system advances from the first status indicator to the second status indicator; and in accordance with a determination that the first rotation input includes movement having a second magnitude different from the first magnitude, the computer system advances from the first status indicator to a third status indicator different from the second status indicator and that includes third status information (e.g., different from the first status information and/or the second status information) that corresponds to a third device function different from the first and second device functions. Allowing a user to provide a swipe input to navigate through different status indicators allows for quicker navigation of status indicators without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently. While displaying the first status indicator (e.g., 1712a, 1712b, 1712c, and/or 1712d), the computer system detects, via the one or more input devices, a tap input (e.g., 1732b, 1734b, 1736b, 1740b, and/or 1742b) (e.g., a tap input on a touch-sensitive surface and/or touch-sensitive display); and in response to detecting the tap input, the computer system performs a first respective action that corresponds to the first status indicator (and/or, optionally, corresponds to the first device function). In some embodiments, while displaying the second status indicator (e.g., 1712a, 1712b, 1712c, and/or 1712d), the computer system detects, via the one or more input devices, a second tap input (e.g., 1732b, 1734b, 1736b, 1740b, and/or 1742b). In response to detecting the second tap input, the computer system performs a second respective action different from the first respective action, and that corresponds to the second status indicator (and/or, optionally, corresponds to the second device function) without performing the first respective action. In some embodiments, the first status indicator (e.g., 1712a, 1712b, 1712c, and/or 1712d) includes a plurality of different regions that correspond to different actions being taken in response to a tap input. For example, in some embodiments, the first status indicator includes a first region and a second region different from the first region. In some embodiments, in response to detecting the tap input: in accordance with a determination that the tap input corresponds to selection of the first region (and, optionally, not selection of the second region) (e.g., tap input 1736b, 1736c, 1736d, and/or 1736e), the computer system performs the first respective action; and in accordance with a determination that the tap input corresponds to selection of the second region (and, optionally, not selection of the first region) (e.g., tap input 1736b, 1736c, 1736d, and/or 1736e), the computer system performs a second respective action different from the first respective action (and, optionally, without performing the first respective action). In some embodiments, the first status indicator further includes a third region different from the first and second regions. In some embodiments, in response to detecting the tap input: in accordance with a determination that the tap input corresponds to selection of the third region (and, optionally, not selection of the first or second regions) (e.g., tap input 1736b, 1736c, 1736d, and/or 1736e), the computer system performs a third respective action different from the first and second respective actions (and, optionally, without performing the first respective action and/or the second respective action). Allowing a user to provide a tap input to perform an action pertaining to a currently displayed status indicator allows for faster performance of relevant actions without additional user input. Furthermore, doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

Note that details of the processes described above with respect to method 1800 (e.g., FIG. 18) are also applicable in an analogous manner to the methods described below/above. For example, method 1800 optionally includes one or more of the characteristics of the various methods described below/above with reference to method 900, 1000, 1200, 1300, 1400, 1600, 2000, and/or 2200. For example, in some embodiments, the motion gestures are the same motion gesture. For another example, in some embodiments, the air gestures are the same air gestures. For brevity, these details are not repeated below.

FIGS. 19A-19J illustrate exemplary devices and user interfaces for performing operations in response to detected gestures, in accordance with some embodiments. The user interfaces in these figures are used to illustrate the processes described below, including the process in FIG. 20.

FIG. 19A illustrates a user wearing wearable computer system 600 (e.g., a smart watch) on left wrist 1903A of the user. Computer system 600 includes display 602 (e.g., a touchscreen display) rotatable input mechanism 604 (e.g., a crown or a digital crown), and button 605. Computer system 600 is displaying, via display 602, message conversation 712, as discussed above with reference to FIGS. 7B-7C. In FIG. 19A, message conversation 712 includes messages 712B-712D, as well as text entry field 714. In some embodiments, text entry field 714 is an affordance that is selectable by a user to initiate a dictation operation and/or a dictation function of computer system 600, in which a user can dictate (e.g., speak) a message to be transmitted into message conversation 712 (e.g., as shown and described with reference to FIGS. 7I-7J above). At FIG. 19A, computer system 600 detects air gesture 1902 (e.g., a pinch air gesture, a double pinch air gesture, a tap air gesture, and/or a pinch-and-hold air gesture).

At FIG. 19B, in response to detecting air gesture 1902, computer system 600 highlights (e.g., visually emphasizes) text entry field 714, and dims and/or otherwise visually de-emphasizes other aspects of message conversation 712. In response to detecting air gesture 1902, computer system 600 also outputs haptic output 1904A and audio output 1904B. In some embodiments, when computer system 600 detects an air gesture (e.g., detects a particular air gesture) by a user, computer system 600 performs a particular operation based on the current operating context of computer system 600. In some embodiments, computer system 600 performs the particular operation after a threshold amount of time has elapsed after detecting the particular air gesture. In this way, a user is given the opportunity to cancel the operation before it is performed, as will be described in greater detail below. For example, in some embodiments, a user can provide a wrist gesture to cancel the operation before it is performed, as will be described in greater detail below with reference to FIG. 19D.

In FIG. 19B, computer system 600 highlights text entry field 714 to indicate that computer system 600 is about to perform a dictation operation in response to air gesture 1902 (e.g., once a threshold duration of time has elapsed after detecting air gesture 1902). FIG. 19B includes elapsed time indication 1900 which indicates how much time has elapsed since air gesture 1902 (e.g., a starting point represented by line 1900A) and how much time remains until the threshold duration of time has passed (e.g., as represented by line 1900B), after which computer system 600 will perform the operation corresponding to air gesture 1902. In FIG. 19B, the elapsed time has not yet reached line 1900B and, as such, computer system 600 has not yet performed the dictation operation.

At FIG. 19C, elapsed time indication 1900 indicates that the threshold amount of time has elapsed since computer system 600 detected air gesture 1902, and computer system 600 has not detected an intervening wrist gesture during that period of time. Accordingly, based on a determination that the threshold amount of time has elapsed since computer system 600 detected air gesture 1902 without an intervening wrist gesture, computer system 600 performs the dictation operation. In the depicted embodiments, this includes displaying voice dictation user interface 730 for a user to verbally provide a message to be transmitted into message conversation 712 (e.g., as described above with reference to FIGS. 7I-7J). In FIG. 19C, computer system 600 also outputs haptic output 1906A and audio output 1906B indicating that the threshold duration of time has elapsed and/or that the dictation operation has been performed.

FIG. 19D depicts a different example scenario, in which, after FIG. 19B, computer system 600 detects wrist down gesture 1908 in which user 660 lowers left wrist 1903A on which computer system 600 is worn before the threshold duration of time has elapsed from air gesture 1902 (e.g., as indicated by elapsed time indication 1900). In FIG. 19D, in response to detecting wrist down gesture 1908 before the threshold duration of time has elapsed from gesture 1902, computer system 600 forgoes performing the dictation operation (e.g., forgoes displaying voice dictation user interface 730), ceases visually emphasizing text entry field 714, and returns to displaying message conversation 712 as it was displayed prior to air gesture 1902. In some embodiments, rather than re-displaying message conversation 712 as it was displayed prior to air gesture 1902, a wrist down gesture causes computer system 600 to cancel the dictation operation and enter a low power mode in which computer system 600 consumes less power as compared to a normal or high power mode. For example, in some embodiments, rather than re-displaying message conversation 712 as it was displayed prior to air gesture 1902, a wrist down gesture causes computer system 600 to display message conversation 712 in a low power mode with lower brightness and less frequent updates; and/or a wrist down gesture causes computer system 600 to turn display 602 off.

FIG. 19E depicts yet a different example scenario in which, after FIG. 19B, computer system 600 detects wrist cover gesture 1910, in which the user covers computer system 600 with right hand 1901B before the threshold duration of time has elapsed from air gesture 1902 (e.g., as indicated by elapsed time indication 1900). In FIG. 19E, in response to detecting wrist cover gesture 1910 before the threshold duration of time has elapsed from gesture 1902, computer system 600 performs the dictation operation and displays voice dictation user interface 730 before the threshold duration of time has elapsed from air gesture 1902. In response to detecting wrist cover gesture 1910 before the threshold duration of time has elapsed from gesture 1902, computer system 600 also outputs haptic output 1912A and audio output 1912B. In this way, a user can provide a first type of wrist gesture to cancel the operation (e.g., FIG. 19D), and a second type of wrist gesture to accelerate or speed up the operation (e.g., FIG. 19E). Although the depicted embodiments show a wrist down gesture as a cancellation gesture and a wrist cover gesture as a speed-up gesture, other variations are possible. For example, in some embodiments, a wrist down gesture is a speed-up gesture and a wrist cover gesture is a cancellation gesture; in some embodiments, both a wrist down gesture and a wrist cover gesture are cancellation gestures; and in some embodiments, both a wrist down gesture and a wrist cover gesture are speed-up gestures.

At FIG. 19F, computer system 600 displays, via display 602, media user interface 610, which was described above with reference to FIGS. 6A-6F. At FIG. 19F, while displaying media user interface 610, computer system 600 detects air gesture 1914 (e.g., a pinch air gesture, a double pinch air gesture, a tap air gesture, and/or a pinch-and-hold air gesture).

At FIG. 19G, in response to detecting air gesture 1914, computer system 600 highlights (e.g., visually emphasizes) play/pause button 610B, and dims and/or otherwise visually de-emphasizes other aspects of user interface 610. In response to detecting air gesture 1914, computer system 600 also outputs haptic output 1916A and audio output 1916B. As discussed above, in some embodiments, when computer system 600 detects an air gesture (e.g., detects a particular air gesture) by a user, computer system 600 performs a particular operation based on the current operating context of computer system 600. In some embodiments, computer system 600 performs the particular operation after a threshold amount of time has elapsed after detecting the particular air gesture. In FIGS. 19A-19E, the particular operation was a dictation operation based on computer system 600 displaying message conversation 712 when the air gesture was detected. In FIG. 19F, the particular operation is a selection of play/pause button 610B based on computer system 600 displaying media user interface 610 when air gesture 1914 is detected.

In FIG. 19G, in response to detecting air gesture 1914, computer system 600 highlights play/pause button 610B to indicate that computer system 600 is about to perform a selection operation selecting play/pause button 610B. FIG. 19G includes elapsed time indication 1900 which indicates how much time has elapsed since air gesture 1914 (e.g., a starting point represented by line 1900A) and how much time remains until the threshold duration of time has passed (e.g., as represented by line 1900B), after which computer system 600 will perform the operation corresponding to air gesture 1914. In FIG. 19G, the elapsed time has not yet reached line 1900B and, as such, computer system 600 has not yet performed the selection operation of play/pause button 610B.

At FIG. 19H, elapsed time indication 1900 indicates that the threshold amount of time has elapsed since computer system 600 detected air gesture 1914, and computer system 600 has not detected an intervening wrist gesture during that period of time. Accordingly, based on a determination that the threshold amount of time has elapsed since computer system 600 detected air gesture 1914 without an intervening wrist gesture, computer system 600 performs the selection operation of play/pause button 610B. In the depicted embodiments, this includes pausing media playback, and changing play/pause button 610B from a pause button to a play button. In FIG. 19H, computer system 600 also outputs haptic output 1918A and audio output 1918B indicating that the threshold duration of time has elapsed and/or that the selection operation has been performed.

FIG. 19I depicts a different example scenario, in which, after FIG. 19G, computer system 600 detects wrist down gesture 1920 in which user 660 lowers left wrist 1903A on which computer system 600 is worn before the threshold duration of time has elapsed from air gesture 1902 (e.g., as indicated by elapsed time indication 1900). In FIG. 19I, in response to detecting wrist down gesture 1920 before the threshold duration of time has elapsed from gesture 1914, computer system 600 forgoes performing the selection operation (e.g., forgoes selecting play/pause button 610B), ceases visually emphasizing play/pause button 610B, and returns to displaying media user interface 610 as it was displayed prior to air gesture 1914. In some embodiments, rather than re-displaying media user interface 610 as it was displayed prior to air gesture 1914, a wrist down gesture causes computer system 600 to cancel the selection operation and enter a low power mode in which computer system 600 consumes less power as compared to a normal or high power mode. For example, in some embodiments, rather than re-displaying media user interface 610 as it was displayed prior to air gesture 1914, a wrist down gesture causes computer system 600 to display media user interface 610 in a low power mode with lower brightness and less frequent updates; and/or a wrist down gesture causes computer system 600 to turn display 602 off.

FIG. 19J depicts yet a different example scenario in which, after FIG. 19G, computer system 600 detects wrist cover gesture 1922, in which the user covers computer system 600 with right hand 1901B before the threshold duration of time has elapsed from air gesture 1914 (e.g., as indicated by elapsed time indication 1900). In FIG. 19J, in response to detecting wrist cover gesture 1922 before the threshold duration of time has elapsed from gesture 1914, computer system 600 performs the selection operation of play/pause button 610B before the threshold duration of time has elapsed from air gesture 1914. Once again, in this way, a user can provide a first type of wrist gesture to cancel the operation (e.g., FIG. 19I), and a second type of wrist gesture to accelerate or speed up the operation (e.g., FIG. 19J). As discussed above, although the depicted embodiments show a wrist down gesture as a cancellation gesture and a wrist cover gesture as a speed-up gesture, other variations are possible. For example, in some embodiments, a wrist down gesture is a speed-up gesture and a wrist cover gesture is a cancellation gesture; in some embodiments, both a wrist down gesture and a wrist cover gesture are cancellation gestures; and in some embodiments, both a wrist down gesture and a wrist cover gesture are speed-up gestures.

FIG. 20 is a flow diagram illustrating methods for performing operations in response to detected gestures, in accordance with some embodiments. Method 2000 is performed at a computer system (e.g., 100, 300, 500, 600, and/or 1510) (e.g., a smart phone, a smart watch, a tablet, a laptop, a desktop, a wearable device, wrist-worn device, and/or head-mounted device) that is in communication with one or more input devices (e.g., a touch-sensitive surface, a touch-sensitive display, a button, a rotatable input mechanism, a depressible and rotatable input mechanism, a camera, an accelerometer, an inertial measurement unit (IMU), a blood flow sensor, a photoplethysmography sensor (PPG), and/or an electromyography sensor (EMG)) and, in some embodiments, is optionally in communication with one or more display generation components (e.g., a display, a touch-sensitive display, and/or a display controller). Some operations in method 2000 are, optionally, combined, the orders of some operations are, optionally, changed, and some operations are, optionally, omitted.

In some embodiments, the computer system (e.g., 600) detects (2002), via the one or more input devices, a first air gesture (e.g., 1902 and/or 1914) (e.g., a user input corresponding to movement of one or more fingers in the air, including one or more of a pinch air gesture, a double pinch air gesture, a long pinch air gesture, a tap air gesture, a double tap air gesture, and/or a swipe air gesture). In response to detecting the first air gesture (2004): in accordance with a determination that a wrist gesture (e.g., movement of a hand of a person over a wrist of the person (e.g., movement of a hand of the person over the wrist of the person while the person wears the computer system on the wrist such that the hand of the person at least partially covers the computer system that is worn on the wrist of the person); movement of the wrist of a person (e.g., a user of the computer system and/or a user that is wearing the computer system) (e.g., a left wrist of the person, a right wrist of the person, a wrist on which on the computer system is worn, and/or a wrist on which the computer system is not worn); movement of the wrist of a person in a prescribed and/or predetermined manner (e.g., downward movement of the wrist, movement of the wrist away from the face of the person, and/or movement of the wrist in a manner indicating that the person is no longer looking at the computer system); and/or movement of the wrist of a person in a prescribed and/or predetermined direction (e.g., downward movement of the wrist and/or movement of the wrist away from the face of the person)) is not detected within a threshold period of time (e.g., within 0.1 seconds, 0.25 seconds, 0.5 seconds, or 1 second) after the first air gesture is detected (2006) (e.g., FIG. 19C and/or FIG. 19H), the computer system performs (2008) a respective operation associated with the first air gesture (e.g., in FIG. 19C, computer system 600 performs a dictation operation in response to air gesture 1902, and in FIG. 19H, computer system 600 performs a selection operation of play/pause button 610B in response to air gesture 1914); and in accordance with a determination that a wrist gesture (e.g., 1908, 1910, 1920, and/or 1922) (e.g., movement of a hand of a person over a wrist of the person (e.g., movement of a hand of the person over the wrist of the person while the person wears the computer system on the wrist such that the hand of the person at least partially covers the computer system that is worn on the wrist of the person); movement of the wrist of a person (e.g., a user of the computer system and/or a user that is wearing the computer system) (e.g., a left wrist of the person, a right wrist of the person, a wrist on which on the computer system is worn, and/or a wrist on which the computer system is not worn); movement of the wrist of a person in a prescribed and/or predetermined manner (e.g., downward movement of the wrist, movement of the wrist away from the face of the person, and/or movement of the wrist in a manner indicating that the person is no longer looking at the computer system); and/or movement of the wrist of a person in a prescribed and/or predetermined direction (e.g., downward movement of the wrist and/or movement of the wrist away from the face of the person)) is detected within the threshold period of time after the first air gesture is detected (2010) (e.g., FIGS. 19D, 19E, 19I, and/or 19J), the computer system modifies (2012) performance of the respective operation (e.g., forgoes performance of the respective operation; performs the respective operation at a greater speed and/or in less time; accelerates performance of the respective operation; and/or performs a second operation different from the respective operation). Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, detecting the first air gesture (e.g., 1902 and/or 1914) comprises detecting movement of one or more fingers of a person (e.g., FIG. 19A and/or FIG. 19F) (e.g., a user of the computer system; and/or a person that is wearing the computer system or wearing an input device that is in communication with the computer system) (e.g., movement of one or more fingers in a prescribed and/or predetermined manner). In some embodiments, the first air gesture (e.g., 1902 and/or 1914) is performed with one or more fingers. Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first air gesture (e.g., 1902 and/or 1914) is a pinch air gesture. In some embodiments, the pinch air gesture includes movement of a thumb of a hand of a user with respect to a second finger (e.g., a forefinger) of the same hand of the user such that the tip of one finger touches the other and/or such that the tips of both fingers touch. Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first air gesture (e.g., 1902 and/or 1914) is a double pinch air gesture. In some embodiments, the double-pinch air gesture includes movement of a thumb of a hand of a user with respect to a second finger (e.g., a forefinger) of the same hand of the user such that the tip of one finger touches the other finger twice within a threshold time and/or such that the tips of both fingers touch twice within the threshold time. Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first air gesture (e.g., 1902 and/or 1914) is a pinch-and-hold air gesture (e.g., a long pinch air gesture). In some embodiments, the pinch-and-hold air gesture includes movement of a thumb of a hand of a user with respect to a second finger (e.g., a forefinger) of the same hand of the user such that the tip of one finger touches the other finger and/or such that the tips of both fingers touch, and the touch is maintained for more than a threshold duration of time (e.g., a threshold hold duration of time, such as 0.1 seconds, 0.2 seconds, 0.3 seconds, 0.5 seconds, or 1 second). In some embodiments, the two fingers touching each other is not directly detected and is inferred from measurements/data from one or more sensors. In some embodiments, a pinch air gesture is detected based on the touch being maintained for less than a threshold duration of time (e.g., same as or different from the threshold hold duration of time; such as 0.01 seconds, 0.02 seconds, 0.05 seconds, 0.1 second, 0.2 seconds, or 0.3 seconds). Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the wrist gesture (e.g., 1908 and/or 1920) includes movement of a wrist (e.g., 1903A and/or 1903B) of a user (e.g., a wrist on which the computer system is worn and/or a wrist that is connected to the hand that performed the first air gesture) in a downward direction (e.g., toward the floor and/or in a direction that corresponds to the direction of gravity) (in some embodiments, the wrist gesture includes movement of the wrist of the user away from the face and/or the head of the user) (e.g., FIGS. 19D and/or 19I). In some embodiments, in response to detecting the wrist gesture (e.g., 1908, 1910, 1920, and/or 1922) (optionally, in some embodiments, in accordance with a determination that the wrist gesture is detected within the threshold period of time after the first air gesture is detected), the computer system (e.g., 600) visually modifies (e.g., changes, ceases display of, and/or replaces) a displayed user interface. In some embodiments, visually modifying the displayed user interface includes turning off a display and/or turning off one or more display generation components of the computer system. In some embodiments, visually modifying the displayed user interface includes transitioning the computer system from a high power mode to a low power mode (e.g., transitioning the displayed user interface form a high power user interface to a low power user interface). In some embodiments, the low power mode is a mode in which the computer system consumes a reduced amount of power as compared to a normal power mode or a high power mode. In some embodiments, the low power user interface is dimmer than the high power user interface and/or is updated less frequently than the high power user interface. In some embodiments, the computer system transitions from the off state to an on state and/or from the low power state to a high power state based on a detected user input, such as a wrist raise, a button press, a crown rotation, and/or a touch input. Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the computer system (e.g., 600) is worn on a first wrist (e.g., 1903A) of a user; and the wrist gesture includes movement of a hand (e.g., 1901B) of the user over the computer system (e.g., 600) that is worn on the first wrist (e.g., 1903A) of the user (e.g., FIGS. 19E and/or 19J) (e.g., such that the hand covers more than a threshold amount (e.g., 30%, 50%, 75%, 90%, or 100%) of a respective portion (e.g., a display, a touch-sensitive surface, a touch screen display, and/or a proximity sensor) of the computer system that is worn on the first wrist of the user). Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first air gesture (e.g., 1902 and/or 1914) is performed using a first hand (e.g., 1901A) (e.g., one or more fingers of a first hand) of a user (e.g., a left hand or a right hand); and the wrist gesture (e.g., 1908, 1910, 1920, and/or 1922) is performed using a first wrist of the user (e.g., 1903A) that extends from the first hand (e.g., 1901A) of the user (e.g., a wrist that directly extends from and/or is directly connected to the first hand of the user) (e.g., a left wrist or a right wrist). Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, detecting the first air gesture (e.g., 1902 and/or 1914) comprises detecting that the first air gesture is performed using the first hand (e.g., 1901A) of the user while the computer system (e.g., 600) is worn on the first wrist (e.g., 1903A) of the user; and the determination that that the wrist gesture (e.g., 1908, 1910, 1920, and/or 1922) is detected comprises a determination that the wrist gesture is performed using the first wrist (e.g., 1903A) of the user while the computer system (e.g., 600) is worn on the first wrist of the user. In some embodiments, the determination that the wrist gesture is not detected comprises a determination that the wrist gesture is not performed using the first wrist of the user while the computer system is worn on the first wrist of the user. In some embodiments, the computer system optionally ignores or does not monitor air gestures performed with a second hand (e.g., 1901B) (e.g., the other hand) of the user while the computer system (e.g., 600) is worn on the first wrist (e.g., 1903A) of the user. In some embodiments, the computer system optionally ignores or does not monitor wrist gestures performed using a second wrist (e.g., 1903B) (e.g., the other wrist) of the user while the computer system (e.g., 600) is worn on the first wrist (e.g., 1903A) of the user. Allowing a user to perform a respective operation with an air gesture, and modify the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, modifying performance of the respective operation comprises forgoing performance of the respective operation (e.g., FIGS. 19D and/or 19I) (e.g., canceling the respective operation). In some embodiments, the wrist gesture causes the computer system to cancel the respective operation. In some embodiments, the respective operation is canceled after the computer system outputs feedback (e.g., visual feedback and/or non-visual feedback (e.g., audio feedback, and/or haptic feedback)) corresponding to and/or indicative of the respective operation (e.g., indicative of the computer system being ready to perform the respective operation and/or about to perform the respective operation) (e.g., in FIG. 19B, visually emphasizing text entry field 714; and/or in FIG. 19G, visually emphasizing play/pause button 610B). Allowing a user to perform a respective operation with an air gesture, and cancel the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, modifying performance of the respective operation comprises performing the respective operation before the threshold period of time after the first air gesture is detected has elapsed (e.g., FIGS. 19E and/or 19J). In some embodiments, in accordance with a determination that a wrist gesture is not detected within the threshold period of time after the first air gesture is detected, the computer system performs the respective operation after the threshold period of time after the first air gesture is detected has elapsed (e.g., FIGS. 19C and/or 19H). In some embodiments, in accordance with a determination that the wrist gesture (e.g., 1908, 1910, 1920, and/or 1922) is detected within the threshold period of time after the first air gesture (e.g., 1902 and/or 1914) is detected, the computer system performs the respective operation before the threshold period of time after the first air gesture is detected has elapsed (e.g., FIGS. 19E and/or 19J). Accordingly, in some embodiments, the wrist gesture causes the respective operation to be performed more quickly. Allowing a user to perform a respective operation with an air gesture, and to accelerate and/or speed up performance of the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, modifying performance of the respective operation comprises performing the respective operation in response to detecting the wrist gesture (e.g., 1908, 1910, 1920, and/or 1922) and before the threshold period of time after the first air gesture is detected has elapsed (e.g., FIGS. 19E and/or 19J). Allowing a user to perform a respective operation with an air gesture, and to accelerate and/or speed up performance of the respective operation with a wrist gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to detecting the first air gesture, the computer system outputs first non-visual feedback (e.g., 1904A, 1904B, 1916A, and/or 1916B) (e.g., audio feedback and/or haptic feedback) (e.g., non-visual feedback indicative of detecting the first air gesture). Outputting non-visual feedback in response to detecting the first air gesture provides the user with feedback about a state of the system (e.g., that the computer system has detected the first air gesture). Doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in accordance with the determination that the wrist gesture is not detected within the threshold period of time after the first air gesture is detected (e.g., FIGS. 19C and/or 19H), the computer system outputs second non-visual feedback (e.g., 1906A, 1906B, 1918A, and/or 1918B) (e.g., audio feedback and/or haptic feedback) (e.g., second non-visual feedback indicative of the computer system performing the respective operation and/or the respective operation being successfully performed) (e.g., second non-visual feedback (e.g., 1906A, 1906B, 1918A, and/or 1918B) that is the same as or different from the first non-visual feedback (e.g., 1904A, 1904B, 1916A, and/or 1916B)). In some embodiments, the computer system outputs second non-visual feedback (e.g., 1906A, 1906B, 1918A, and/or 1918B) based on a determination that the respective operation is performed, to indicate that the respective operation is being performed, and/or to indicate that the respective operation has been performed. Outputting non-visual feedback in accordance with the determination that the wrist gesture is not detected within the threshold period of time after the first air gesture is detected provides the user with feedback about a state of the system (e.g., that the computer system has not detected a wrist gesture within the threshold period of time, that the computer system is performing the respective operation, and/or that the computer system has performed the respective operation). Doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in accordance with the determination that the wrist gesture (e.g., 1908, 1910, 1920, and/or 1922) is detected within the threshold period of time after the first air gesture (e.g., 1902 and/or 1914) is detected, the computer system forgoes outputting the second non-visual feedback (e.g., 1906A, 1906B, 1918A, and/or 1918B) (e.g., FIGS. 19D and/or 19I) (e.g., outputting third non-visual feedback different from the second non-visual feedback or forgoing outputting any non-visual feedback). Forgoing outputting the second non-visual feedback in accordance with the determination that the wrist gesture is detected within the threshold period of time after the first air gesture is detected provides the user with feedback about a state of the system (e.g., that the computer system has detected the wrist gesture within the threshold period time; and/or that the computer system is modifying performance of the respective operation). Doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in accordance with the determination that the wrist gesture (e.g., 1908, 1910, 1920, and/or 1922) is detected within the threshold period of time after the first air gesture (e.g., 1902 and/or 1914) is detected, the computer system outputs third non-visual feedback (e.g., 1912A, 1912B, 1924A, and/or 1924B) (e.g., audio feedback and/or haptic feedback) different from the second non-visual feedback (e.g., 1906A, 1906B, 1918A, and/or 1918B) (e.g., third non-visual feedback indicative of the computer system detecting the wrist gesture within the threshold period of time and/or third non-visual feedback indicative of the computer system modifying performance of the respective operation) (e.g., in some embodiments, in FIG. 19D computer system 600 outputs non-visual feedback (e.g., audio feedback and/or haptic feedback) different from haptic feedback 1906A and/or audio feedback 1906B; and/or in FIG. 19I, computer system 600 outputs non-visual feedback (e.g., audio feedback and/or haptic feedback) different from haptic feedback 1918A and/or audio feedback 1918B). Outputting third non-visual feedback in accordance with the determination that the wrist gesture is detected within the threshold period of time after the first air gesture is detected provides the user with feedback about a state of the system (e.g., that the computer system has detected the wrist gesture within the threshold period time; and/or that the computer system is modifying performance of the respective operation). Doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, outputting the second non-visual feedback (e.g., 1906A, 1906B, 1918A, and/or 1918B) comprises outputting the second non-visual feedback after the threshold period of time after the first air gesture is detected has elapsed (e.g., FIGS. 19C and/or 19H); and outputting the third non-visual feedback (e.g., 1912A, 1912B, 1924A, and/or 1924B) comprises outputting the third non-visual feedback before the threshold period of time after the first air gesture is detected has elapsed (e.g., FIGS. 19E and/or 19J). In some embodiments, in accordance with a determination that the wrist gesture (e.g., 1908, 1910, 1920, and/or 1922) is detected within the threshold period of time after the first air gesture (e.g., 1902 and/or 1914) is detected, the computer system performs the respective operation before the threshold period of time after the first air gesture is detected has elapsed (e.g., FIGS. 19E and/or 19J). In some embodiments, outputting the third non-visual feedback before the threshold period of time after the first air gesture is detected has elapsed comprises outputting the third non-visual feedback when the computer system is performing the respective operation and/or after the computer system has performed the respective operation. In some embodiments, when the wrist gesture is not detected within the threshold period of time after the first air gesture is detected, the computer system outputs the second non-visual feedback (e.g., 1906A, 1906B, 1918A, and/or 1918B) and performs the respective operation after the threshold period of time after the first air gesture is detected has elapsed (e.g., FIGS. 19C and/or 19H). In some embodiments, when the wrist gesture (e.g., 1908, 1910, 1920, and/or 1922) is detected within the threshold period of time after the first air gesture (e.g., 1902 and/or 1914) is detected, the computer system outputs the third non-visual feedback (e.g., 1912A, 1912B, 1924A, and/or 1924B) (and, optionally, performs the respective operation) before the threshold period of time after the first air gesture is detected has elapsed (e.g., when the wrist gesture is detected). Outputting second non-visual feedback in accordance with the determination that the wrist gesture is not detected within the threshold period of time after the first air gesture is detected, and outputting third non-visual feedback different from the second non-visual feedback in accordance with the determination that the wrist gesture is detected within the threshold period of time after the first air gesture is detected provides the user with feedback about a state of the system (e.g., whether the computer system has detected the wrist gesture within the threshold period of time after the first air gesture is detected). Doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to detecting the first air gesture (e.g., 1902 and/or 1914): the computer system displays, via one or more display generation components (e.g., one or more display generation components that are in communication with the computer system), first visual feedback (e.g., FIG. 19B visually emphasizing text entry field 714 and/or FIG. 19G visually emphasizing play/pause button 610B) (e.g., first visual feedback indicative of the first air gesture being detected, first visual feedback corresponding to the first air gesture, and/or first visual feedback corresponding to and/or indicative of the respective operation); and in accordance with a determination that the wrist gesture is not detected within the threshold period of time after the first air gesture is detected, the computer system, displays, via the one or more display generation components, second visual feedback different from the first visual feedback (e.g., second visual feedback corresponding to and/or indicative of the respective operation being performed) (e.g., FIG. 19C, displaying voice dictation user interface 730; and/or in FIG. 19H, displaying play/pause button 610B change from a pause button to a play button). In some embodiments, in response to detecting the first air gesture: in accordance with a determination that the wrist gesture is detected within the threshold period of time after the first air gesture is detected, the computer system forgoes displaying the second visual feedback (e.g., FIGS. 19D and/or 19I). In some embodiments, in response to detecting the first air gesture (e.g., 1902 and/or 1914): in accordance with a determination that the wrist gesture is not detected within the threshold period of time after the first air gesture is detected, the computer system displays the second visual feedback after the threshold period of time after the first air gesture is detected has elapsed (e.g., FIGS. 19C and/or 19H). In some embodiments, in response to detecting the first air gesture: in accordance with a determination that the wrist gesture is detected within the threshold period of time after the first air gesture is detected, the computer system displays the second visual feedback before the threshold period of time after the first air gesture is detected has elapsed (e.g., FIGS. 19E and/or 19J). Displaying first visual feedback in response to detecting the first air gesture, and displaying second visual feedback when the respective operation is performed, provides the user with feedback about a state of the system (e.g., the computer system has detected the first air gesture, the computer system has not detected the wrist gesture within the threshold period of time, and/or the computer system has performed and/or is performing the respective operation). Doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, displaying the first visual feedback comprises visually emphasizing a first affordance (e.g., 714 in FIG. 19B and/or 610B in FIG. 19G) that corresponds to the respective operation (e.g., a first affordance that is selectable to perform the respective operation and/or that is indicative of the respective operation). In some embodiments, visually emphasizing the first affordance includes dimming, darkening, de-saturating, blurring, and/or visually de-emphasizing displayed content other than the first affordance. Visually emphasizing the first affordance in response to detecting the first air gesture provides the user with feedback about a state of the system (e.g., the computer system has detected the first air gesture and/or is about to perform the respective operation). Doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, displaying the second visual feedback different from the first visual feedback comprises modifying a visual appearance of the first affordance (e.g., ceasing display of 714 in FIGS. 19B-19C; and/or changing button 610B in FIGS. 19G-19H) (e.g., ceasing display of the first affordance, ceasing to visually emphasize the first affordance, and/or displaying an animation indicative of the first affordance being selected). Modifying a visual appearance of the first affordance in accordance with a determination that the wrist gesture is not detected within the threshold period of time after the first air gesture is detected provides the user with feedback about a state of the system (e.g., the computer system has not detected the wrist gesture and/or the computer system is performing the respective operation). Doing so also enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in accordance with a determination that a first set of computer system context criteria (e.g., based on location of the computer system, current time, network connectivity status, currently running applications, one or more active and/or ongoing functions and/or actions of one or more applications, status of one or more applications on the computer system, and/or battery charge) (e.g., the leftmost column in Table 1 and/or Table 2) is met, the respective operation is a first operation; (and, optionally the second operation is not performed in response to the air gesture) and in accordance with a determination that a second set of computer system context criteria ((e.g., based on location of the computer system, current time, network connectivity status, currently running applications, one or more active and/or ongoing functions and/or actions of one or more applications, status of one or more applications on the computer system, and/or battery charge) is met (e.g., the leftmost column in Table 1 and/or Table 2), the respective operation is a second operation different from the first operation (and, optionally the first operation is not performed is not performed in response to the air gesture) (e.g., in FIGS. 19A-19E, the context of computer system 600 is different from FIGS. 19F-19J and, accordingly, the operation performed in response to air gesture 1902 is different from the operation performed in response to air gesture 1914). In some embodiments, the same air gesture results in different operations being performed based on different contexts of the computer system. For example, in some embodiments, the context of the computer system can be used to differentiate between any of the operations described above in Table 1 and Table 2. Performing different operations in response to the same air gesture based on a context of the computer system enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the computer system (e.g., 600) is a wrist-worn device (e.g., a wearable smart watch, a wearable fitness monitor, or a wrist worn controller). The computer system being a wrist-worn device (e.g., a wearable smart watch) enables the computer system to provide feedback to the user without the user needing to pick up or hold the system, thereby providing an improved man-machine interface.

Note that details of the processes described above with respect to method 2000 (e.g., FIG. 20) are also applicable in an analogous manner to the methods described below/above. For example, method 2000 optionally includes one or more of the characteristics of the various methods described below/above with reference to method 900, 1000, 1200, 1300, 1400, 1600, 1800, and/or 2200. For example, in some embodiments, the motion gestures are the same motion gesture. For another example, in some embodiments, the air gestures are the same air gestures. For brevity, these details are not repeated below.

FIGS. 21A-21M illustrate exemplary devices and user interfaces for performing operations in response to detected gestures, in accordance with some embodiments. The user interfaces in these figures are used to illustrate the processes described below, including the process in FIG. 22.

FIG. 21A illustrates a user wearing wearable computer system 600 (e.g., a smart watch) on left wrist 1903A of a user. Computer system 600 includes display 602 (e.g., a touchscreen display) rotatable input mechanism 604 (e.g., a crown or a digital crown), and button 605. Computer system 600 is displaying, via display 602, message conversation 2100 (e.g., similar to message conversation 712 discussed above with reference to FIGS. 7B-7C). In FIG. 21A, message conversation 2100 includes messages 2100A-2100D that have previously been exchanged between a user of computer system 600 and an external user (e.g., “John Appleseed”). In some embodiments, message conversation 2100 is associated with (e.g., includes and/or corresponds to) text entry field 2106, which is not displayed in FIG. 21A (but is displayed later in FIG. 21C). In some embodiments, text entry field 2106 is an affordance that is selectable by a user to initiate a dictation operation and/or a dictation function of computer system 600, in which a user can dictate (e.g., speak) a message to be transmitted into message conversation 2100 (e.g., in some embodiments, similar to the process shown and described above with reference to text entry field 714 in FIGS. 7I-7J). In some embodiments, text entry field 2106 is displayed at the end of message conversation 2100 (e.g., below a latest and/or most recent message transmitted into message conversation 2100) (e.g., see FIG. 21C). In FIG. 21A, computer system 600 displays a portion of message conversation 2100, and does not display text entry field 2106. At FIG. 21A, computer system 600 detects air gesture 2102 (e.g., a pinch air gesture, a double pinch air gesture, a tap air gesture, and/or a pinch-and-hold air gesture) performed by hand 1901A.

At FIG. 21B, in response to detecting air gesture 2102, and based on a determination that message conversation 2100 is scrollable (e.g., includes additional content that is not displayed) and that text entry field 2106 is not displayed (e.g., when air gesture 2102 is detected), computer system 600 scrolls message conversation 2100 to display additional messages 2100E-2100G. In some embodiments, message conversation 2100 is also scrollable by rotating rotatable input mechanism 604 (e.g., scroll upwards by rotating rotatable input mechanism 604 in a first direction (e.g., clockwise or counterclockwise); and scroll downwards by rotating rotatable input mechanism 604 in a second direction (e.g., counterclockwise or clockwise)). In some embodiments, message conversation 2100 is also scrollable by providing a touch input via touch-sensitive display 602 (e.g., swipe in a first direction (e.g., up or down) to scroll up; and swipe in a second direction (e.g., down or up) to scroll down). At FIG. 21B, despite scrolling message conversation 2100, the end of message conversation 2100 is still not reached and text entry field 2106 is still not displayed. At FIG. 21B, computer system 600 detects air gesture 2104 (e.g., a pinch air gesture, a double pinch air gesture, a tap air gesture, and/or a pinch-and-hold air gesture) performed by hand 1901A.

At FIG. 21C, in response to detecting air gesture 2104, and based on a determination that message conversation 2100 is scrollable and that text entry 2106 is not displayed (e.g., when air gesture 2104 is detected), computer system 600 once again scrolls message conversation 2100 to display additional messages 2100H-2100J, and also to display text entry field 2106. At FIG. 21C, computer system 600 detects air gesture 2108 (e.g., a pinch air gesture, a double pinch air gesture, a tap air gesture, and/or a pinch-and-hold air gesture) performed by hand 1901A.

At FIG. 21D, in response to detecting air gesture 2108, computer system 600 highlights (e.g., visually emphasizes) text entry field 2106, and dims and/or otherwise visually de-emphasizes other aspects of message conversation 2100 to indicate that computer system 600 is about to perform a dictation operation in response to air gesture 2108. In response to detecting air gesture 2108, computer system 600 also outputs haptic output 2100A and audio output 2100B (e.g., to indicate that it has detected air gesture 2108).

As discussed above with reference to FIGS. 19A-19J, in some embodiments, when computer system 600 detects an air gesture (e.g., detects a particular air gesture), computer system 600 performs a particular operation based on the current operating context of computer system 600. In some embodiments, computer system 600 performs the particular operation after a threshold amount of time has elapsed after detecting the particular air gesture. In this way, a user is given the opportunity to cancel the operation before it is performed, as will be described in greater detail below. For example, in some embodiments, a user can provide a wrist gesture to cancel the operation before it is performed, as described above with reference to FIGS. 19A-19J. In FIG. 21D, computer system 600 highlights text entry field 2106 and displays progress indicator 744 to indicate when the operation corresponding to text entry field 2106 will be performed (and/or to indicate how much time the user has to provide a cancellation gesture and/or a wrist gesture to cancel the dictation operation).

At FIG. 21E, in response to air gesture 2108 (and, in some embodiments, optionally, based on a determination that the threshold amount of time has elapsed since computer system 600 detected air gesture 2108 without an intervening wrist gesture) and based on a determination that text entry field 2106 is displayed (e.g., when air gesture 2108 was detected), computer system 600 prepares to perform the dictation operation corresponding to selection of text entry field 2106. In the depicted embodiments, this includes displaying voice dictation user interface 730 for a user to verbally provide a message to be transmitted into message conversation 2100 (e.g., as described above with reference to FIGS. 7I-7J). In FIG. 21E, computer system 600 also outputs haptic output 2112A and audio output 2112B indicating that the threshold duration of time has elapsed and/or that the dictation operation has been performed. In some embodiments, rather than providing air gesture 2108, a user can perform the dictation operation by providing a touch input selecting text entry field 2106 (e.g., as indicated by user input 2109 in FIG. 21C).

FIG. 21F depicts a different example scenario in which computer system 600 is in a locked state (e.g., as indicated by lock icon 1104), and has received an indication of a new message received from an external device. At FIG. 21F, in response to receiving the new message, computer system 600 displays notification 2114, which displays message 2114A. In some embodiments, notification 2114 is associated with (e.g., includes and/or corresponds to) reply affordance 2120, which is not displayed in FIG. 21F (but is displayed later in FIG. 21H). In some embodiments, reply affordance 2120 is an affordance that is selectable by a user to initiate a dictation operation and/or a dictation function of computer system 600, in which a user can dictate (e.g., speak) a message to respond to message 2114A. In some embodiments, reply affordance 2120 is displayed at the end of notification 2114 (e.g., below notification 2114) (e.g., see FIG. 21H). In FIG. 21F, computer system 600 displays a portion of notification 2114 (e.g., a portion of message 2114A), and does not display reply affordance 2120. At FIG. 21F, computer system 600 detects air gesture 2116 (e.g., a pinch air gesture, a double pinch air gesture, a tap air gesture, and/or a pinch-and-hold air gesture) performed by hand 1901A.

At FIG. 21G, in response to detecting air gesture 2116, and based on a determination that notification 2114 is scrollable (e.g., includes additional content that is not displayed) and that reply affordance 2120 is not displayed (e.g., when air gesture 2116 is detected), computer system 600 scrolls notification 2114 to display additional content of message 2114A. In some embodiments, notification 2114 is also scrollable by rotating rotatable input mechanism 604 (e.g., scroll upwards by rotating rotatable input mechanism 604 in a first direction (e.g., clockwise or counterclockwise); and scroll downwards by rotating rotatable input mechanism 604 in a second direction (e.g., counterclockwise or clockwise) (e.g., a second direction opposite the first direction)). In some embodiments, notification 2114 is also scrollable by providing a touch input via touch-sensitive display 602 (e.g., swipe in a first direction (e.g., up or down) to scroll up; and swipe in a second direction (e.g., down or up) (e.g., a second direction opposite the first direction) to scroll down). In some embodiments, the device will scroll content using a combination of inputs (e.g., scrolling using an air gesture and then scrolling using a touch input, scrolling using a touch input and then scrolling using an air gesture, scrolling using a rotatable input mechanism and then scrolling using an air gesture, and/or scrolling using an air gesture and then scrolling using a rotatable input mechanism). At FIG. 21G, despite scrolling notification 2114, the end of notification 2114 is still not reached and reply affordance 2120 is still not displayed. At FIG. 21G, computer system 600 detects air gesture 2118 (e.g., a pinch air gesture, a double pinch air gesture, a tap air gesture, and/or a pinch-and-hold air gesture) performed by hand 1901A.

At FIG. 21H, in response to detecting air gesture 2118, and based on a determination that notification 2114 is scrollable and that reply affordance 2120 is not displayed (e.g., when air gesture 2118 is detected), computer system 600 once again scrolls notification 2114 to display additional content of message 2114A, and also to display reply affordance 2120. At FIG. 21H, computer system 600 detects air gesture 2122 (e.g., a pinch air gesture, a double pinch air gesture, a tap air gesture, and/or a pinch-and-hold air gesture) performed by hand 1901A.

At FIG. 21I, in response to detecting air gesture 2122 (and, optionally, in some embodiments, based on a determination that the threshold amount of time has elapsed since computer system 600 detected air gesture 2122 without an intervening wrist gesture), and based on a determination that reply affordance 2120 is displayed (e.g., when air gesture 2122 was detected), computer system 600 performs the dictation operation that corresponds to selection of reply affordance 2120. In the depicted embodiments, this includes displaying voice dictation user interface 730 for a user to verbally provide a message to be transmitted to another user in response to message 2114A. In FIG. 21I, computer system 600 also outputs haptic output 2126A and audio output 2126B indicating that the dictation operation has been performed. In some embodiments, rather than providing air gesture 2122, a user can perform the dictation operation by providing a touch input selecting reply affordance 2120 (e.g., as indicated by user input 2124 in FIG. 21H).

FIG. 21J depicts a different example scenario in which computer system 600 detects an air gesture while displaying non-scrollable content. In FIG. 21J, computer system 600 is in a locked state (e.g., as indicated by lock icon 1104), and has received an indication of a new message received from an external device. At FIG. 21J, in response to receiving the new message, computer system 600 displays notification 2114-1, which displays content 2114A-1. However, in FIG. 21J, the received message is short and, as such, the entirety of notification 2114-1 fits on display 602 (e.g., notification 2114-1 is non-scrollable), and display 602 also displays reply affordance 2120. At FIG. 21J, computer system 600 detects air gesture 2128 (e.g., a pinch air gesture, a double pinch air gesture, a tap air gesture, and/or a pinch-and-hold air gesture) performed by hand 1901A. In response to detecting air gesture 2128, and based on a determination that notification 2114-1 is not scrollable and reply affordance 2120 is displayed (e.g., when air gesture 2128 is detected), computer system 600 computer system 600 performs the dictation operation that corresponds to selection of reply affordance 2120 (e.g., as shown in FIG. 21I). In some embodiments, rather than providing air gesture 2128, a user can perform the dictation operation by providing a touch input selecting reply affordance 2120 (e.g., as indicated by user input 2130 in FIG. 21J).

FIGS. 21K-21M depict a different example scenario in which computer system 600 detects an air gesture while displaying scrollable content that does not have a corresponding affordance and/or that does not include an affordance. In FIG. 21K, computer system 600 displays user interface 2132. User interface 2132 provides weather information. User interface 2132 is scrollable, but does not include any selectable affordances. At FIG. 21K, computer system 600 detects air gesture 2134 (e.g., a pinch air gesture, a double pinch air gesture, a tap air gesture, and/or a pinch-and-hold air gesture) performed by hand 1901A.

In some embodiments, in response to detecting air gesture 2134, and based on a determination that user interface 2132 does not include and/or correspond to an affordance, computer system 600 does not scroll user interface 2132 (and, optionally, does not perform an operation in response to air gesture 2134).

In some embodiments, and in FIG. 21L, in response to detecting air gesture 2134, and based on a determination that user interface 2132 does not include and/or correspond to an affordance, computer system 600 scrolls user interface 2132 to display additional content of user interface 2132. At FIG. 21L, computer system 600 detects air gesture 2136 (e.g., a pinch air gesture, a double pinch air gesture, a tap air gesture, and/or a pinch-and-hold air gesture) performed by hand 1901A. In the depicted embodiment, in FIG. 21M, in response to air gesture 2136, and based on a determination that user interface 2132 does not include and/or correspond to an affordance, computer system 600 scrolls user interface 2132 to display additional content of user interface 2132. In some embodiments, user interface 2132 is also scrollable by rotating rotatable input mechanism 604 (e.g., scroll upwards by rotating rotatable input mechanism 604 in a first direction (e.g., clockwise or counterclockwise); and scroll downwards by rotating rotatable input mechanism 604 in a second direction (e.g., counterclockwise or clockwise) (e.g., a second direction opposite the first direction)). In some embodiments, user interface 2132 is also scrollable by providing a touch input via touch-sensitive display 602 (e.g., swipe in a first direction (e.g., up or down) to scroll up; and swipe in a second direction (e.g., down or up) (e.g., a second direction opposite the first direction) to scroll down).

FIG. 22 is a flow diagram illustrating methods for performing operations in response to detected gestures, in accordance with some embodiments. Method 2200 is performed at a computer system (e.g., 100, 300, 500, 600, and/or 1510) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., a touch-sensitive surface, a touch-sensitive display, a button, a rotatable input mechanism, a depressible and rotatable input mechanism, a camera, an accelerometer, an inertial measurement unit (IMU), a blood flow sensor, a photoplethysmography sensor (PPG), and/or an electromyography sensor (EMG)) and, in some embodiments, is optionally in communication with one or more display generation components (e.g., a display, a touch-sensitive display, and/or a display controller). Some operations in method 2200 are, optionally, combined, the orders of some operations are, optionally, changed, and some operations are, optionally, omitted.

In some embodiments, the computer system (e.g., 600) displays (2202), via the one or more display generation components (e.g., 602), a first portion of first content (e.g., 2100, 2114, 2114-1, and/or 2132) (e.g., displays at least a portion of the first content). While displaying the first portion of the first content (2204), the computer system detects (2206), via the one or more input devices, a first air gesture (e.g., 2102, 2104, 2108, 2116, 2118, 2122, 2128, 2134, and/or 2136) (e.g., a user input corresponding to movement of one or more fingers in the air, including one or more of a pinch air gesture, a double pinch air gesture, a long pinch air gesture, a tap air gesture, a double tap air gesture, and/or a swipe air gesture). In response to detecting the first air gesture (2208): in accordance with a determination that the first content (e.g., 2100, 2114, 2114-1, and/or 2132) includes scrollable content (e.g., the first content includes additional content that is not displayed on the one or more display generation components and/or includes additional content that extends beyond an edge of the one or more display generation components; and/or the first content includes additional content that is not displayed on the one or more display generation components and is scrollable to reveal the additional content), that the first content corresponds to (e.g., is associated with and/or includes) a first affordance (e.g., 2106 and/or 2120) for performing a first operation (e.g., a first affordance that is selectable and/or can be activated with an air gesture (e.g., selectable and/or can be activated to perform the first operation)), and that the first affordance is not displayed via the one or more display generation components (e.g., 602) (2210) (e.g., in FIGS. 21A and 21B, affordance 2106 is not displayed, and in FIGS. 21F and 21G, affordance 2120 is not displayed) (e.g., is not displayed via the one or more display generation components when the first air gesture is detected; and/or the first affordance is not part of the first portion of the first content), the computer system (e.g., 600) scrolls (2212) the first content to display a second portion of the first content that is different from the first portion of the first content (e.g., from FIGS. 21A-21B and FIGS. 21B-21C, computer system 600 scrolls user interface 2100; and from FIGS. 21F-21G, and FIGS. 21G-21H, computer system 600 scrolls notification 2114) (e.g., displays scrolling of the first content; displays movement of the first content (e.g., movement in which the first portion of the first content moves off of the one or more display generation components and the second portion of the first content moves onto the one or more display generation components); and/or displays the second portion of the first content that was not displayed when the first air gesture was detected (and, optionally, ceases display of a first portion of the first content that was displayed when the first air gesture was detected)). Scrolling content in response to an air gesture based on a determination that an affordance is not displayed enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently. In some embodiments, scrolling the content in response to the air gesture when the affordance is not displayed, and performing the first operation in response to the air gesture when the affordance is displayed, allows a user to view the entirety of the first content before deciding whether or not to perform the first operation, which enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in accordance with a determination that a first set of computer system context criteria (e.g., based on location of the computer system, current time, network connectivity status, currently running applications, one or more active and/or ongoing functions and/or actions of one or more applications, status of one or more applications on the computer system, and/or battery charge) is met (e.g., the leftmost column in Table 1 and/or Table 2) when the first air gesture (e.g., 2102, 2104, 2108, 2116, 2118, 2122, 2128, 2134, and/or 2136) is detected, the first operation is a first respective operation (e.g., the center and/or rightmost column in Table 1; and/or the rightmost column in Table 2) (and, optionally the second respective operation is not performed in response to the air gesture) (e.g., performing the first operation comprises performing the first respective operation (optionally, without performing the second respective operation)). In some embodiments, in accordance with a determination that a second set of computer system context criteria (e.g., based on location of the computer system, current time, network connectivity status, currently running applications, one or more active and/or ongoing functions and/or actions of one or more applications, status of one or more applications on the computer system, and/or battery charge) different from the first set of computer system context criteria is met (e.g., the leftmost column in Table 1 and/or Table 2) when the first air gesture is detected, the first operation is a second respective operation (e.g., the center and/or rightmost column in Table 1; and/or the rightmost column in Table 2) different from the first respective operation (and, optionally the first respective operation is not performed in response to the air gesture) (e.g., in some embodiments, performing the first operation comprises performing the second respective operation (optionally, without performing the first respective operation)). In some embodiments, the same air gesture results in different operations being performed based on different contexts of the computer system. For example, in some embodiments, the context of the computer system (e.g., the leftmost column in Table 1 and/or Table 2) can be used to differentiate between any of the operations described above in Table 1 and Table 2 (e.g., the center and/or rightmost column in Table 1; and/or the rightmost column in Table 2). Performing different operations in response to the same air gesture based on a context of the computer system enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to detecting the first air gesture (e.g., 2102, 2104, 2108, 2116, 2118, 2122, 2128, 2134, and/or 2136): in accordance with a determination that the first affordance (e.g., 2106 and/or 2120) for performing the first operation is displayed via the one or more display generation components when the first air gesture is detected (e.g., the first affordance is part of the first portion of the first content) (e.g., FIGS. 21C, 21H, and/or 21J), the computer system performs the first operation (e.g., FIGS. 21E and/or 21I). Scrolling content in response to an air gesture based on a determination that an affordance is not displayed, and performing the first operation in response to the air gesture when the affordance is displayed, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently. In some embodiments, scrolling the content in response to the air gesture when the affordance is not displayed, and performing the first operation in response to the air gesture when the affordance is displayed, allows a user to view the entirety of the first content before deciding whether or not to perform the first operation, which enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to detecting the first air gesture (e.g., 2102, 2104, 2108, 2116, 2118, 2122, 2128, 2134, and/or 2136): in accordance with a determination that the first affordance (e.g., 2106 and/or 2120) for performing the first operation is displayed via the one or more display generation components when the first air gesture is detected (e.g., the first affordance is part of the first portion of the first content) (e.g., FIGS. 21C, 21H, and/or 21J) and that a cancellation gesture (e.g., an air gesture, a touch input, and/or a wrist gesture) is not detected within a threshold period of time (e.g., within 0.1 seconds, 0.25 seconds, 0.5 seconds, or 1 second) after the first air gesture is detected, the computer system performs the first operation (e.g., FIGS. 21E and/or 21I). In some embodiments, in accordance with a determination that the first affordance (e.g., 2106 and/or 2120) for performing the first operation is displayed via the one or more display generation components when the first air gesture is detected (e.g., the first affordance is part of the first portion of the first content) (e.g., FIGS. 21C, 21H, and/or 21J) and that a cancellation gesture (e.g., an air gesture, a touch input, and/or a wrist gesture) is detected within a threshold period of time (e.g., within 0.1 seconds, 0.25 seconds, 0.5 seconds, or 1 second) after the first air gesture is detected, the computer system forgoes performance of the first operation (for example, as described above with reference to FIGS. 19A-19J, and FIG. 20, in accordance with some embodiments) (e.g., FIGS. 19D, 19E, 19I, and 19J describe examples of cancellation gestures, in accordance with some embodiments). In some embodiments, a cancellation gesture and/or a wrist gesture includes movement of a hand of a person over a wrist of the person (e.g., movement of a hand of the person over the wrist of the person while the person wears the computer system on the wrist such that the hand of the person at least partially covers the computer system that is worn on the wrist of the person). In some embodiments, a cancellation gesture and/or a wrist gesture includes movement of the wrist of a person (e.g., a user of the computer system and/or a user that is wearing the computer system) (e.g., a left wrist of the person, a right wrist of the person, a wrist on which on the computer system is worn, and/or a wrist on which the computer system is not worn). In some embodiments, a cancellation gesture and/or a wrist gesture includes movement of the wrist of a person in a prescribed and/or predetermined manner (e.g., downward movement of the wrist, movement of the wrist away from the face of the person, and/or movement of the wrist in a manner indicating that the person is no longer looking at the computer system). In some embodiments, a cancellation gesture and/or a wrist gesture includes movement of the wrist of a person in a prescribed and/or predetermined direction (e.g., downward movement of the wrist and/or movement of the wrist away from the face of the person)). Allowing a user to perform a first operation with an air gesture, and cancel the first operation with a cancellation gesture, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to detecting the first air gesture (e.g., 2102, 2104, 2108, 2116, 2118, 2122, 2128, 2134, and/or 2136): in accordance with a determination that the first content does not correspond to an affordance for performing a respective operation (e.g., in accordance with a determination that the first content does not include and/or does not correspond to an affordance that is selectable to perform a respective operation) (and, optionally, in accordance with a determination that the first content includes scrollable content; or, in some embodiments, regardless of whether the first content includes scrollable content) (e.g., in some embodiments, user interface 2132 in FIGS. 21K-21M does not include a selectable affordance), the computer system forgoes scrolling the first content (e.g., maintains display of the first portion of the first content) (e.g., in some embodiments, in FIG. 21K, in response to air gesture 2134, computer system 600 does not scroll user interface 2132). Scrolling content in response to an air gesture based on a determination that the first content corresponds to an affordance, and forgoing scrolling of the content when the first content does not correspond to an affordance, enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, in response to detecting the first air gesture (e.g., 2102, 2104, 2108, 2116, 2118, 2122, 2128, 2134, and/or 2136): in accordance with a determination that the first content does not correspond to an affordance for performing a respective operation (e.g., in accordance with a determination that the first content does not include and/or does not correspond to an affordance that is selectable to perform a respective operation) (and, optionally, in accordance with a determination that the first content includes scrollable content; or, in some embodiments, regardless of whether the first content includes scrollable content) (e.g., in some embodiments, user interface 2132 in FIGS. 21K-21M does not include a selectable affordance), the computer system scrolls the first content to display the second portion of the first content that is different from the first portion of the first content (e.g., FIGS. 21K-21M, computer system 600 scrolls user interface 2132 in response to air gestures 2134, 2136). In some embodiments, scrolling the first content to display the second portion of the first content includes displaying scrolling of the first content; displaying movement of the first content (e.g., movement in which the first portion of the first content moves off of the one or more display generation components and the second portion of the first content moves onto the one or more display generation components); and/or displaying the second portion of the first content that was not displayed when the first air gesture was detected (and, optionally, ceasing display of a first portion of the first content that was displayed when the first air gesture was detected). Scrolling content in response to an air gesture based on a determination that the first content does not correspond to an affordance enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the second portion of the first content includes the first affordance (e.g., 2106 and/or 2120) for performing the first operation (e.g., in FIGS. 21B-21C, computer system 600 scrolls user interface 2100 to reveal affordance 2106; and in FIGS. 21G-21H, computer system 600 scrolls notification 2114 to reveal affordance 2120). In some embodiments, scrolling the first content to display the second portion of the first content that is different from the first portion of the first content comprises scrolling the first content to display the first affordance for performing the first operation. Scrolling content in response to an air gesture based on a determination that an affordance is not displayed enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, while displaying the second portion of the first content (e.g., 2100 in FIG. 21B; and/or 2114 in FIG. 21G), the computer system detects, via the one or more input devices, a second air gesture (e.g., 2104 and/or 2118) (e.g., a second air gesture that is the same as the first air gesture (e.g., the same gesture and/or a second instance of the same gesture) or different from the air gesture). In response to detecting the second air gesture: in accordance with a determination that the first content includes scrollable content (e.g., the first content includes additional content that is not displayed on the one or more display generation components and/or includes additional content that extends beyond an edge of the one or more display generation components; and/or the first content includes additional content that is not displayed on the one or more display generation components and is scrollable to reveal the additional content) (e.g., 2100 in FIG. 21B and/or 2114 in FIG. 21G), that the first content corresponds to (e.g., is associated with and/or includes) a first affordance (e.g., 2106 and/or 2120) for performing the first operation (e.g., a first affordance that is selectable and/or can be activated with an air gesture (e.g., selectable and/or can be activated to perform the first operation)), and that the first affordance is not displayed via the one or more display generation components when the second air gesture is detected (e.g., the first affordance is not part of the second portion of the first content) (e.g., FIGS. 21B and/or 21G), the computer system scrolls the first content to display a third portion of the first content that is different from the first portion of the first content and the second portion of the first content (e.g., FIGS. 21B-21C and/or FIGS. 21G-21H). In some embodiments, scrolling the first content to display the third portion of the first content includes displaying scrolling of the first content; displaying movement of the first content (e.g., movement in which the second portion of the first content moves off of the one or more display generation components and the third portion of the first content moves onto the one or more display generation components); and/or displaying the third portion of the first content that was not displayed when the second air gesture was detected (and, optionally, ceasing display of a second portion of the first content that was displayed when the second air gesture was detected). In some embodiments, a user can provide multiple air gestures to continuously scroll the first content (e.g., until an end of the first content is reached and/or until the first affordance is displayed) (e.g., FIGS. 21A-21C; and/or FIGS. 21F-21H). In some embodiments, in response to detecting the second air gesture: in accordance with a determination that the first affordance is displayed when the second air gesture is detected, the computer system performs the first operation (e.g., FIGS. 21C-21E; and/or FIGS. 21H-21I). As noted elsewhere, the first operation is optionally a contextually determined operation that is different for different user interfaces or device contexts. Scrolling content in response to an air gesture based on a determination that an affordance is not displayed enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently. In some embodiments, scrolling the content in response to the air gesture when the affordance is not displayed, and performing the first operation in response to the air gesture when the affordance is displayed, allows a user to view the entirety of the first content before deciding whether or not to perform the first operation, which enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first content includes (or, in some embodiments, consists of and/or consists essentially of) a first notification (e.g., 2114 and/or 2114-1) (e.g., a push notification; a lock-screen notification; a notification that causes the computer system to transition from a sleep state to a wake state; a notification that causes the one or more display generation components to transition from an off state to an on state; a notification that causes the one or more display generation components to transition from a low power state to a high power state; a notification that is displayed in response to information generated by one or more applications of the computer system; and/or a notification that is displayed in response to information received at the computer system). In some embodiments when the first content includes a first notification, the first operation is a dismiss operation that dismisses the first notification. In some embodiments, when the first content includes a first notification, the first operation is an operation associated with the notification (e.g., an operation to initiate a response to a message, trigger dictation, open a voice communication channel with a smart doorbell, play a voicemail, start a meditation, start a workout, pause a timer, resume a timer, answer a phone call, end a phone call, stop an alarm, stop a stopwatch, resume a stopwatch, play media, pause media, switch between a compass dial and an elevation dial, record a message, send a message, toggle between different flashlight modes, open an application, start recording audio, stop recording audio, end navigation, and/or capture a photograph). Scrolling a notification in response to an air gesture based on a determination that an affordance is not displayed enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first content includes (or, in some embodiments, consists of and/or consists essentially of) one or more messages (e.g., 2100A-2100J, 2114A-1 and/or 2114A) received at the computer system (e.g., 600) from one or more external computer systems separate from the computer system (e.g., one or more text messages and/or one or more instant messages). In some embodiments, the first content comprises (or, in some embodiments, consists of and/or consists essentially of) one or more messages received at the computer system and transmitted to the computer system by one or more external users using one or more external computer systems separate from the computer system. In some embodiments, the first content corresponds to a messaging session between a user of the computer system and one or more external users separate from the user of the computer system (e.g., the first content includes a messaging user interface and/or a message transcript that includes one or more messages exchanged between the user of the computer system and the one or more external users) (e.g., FIGS. 21A-21D). In some embodiments when the first content includes one or more messages, the first operation includes transitioning to a mode for responding to the one or more messages or adding a message to a conversation that includes the one or more messages, such as enabling dictation of a response or recording of an audio response, opening a real-time communication channel with one or more participants in a conversation that includes the one or more messages, and/or displaying a user interface for composing a message that can be added to the conversation). Scrolling messages in response to an air gesture based on a determination that an affordance is not displayed enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first air gesture (e.g., 2102, 2104, 2108, 2116, 2118, 2122, 2128, 2134, and/or 2136) is a pinch air gesture. In some embodiments, the pinch air gesture includes movement of a thumb of a hand of a user with respect to a second finger (e.g., a forefinger) of the same hand of the user such that the tip of one finger touches the other and/or such that the tips of both fingers touch. Scrolling content in response to an air gesture based on a determination that an affordance is not displayed enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently. In some embodiments, scrolling the content in response to the air gesture when the affordance is not displayed, and performing the first operation in response to the air gesture when the affordance is displayed, allows a user to view the entirety of the first content before deciding whether or not to perform the first operation, which enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first air gesture (e.g., 2102, 2104, 2108, 2116, 2118, 2122, 2128, 2134, and/or 2136) is a double pinch air gesture. In some embodiments, the double-pinch air gesture includes movement of a thumb of a hand of a user with respect to a second finger (e.g., a forefinger) of the same hand of the user such that the tip of one finger touches the other finger twice within a threshold time and/or such that the tips of both fingers touch twice within the threshold time. Scrolling content in response to an air gesture based on a determination that an affordance is not displayed enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently. In some embodiments, scrolling the content in response to the air gesture when the affordance is not displayed, and performing the first operation in response to the air gesture when the affordance is displayed, allows a user to view the entirety of the first content before deciding whether or not to perform the first operation, which enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the first air gesture (e.g., 2102, 2104, 2108, 2116, 2118, 2122, 2128, 2134, and/or 2136) is a pinch-and-hold air gesture (e.g., a long pinch air gesture). In some embodiments, the pinch-and-hold air gesture includes movement of a thumb of a hand of a user with respect to a second finger (e.g., a forefinger) of the same hand of the user such that the tip of one finger touches the other finger and/or such that the tips of both fingers touch, and the touch is maintained for more than a threshold duration of time (e.g., a threshold hold duration of time, such as 0.1 seconds, 0.2 seconds, 0.3 seconds, 0.5 seconds, or 1 second). In some embodiments, the two fingers touching each other is not directly detected and is inferred from measurements/data from one or more sensors. In some embodiments, a pinch air gesture is detected based on the touch being maintained for less than a threshold duration of time (e.g., same as or different from the threshold hold duration of time; such as 0.01 seconds, 0.02 seconds, 0.05 seconds, 0.1 second, 0.2 seconds, or 0.3 seconds). Scrolling content in response to an air gesture based on a determination that an affordance is not displayed enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently. In some embodiments, scrolling the content in response to the air gesture when the affordance is not displayed, and performing the first operation in response to the air gesture when the affordance is displayed, allows a user to view the entirety of the first content before deciding whether or not to perform the first operation, which enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

In some embodiments, the computer system (e.g., 600) displays, via the one or more display generation components (e.g., 602), the first affordance (e.g., 2106 and/or 2120) for performing the first operation (e.g., in some embodiments, as part of the first content). While displaying the first affordance for performing the first operation, the computer system detects, via the one or more input devices, a selection input (e.g., 2109, 2124, and/or 2130) (e.g., a selection input that includes direct input on a portion of the computer system or another input that is not an air gesture) corresponding to selection of the first affordance (e.g., a touch input (e.g., a tap input, a double tap input, and/or a swipe input); a hardware input (e.g., a button press of a button, a press of a rotatable input mechanism, and/or a rotation of a rotatable input mechanism); and/or an air gesture). In response to detecting the selection input corresponding to selection of the first affordance, the computer system performs the first operation (e.g., FIGS. 21E and/or 21I). Allowing a user to provide a selection input to perform the first operation enhances the operability of the system and makes the user-system interface more efficient (e.g., by preventing erroneous inputs, and helping the user to provide proper inputs and reducing errors) which, additionally, reduces power usage and improves battery life of the device by enabling the user to use the system more quickly and efficiently.

Note that details of the processes described above with respect to method 2000 (e.g., FIG. 20) are also applicable in an analogous manner to the methods described below/above. For example, method 2000 optionally includes one or more of the characteristics of the various methods described below/above with reference to method 900, 1000, 1200, 1300, 1400, 1600, and/or 1800. For example, in some embodiments, the motion gestures are the same motion gesture. For another example, in some embodiments, the air gestures are the same air gestures. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve user inputs. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to better understand user inputs. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of user input detection, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

1.-290. (canceled)

291. A computer system configured to communicate with one or more input devices, comprising:
one or more processors; and
memory storing one or more programs configured to be executed by the one or more processors, the one or more programs including instructions for:
detecting, via the one or more input devices, a first air gesture; and
in response to detecting the first air gesture:
in accordance with a determination that a wrist gesture is not detected within a threshold period of time after the first air gesture is detected, performing a respective operation associated with the first air gesture; and
in accordance with a determination that a wrist gesture is detected within the threshold period of time after the first air gesture is detected, modifying performance of the respective operation.

292. The computer system of claim 291, wherein detecting the first air gesture comprises detecting movement of one or more fingers of a person.

293. The computer system of claim 292, wherein the first air gesture is a pinch air gesture.

294. The computer system of claim 292, wherein the first air gesture is a double pinch air gesture.

295. The computer system of claim 292, wherein the first air gesture is a pinch-and-hold air gesture.

296. The computer system of claim 291, wherein the wrist gesture includes movement of a wrist of a user in a downward direction.

297. The computer system of claim 291, wherein:
the computer system is worn on a first wrist of a user; and
the wrist gesture includes movement of a hand of the user over the computer system that is worn on the first wrist of the user.

298. The computer system of claim 291, wherein:
the first air gesture is performed using a first hand of a user; and
the wrist gesture is performed using a first wrist of the user that extends from the first hand of the user.

299. The computer system of claim 298, wherein:
detecting the first air gesture comprises detecting that the first air gesture is performed using the first hand of the user while the computer system is worn on the first wrist of the user; and
the determination that that the wrist gesture is detected comprises a determination that the wrist gesture is performed using the first wrist of the user while the computer system is worn on the first wrist of the user.

300. The computer system of claim 291, wherein modifying performance of the respective operation comprises forgoing performance of the respective operation.

301. The computer system of claim 291, wherein modifying performance of the respective operation comprises performing the respective operation before the threshold period of time after the first air gesture is detected has elapsed.

302. The computer system of claim 301, wherein modifying performance of the respective operation comprises performing the respective operation in response to detecting the wrist gesture and before the threshold period of time after the first air gesture is detected has elapsed.

303. The computer system of claim 291, the one or more programs further including instructions for:
in response to detecting the first air gesture, outputting first non-visual feedback.

304. The computer system of claim 291, the one or more programs further including instructions for:
in accordance with the determination that the wrist gesture is not detected within the threshold period of time after the first air gesture is detected, outputting second non-visual feedback.

305. The computer system of claim 304, the one or more programs further including instructions for:
in accordance with the determination that the wrist gesture is detected within the threshold period of time after the first air gesture is detected, forgoing outputting the second non-visual feedback.

306. The computer system of claim 304, the one or more programs further including instructions for:
in accordance with the determination that the wrist gesture is detected within the threshold period of time after the first air gesture is detected, outputting third non-visual feedback.

307. The computer system of claim 306, wherein:
outputting the second non-visual feedback comprises outputting the second non-visual feedback after the threshold period of time after the first air gesture is detected has elapsed; and
outputting the third non-visual feedback comprises outputting the third non-visual feedback before the threshold period of time after the first air gesture is detected has elapsed.

308. The computer system of claim 291, the one or more programs further including instructions for:
in response to detecting the first air gesture:
displaying, via one or more display generation components, first visual feedback; and
in accordance with a determination that the wrist gesture is not detected within the threshold period of time after the first air gesture is detected, displaying, via the one or more display generation components, second visual feedback different from the first visual feedback.

309. The computer system of claim 308, wherein displaying the first visual feedback comprises visually emphasizing a first affordance that corresponds to the respective operation.

310. The computer system of claim 309, wherein displaying the second visual feedback different from the first visual feedback comprises modifying a visual appearance of the first affordance.

311. The computer system of claim 291, wherein:
in accordance with a determination that a first set of computer system context criteria is met, the respective operation is a first operation; and
in accordance with a determination that a second set of computer system context criteria is met, the respective operation is a second operation different from the first operation.

312. The computer system of claim 291, wherein the computer system is a wrist-worn device.

313. A non-transitory computer-readable storage medium storing one or more programs configured to be executed by one or more processors of a computer system that is in communication with one or more input devices, the one or more programs including instructions for:
detecting, via the one or more input devices, a first air gesture; and
in response to detecting the first air gesture:
in accordance with a determination that a wrist gesture is not detected within a threshold period of time after the first air gesture is detected, performing a respective operation associated with the first air gesture; and
in accordance with a determination that a wrist gesture is detected within the threshold period of time after the first air gesture is detected, modifying performance of the respective operation.

314. A method, comprising:
at a computer system that is in communication with one or more input devices:
detecting, via the one or more input devices, a first air gesture; and
in response to detecting the first air gesture:
in accordance with a determination that a wrist gesture is not detected within a threshold period of time after the first air gesture is detected, performing a respective operation associated with the first air gesture; and
in accordance with a determination that a wrist gesture is detected within the threshold period of time after the first air gesture is detected, modifying performance of the respective operation.
